(19) United States
(12) Patent Application Publication
(10) Pub. No.: US 2024/0069973 A1
(43) Pub. Date: Feb. 29, 2024

(54) APPLICATION PROGRAMMING INTERFACE TO TERMINATE SOFTWARE WORKLOADS

(71) Applicant: NVIDIA Corporation, Santa Clara, CA (US)

(72) Inventors: Sanjay Chatterjee, San Ramon, CA (US); Sabu Nadarajan, Los Altos, CA (US); Sukesh Roy, San Ramon, CA (US); Madhukar Korupolu, Austin, TX (US); Nivedita Viswanath, San Jose, CA (US); Suryanarayan Ramamurthy, Sunnyvale, CA (US); Raghav Hrishikeshan Mukundan, Sunnyvale, CA (US); Abhijit Prakash Paithankar, San Jose, CA (US)

(21) Appl. No.: 18/219,017

(22) Filed: Jul. 6, 2023

Related U.S. Application Data
(60) Provisional application No. 63/400,887, filed on Aug. 25, 2022.

(51) Int. Cl. G06F 9/50

(52) U.S. Cl. CPC G06F 9/5033; G06F 9/5055

(57) ABSTRACT

Apparatuses, systems, and techniques to perform software workloads. In at least one embodiment, one or more circuits of a processor perform a first application programming interface to select a second application programming interface, wherein the second application programming interface terminates performance of one or more software workloads identified by the first application programming interface.

### CROSS-REFERENCE TO RELATED APPLICATIONS

This application claims the benefit of U.S. Provisional Application No. 63/400,887, entitled “MULTIPLE-NODE LAUNCHER,” filed Aug. 25, 2022, the entire contents of which is incorporated herein by reference. This application also incorporates for all purposes the full disclosure of co-pending U.S. patent application Ser. No. ______, filed concurrently herewith, entitled “APPLICATION PROGRAMMING INTERFACE TO LAUNCH SOFTWARE WORKLOADS” (Attorney Docket No. 0112912-760U50), and co-pending U.S. patent application Ser. No. ______, filed concurrently herewith, entitled “APPLICATION PROGRAMMING INTERFACE TO MONITOR SOFTWARE WORKLOADS” (Attorney Docket No. 0112912-A29US0).

### TECHNICAL FIELD

At least one embodiment pertains to processing resources used manage one or more applications executing on a distributed system. For example, at least one embodiment pertains to launching, monitoring, and/or terminating applications on a distributed system.

### BACKGROUND

Performing computational operations can use significant memory, time, or computing resources. The amount of memory, time, and/or resources (e.g., computing resources) can be improved. Computer programs can be organized where various components can be executed in different ways, in different orders, and using a plurality of computer systems. Despite computer hardware advances that accelerate or otherwise assist the performance of the various components of a computer program, advances are generally unable to take into account all of the various ways in which computer programs can be structured and the various ways that elements of computer programs can be distributed to computer systems. Generating a computational program to perform computational operations where some operations are deployed to various systems may cause a delay in execution of software programs while operations are completing.

### BRIEF DESCRIPTION OF THE DRAWINGS

FIG. 1 is a block diagram illustrating using a computing environment to perform operations, according to at least one embodiment;

FIG. 2 is a block diagram illustrating an example system that uses a multi-node launcher utility to launch and terminate a distributed application on multiple nodes, according to at least one embodiment;

FIG. 3 illustrates a process to use a multi-node launcher utility to launch and terminate a distributed application on multiple nodes, according to at least one embodiment;

FIG. 4 is a block diagram illustrating an example compute cluster of a high-performance computer system, in accordance with at least one embodiment;

FIG. 5 illustrates a process to launch one or more workloads using a high-performance computing environment, in accordance with at least one environment;

FIG. 6 illustrates a process to monitor one or more workloads using a high-performance computing environment, in accordance with at least one environment;

FIG. 7 illustrates a process to terminate one or more workloads using a high-performance computing environment, in accordance with at least one environment;

FIG. 8 is a block diagram illustrating a software program to be performed by one or more processors, in accordance with at least one embodiment;

FIG. 9 is a block diagram illustrating an application programming interface (API) to launch one or more software workloads, in accordance with at least one embodiment;

FIG. 10 is a block diagram illustrating an application programming interface (API) to monitor one or more software workloads, in accordance with at least one embodiment;

FIG. 11 is a block diagram illustrating an application programming interface (API) to terminate one or more software workloads, in accordance with at least one embodiment;

FIG. 12 illustrates a process to perform one or more application programming interfaces (APIs), in accordance with at least one embodiment;

FIG. 13 is a block diagram illustrating an example software stack where application programming interfaces (API) are processed, in accordance with at least one embodiment;

FIG. 14 is a block diagram illustrating a processor and modules, in accordance with at least one embodiment;

FIG. 15 is a block diagram illustrating a driver and/or runtime comprising one or more libraries to provide one or more application programming interfaces (APIs), in accordance with at least one embodiment;

FIG. 16 illustrates a distributed system, in accordance with at least one embodiment;

FIG. 17 illustrates an exemplary data center, in accordance with at least one embodiment;

FIG. 18 illustrates a client-server network, in accordance with at least one embodiment;

FIG. 19 illustrates an example of a computer network, in accordance with at least one embodiment;

FIG. 20A illustrates a networked computer system, in accordance with at least one embodiment;

FIG. 20B illustrates a networked computer system, in accordance with at least one embodiment;

FIG. 20C illustrates a networked computer system, in accordance with at least one embodiment;

FIG. 21 illustrates one or more components of a system environment in which services may be offered as third party network services, in accordance with at least one embodiment;

FIG. 22 illustrates a cloud computing environment, in accordance with at least one embodiment;

FIG. 23 illustrates a set of functional abstraction layers provided by a cloud computing environment, in accordance with at least one embodiment;

FIG. 24 illustrates a supercomputer at a chip level, in accordance with at least one embodiment;

FIG. 25 illustrates a supercomputer at a rack module level, in accordance with at least one embodiment;

FIG. 26 illustrates a supercomputer at a rack level, in accordance with at least one embodiment;

FIG. 27 illustrates a supercomputer at a whole system level, in accordance with at least one embodiment;

FIG. 28A illustrates inference and/or training logic, in accordance with at least one embodiment;

FIG. 28B illustrates inference and/or training logic, in accordance with at least one embodiment;

FIG. 29 illustrates training and deployment of a neural network, in accordance with at least one embodiment;

FIG. 30 illustrates an architecture of a system of a network, in accordance with at least one embodiment;

FIG. 31 illustrates an architecture of a system of a network, in accordance with at least one embodiment;

FIG. 32 illustrates a control plane protocol stack, in accordance with at least one embodiment;

FIG. 33 illustrates a user plane protocol stack, in accordance with at least one embodiment;

FIG. 34 illustrates components of a core network, in accordance with at least one embodiment;

FIG. 35 illustrates components of a system to support network function virtualization (NFV), in accordance with at least one embodiment;

FIG. 36 illustrates a processing system, in accordance with at least one embodiment;

FIG. 37 illustrates a computer system, in accordance with at least one embodiment;

FIG. 38 illustrates a system, in accordance with at least one embodiment;

FIG. 39 illustrates an exemplary integrated circuit, in accordance with at least one embodiment;

FIG. 40 illustrates a computing system, according to at least one embodiment;

FIG. 41 illustrates an APU, in accordance with at least one embodiment;

FIG. 42 illustrates a CPU, in accordance with at least one embodiment;

FIG. 43 illustrates an exemplary accelerator integration slice, in accordance with at least one embodiment;

FIGS. 44A and 44B illustrate exemplary graphics processors, in accordance with at least one embodiment;

FIG. 45A illustrates a graphics core, in accordance with at least one embodiment;

FIG. 45B illustrates a GPGPU, in accordance with at least one embodiment;

FIG. 46A illustrates a parallel processor, in accordance with at least one embodiment;

FIG. 46B illustrates a processing cluster, in accordance with at least one embodiment;

FIG. 46C illustrates a graphics multiprocessor, in accordance with at least one embodiment;

FIG. 47 illustrates a software stack of a programming platform, in accordance with at least one embodiment;

FIG. 48 illustrates a CUDA implementation of a software stack of FIG. 47, in accordance with at least one embodiment;

FIG. 49 illustrates a ROCm implementation of a software stack of FIG. 47, in accordance with at least one embodiment;

FIG. 50 illustrates an OpenCL implementation of a software stack of FIG. 47, in accordance with at least one embodiment;

FIG. 51 illustrates software that is supported by a programming platform, in accordance with at least one embodiment;

FIG. 52 illustrates compiling code to execute on programming platforms of FIGS. 47-50, in accordance with at least one embodiment; and

FIG. 53 illustrates components of a system to access a large language model, according to at least one embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

In at least one embodiment, distributed deep learning applications require a multi-node launcher utility to launch and terminate distributed application on multiple nodes. In at least one embodiment, multi-node launcher utilities exist in high performance computing (HPC) domain but have major shortcomings. In at least one embodiment, one shortcoming is HPC multi-node launchers are not aware of deep learning (DL) framework setup requirements and are not integrated with DL workload. In at least one embodiment, another shortcoming is HPC multi-node launchers do not work “out of the box” when used inside containers and typically require platform specific setup.

In at least one embodiment, ideally, a multi-node launcher on an AI training platform should provide a unified launch and termination mechanism for both HPC and DL applications when running inside a container using a same unified application programming interface (API). In at least one embodiment, a need exists for a launcher that can handle applications such as, MPI PyTorch and Tensorflow, with a unified API and one which requires no changes to existing applications.

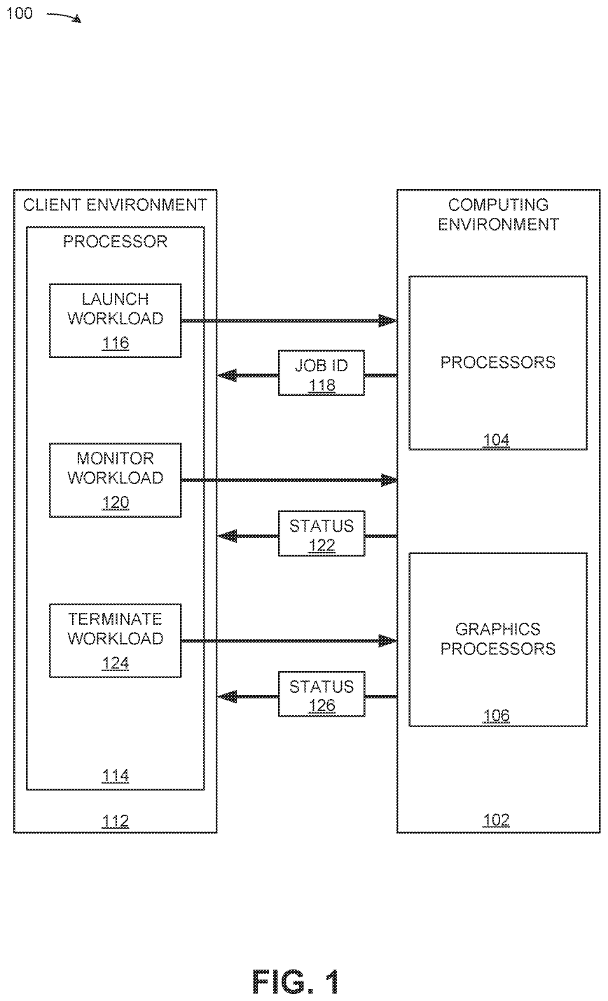

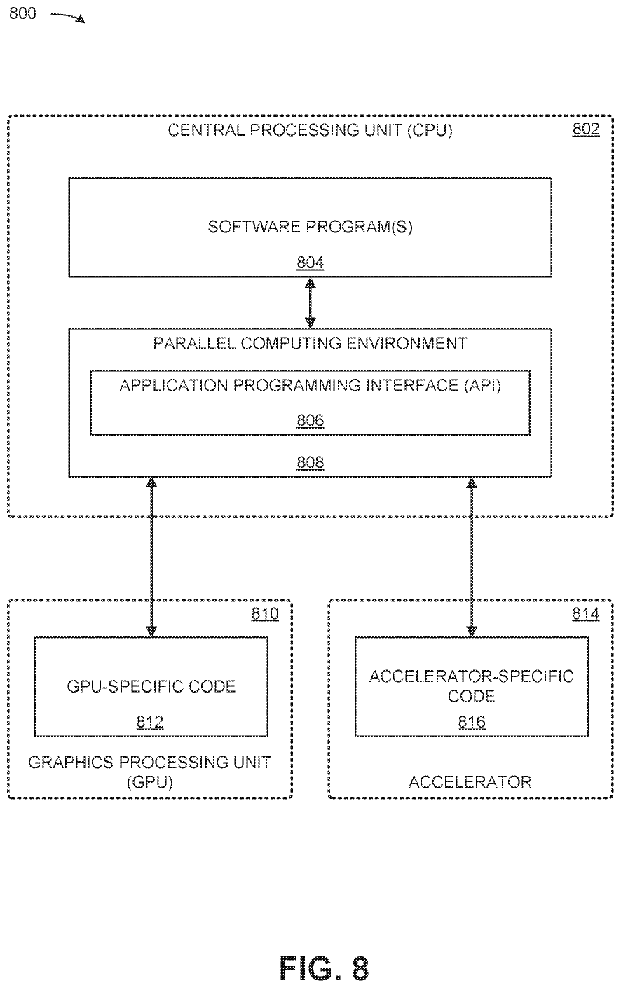

FIG. 1 is a block diagram 100 illustrating using a computing environment to perform operations, according to at least one embodiment. In at least one embodiment, a processor 114 of a client environment 112 comprises one or more circuits to cause one or more application programming interfaces (APIs) to perform operations described herein. In at least one embodiment, an application programming interface (API) specifies or otherwise indicates one or more operations to be performed by a processor such as those described herein to cause one or more operations to be performed by said processor (e.g., to launch software workloads, to monitor software workloads, to terminate software workloads, and/or other such operations described herein). In at least one embodiment, client environment 112 is an environment of one or more client devices such as those described herein. In at least one embodiment, not shown in FIG. 1, client environment 112 is an environment of one or more client devices that are clients of a cloud computing environment such as those described herein. In at least one embodiment, processor 114 is a processor such as those described below. In at least one embodiment, processor 114 is a central processing unit (CPU), a graphics processing unit (GPU), a parallel processing unit (PPU), a general-purpose graphics processing unit (GPGPU), a compute cluster, and/or a combination of these and/or other such processors. In at least one embodiment, processor 114 is part of a computer system such as those described herein. In at least one embodiment, an API is an API such as those described herein at least in connection with FIGS. 8-15.

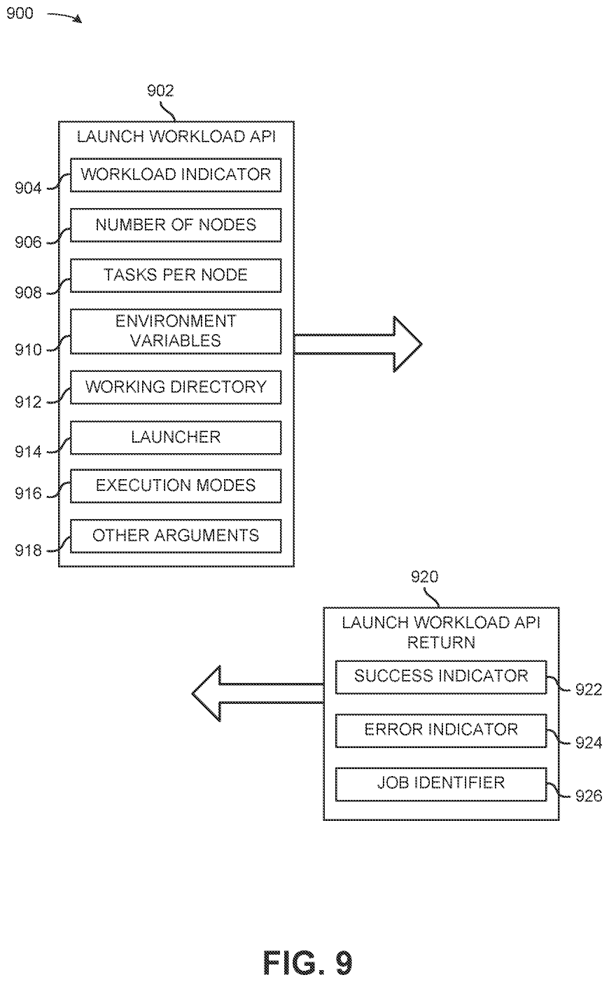

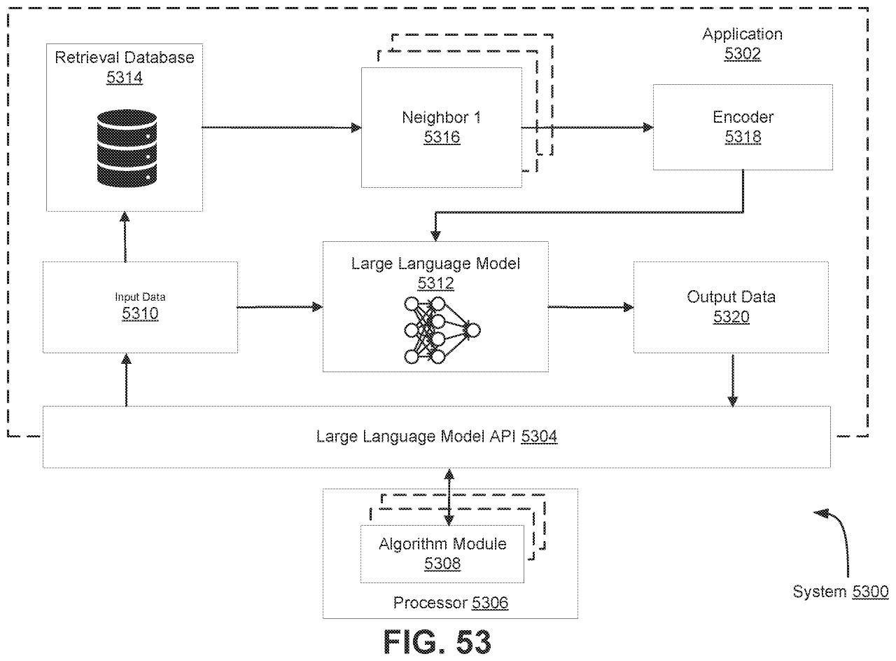

In at least one embodiment, one or more circuits of processor 114 cause a launch workload 116 operation to be performed. In at least one embodiment, launch workload 116 includes operations to perform software workloads using computing environment 102. In at least one embodiment, for example, launch workload 116 includes launching a workload to perform a neural network training operation, as described herein, launching a workload to perform one or more molecular chemistry analyses, launching a workload to perform a large language module (e.g., as described herein at least in connection with FIG. 53), and/or other operations described herein. In at least one embodiment, launch workload 116 is performed using an API such as launch workload API 902, described herein at least in connection with FIG. 9. In at least one embodiment, launch workload 116 is to cause a first application programming interface (API) to select a second API to perform one or more software workloads identified by the first API. In at least one embodiment, not shown in FIG. 1, launch workload 116 comprises one or more arguments including, but not limited to, those described herein in accordance with FIG. 9. In at least one embodiment, launch workload 116, when performed, launches a single workload or a single job. In at least one embodiment, launch workload 116, when performed, launches a single workload with a plurality of jobs. In at least one embodiment, monitor workload 120, when performed, launches a plurality of workloads.

In at least one embodiment, launch workload 116 is indicated, sent, or otherwise provided to computing environment 102. In at least one embodiment, computing environment 102 is a high-performance computing environment. In at least one embodiment, computing environment 102 is a deep-learning environment. In at least one embodiment, launch workload 116 is performed using computing environment 102, using systems, methods, operations, and/or techniques described herein. In at least one embodiment, computing environment 102 is a cloud computing environment such as those described herein. In at least one embodiment, computing environment 102 comprises one or more processors 104. In at least one embodiment, computing environment 102 comprises one or more graphics processors 106. In at least one embodiment, processors 104 comprise one or more processors such as those described herein. In at least one embodiment, graphics processors 106 are one or more graphics processors such as those described herein. In at least one embodiment, not shown in FIG. 1, processors 104 and/or graphics processors 106 include one or more central processing units (CPUs), graphics processing units (GPUs), parallel processing units (PPUs), general-purpose graphics processing units (GPGPUs), compute clusters, and/or a combination of these and/or other such processors, as described herein.

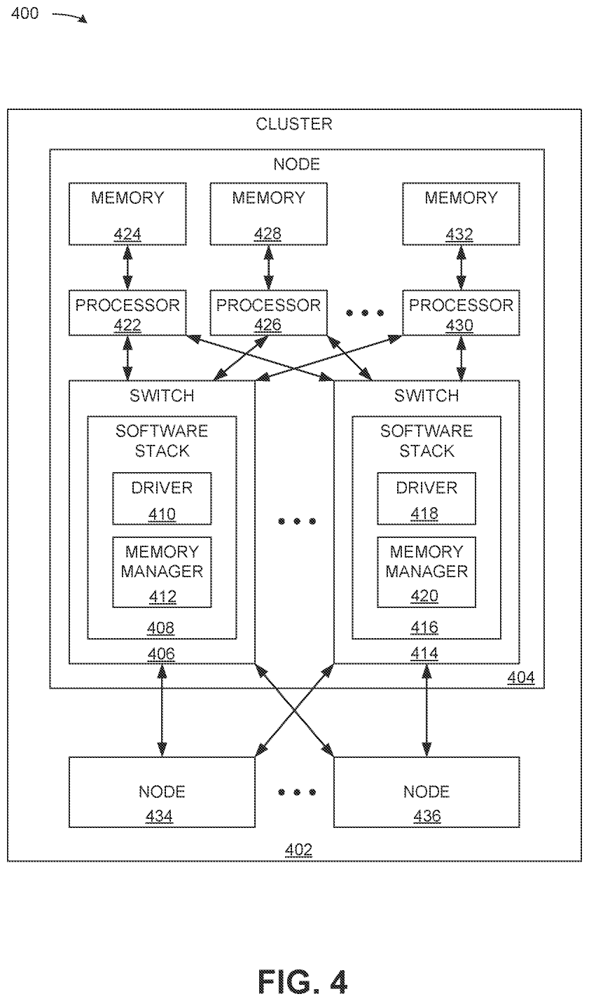

In at least one embodiment, at least a portion of launch workload 116 is performed using one or more of processors 104 and/or one or more of graphics processors 106. In at least one embodiment, processors 104 comprises one or more processors such as those described herein. In at least one embodiment, graphics processors 106 comprises one or more graphics processors such as those described herein. In at least one embodiment, one or more processors of processors 104 are connected together using systems and methods such as those described herein. In at least one embodiment, for example, at least some processors of processors 104 are connected together using one or more clusters such as cluster 402, described herein at least in connection with FIG. 4. In at least one embodiment, one or more graphics processors of graphics processors 106 are connected together using systems and methods such as those described herein. In at least one embodiment, for example, at least some graphics processors of graphics processors 106 are connected together using one or more clusters such as cluster 402, described herein at least in connection with FIG. 4.

In at least one embodiment, not shown in FIG. 1, when launch workload 116 is performed using computing environment 102, one or more additional APIs such as those described herein is performed (e.g., using processors 104 and/or graphics processors 106). In at least one embodiment, not shown in FIG. 1, when launch workload 116 is performed using computing environment 102, at least a portion of launch workload 116 is performed using one or more additional processors of computing environment 102 (e.g., one or more of processors 104 and/or one or more of graphics processors 106). In at least one embodiment, computing environment 102 indicates, sends, or otherwise provides one or more responses to client environment 112 including, but not limited to, those described herein at least in connection with FIG. 9. In at least one embodiment, computing environment 102 indicates, sends, or otherwise provides a job ID 118 (e.g., a job identifier) to client environment 112. In at least one embodiment, job ID 118 indicates one or more processes of computing environment 102 used to perform launch workload 116. In at least one embodiment, not shown in FIG. 1, job ID 118 comprises a plurality of identifiers of processes of computing environment 102 used to perform launch workload 116.

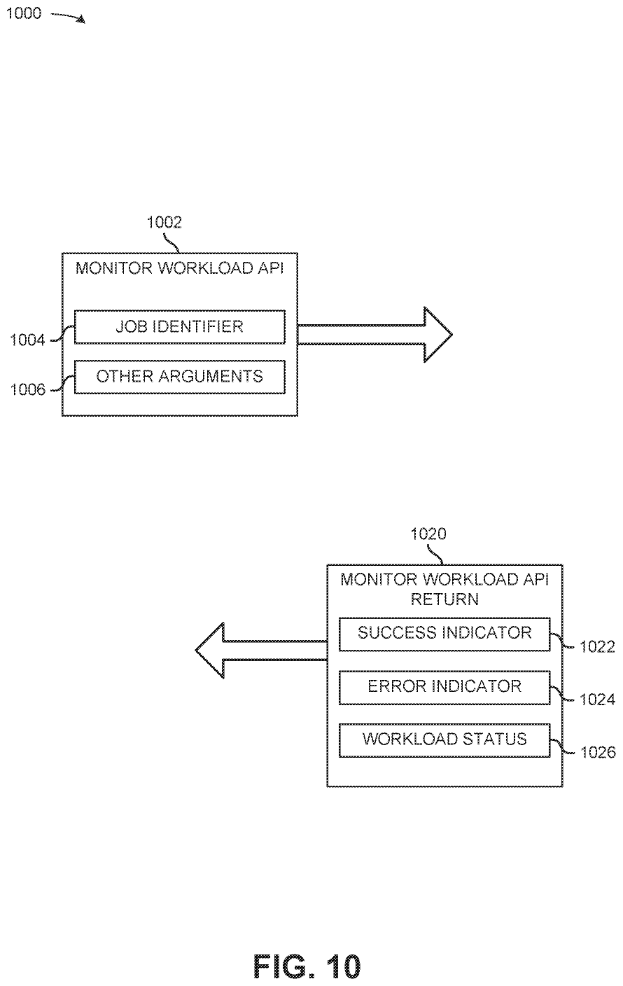

In at least one embodiment, one or more circuits of processor 114 cause a monitor workload 120 operation to be performed. In at least one embodiment, monitor workload 120 is performed using an API such as monitor workload API 1002, described herein at least in connection with FIG. 10. In at least one embodiment, monitor workload 120 is to perform a first application programming interface (API) to select a second API to monitor performance of one or more software workloads identified by the first API. In at least one embodiment, not shown in FIG. 1, monitor workload 120 comprises one or more arguments including, but not limited to, those described herein in accordance with FIG. 10. In at least one embodiment, said one or more arguments comprise one or more job IDs (e.g., such as job ID 118) that indicate processes to be monitored. In at least one embodiment, said one or more job IDs indicate processes of computing environment 102 used to perform launch workload 116, as described above. In at least one embodiment, monitor workload 120, when performed, monitors a single workload (e.g., corresponding to a job ID such as job ID 118). In at least one embodiment, monitor workload 120, when performed, monitors a plurality of workloads (e.g., corresponding to a single job ID such as job ID 118).

In at least one embodiment, monitor workload 120 is indicated, sent, or otherwise provided to computing environment 102. In at least one embodiment, monitor workload 120 is performed using computing environment 102, using systems, methods, operations, and/or techniques described herein. In at least one embodiment, at least a portion of monitor workload 120 is performed using one or more of processors 104 and/or one or more of graphics processors 106.

In at least one embodiment, not shown in FIG. 1, when monitor workload 120 is performed using computing environment 102, one or more additional APIs such as those described herein is performed (e.g., using processors 104 and/or graphics processors 106). In at least one embodiment, not shown in FIG. 1, when monitor workload 120 is performed using computing environment 102, at least a portion of monitor workload 120 is performed using one or more additional processors of computing environment 102 (e.g., one or more of processors 104 and/or one or more of graphics processors 106). In at least one embodiment, computing environment 102 indicates, sends, or otherwise provides one or more responses to monitor workload 120 including, but not limited to, those described herein at least in connection with FIG. 10. In at least one embodiment, computing environment 102 indicates, sends, or otherwise provides a status 122 (e.g., a status of one or more workloads to be monitored) to client environment 112. In at least one embodiment, status 122 indicates status of one or more workloads to be monitored such as, for example, running, waiting, terminated, one or more error conditions, etc. In at least one embodiment, status 122 indicates a status of one or more processes of computing environment 102 used to perform launch workload 116, as described above. In at least one embodiment, not shown in FIG. 1, status 122 comprises a plurality of statuses of processes of computing environment 102 used to perform launch workload 116, as described above.

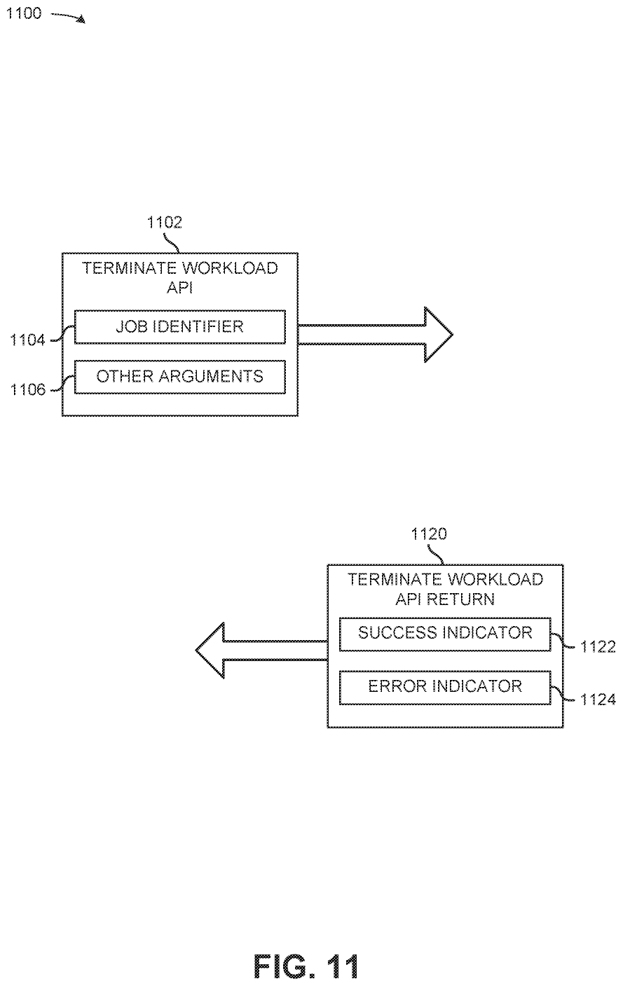

In at least one embodiment, one or more circuits of processor 114 cause a terminate workload 124 operation to be performed. In at least one embodiment, terminate workload 124 is performed using an API such as terminate workload API 1102, described herein at least in connection with FIG. 11. In at least one embodiment, terminate workload 124 is to perform a first application programming interface (API) to select a second API to terminate performance of one or more software workloads identified by the first API. In at least one embodiment, not shown in FIG. 1, terminate workload 124 comprises one or more arguments including, but not limited to, those described herein in accordance with FIG. 11. In at least one embodiment, said one or more arguments comprise one or more job IDs (e.g., such as job ID 118) that indicate processes to be terminated. In at least one embodiment, said one or more job IDs indicate processes of computing environment 102 used to perform launch workload 116, as described above. In at least one embodiment, terminate workload 124, when performed, causes a single workload (e.g., corresponding to a job ID such as job ID 118) to be terminated. In at least one embodiment, terminate workload 124, when performed, causes a plurality of workloads (e.g., corresponding to a single job ID such as job ID 118) to be terminated.

In at least one embodiment, terminate workload 124 is indicated, sent, or otherwise provided to computing environment 102. In at least one embodiment, terminate workload 124 is performed using computing environment 102, using systems, methods, operations, and/or techniques described herein. In at least one embodiment, at least a portion of terminate workload 124 is performed using one or more of processors 104 and/or one or more of graphics processors 106.

In at least one embodiment, not shown in FIG. 1, when terminate workload 124 is performed using computing environment 102, one or more additional APIs such as those described herein is performed (e.g., using processors 104 and/or graphics processors 106). In at least one embodiment, not shown in FIG. 1, when terminate workload 124 is performed using computing environment 102, at least a portion of terminate workload 124 is performed using one or more additional processors of computing environment 102 (e.g., one or more of processors 104 and/or one or more of graphics processors 106). In at least one embodiment, computing environment 102 indicates, sends, or otherwise provides one or more responses to terminate workload 124 including, but not limited to, those described herein at least in connection with FIG. 11. In at least one embodiment, computing environment 102 indicates, sends, or otherwise provides a status 126 (e.g., a status of one or more workloads to be terminated) to client environment 112. In at least one embodiment, status 126 indicates status of one or more workloads to be terminated such as, for example, terminated, not terminated, one or more error conditions, etc. In at least one embodiment, status 126 indicates a status of one or more processes of computing environment 102 used to perform launch workload 116, as described above. In at least one embodiment, not shown in FIG. 1, status 126 comprises a plurality of statuses of processes of computing environment 102 used to perform launch workload 116, as described above.

In at least one embodiment, one or more processors (e.g., processor 114, one or more of processors 104, one or more of graphics processors 106, and/or other processors and/or accelerators such as those described herein) comprise one or more circuits to perform operations or instructions described herein, such as one or more circuits to cause a first application programming interface (API) to select a second API to perform one or more software workloads identified by the first API. In at least one embodiment, one or more processors comprise one or more circuits to perform operations or instructions described herein, such as one or more circuits to cause a first application programming interface (API) to select a second API to perform one or more software workloads identified by the first API using an API such as launch workload API 902, described herein at least in connection with FIG. 9. In at least one embodiment, one or more processors comprise one or more circuits to perform operations or instructions described herein, such as one or more circuits to perform a first application programming interface (API) to cause a second API to be performed to cause one or more software workloads to be performed by one or more other processors. In at least one embodiment, not illustrated in FIG. 1, a machine-readable medium has stored thereon a set of instructions which, if performed by one or more processors, are to perform operations described herein at least in connection with FIGS. 1-15, such as operations to cause a first application programming interface (API) to select a second API to perform one or more software workloads identified by the first API. In at least one embodiment, one or more processors comprise one or more circuits to perform operations or instructions to cause a first application programming interface (API) to select a second API to perform one or more software workloads identified by the first API by at least performing operations to or instructions to perform a first application programming interface (API) to cause a second API to be performed to cause one or more software workloads to be performed by one or more other processors.

In at least one embodiment, one or more processors (e.g., processor 114, one or more of processors 104, one or more of graphics processors 106, and/or other processors and/or accelerators such as those described herein) comprise one or more circuits to perform operations or instructions described herein, such as one or more circuits to perform a first application programming interface (API) to select a second API to monitor performance of one or more software workloads identified by the first API. In at least one embodiment, one or more processors comprise one or more circuits to perform operations or instructions described herein, such as one or more circuits to perform a first application programming interface (API) to select a second API to monitor performance of one or more software workloads identified by the first API using an API such as monitor workload API 1002, described herein at least in connection with FIG. 10. In at least one embodiment, one or more processors comprise one or more circuits to perform operations or instructions described herein, such as one or more circuits to perform a first application programming interface (API) to cause a second API to performed to cause a status of one or more software workloads to be provided. In at least one embodiment, not illustrated in FIG. 1, a machine-readable medium has stored thereon a set of instructions which, if performed by one or more processors, are to perform operations described herein at least in connection with FIGS. 1-15, such as operations to perform a first application programming interface (API) to select a second API to monitor performance of one or more software workloads identified by the first API. In at least one embodiment, one or more processors comprise one or more circuits to perform operations or instructions to perform a first application programming interface (API) to select a second API to monitor performance of one or more software workloads identified by the first API by at least performing operations to or instructions to perform a first application programming interface (API) to cause a second API to performed to cause a status of one or more software workloads to be provided.

In at least one embodiment, one or more processors (e.g., processor 114, one or more of processors 104, one or more of graphics processors 106, and/or other processors and/or accelerators such as those described herein) comprise one or more circuits to perform operations or instructions described herein, such as one or more circuits to perform a first application programming interface (API) to select a second API to terminate performance of one or more software workloads identified by the first API. In at least one embodiment, one or more processors comprise one or more circuits to perform operations or instructions described herein, such as one or more circuits to perform a first application programming interface (API) to select a second API to terminate performance of one or more software workloads identified by the first API using an API such as terminate workload API 1102, described herein at least in connection with FIG. 11. In at least one embodiment, one or more processors comprise one or more circuits to perform operations or instructions described herein, such as one or more circuits to perform a first application programming interface (API) to cause a second API to be performed to cause one or more software workloads being performed by one or more other processors to be terminated. In at least one embodiment, not illustrated in FIG. 1, a machine-readable medium has stored thereon a set of instructions which, if performed by one or more processors, are to perform operations described herein at least in connection with FIGS. 1-15, such as operations to perform a first application programming interface (API) to select a second API to terminate performance of one or more software workloads identified by the first API. In at least one embodiment, one or more processors comprise one or more circuits to perform operations or instructions to perform a first application programming interface (API) to select a second API to terminate performance of one or more software workloads identified by the first API by at least performing operations to or instructions to perform a first application programming interface (API) to cause a second API to be performed to cause one or more software workloads being performed by one or more other processors to be terminated.

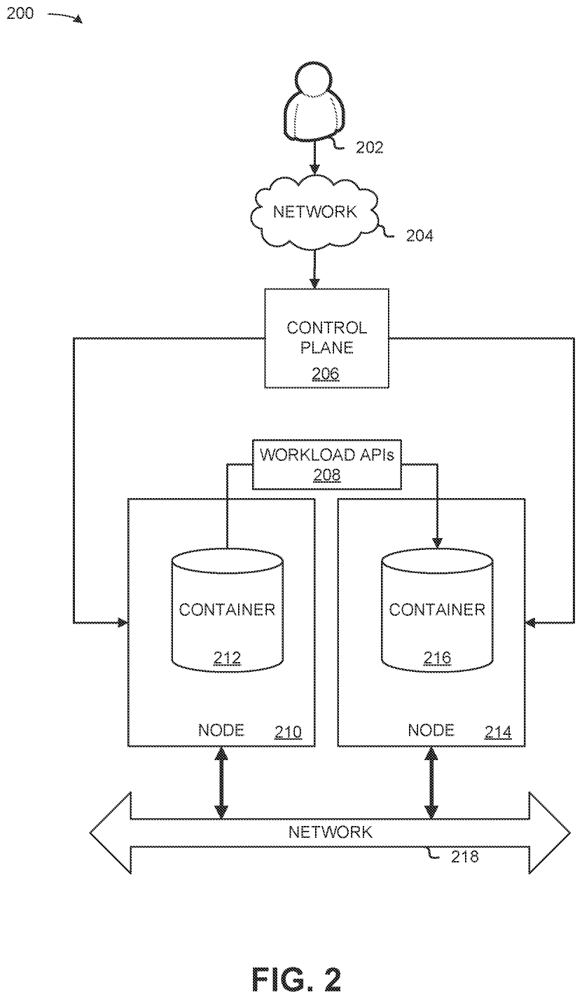

FIG. 2 is a block diagram 200 illustrating an example system that uses a multi-node launcher utility to launch and terminate a distributed application on multiple nodes, according to at least one embodiment. In at least one embodiment, a system illustrated in block diagram 200 is a collection of one or more hardware and/or software computing resources with instructions that, when executed, performs one or more communication processes such as those described herein. In at least one embodiment, a system illustrated in block diagram 200 is a software program executing on computer hardware, application executing on computer hardware, and/or variations thereof. In at least one embodiment, one or more processes of a system illustrated in block diagram 200 are performed by any suitable processing system or unit (e.g., graphics processing unit (GPU), general-purpose GPU (GPGPU), parallel processing unit (PPU), central processing unit (CPU)), such as described below, and in any suitable manner, including sequential, parallel, and/or variations thereof. In at least one embodiment, a system illustrated in block diagram 200 is a software program executing on one or more processors such as processor 114, one or more of processors 104, and/or one or more of graphics processors 106, described herein at least in connection with FIG. 1.

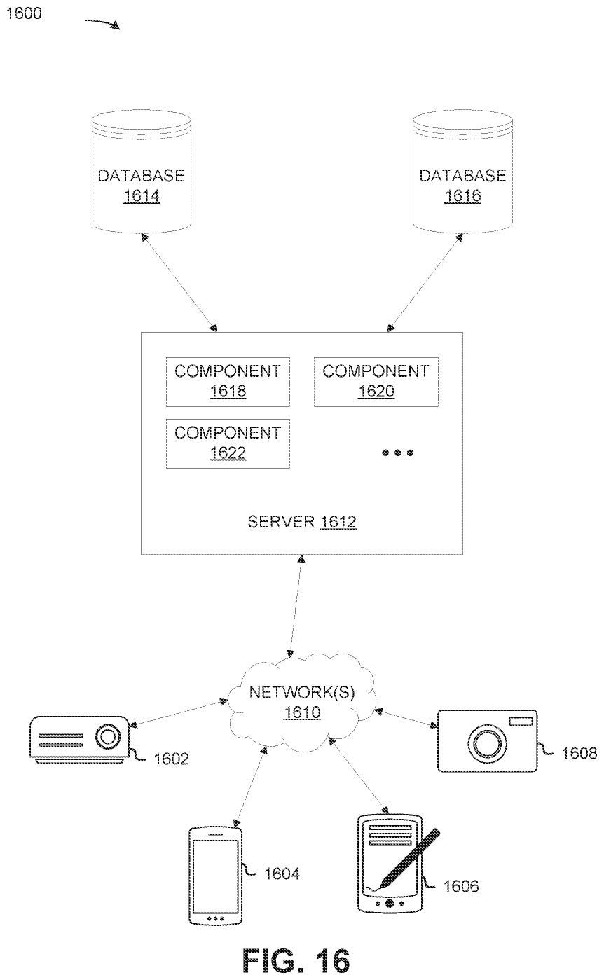

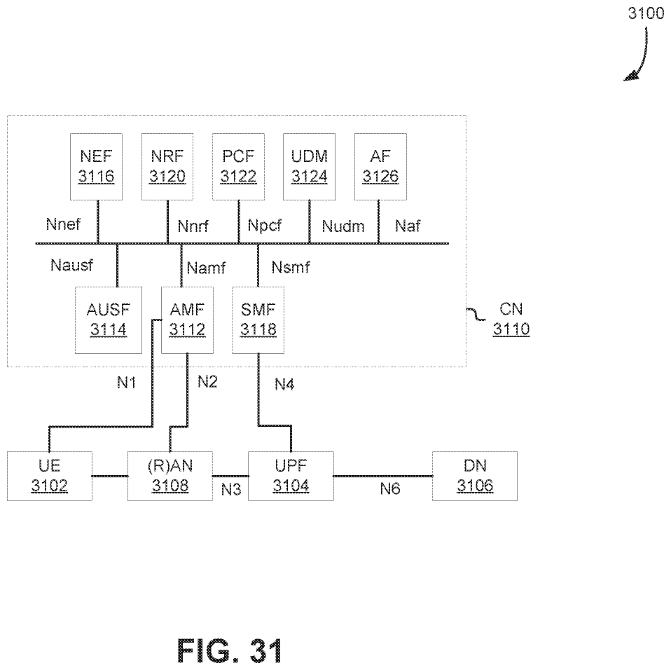

In at least one embodiment, a user 202 may be a user of a computer system. In at least one embodiment, network 204 may be a network as described in accordance with FIGS. 16-53. In at least one embodiment, control plane 206 may be an AI training platform for managing containerized workloads control plane. In at least one embodiment, control plane 206 is a control plane such as those described herein at least in connection with FIGS. 30-33. In at least one embodiment, control plane 206 includes multiple modules such as those described herein in connection with FIGS. 16-53. In at least one embodiment, control plane 206 comprises a scheduler, a job controller, a cluster agent, an PAI server, an MPI operator, or any combination thereof. In at least one embodiment, control plane 206 sends one or more workloads to nodes 210 and node 214. In at least one embodiment, node 210 and node 214 are nodes such as node 404, node 434, and/or node 436, as described herein at least in connection with FIG. 4. In at least one embodiment, node 210 comprises container 212. In at least one embodiment, a container includes a ready-to-run software package, which contains software and/or data needed to run an application. In at least one embodiment, a container such as container 212 comprises code, required runtime information, application libraries, system libraries, environment variables and/or any default values for essential settings. In at least one embodiment, control plane 206 automates container operations. In at least one embodiment, control plane 206 groups containers that make up an application into logical units. In at least one embodiment, control plane 206 allows for clustering of groups of hosts running container applications and said system helps to manage said clusters. In at least one embodiment, node 214 comprises container 216. In at least one embodiment, container 216 is a container such as container 212, described above. In at least one embodiment, container 212 sends one or more workload APIs 208 to container 216 using systems and methods such as those described herein. In at least one embodiment, node 210 and node 214 communicate with a network 218. In at least one embodiment, network 218 is an InfiniBand network (e.g., a network used in high-performance computing environments with high throughput and/or low latency). In at least one embodiment, network 218 is a channel-based fabric network that facilitates high-speed communications between interconnected nodes.

In at least one embodiment, workload APIs 208 include APIs of a multi-node application launcher utility on AI training platforms and GPU cloud clusters such as those described herein (e.g., launch workload API 902, monitor workload API 1002, and/or terminate workload API 1102, described herein). In at least one embodiment, workload APIs 208 include a multi-node launcher utility to launch, monitor, and terminate one or more distributed application on one or more nodes, as described herein. In at least one embodiment, workload APIs 208 are to provide a unified launch mechanism for high-performance computing (HPC) and distributed learning (DL) applications running inside an artificial intelligence (AI) training platform container environment such as those described herein. In at least one embodiment, workload APIs 208 abstract framework-specific environments needed by distributed DL applications, for example distributed PyTorch or Tensorflow. In at least one embodiment, workload APIs 208 allow users, such as user 202, to submit commands as part of a batch script. In at least one embodiment, workload APIs 208 allow users, such as user 202, to submit commands using APIs such as launch workload API 902, described herein at least in connection with FIG. 9, monitor workload API 1002, described herein at least in connection with FIG. 10, and/or terminate workload API 1102, described herein at least in connection with FIG. 11.

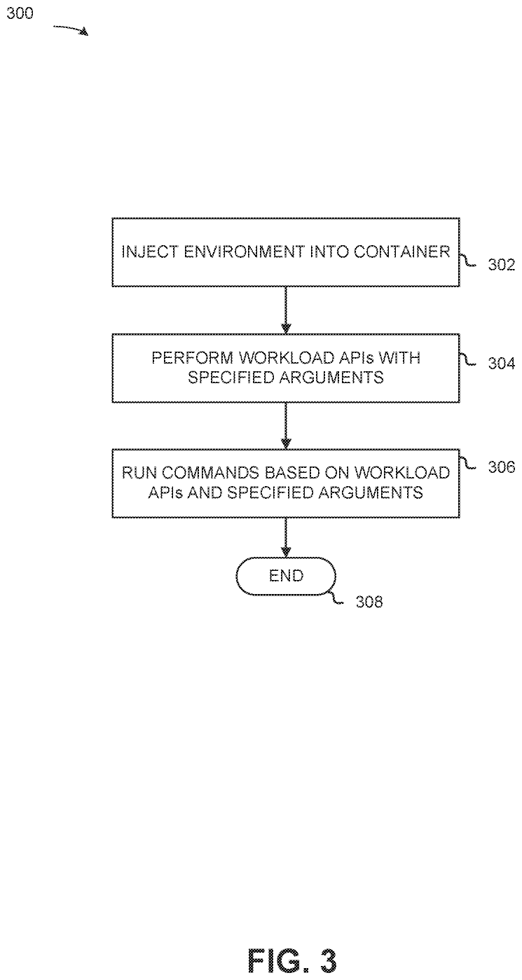

In at least one embodiment, not shown in FIG. 2, an environment to support one or more workload APIs 208 is automatically injected into a container at “/usr/local/bin” (e.g., as described herein at least in connection with FIG. 3). In at least one embodiment, for example, injecting an environment to support one or more workload APIs 208 includes adding software to perform one or more workload APIs 208 when said container (e.g., container 212 and/or container 216) is defined, specified, instantiated, or otherwise created. In at least one embodiment, when an environment to support one or more workload APIs 208 is automatically injected into a container, workload APIs 208 are always available to applications running on AI training platforms that use said container. In at least one embodiment, workload APIs launch processes (e.g., remote processes) using an open source platform for managing containerized workloads and services and manages them together with other processes (e.g., local processes). In at least one embodiment, environment variables and binding information is propagated to all nodes during launch. In at least one embodiment, during termination, one or more workload APIs 208 manages propagation of status indicators, error indicators, debugging information, etc., to calling processes.

In at least one embodiment, arguments of workload APIs 208 include required and optional arguments. In at least one embodiment, required arguments of a launch workload API such as launch workload API 902 comprise a command to launch workload (e.g., as a string)s. In at least one embodiment, for example, an argument to launch workload comprises a string such as “—cmd ‘python train.py.’”

In at least one embodiment, arguments of workload APIs 208 comprise one or more optional arguments such as of number of nodes to run on (e.g., as an integer), In at least one embodiment, arguments of workload APIs 208 has an optional argument of range for a minimum and maximum for a number of nodes. In at least one embodiment, said range's minimum is 1 and said range's maximum value is R, where R is max number or replicas requested by GPU cloud job.

In at least one embodiment, arguments of workload APIs 208 comprise one or more optional arguments such as a number of tasks per node to run (e.g., as an integer). In at least one embodiment, a default value of said number of tasks per node to run is 1.

In at least one embodiment, arguments of workload APIs 208 comprise one or more optional arguments such as environmental variables to set with format ‘key=value’ (e.g., as a string). In at least one embodiment, an environmental variable comprises a string such as “—env ‘var1=value1’—env ‘var2=value2.’” In at least one embodiment, different environment variables require a separate environmental flag for each environment variable.

In at least one embodiment, arguments of workload APIs 208 comprise one or more optional arguments such as of base directory from which to run a command (e.g., as a string). In at least one embodiment, a default value for said base directory argument is a working directory. In at least one embodiment, a directory variable comprises a string such as “—workdir ‘\$WORK_HOME/scripts’—env ‘WORK_HOME=/mnt/workspace.’”

In at least one embodiment, arguments of workload APIs 208 comprise one or more optional arguments such as one or more external launchers used to launch workloads (e.g., as a string). In at least one embodiment, for example, an external launcher is supported is ‘mpirun’ or ‘horovodrun’ or some other such launcher. In at least one embodiment, mpirun maps to one or more OpenMPI options. In at least one embodiment, horovodrun maps to one or more Horovod options. In at least one embodiment, said options assumes launchers exist and are accessible. In at least one embodiment, launcher specific arguments (not part of scriptname options) are provided as a suffix. In at least one embodiment, for example, an external launcher string comprises “—launcher ‘mpirun—allow-run-as-root.’”

In at least one embodiment, arguments of workload APIs 208 comprise one or more optional arguments to specify one or more execution modes including, but not limited to, running asynchronous failure support enabled (e.g., a child process of $scriptname can exit on failure without halting said program). In at least one embodiment, optional argument of running asynchronous failure support enabled means said program will continue while at least one child is running. In at least one embodiment, an optional argument of running asynchronous failure support enabled configures default semantics of scriptname is to halt said program when any child process launched by scriptname exits with error.

In at least one embodiment, arguments of workload APIs 208 comprise one or more optional arguments of ‘binding’ that bind processes to CPU cores. In at least one embodiment, ‘binding’ option is only applicable when arraytype is PYTORCH. In at least one embodiment, an optional argument of binding include whether there are non-uniform memory access (NUMA) binding options available. In at least one embodiment, a binding argument includes an optional argument of a node to which processes are bound to CPUs within a NUMA node. In at least one embodiment, on GPU-enabled compute nodes, a process is bound to all CPUs of affined NUMA node (e.g., mapping local rank to GPU id) and total number of ranks is limited to total number of GPUs. In at least one embodiment, for example, given 2 NUMA nodes N{0,1}, each with 4 GPUs and 32 CPUs C{0-31,32-63},8 processes P{0-7} will be mapped as: P{0-3}:N0:C{0-31}, P{4-7}:N1:C{32-63}.

In at least one embodiment, a binding has an optional argument of ‘exclusive’ in which process are bound to exclusive sets of CPUs within a NUMA node. In at least one embodiment, on GPU-enabled compute nodes, a process is bound to an exclusive CPU set within affined NUMA node (mapping local rank to GPU id), and total number of ranks is limited to total number of GPUs. In at least one embodiment, for example, given 2 NUMA nodes N{0,1}, each with 4 GPUs and 32 CPUs C{0-31,32-63}, 8 processes P{0-7} will be mapped as: P0:N0:C{0-7}, P1:N0:C{8-15}, P2:N0:C{16-23}, P3:N0:C{24-31}, P4:N1:C{32-39}, P5:N1:C{40-47}, P6:N1:C{48-55}, P7:N1:C{56-63}.

In at least one embodiment, a binding has an optional argument of ‘core-complex’ in which processes are bound to a core-complex, e.g., CPUs sharing a last-level cache. In at least one embodiment, on GPU-enabled compute nodes, a process is bound to a core-complex of affined NUMA node (mapping local rank to GPU ID), and total number of ranks is limited to total number of GPUs. In at least one embodiment, for example, given 2 NUMA nodes N{0,1}, each with 2 GPUs and 4 core-complexes X{0-3,4-7},4 processes P{0-3} will be mapped as: P0:N0:X0, P1:N0:X1, P2:N1:X4, P3:N1:X5.

In at least one embodiment, a binding has an optional argument of ‘core-complex’ in which processes are bound to CPUs within a socket. In at least one embodiment, on GPU-enabled compute nodes, a process is bound to CPUs of socket containing an affined NUMA node (mapping local rank to GPU ID), and total number of ranks is limited to total number of GPUs. In at least one embodiment, for example, given 2 Sockets S{0,1}, each with 4 GPUs and 64 CPUs C{0-63,64-127},8 processes P{0-7} will be mapped as: P{0-3}:S0:C{0-63}, P{4-7}:S1:C{64-127}.

In at least one embodiment, arguments of workload APIs 208 includes required and/or optional arguments such as those described at least in connection with launch workload API 902, described herein at least in connection with FIG. 9, monitor workload API 1002, described herein at least in connection with FIG. 10, and/or terminate workload API 1102, described herein at least in connection with FIG. 11.

FIG. 3 illustrates a process 300 to use a multi-node launcher utility to launch and terminate a distributed application on multiple nodes, according to at least one embodiment. In at least one embodiment, some or all of process 300 (or any other processes described herein, or variations and/or combinations thereof) is performed under control of one or more computer systems, such as those described in FIGS. 16-53, configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, a processor such as processor 114, one or more of processors 104, one or more of graphics processors 106, (all as described herein at least in connection with FIG. 1) performs one or more steps of process 300 to use a multi-node launcher utility to launch and terminate a distributed application on multiple nodes, using systems, methods, operations, and techniques such as those described herein.

In at least one embodiment, said system performing at least a part of process 300 to use a multi-node launcher utility to launch and terminate a distributed application on multiple nodes includes executable code to at least inject an environment to support one more workload APIs into a container (e.g., as described in connection FIG. 2 and also as described in connection with step 302, described below). In at least one embodiment, workload APIs arguments are performed (e.g., as described herein at least in connection with FIGS. 1-13 and also as described in connection with step 304, described below). In at least one embodiment, commands are run based on workload APIs and arguments (e.g., as described in connection with step 306, described below).

In at least one embodiment, at step 302 of process 300 to use a multi-node launcher utility to launch and terminate a distributed application on multiple nodes, a system such as a system illustrated in FIG. 1 (e.g., using computing environment 102) includes executable code to inject an environment to support workload APIs into a working directory for executable code of a container (e.g., /usr/local/bin). In at least one embodiment, at step 302, a system such as a system illustrated in FIG. 1 includes executable code to inject an environment to support workload APIs into a container using systems, methods, processes, and techniques such as those described at least in connection with FIG. 2. In at least one embodiment, after step 302, process 300 to use a multi-node launcher utility to launch and terminate a distributed application on multiple nodes continues at step 304.

In at least one embodiment, at step 304 of process 300 to use a multi-node launcher utility to launch and terminate a distributed application on multiple nodes, a system such as a computing environment 102 illustrated in FIG. 1 includes executable code to perform one or more workload APIs with specified arguments. In at least one embodiment, at 304, executable code to perform one or more workload APIs with specified arguments includes executable code to cause a first application programming interface (API) to select a second API to perform one or more software workloads identified by the first API, using a launch workload API 902, described herein at least in connection with FIG. 9. In at least one embodiment, at 304, executable code to perform one or more workload APIs with specified arguments includes executable code to perform a first application programming interface (API) to select a second API to monitor performance of one or more software workloads identified by the first API, using a monitor workload API 1002, described herein at least in connection with FIG. 10. In at least one embodiment, at 304, executable code to perform one or more workload APIs with specified arguments includes executable code to perform a first application programming interface (API) to select a second API to terminate performance of one or more software workloads identified by the first API, using a terminate workload API 1102, described herein at least in connection with FIG. 11. In at least one embodiment, not shown in FIG. 3, at step 304, executable code to perform one or more workload APIs with specified arguments includes executable code to identify one or more APIs, using systems, methods, techniques, and operations such as those described herein. In at least one embodiment, after step 304, process 300 to use a multi-node launcher utility to launch and terminate a distributed application on multiple nodes continues at step 306.

In at least one embodiment, at step 304 of process 300 to use a multi-node launcher utility to launch and terminate a distributed application on multiple nodes, a system such as a computing environment 102 illustrated in FIG. 1 includes executable code to run a command based on workload APIs and specified arguments. In at least one embodiment, executable code to run a command based on workload APIs and specified arguments includes executable code to identify one or more APIs usable to run a command, using systems, methods, techniques, and operations such as those described herein. In at least one embodiment, executable code to run a command based on workload APIs and specified arguments includes executable code to perform one or more APIs including, but not limited to, launch workload API 902, described herein at least in connection with FIG. 9, monitor workload API 1002, described herein at least in connection with FIG. 10, and/or terminate workload API 1102, described herein at least in connection with FIG. 11. In at least one embodiment, after step 306, process 300 to use a multi-node launcher utility to launch and terminate a distributed application on multiple nodes ends 308.

In at least one embodiment, operations of process 300 to use a multi-node launcher utility to launch and terminate a distributed application on multiple nodes are performed in a different order than is illustrated in FIG. 3. In at least one embodiment, operations of process 300 to use a multi-node launcher utility to launch and terminate a distributed application on multiple nodes are performed simultaneously or in parallel. In at least one embodiment, operations of process 300 to use a multi-node launcher utility to launch and terminate a distributed application on multiple nodes that do not depend on each other (e.g., are order independent) are performed simultaneously or in parallel. In at least one embodiment, operations of process 300 to use a multi-node launcher utility to launch and terminate a distributed application on multiple nodes are performed by a plurality of threads executing on a processor such as those described herein.

FIG. 4 is a block diagram 400 illustrating an example high-performance computer system, in accordance with at least one embodiment. In at least one embodiment, a high-performance computer system such as that illustrated in FIG. 4 is implemented using a computing environment such as computing environment 102, described herein at least in connection with FIG. 1. In at least one embodiment, a compute cluster 402 includes one or more nodes. In at least one embodiment, compute cluster 402 includes a node 404. In at least one embodiment, node 404 includes one or more switches. In at least one embodiment, node 404 includes a switch 406. In at least one embodiment, switch 406 is a hardware device that manages connections between processors, processor memory, and/or other nodes. In at least one embodiment, switch 406 is software that manages connections between processors, processor memory, and/or other nodes. In at least one embodiment, switch 406 is a virtual device that emulates hardware and/or software that manages connections between processors, processor memory, and/or other nodes. In at least one embodiment, switch 406 is a device that implements software that manages connections between processors, processor memory, and/or other nodes. In at least one embodiment, node 404 includes one or more other additional switches such as switch 414. In at least one embodiment, switch 414 is a switch that is identical to switch 406 (e.g., is hardware, software, a virtual device).

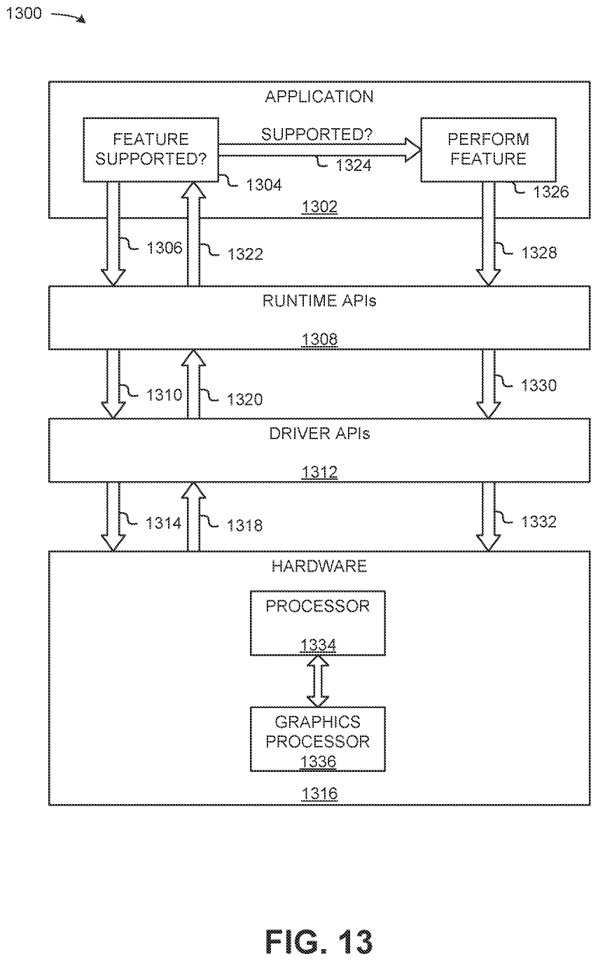

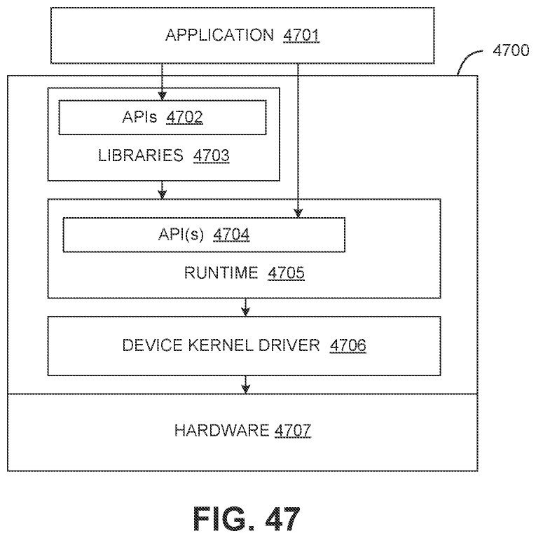

In at least one embodiment, switch 406 includes a software stack 408. In at least one embodiment, software stack 408 implements one or more software systems to enable switch 406 to manage connections between processors, processor memory, and/or other nodes. In at least one embodiment, not shown in FIG. 4, software stack 408 has one or more memory space designations including, but not limited to, kernel space, unprivileged user space, privileged user space, etc. In at least one embodiment, software stack 408 includes one or more drivers such as driver 410. In at least one embodiment, driver 410 is a kernel driver. In at least one embodiment, driver 410 is a runtime driver. In at least one embodiment, software stack 408 includes one or more memory managers such as memory manager 412. In at least one embodiment, software stack 408 is a software stack such as software stack illustrated in block diagram 1300, described herein at least in connection with FIG. 13. In at least one embodiment, software stack 408 is a software stack such as those described herein at least in connection with FIGS. 47-50.

In at least one embodiment, switch 414 includes a software stack 416. In at least one embodiment, software stack 416 implements one or more software systems to enable switch 414 to manage connections between processors, processor memory, and/or other nodes. In at least one embodiment, not shown in FIG. 4, software stack 416 has one or more memory space designations such as those described herein. In at least one embodiment, software stack 416 includes one or more drivers such as driver 418. In at least one embodiment, driver 418 is a kernel driver, as described herein. In at least one embodiment, driver 418 is a runtime driver, as described herein. In at least one embodiment, software stack 416 includes one or more memory managers such as memory manager 420. In at least one embodiment, software stack 416 is a software stack such as software stack illustrated in block diagram 1300, described herein at least in connection with FIG. 13. In at least one embodiment, software stack 416 is a software stack such as those described herein at least in connection with FIGS. 47-50.

In at least one embodiment, node 404 includes one or more processors such as processor 422, processor 426, and/or processor 430. In at least one embodiment, processor 422, processor 426, and/or processor 430 are processors such as those described herein at least in connection with FIG. 1 (e.g., one or more of processors 104 and/or one or more of graphics processors 106). In at least one embodiment, processor 422 has access to memory 424, processor 426 has access to memory 428, and processor 430 has access to memory 432. In at least one embodiment, memory 424, memory 428, and memory 432 are memory such as that described herein.

In at least one embodiment, switch 406 is connected to processor 422, processor 426, and/or processor 430 using systems and methods such as those described herein. In at least one embodiment, switch 406 has access to memory 424 (using processor 422), memory 428 (using processor 426) and/or to memory 432 (using processor 430). In at least one embodiment, switch 406 may be connected to one or more other processors and/or may have access to other memory, not illustrated in FIG. 4.

In at least one embodiment, switch 414 is connected to processor 422, processor 426, and/or processor 430 using systems and methods such as those described herein and switch 406 has access to memory 424 (using processor 422), memory 428 (using processor 426), and/or to memory 432 (using processor 430). In at least one embodiment, switch 414 may also be connected to one or more other processors and/or may have access to other memory, not illustrated in FIG. 4. In at least one embodiment, switch 406 and/or switch 414 are connected to one or more other nodes such as node 434 and/or node 436. In at least one embodiment, not illustrated in FIG. 4, node 434 and/or node 436 include one or more switches, processors, and memory, as described herein.

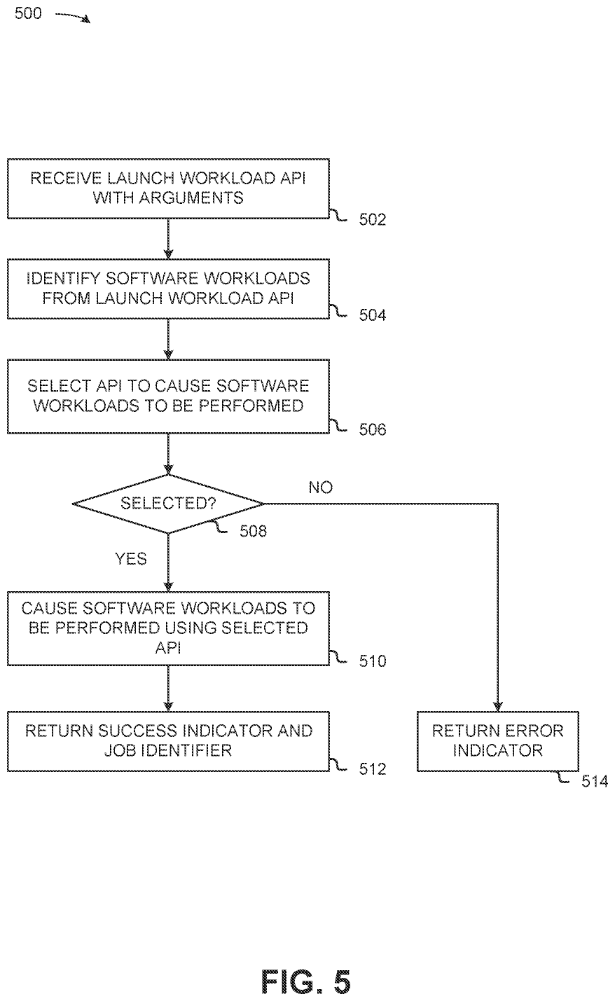

FIG. 5 illustrates a process 500 to launch one or more workloads using a high-performance computing environment, in accordance with at least one environment. In at least one embodiment, some or all of process 500 (or any other processes described herein, or variations and/or combinations thereof) is performed under control of one or more computer systems, such as those described in FIGS. 16-53, configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, a processor such as processor 114, one or more of processors 104, one or more of graphics processors 106, (all as described herein at least in connection with FIG. 1) performs one or more steps of process 500, using systems, methods, operations, and techniques such as those described herein.

In at least one embodiment, at step 502 of process 500 to launch workloads using a high-performance computing environment, a processor executing process 500 performs instructions to receive or otherwise obtain a launch workload API with arguments. In at least one embodiment, at step 502, a launch workload API with arguments is received from an environment such as client environment 112, described herein at least in connection with FIG. 1. In at least one embodiment, at step 502, a launch workload API with arguments is an API such as launch workload API 902, described herein at least in connection with FIG. 9. In at least one embodiment, at step 502, arguments of a launch workload API include one or more of workload indicator 904, number of nodes 906, tasks per node 908, environment variables 910, working directory 912, launcher 914, execution modes 916, and/or other arguments 918, described herein at least in connection with FIG. 9. In at least one embodiment, after step 502, process 500 to launch workloads using a high-performance computing environment continues at step 504.

In at least one embodiment, at step 504 of process 500 to launch workloads using a high-performance computing environment, a processor executing process 500 performs instructions to identify one or more software workloads to launch. In at least one embodiment, at step 504, said one or more software workloads to launch are arguments of launch workload API with arguments received at step 502. In at least one embodiment, after step 504, process 500 to launch workloads using a high-performance computing environment continues at step 506.

In at least one embodiment, at step 506 of process 500 to launch workloads using a high-performance computing environment, a processor executing process 500 performs instructions to select one or more APIs to cause software workloads to be launched. In at least one embodiment, at step 506, selecting one or more APIs to cause software workloads to be launched is based, at least in part, on one or more arguments of launch workload API with arguments received at step 502. In at least one embodiment, at step 506, selecting one or more APIs to cause software workloads to be launched comprises selecting one or more APIs from a list of candidate APIs using, for example, a lookup table, a decision tree, an algorithm, or some other such method. In at least one embodiment, at step 506, selecting one or more APIs to cause software workloads to be launched includes selecting a default API. In at least one embodiment, after step 506, process 500 to launch workloads using a high-performance computing environment continues at step 508.

In at least one embodiment, at step 508 of process 500 to launch workloads using a high-performance computing environment, it is determined whether an API (or APIs) to cause software workloads to be launched was selected at step 506. In at least one embodiment, at step 508, determining whether an API (or APIs) to cause software workloads to be launched was selected at step 506 includes determining whether a plurality of acceptable APIs were selected, determining whether a single API (or set of APIs) was selected, determining whether a default API was selected, and/or determining whether no APIs were selected. In at least one embodiment, at step 508, if it is determined that an API (or APIs) to cause software workloads to be launched was selected at step 506 (“YES” branch), process 500 to launch workloads using a high-performance computing environment continues at step 510. In at least one embodiment, at step 508, if it is determined that an API (or APIs) to cause software workloads to be launched was not selected at step 506 (“NO” branch), process 500 to launch workloads using a high-performance computing environment continues at step 514.

In at least one embodiment, at step 510 of process 500 to launch workloads using a high-performance computing environment, a processor executing process 500 performs instructions to cause software workloads to be launched using one or more APIs selected at step 506. In at least one embodiment, after step 510, process 500 to launch workloads using a high-performance computing environment continues at step 512.

In at least one embodiment, at step 512 of process 500 to launch workloads using a high-performance computing environment, a processor executing process 500 performs instructions to return a success indicator and a job identifier. In at least one embodiment, at step 512, a processor executing process 500 performs instructions to return a success indicator (e.g., success indicator 922) and a job identifier (e.g., job identifier 926) using launch workload API return 920, described herein at least in connection with FIG. 9. In at least one embodiment, a job identifier such as job identifier 926 includes an indicator of one or more jobs (e.g., “JOB12345,” “123456,” “JOBID_ABCDE,” etc.). In at least one embodiment, after step 512, process 500 to launch workloads using a high-performance computing environment ends. In at least one embodiment, not shown in FIG. 5, after step 512, process 500 to launch workloads using a high-performance computing environment continues at step 502, to receive an additional launch workload API with arguments.

In at least one embodiment, at step 514 of process 500 to launch workloads using a high-performance computing environment, a processor executing process 500 performs instructions to return an error indicator. In at least one embodiment, at step 514, a processor executing process 500 performs instructions to return an error indicator (e.g., error indicator 924) using launch workload API return 920, described herein at least in connection with FIG. 9. In at least one embodiment, after step 514, process 500 to launch workloads using a high-performance computing environment ends. In at least one embodiment, not shown in FIG. 5, after step 514, process 500 to launch workloads using a high-performance computing environment continues at step 502, to receive an additional launch workload API with arguments.

In at least one embodiment, operations of process 500 to launch workloads using a high-performance computing environment are performed in a different order than is illustrated in FIG. 5. In at least one embodiment, operations of process 500 to launch workloads using a high-performance computing environment are performed simultaneously or in parallel. In at least one embodiment, operations of process 500 to launch workloads using a high-performance computing environment that do not depend on each other (e.g., are order independent) are performed simultaneously or in parallel. In at least one embodiment, operations of process 500 to launch workloads using a high-performance computing environment are performed by a plurality of threads executing on a processor such as those described herein.

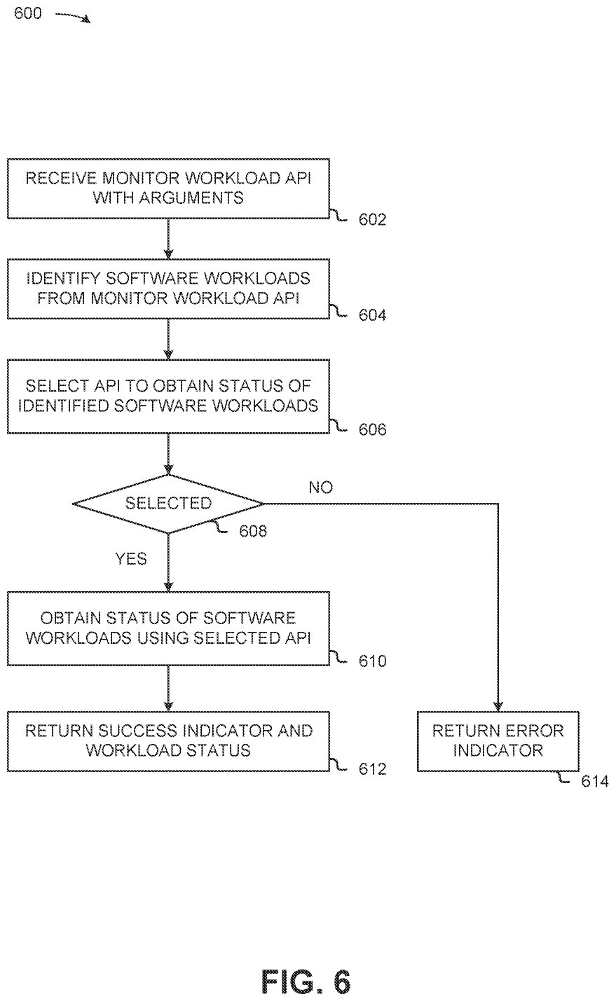

FIG. 6 illustrates a process 600 to monitor one or more workloads using a high-performance computing environment, in accordance with at least one environment. In at least one embodiment, some or all of process 600 (or any other processes described herein, or variations and/or combinations thereof) is performed under control of one or more computer systems, such as those described in FIGS. 16-53, configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, a processor such as processor 114, one or more of processors 104, one or more of graphics processors 106, (all as described herein at least in connection with FIG. 1) performs one or more steps of process 600, using systems, methods, operations, and techniques such as those described herein.

In at least one embodiment, at step 602 of process 600 to monitor workloads using a high-performance computing environment, a processor executing process 600 performs instructions to receive or otherwise obtain a monitor workload API with arguments. In at least one embodiment, at step 602, a monitor workload API with arguments is received from an environment such as client environment 112, described herein at least in connection with FIG. 1. In at least one embodiment, at step 602, a monitor workload API with arguments is an API such as monitor workload API 1002, described herein at least in connection with FIG. 10. In at least one embodiment, at step 602, arguments of a monitor workload API include one or more of job identifier 1004 and/or other arguments 1006, described herein at least in connection with FIG. 10. In at least one embodiment, after step 602, process 600 to monitor workloads using a high-performance computing environment continues at step 604.

In at least one embodiment, at step 604 of process 600 to monitor workloads using a high-performance computing environment, a processor executing process 600 performs instructions to identify one or more software workloads to monitor. In at least one embodiment, at step 604, said one or more software workloads to monitor are arguments of monitor workload API with arguments received at step 602. In at least one embodiment, after step 604, process 600 to monitor workloads using a high-performance computing environment continues at step 606.

In at least one embodiment, at step 606 of process 600 to monitor workloads using a high-performance computing environment, a processor executing process 600 performs instructions to select one or more APIs to obtain status of identified software workloads. In at least one embodiment, at step 606, selecting one or more APIs to cause software workloads to be monitored is based, at least in part, on one or more arguments of monitor workload API with arguments received at step 602. In at least one embodiment, at step 606, selecting one or more APIs to cause software workloads to be monitored comprises selecting one or more APIs from a list of candidate APIs using, for example, a lookup table, a decision tree, an algorithm, or some other such method. In at least one embodiment, at step 606, selecting one or more APIs to cause software workloads to be monitored includes selecting a default API. In at least one embodiment, after step 606, process 600 to monitor workloads using a high-performance computing environment continues at step 608.

In at least one embodiment, at step 608 of process 600 to monitor workloads using a high-performance computing environment, it is determined whether an API (or APIs) to cause software workloads to be monitored was selected at step 606. In at least one embodiment, at step 608, determining whether an API (or APIs) to cause software workloads to be monitored was selected at step 606 includes determining whether a plurality of acceptable APIs were selected, determining whether a single API (or set of APIs) was selected, determining whether a default API was selected, and/or determining whether no APIs were selected. In at least one embodiment, at step 608, if it is determined that an API (or APIs) to cause software workloads to be monitored was selected at step 606 (“YES” branch), process 600 to monitor workloads using a high-performance computing environment continues at step 610. In at least one embodiment, at step 608, if it is determined that an API (or APIs) to cause software workloads to be monitored was not selected at step 606 (“NO” branch), process 600 to monitor workloads using a high-performance computing environment continues at step 614.

In at least one embodiment, at step 610 of process 600 to monitor workloads using a high-performance computing environment, a processor executing process 600 performs instructions to obtain statuses of one or more software workloads to be monitored using one or more APIs selected at step 606. In at least one embodiment, at step 610, a processor executing process 600 performs instructions to obtain statuses of one or more software workloads to be monitored obtains said status from a computing environment such as computing environment 102, described herein at least in connection with FIG. 1. In at least one embodiment, after step 610, process 600 to monitor workloads using a high-performance computing environment continues at step 612.

In at least one embodiment, at step 612 of process 600 to monitor workloads using a high-performance computing environment, a processor executing process 600 performs instructions to return a success indicator and a job identifier. In at least one embodiment, at step 612, a processor executing process 600 performs instructions to return a success indicator (e.g., success indicator 1022) and a workload status (e.g., workload status 1026) using monitor workload API return 1020, described herein at least in connection with FIG. 10. In at least one embodiment, after step 612, process 600 to monitor workloads using a high-performance computing environment ends. In at least one embodiment, not shown in FIG. 6, after step 612, process 600 to monitor workloads using a high-performance computing environment continues at step 602, to receive an additional monitor workload API with arguments.

In at least one embodiment, at step 614 of process 600 to monitor workloads using a high-performance computing environment, a processor executing process 600 performs instructions to return an error indicator. In at least one embodiment, at step 614, a processor executing process 600 performs instructions to return an error indicator (e.g., error indicator 1024) using monitor workload API return 1020, described herein at least in connection with FIG. 10. In at least one embodiment, after step 614, process 600 to monitor workloads using a high-performance computing environment ends. In at least one embodiment, not shown in FIG. 6, after step 614, process 600 to monitor workloads using a high-performance computing environment continues at step 602, to receive an additional monitor workload API with arguments.

In at least one embodiment, operations of process 600 to monitor workloads using a high-performance computing environment are performed in a different order than is illustrated in FIG. 6. In at least one embodiment, operations of process 600 to monitor workloads using a high-performance computing environment are performed simultaneously or in parallel. In at least one embodiment, operations of process 600 to monitor workloads using a high-performance computing environment that do not depend on each other (e.g., are order independent) are performed simultaneously or in parallel. In at least one embodiment, operations of process 600 to monitor workloads using a high-performance computing environment are performed by a plurality of threads executing on a processor such as those described herein.

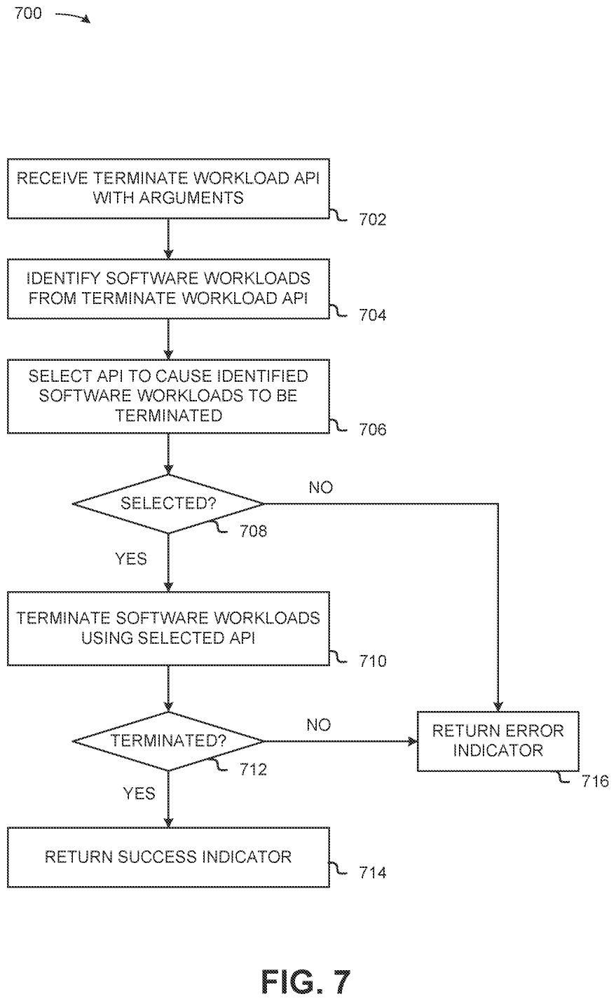

FIG. 7 illustrates a process 700 to terminate one or more workloads using a high-performance computing environment, in accordance with at least one environment. In at least one embodiment, some or all of process 700 (or any other processes described herein, or variations and/or combinations thereof) is performed under control of one or more computer systems, such as those described in FIGS. 16-53, configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, a processor such as processor 114, one or more of processors 104, one or more of graphics processors 106, (all as described herein at least in connection with FIG. 1) performs one or more steps of process 700, using systems, methods, operations, and techniques such as those described herein.

In at least one embodiment, at step 702 of process 700 to terminate workloads using a high-performance computing environment, a processor executing process 700 performs instructions to receive or otherwise obtain a terminate workload API with arguments. In at least one embodiment, at step 702, a terminate workload API with arguments is received from an environment such as client environment 112, described herein at least in connection with FIG. 1. In at least one embodiment, at step 702, a terminate workload API with arguments is an API such as terminate workload API 1102, described herein at least in connection with FIG. 11. In at least one embodiment, at step 702, arguments of a terminate workload API include one or more of job identifier 1104 and/or other arguments 1106, described herein at least in connection with FIG. 11. In at least one embodiment, after step 702, process 700 to terminate workloads using a high-performance computing environment continues at step 704.

In at least one embodiment, at step 704 of process 700 to terminate workloads using a high-performance computing environment, a processor executing process 700 performs instructions to identify one or more software workloads to terminate. In at least one embodiment, at step 704, said one or more software workloads to terminate are arguments of terminate workload API with arguments received at step 702. In at least one embodiment, after step 704, process 700 to terminate workloads using a high-performance computing environment continues at step 706.

In at least one embodiment, at step 706 of process 700 to terminate workloads using a high-performance computing environment, a processor executing process 700 performs instructions to select one or more APIs to terminate identified software workloads. In at least one embodiment, at step 706, selecting one or more APIs to cause software workloads to be terminated is based, at least in part, on one or more arguments of terminate workload API with arguments received at step 702. In at least one embodiment, at step 706, selecting one or more APIs to cause software workloads to be terminated comprises selecting one or more APIs from a list of candidate APIs using, for example, a lookup table, a decision tree, an algorithm, or some other such method. In at least one embodiment, at step 706, selecting one or more APIs to cause software workloads to be terminated includes selecting a default API. In at least one embodiment, after step 706, process 700 to terminate workloads using a high-performance computing environment continues at step 708.

In at least one embodiment, at step 708 of process 700 to terminate workloads using a high-performance computing environment, it is determined whether an API (or APIs) to cause software workloads to be terminated was selected at step 706. In at least one embodiment, at step 708, determining whether an API (or APIs) to cause software workloads to be terminated was selected at step 706 includes determining whether a plurality of acceptable APIs were selected, determining whether a single API (or set of APIs) was selected, determining whether a default API was selected, and/or determining whether no APIs were selected. In at least one embodiment, at step 708, if it is determined that an API (or APIs) to cause software workloads to be terminated was selected at step 706 (“YES” branch), process 700 to terminate workloads using a high-performance computing environment continues at step 710. In at least one embodiment, at step 708, if it is determined that an API (or APIs) to cause software workloads to be terminated was not selected at step 606 (“NO” branch), process 700 to terminate workloads using a high-performance computing environment continues at step 716.

In at least one embodiment, at step 710 of process 700 to terminate workloads using a high-performance computing environment, a processor executing process 700 performs instructions to cause one or more software workloads to be terminated using one or more APIs selected at step 706. In at least one embodiment, at step 710, a processor executing process 700 performs instructions to cause one or more software workloads to be terminated, terminates said status operating on a computing environment such as computing environment 102, described herein at least in connection with FIG. 1. In at least one embodiment, after step 710, process 700 to terminate workloads using a high-performance computing environment continues at step 712.

In at least one embodiment, at step 712 of process 700 to terminate workloads using a high-performance computing environment, it is determined whether software workloads identified at step 704 were terminated at step 710. In at least one embodiment, at step 712, a processor executing process 700 performs instructions to determine whether software workloads identified at step 704 were terminated at step 710 by querying a computing environment such as computing environment 102, described herein at least in connection with FIG. 1. In at least one embodiment, at step 712, a processor executing process 700 performs instructions to determine whether software workloads identified at step 704 were terminated at step 710 by performing one or more additional APIs such as monitor workload API 1002, described herein at least in connection with FIG. 10. In at least one embodiment, at step 712, a processor executing process 700 performs instructions to determine whether software workloads identified at step 704 were terminated at step 710 by performing one or more steps of process 600, described herein at least in connection with FIG. 6. In at least one embodiment, at step 712, if it is determined that software workloads identified at step 704 were terminated at step 710 (“YES” branch), process 700 to terminate workloads using a high-performance computing environment continues at step 714. In at least one embodiment, at step 712, if it is determined that software workloads identified at step 704 were not terminated at step 710 (“NO” branch), process 700 to terminate workloads using a high-performance computing environment continues at step 716.

In at least one embodiment, at step 714 of process 700 to terminate workloads using a high-performance computing environment, a processor executing process 700 performs instructions to return a success indicator. In at least one embodiment, at step 714, a processor executing process 700 performs instructions to return a success indicator (e.g., success indicator 1022) using terminate workload API return 1120, described herein at least in connection with FIG. 11. In at least one embodiment, after step 714, process 700 to terminate workloads using a high-performance computing environment ends. In at least one embodiment, not shown in FIG. 7, after step 714, process 700 to terminate workloads using a high-performance computing environment continues at step 702, to receive an additional terminate workload API with arguments.

In at least one embodiment, at step 716 of process 700 to terminate workloads using a high-performance computing environment, a processor executing process 700 performs instructions to return an error indicator. In at least one embodiment, at step 714, a processor executing process 700 performs instructions to return an error indicator (e.g., error indicator 1124) using terminate workload API return 1120, described herein at least in connection with FIG. 11. In at least one embodiment, after step 716, process 700 to terminate workloads using a high-performance computing environment ends. In at least one embodiment, not shown in FIG. 7, after step 716, process 700 to terminate workloads using a high-performance computing environment continues at step 702, to receive an additional terminate workload API with arguments.

In at least one embodiment, operations of process 700 to terminate workloads using a high-performance computing environment are performed in a different order than is illustrated in FIG. 7. In at least one embodiment, operations of process 700 to terminate workloads using a high-performance computing environment are performed simultaneously or in parallel. In at least one embodiment, operations of process 700 to terminate workloads using a high-performance computing environment that do not depend on each other (e.g., are order independent) are performed simultaneously or in parallel. In at least one embodiment, operations of process 700 to terminate workloads using a high-performance computing environment are performed by a plurality of threads executing on a processor such as those described herein.

FIG. 8 is a block diagram 800 illustrating a software program to be performed by one or more processors, in accordance with at least one embodiment. In at least one embodiment, block diagram 800 illustrates a software program 804 to be performed by a processor, such as a CPU 802 (e.g., a central processing unit) as well as a GPU 810 (e.g., a graphics processing unit) and an accelerator 814 within a heterogeneous processor. In at least one embodiment, CPU 802 is a processor such as processor 114 and/or one or more of processors 104, as described herein at least in connection with FIG. 1. In at least one embodiment, CPU 802 comprises one or more processors such as one or more of processor 114, one or more of processors 104, one or more of graphics processors 106, and/or one or more of other processors and/or accelerators such as those described herein. In at least one embodiment, GPU 810 is a graphics processor such one or more of graphics processors 106, as described herein at least in connection with FIG. 1. In at least one embodiment, GPU 810 comprises one or more processors such as one or more of processor 114, one or more of processors 104, one or more of graphics processors 106, and/or one or more of other processors and/or accelerators such as those described herein. In at least one embodiment, CPU 802 is any processor with any architecture further described herein. In at least one embodiment, a CPU 802 is any general processor with any architecture further described herein. In at least one embodiment, a processor, such as CPU 802, comprises circuits to perform one or more computing operations. In at least one embodiment, a processor, such as CPU 802, comprises any configuration of circuits to perform one or more computing operations further described herein.

In at least one embodiment, a CPU 802, performs a parallel computing environment 808. In at least one embodiment, CPU 802 comprises one or more processors such as those described herein. In at least one embodiment, a processor, such as CPU 802, performs a parallel computing environment 808, such as compute uniform device architecture (CUDA). In at least one embodiment, parallel computing environment 808 includes instructions that, if performed by one or more processors, such as CPU 802, facilitate execution of one or more software programs by one or more CPUs 802, one or more parallel processing units (PPUs), such as GPUs 810, and/or one or more accelerators 814 within a heterogeneous processor.

In at least one embodiment, one or more PPUs are processors comprising one or more circuits to perform parallel computational operations, such as GPUs 810 and any other parallel processor further described herein. In at least one embodiment, a GPU 810 is hardware comprising circuits to perform one or more computational operations, as further described below in conjunction with various embodiments. In at least one embodiment, a GPU 810 comprises one or more processing cores to each perform one or more computational operations. In at least one embodiment, a GPU 810 comprises one or more processing cores to perform one or more parallel computational operations. In at least one embodiment, a GPU 810 is packaged together with CPU 802 or other processors as a system-on-chip (SoC). In at least one embodiment, a GPU 810 is packaged on a shared die or other substrate with CPU 802 or other processors as a system-on-chip (SoC). In at least one embodiment, one or more accelerators 814 within heterogeneous processors are hardware comprising one or more circuits to perform specific computational operations, such as a deep learning accelerator (DLA), programmable vision accelerator (PVA), field-programmable gate array (FPGA), or any other accelerator further described herein. In at least one embodiment, an accelerator 814 within a heterogeneous processor is packaged together with CPU 802 or other processors as a system-on-chip (SoC). In at least one embodiment, an accelerator 814 within a heterogeneous processor is packaged on a shared die or other substrate with CPU 802 or other processors as a system-on-chip (SoC). In at least one embodiment, one or more CPUs such as CPU 802, one or more GPUs such as GPU 810, one or more or other PPUs, and/or accelerators 814 within heterogeneous processors are packaged as a as a system-on-chip (SoC). In at least one embodiment, one or more CPUs 802, one or more GPUs 810 or other PPUs, and/or accelerators 814 within heterogeneous processors are packaged on a shared die or other substrate as a system-on-chip (SoC).

In at least one embodiment, parallel computing environment 808, such as CUDA, comprises libraries and other software programs to perform one or more computing operations using one or more PPUs, such as GPUs 810, and/or one or more accelerators 814 within a heterogeneous processor. In at least one embodiment, parallel computing environment 808 comprises libraries and other software programs that, if performed by one or more processors, such as one or more CPUs 802, cause one or more PPUs, such as GPUs 810, and/or one or more accelerators 814 within a heterogeneous processor, to perform one or more computational operations. In at least one embodiment, parallel computing environment 808 comprises libraries that, if performed, cause one or more PPUs, such as GPUs 810, and/or one or more accelerators 814 within heterogeneous processors, to perform mathematical operations. In at least one embodiment, parallel computing environment 808 comprises libraries that, if performed, cause one or more PPUs, such as GPUs 810, and/or one or more accelerators 814 within heterogeneous processors, to perform any other operation further described herein.

In at least one embodiment, one or more PPUs, such as GPUs 810, and/or one or more accelerators 814 within heterogeneous processors, perform one or more computational operations in response to one or more application programming interfaces (APIs). In at least one embodiment, an API is a set of software instructions that, if performed by one or more processors, such as one or more CPUs 802, cause one or more PPUs, such as GPUs 810 and/or one or more accelerators 814 within heterogeneous processors to perform one or more computational operations. In at least one embodiment, parallel computing environment 808 comprises one or more APIs 806 that, if performed by one or more processors, such as one or more CPUs 802, cause one or more PPUs, such as GPUs 810 and/or one or more accelerators 814 within heterogeneous processors to perform one or more computational operations. In at least one embodiment, one or more APIs 806 comprise one or more functions that, if performed, cause one or more processors, such as one or more CPUs 802, to perform one or more operations, such as computational operations, error reporting, scheduling of other operations to be performed by GPUs 810 and/or accelerators 814 within heterogeneous processors, or any other operation further described herein. In at least one embodiment, one or more APIs 806 comprise one or more functions that, if performed, cause one or more PPUs, such as GPUs 810, to perform one or more operations, such as computational operations, error reporting, or any other operation further described herein. In at least one embodiment, one or more APIs 806 comprise one or more functions, such as those described below in conjunction with FIGS. 9-11, that, if performed, cause one or more accelerators 814 within heterogeneous processors to perform one or more operations, such as computational operations, error reporting, or any other operation further described herein. In at least one embodiment, one or more APIs 806 comprise one or more functions to cause CPU 802 to perform one or more computational operations in response to information or events generated by one or more PPUs, such as GPUs 810, and/or one or more accelerators 814 within heterogeneous processors. In at least one embodiment, one or more APIs 806 comprise one or more functions that, if invoked, cause CPU 802 to perform one or more computational operations in response to information or events generated by one or more PPUs, such as GPUs 810, and/or one or more accelerators 814 within heterogeneous processors.

In at least one embodiment, a processor, such as CPU 802, performs one or more software programs 804. In at least one embodiment, one or more software programs are sets of instructions that, if performed, cause one or more processors, such as one or more CPUs 802, PPUs such as GPUs 810, and/or accelerators 814 in heterogeneous processors, to perform computational operations. In at least one embodiment, software programs 804 comprise instructions and/or operations to be performed by one or more PPUs, such as GPUs 810. In at least one embodiment, one or more software programs 804 comprise GPU-specific code 812 and/or accelerator-specific code 816. In at least one embodiment, instructions and/or operations to be performed by one or more PPUs, such as GPUs 810, are PPU-specific or GPU-specific code 812. In at least one embodiment, GPU-specific code 812 is a set of software instructions and/or other operations, as further described herein, to be performed by one or more GPUs 810. In at least one embodiment, software programs 804 comprise instructions and/or operations to be performed by one or more accelerators 814 in heterogeneous processors. In at least one embodiment, instructions and/or operations to be performed by one or more accelerators 814 in heterogeneous processors are accelerator-specific code 816. In at least one embodiment, accelerator-specific code 816 is a set of software instructions and/or other operations, as further described herein, to be performed by one or more accelerators 814. In at least one embodiment, PPU-specific or GPU-specific code 812 and/or accelerator-specific code 816 is to be performed in response to one or more APIs 806, as described below in conjunction with FIGS. 9-11.

FIG. 9 is a block diagram 900 illustrating an application programming interface (API) to launch one or more software workloads, in accordance with at least one embodiment. In at least one embodiment, one or more circuits of a processor are to perform a launch workload API 902, to launch one or more software workloads using a computing environment such as computing environment 102, described herein at least in connection with FIG. 1. In at least one embodiment, not shown in FIG. 9, one or more circuits of a processor such as those described herein performs one or more instructions to perform launch workload API 902 to cause a first application programming interface (API) to select a second API to perform one or more software workloads identified by the first API. In at least one embodiment, not shown in FIG. 9, one or more circuits of a processor such as those described herein performs one or more instructions to perform launch workload API 902 to perform a first application programming interface (API) to cause a second API to be performed to cause one or more software workloads to be performed by one or more other processors. In at least one embodiment, also not shown in FIG. 9, one or more circuits of a processor such as those described herein performs one or more instructions to perform launch workload API 902 to cause a first application programming interface (API) to select a second API to perform one or more software workloads identified by the first API in response to receiving an additional API such as those described herein.

In at least one embodiment, launch workload API 902 receives, when invoked, one or more arguments to indicate information about operations to be performed using techniques such as those described herein. In at least one embodiment, launch workload API 902 receives, when invoked, one or more arguments to indicate information about instructions to be performed using techniques such as those described herein.

In at least one embodiment, launch workload API 902 receives, as input, one or more arguments comprising a workload indicator 904. In at least one embodiment, workload indicator 904 is a data value comprising information usable to identify, indicate, or otherwise specify one or more workloads to be launched using launch workload API 902. In at least one embodiment, workload indicator 904 is a command to be executed to cause one or more workloads to be launched (e.g., a script of a command-line command). In at least one embodiment, said one or more workloads to be launched that are identified, indicated, or otherwise specified by workload indicator 904 are one or more of a plurality of parameters usable by launch workload API 902 to launch one or more software workloads. In at least one embodiment, workload indicator 904 is a data value to identify, indicate, or otherwise specify to an API such as launch workload API 902, a set of operations or instructions to be performed by one or more PPUs, such as GPUs, and/or one or more accelerators within a heterogeneous processor, as described herein.

In at least one embodiment, launch workload API 902 receives, as input, one or more arguments comprising number of nodes 906. In at least one embodiment, number of nodes 906 is a data value comprising information usable to identify, indicate, or otherwise specify a number of nodes to be used to launch workloads using launch workload API 902. In at least one embodiment, a number of nodes to be used to launch workloads identified, indicated, or otherwise specified by number of nodes 906 is one of a plurality of parameters usable by launch workload API 902 to launch one or more software workloads. In at least one embodiment, number of nodes 906 is a data value to identify, indicate, or otherwise specify to an API such as launch workload API 902, a set of operations or instructions to be performed by one or more PPUs, such as GPUs, and/or one or more accelerators within a heterogeneous processor, as described herein.

In at least one embodiment, launch workload API 902 receives, as input, one or more arguments comprising tasks per node 908. In at least one embodiment, tasks per node 908 is a data value comprising information usable to identify, indicate, or otherwise specify a number of tasks per node to be used to launch workloads using launch workload API 902. In at least one embodiment, a number of tasks per node to be used to launch workloads identified, indicated, or otherwise specified by tasks per node 908 is one of a plurality of parameters usable by launch workload API 902 to launch one or more software workloads. In at least one embodiment, tasks per node 908 is a data value to identify, indicate, or otherwise specify to an API such as launch workload API 902, a set of operations or instructions to be performed by one or more PPUs, such as GPUs, and/or one or more accelerators within a heterogeneous processor, as described herein.

In at least one embodiment, launch workload API 902 receives, as input, one or more arguments comprising environment variables 910. In at least one embodiment, environment variables 910 is a data value comprising information usable to identify, indicate, or otherwise specify one or more environment variables using launch workload API 902. In at least one embodiment, environment variables 910 comprise one or more key-value pairs (e.g., key=value), specified using a list of pairs. In at least one embodiment, environment variables identified, indicated, or otherwise specified by environment variables 910 is one of a plurality of parameters usable by launch workload API 902 to launch one or more software workloads. In at least one embodiment, environment variables 910 is a data value to identify, indicate, or otherwise specify to an API such as launch workload API 902, a set of operations or instructions to be performed by one or more PPUs, such as GPUs, and/or one or more accelerators within a heterogeneous processor, as described herein.

In at least one embodiment, launch workload API 902 receives, as input, one or more arguments comprising working directory 912. In at least one embodiment, working directory 912 is a data value comprising information usable to identify, indicate, or otherwise specify a working directory from which to launch workloads using launch workload API 902. In at least one embodiment, a working directory identified, indicated, or otherwise specified by working directory 912 is one of a plurality of parameters usable by launch workload API 902 to launch one or more software workloads. In at least one embodiment, working directory 912 is a data value to identify, indicate, or otherwise specify to an API such as launch workload API 902, a set of operations or instructions to be performed by one or more PPUs, such as GPUs, and/or one or more accelerators within a heterogeneous processor, as described herein.

In at least one embodiment, launch workload API 902 receives, as input, one or more arguments comprising launcher 914. In at least one embodiment, launcher 914 is a data value comprising information usable to identify, indicate, or otherwise specify a launcher to be used to launch software workloads using launch workload API 902. In at least one embodiment, launcher 914 identifies, indicates, or otherwise specifies a software program to be used to launch software workloads using launch workload API 902. In at least one embodiment, a launcher identified, indicated, or otherwise specified by launcher 914 is one of a plurality of parameters usable by launch workload API 902 to launch one or more software workloads. In at least one embodiment, launcher 914 is a data value to identify, indicate, or otherwise specify to an API such as launch workload API 902, a set of operations or instructions to be performed by one or more PPUs, such as GPUs, and/or one or more accelerators within a heterogeneous processor, as described herein.

In at least one embodiment, launch workload API 902 receives, as input, one or more arguments comprising execution modes 916. In at least one embodiment, execution modes 916 is a data value comprising information usable to identify, indicate, or otherwise specify one or more execution modes to use when using launch workload API 902 to launch software workloads. In at least one embodiment, execution modes 916 specifies one or more execution modes including, but not limited to, launch with asynchronous failure support and/or launch in debug mode. In at least one embodiment, one or more execution modes identified, indicated, or otherwise specified by execution modes 916 is one of a plurality of parameters usable by launch workload API 902 to launch one or more software workloads. In at least one embodiment, execution modes 916 is a data value to identify, indicate, or otherwise specify to an API such as launch workload API 902, a set of operations or instructions to be performed by one or more PPUs, such as GPUs, and/or one or more accelerators within a heterogeneous processor, as described herein.

In at least one embodiment, launch workload API 902 receives, as input, one or more arguments comprising one or more other arguments 918. In at least one embodiment, other arguments 918 are data comprising information to indicate any other information usable in performing launch workload API 902 to launch one or more software workloads. In at least one embodiment, one or more of workload indicator 904, number of nodes 906, tasks per node 908, environment variables 910, working directory 912, launcher 914, execution modes 916, and/or other arguments 918 are required arguments to launch workload API 902. In at least one embodiment, one or more of workload indicator 904, number of nodes 906, tasks per node 908, environment variables 910, working directory 912, launcher 914, execution modes 916, and/or other arguments 918 are optional arguments to launch workload API 902.

In at least one embodiment, not shown in FIG. 9, a processor performs one or more instructions to perform one or more APIs such as launch workload API 902 to cause a first application programming interface (API) to select a second API to perform one or more software workloads identified by the first API using one or more arguments including, but not limited to, workload indicator 904, number of nodes 906, tasks per node 908, environment variables 910, working directory 912, launcher 914, execution modes 916, and/or other arguments 918. In at least one embodiment, not shown in FIG. 9, a processor performs one or more instructions to perform one or more APIs such as launch workload API 902 to perform a first application programming interface (API) to cause a second API to be performed to cause one or more software workloads to be performed by one or more other processors using one or more arguments including, but not limited to, workload indicator 904, number of nodes 906, tasks per node 908, environment variables 910, working directory 912, launcher 914, execution modes 916, and/or other arguments 918.

In at least one embodiment, launch workload API 902, if invoked, causes one or more APIs such as one or more APIs 806, described herein at least in connection with FIG. 8, to add one or more operations or instructions to be added, inserted, or otherwise included in a stream or set of instructions to be performed by one or more accelerators within a heterogenous processor. In at least one embodiment, launch workload API 902, if invoked, causes one or more APIs such as one or more APIs 806 to, in a parallel computing environment such as parallel computing environment 808, described herein at least in connection with FIG. 8, add one or more operations or instructions to be added, inserted, or otherwise included in a stream or set of instructions to be performed by one or more accelerators within a heterogenous processor.

In at least one embodiment, in response to launch workload API 902, one or more APIs 806, if performed, are to cause one or more processors to perform a launch workload API return 920. In at least one embodiment, launch workload API return 920 is a set of instructions that, if performed, generate and/or indicate one or more data values in response to launch workload API 902.

In at least one embodiment, launch workload API return 920 indicates a success indicator 922. In at least one embodiment, success indicator 922 is data comprising any value to indicate success of launch workload API 902. In at least one embodiment, success indicator 922 comprises information indicating one or more specific types of successes generated as a result of performing launch workload API 902. In at least one embodiment, success indicator 922 comprises information indicating one or more other data values generated as a result of launch workload API 902.

In at least one embodiment, launch workload API return 920 indicates an error indicator 924. In at least one embodiment, error indicator 924 is data comprising any value to indicate failure of launch workload API 902. In at least one embodiment, error indicator 924 comprises information indicating one or more specific types of errors generated as a result of performing launch workload API 902. In at least one embodiment, error indicator 924 comprises information indicating one or more other data values generated as a result of launch workload API 902.

In at least one embodiment, launch workload API return 920 indicates a job identifier 926. In at least one embodiment, job identifier 926 is data comprising any value to indicate identifiers of jobs used to launch workload API 902 (e.g., identifiers of launched workloads). In at least one embodiment, job identifier 926 comprises information usable to identify launched workloads to monitor workload API 1002, terminate workload API 1102, and/or other such APIs, as described herein. In at least one embodiment, job identifier 926 comprises information indicating one or more other data values generated as a result of launch workload API 902. In at least one embodiment, job identifier 926 an argument to one or more other APIs including, but not limited to, an API to monitor workloads such as monitor workload API 1002 (described herein at least in connection with FIG. 10) and/or an API to terminate workloads such as terminate workload API 1102 (described herein at least in connection with FIG. 11).

In at least one embodiment, parallel computing environment 808 comprising one or more APIs 806 including, but not limited to, launch workload API 902 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, example software code indicating stream operation types is as follows:

/**
* Types of stream operations
*/
typedef enum
{
/**< Acquire semaphore */
CUSOCKET_STREAM_OP_SEMA_ACQ,
/**< Release semaphore */
CUSOCKET_STREAM_OP_SEMA_REL,
/**< Flush GPU L2 cache */
CUSOCKET_STREAM_OP_GPU_L2_FLUSH,
/**< Invalidate GPU L2 cache */
CUSOCKET_STREAM_OP_GPU_L2_INVALIDATE,
/**< Submitting an operation to an external device */
CUSOCKET_STREAM_OP_EXTERNAL_DEVICE_SUBMIT
} cuSocketStreamOpType;

In at least one embodiment, parallel computing environment 808 comprising one or more APIs 806 including, but not limited to, launch workload API 902 comprises one or more function signatures usable to indicate one or more callback functions for operations to be performed by one or more accelerators within heterogeneous processors. In at least one embodiment, one or more operations cause one or more callback functions to be performed. In at least one embodiment, example software code indicating a function signature for a callback function is as follows:

/**
* Callback function signature for submitting to an external device.
*/
typedef unsigned int (*cuSocketExternalDeviceSubmitCallback)(void
*submitArgs);

In at least one embodiment, in order to specify one or more accelerators within heterogeneous processors to perform one or more operations indicated by launch workload API 902 to one or more APIs 806, one or more data structures of one or more APIs 806 are usable to specify one or more external devices for which said one or more APIs 806 are to submit said one or more operations. In at least one embodiment, example software code indicating a data structure representing a device node for one or more accelerators within heterogeneous processors is as follows:

/**
* Struct representing the external device node that captures the information
* about a particular task submit for an external device.
*/
typedef struct
{
void *submitArgs;
cuSocketExternalDeviceSubmitCallback callback;
} cuSocketExternalDeviceNodeParams;

In at least one embodiment, in order to specify type and data of one or more operations indicated by one or more operations to be performed by one or more accelerators within heterogeneous processors, one or more data structures of one or more APIs 806 are to be used. In at least one embodiment, example software code indicating a data structure to specify type and data of one or more operations to be performed by one or more accelerators within heterogeneous processors is as follows:

```
/**
* Struct tracking the type and data for stream operations. The \p data is
populated
* with semaphore address and payload for types
* ::CUSOCKET_STREAM_OP_SEMA_ACQ and
* ::CUSOCKET_STREAM_OP_SEMA_REL
*/
typedef struct
{
/**
* Type of stream operation
*/
cuSocketStreamOpType type;
union {
/**
* Parameters for semaphore
*/
struct {
/**
* Address of semaphore to be acquired or released.
*/
void *semaAddr;
/**
* Payload value of semaphore.
*/
    unsigned int payload;
  } sema;
/**
* The particular task that needs to be submitted to the external device.
*/
cuSocketExternalDeviceNodeParams task;
} data;
} cuSocketStreamOp;
```

In at least one embodiment, one or more APIs 806 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to launch workload API 902, as described above. In at least one embodiment, example software code indicating a stream operation API call in parallel computing environment 808, such as CUDA, is as follows:

/**
* Submit a list of operations to a CUDA stream.
*
* - param[in] usrStream - The stream into which the operations are
submitted.
*
* - param[in] streamOp - The list of operations to be submitted.
*
* - param[in] count - The number of operations to be submitted.
*
* - Returns CUDA_SUCCESS on success, otherwise it returns an
appropriate error.
*/
CUresult cuSocketStreamOps(
CUstream usrStream,
cuSocketStreamOp *streamOp,
unsigned int count,
unsigned int flags
);

In at least one embodiment, one or more APIs 806 comprise instructions that, if performed, cause one or more operations or instructions to be performed by one or more accelerators within heterogeneous processors to be added to one or more executable graphs similar to how one or more operations or instructions to be performed by one or more accelerators within heterogeneous processors are to be added to one or more streams or sets of instructions in response to launch workload API 902. In at least one embodiment, example software code indicating addition of one or more operations or instructions to one or more executable graphs by one or more APIs 806 of parallel computing environment 808 is as follows:

/**
* Submit a task for an external device on a CUDA stream.
*
* - param[in] graphNode - The newly created node.
*
* - param[in] graph - The graph in which this node should be added.
*
* - param[in] dependencies - The dependencies that need to be met before
this node can
* be executed.
* - param[in] numDependencies - The number of dependencies.
* - param[in] nodeParams - The execution parameters of the node.
*
* - Returns CUDA_SUCCESS on success, otherwise it returns an
appropriate error.
*/
CUresult cuSocketAddExternalDeviceNode (
CUgraphNode* graphNode,
CUgraph graph,
CUgraphNode* dependencies,
unsigned int numDependencies,
cuSocketExternalDeviceNodeParams* nodeParams
);

FIG. 10 is a block diagram 1000 illustrating an application programming interface (API) to monitor one or more software workloads, in accordance with at least one embodiment. In at least one embodiment, one or more circuits of a processor are to perform a monitor workload API 1002, to monitor one or more software workloads of a computing environment such as computing environment 102, described herein at least in connection with FIG. 1. In at least one embodiment, one or more circuits of a processor are to perform monitor workload API 1002, to monitor one or more software workloads launched using launch workload API 902, described herein at least in connection with FIG. 9. In at least one embodiment, not shown in FIG. 10, one or more circuits of a processor such as those described herein performs one or more instructions to perform monitor workload API 1002 to perform a first application programming interface (API) to select a second API to monitor performance of one or more software workloads identified by the first API. In at least one embodiment, not shown in FIG. 10, one or more circuits of a processor such as those described herein performs one or more instructions to perform monitor workload API 1002 to perform a first application programming interface (API) to cause a second API to performed to cause a status of one or more software workloads to be provided. In at least one embodiment, also not shown in FIG. 10, one or more circuits of a processor such as those described herein performs one or more instructions to perform monitor workload API 1002 to perform a first application programming interface (API) to select a second API to monitor performance of one or more software workloads identified by the first API in response to receiving an additional API such as those described herein.

In at least one embodiment, monitor workload API 1002 receives, when invoked, one or more arguments to indicate information about operations to be performed using techniques such as those described herein. In at least one embodiment, monitor workload API 1002 receives, when invoked, one or more arguments to indicate information about instructions to be performed using techniques such as those described herein.

In at least one embodiment, monitor workload API 1002 receives, as input, one or more arguments comprising job identifier 1004. In at least one embodiment, job identifier 1004 is a data value comprising information usable to identify, indicate, or otherwise specify one or more workloads to be monitored using monitor workload API 1002. In at least one embodiment, job identifier 1004 is a job identifier returned by launch workload API 902 (e.g., job identifier 926), described herein. In at least one embodiment, a job identifier identified, indicated, or otherwise specified by job identifier 1004 is one of a plurality of parameters usable by monitor workload API 1002 to monitor one or more software workloads. In at least one embodiment, job identifier 1004 is a data value to identify, indicate, or otherwise specify to an API such as monitor workload API 1002, a set of operations or instructions to be performed by one or more PPUs, such as GPUs, and/or one or more accelerators within a heterogeneous processor, as described herein.

In at least one embodiment, monitor workload API 1002 receives, as input, one or more arguments comprising one or more other arguments 1006. In at least one embodiment, other arguments 1006 are data comprising information to indicate any other information usable in performing monitor workload API 1002 to monitor one or more software workloads. In at least one embodiment, one or more of job identifier 1004 and/or other arguments 1006 are required arguments to monitor workload API 1002. In at least one embodiment, one or more of job identifier 1004 and/or other arguments 1006 are required arguments to monitor workload API 1002.

In at least one embodiment, not shown in FIG. 10, a processor performs one or more instructions to perform one or more APIs such as monitor workload API 1002 to perform a first application programming interface (API) to select a second API to monitor performance of one or more software workloads identified by the first API using one or more arguments including, but not limited to, job identifier 1004 and/or other arguments 1006. In at least one embodiment, not shown in FIG. 10, a processor performs one or more instructions to perform one or more APIs such as monitor workload API 1002 to perform a first application programming interface (API) to cause a second API to performed to cause a status of one or more software workloads to be provided using one or more arguments including, but not limited to, job identifier 1004 and/or other arguments 1006.

In at least one embodiment, monitor workload API 1002, if invoked, causes one or more APIs such as one or more APIs 806, described herein at least in connection with FIG. 8, to add one or more operations or instructions to be added, inserted, or otherwise included in a stream or set of instructions to be performed by one or more accelerators within a heterogenous processor. In at least one embodiment, monitor workload API 1002, if invoked, causes one or more APIs such as one or more APIs 806 to, in a parallel computing environment such as parallel computing environment 808, described herein at least in connection with FIG. 8, add one or more operations or instructions to be added, inserted, or otherwise included in a stream or set of instructions to be performed by one or more accelerators within a heterogenous processor.

In at least one embodiment, in response to monitor workload API 1002, one or more APIs 806, if performed, are to cause one or more processors to perform a monitor workload API return 1020. In at least one embodiment, monitor workload API return 1020 is a set of instructions that, if performed, generate and/or indicate one or more data values in response to monitor workload API 1002. In at least one embodiment, monitor workload API return 1020 indicates a success indicator 1022. In at least one embodiment, success indicator 1022 is data comprising any value to indicate success of monitor workload API 1002. In at least one embodiment, success indicator 1022 comprises information indicating one or more specific types of successes generated as a result of performing monitor workload API 1002. In at least one embodiment, success indicator 1022 comprises information indicating one or more other data values generated as a result of monitor workload API 1002.

In at least one embodiment, monitor workload API return 1020 indicates an error indicator 1024. In at least one embodiment, error indicator 1024 is data comprising any value to indicate failure of monitor workload API 1002. In at least one embodiment, error indicator 1024 comprises information indicating one or more specific types of errors generated as a result of performing monitor workload API 1002. In at least one embodiment, error indicator 1024 comprises information indicating one or more other data values generated as a result of monitor workload API 1002.

In at least one embodiment, monitor workload API return 1020 indicates a workload status 1026. In at least one embodiment, workload status 1026 is data comprising any value to indicate one or more statuses of workloads to be monitored, which is obtained as a result of performing monitor workload API 1002. In at least one embodiment, workload status 1026 comprises information indicating one or more other data values generated as a result of monitor workload API 1002.

In at least one embodiment, parallel computing environment 808 comprising one or more APIs 806 including, but not limited to, monitor workload API 1002 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 9.

In at least one embodiment, parallel computing environment 808 comprising one or more APIs 806 including, but not limited to, monitor workload API 1002 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 9.

In at least one embodiment, in order to specify one or more accelerators within heterogeneous processors to perform one or more operations indicated by monitor workload API 1002 to one or more APIs 806, one or more data structures of one or more APIs 806 are usable to specify one or more external devices for which said one or more APIs 806 are to submit said one or more operations. In at least one embodiment, one or more data structures of one or more APIs 806 usable to specify one or more external devices for which said one or more APIs 806 are to submit said one or more operations use software code such as example software code indicating a data structure representing a device node for one or more accelerators within heterogeneous processors as described herein at least in connection with FIG. 9.

In at least one embodiment, in order to specify type and data of one or more operations indicated by one or more operations to be performed by one or more accelerators within heterogeneous processors, one or more data structures of one or more APIs 806 are to be used. In at least one embodiment, one or more data structures of one or more APIs 806 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 9.

In at least one embodiment, one or more APIs 806 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to monitor workload API 1002, as described above. In at least one embodiment, instructions to cause one or more operations or instructions to be added to a stream or other set of instructions to be performed in response to monitor workload API 1002 use software code such as example software code indicating a stream operation API call in parallel computing environment 808 as described herein at least in connection with FIG. 9.

In at least one embodiment, one or more APIs 806 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to monitor workload API 1002, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 806 of parallel computing environment 808 as described herein at least in connection with FIG. 9.

FIG. 11 is a block diagram 1100 illustrating an application programming interface (API) to terminate one or more software workloads, in accordance with at least one embodiment. In at least one embodiment, one or more circuits of a processor are to perform a terminate workload API 1102, to terminate one or more software workloads of a computing environment such as computing environment 102, described herein at least in connection with FIG. 1. In at least one embodiment, one or more circuits of a processor are to perform terminate workload API 1102, to terminate one or more software workloads launched using launch workload API 902, described herein at least in connection with FIG. 9. In at least one embodiment, not shown in FIG. 11, one or more circuits of a processor such as those described herein performs one or more instructions to perform terminate workload API 1102 to perform a first application programming interface (API) to select a second API to terminate performance of one or more software workloads identified by the first API. In at least one embodiment, not shown in FIG. 11, one or more circuits of a processor such as those described herein performs one or more instructions to perform terminate workload API 1102 to perform a first application programming interface (API) to cause a second API to be performed to cause one or more software workloads being performed by one or more other processors to be terminated. In at least one embodiment, also not shown in FIG. 11, one or more circuits of a processor such as those described herein performs one or more instructions to perform terminate workload API 1102 to perform a first application programming interface (API) to select a second API to terminate performance of one or more software workloads identified by the first API in response to receiving an additional API such as those described herein.

In at least one embodiment, terminate workload API 1102 receives, when invoked, one or more arguments to indicate information about operations to be performed using techniques such as those described herein. In at least one embodiment, terminate workload API 1102 receives, when invoked, one or more arguments to indicate information about instructions to be performed using techniques such as those described herein.

In at least one embodiment, terminate workload API 1102 receives, as input, one or more arguments comprising job identifier 1104. In at least one embodiment, job identifier 1104 is a data value comprising information usable to identify, indicate, or otherwise specify one or more workloads to be terminated using terminate workload API 1102. In at least one embodiment, job identifier 1104 is a job identifier returned by launch workload API 902 (e.g., job identifier 926), described herein. In at least one embodiment, a job identifier identified, indicated, or otherwise specified by job identifier 1104 is one of a plurality of parameters usable by terminate workload API 1102 to terminate one or more software workloads. In at least one embodiment, job identifier 1104 is a data value to identify, indicate, or otherwise specify to an API such as terminate workload API 1102, a set of operations or instructions to be performed by one or more PPUs, such as GPUs, and/or one or more accelerators within a heterogeneous processor, as described herein.

In at least one embodiment, terminate workload API 1102 receives, as input, one or more arguments comprising one or more other arguments 1106. In at least one embodiment, other arguments 1106 are data comprising information to indicate any other information usable in performing terminate workload API 1102 to terminate one or more software workloads. In at least one embodiment, one or more of job identifier 1104 and/or other arguments 1106 are required arguments to terminate workload API 1102. In at least one embodiment, one or more of job identifier 1104 and/or other arguments 1106 are required arguments to terminate workload API 1102.

In at least one embodiment, not shown in FIG. 11, a processor performs one or more instructions to perform one or more APIs such as terminate workload API 1102 to perform a first application programming interface (API) to select a second API to monitor performance of one or more software workloads identified by the first API using one or more arguments including, but not limited to, job identifier 1104 and/or other arguments 1106. In at least one embodiment, not shown in FIG. 11, a processor performs one or more instructions to perform one or more APIs such as terminate workload API 1102 to perform a first application programming interface (API) to cause a second API to performed to cause a status of one or more software workloads to be provided using one or more arguments including, but not limited to, job identifier 1104 and/or other arguments 1118.

In at least one embodiment, terminate workload API 1102, if invoked, causes one or more APIs such as one or more APIs 806, described herein at least in connection with FIG. 8, to add one or more operations or instructions to be added, inserted, or otherwise included in a stream or set of instructions to be performed by one or more accelerators within a heterogenous processor. In at least one embodiment, terminate workload API 1102, if invoked, causes one or more APIs such as one or more APIs 806 to, in a parallel computing environment such as parallel computing environment 808, described herein at least in connection with FIG. 8, add one or more operations or instructions to be added, inserted, or otherwise included in a stream or set of instructions to be performed by one or more accelerators within a heterogenous processor.

In at least one embodiment, in response to terminate workload API 1102, one or more APIs 806, if performed, are to cause one or more processors to perform a terminate workload API return 1120. In at least one embodiment, terminate workload API return 1120 is a set of instructions that, if performed, generate and/or indicate one or more data values in response to terminate workload API 1102. In at least one embodiment, terminate workload API return 1120 indicates a success indicator 1122. In at least one embodiment, success indicator 1122 is data comprising any value to indicate success of terminate workload API 1102. In at least one embodiment, success indicator 1122 comprises information indicating one or more specific types of successes generated as a result of performing terminate workload API 1102. In at least one embodiment, success indicator 1122 comprises information indicating one or more other data values generated as a result of terminate workload API 1102.

In at least one embodiment, terminate workload API return 1120 indicates an error indicator 1124. In at least one embodiment, error indicator 1124 is data comprising any value to indicate failure of terminate workload API 1102. In at least one embodiment, error indicator 1124 comprises information indicating one or more specific types of errors generated as a result of performing terminate workload API 1102. In at least one embodiment, error indicator 1124 comprises information indicating one or more other data values generated as a result of terminate workload API 1102.

In at least one embodiment, parallel computing environment 808 comprising one or more APIs 806 including, but not limited to, terminate workload API 1102 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 9.

In at least one embodiment, parallel computing environment 808 comprising one or more APIs 806 including, but not limited to, terminate workload API 1102 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 9.

In at least one embodiment, in order to specify one or more accelerators within heterogeneous processors to perform one or more operations indicated by terminate workload API 1102 to one or more APIs 806, one or more data structures of one or more APIs 806 are usable to specify one or more external devices for which said one or more APIs 806 are to submit said one or more operations. In at least one embodiment, one or more data structures of one or more APIs 806 usable to specify one or more external devices for which said one or more APIs 806 are to submit said one or more operations use software code such as example software code indicating a data structure representing a device node for one or more accelerators within heterogeneous processors as described herein at least in connection with FIG. 9.

In at least one embodiment, in order to specify type and data of one or more operations indicated by one or more operations to be performed by one or more accelerators within heterogeneous processors, one or more data structures of one or more APIs 806 are to be used. In at least one embodiment, one or more data structures of one or more APIs 806 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 9.

In at least one embodiment, one or more APIs 806 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to terminate workload API 1102, as described above. In at least one embodiment, instructions to cause one or more operations or instructions to be added to a stream or other set of instructions to be performed in response to terminate workload API 1102 use software code such as example software code indicating a stream operation API call in parallel computing environment 808 as described herein at least in connection with FIG. 9.

In at least one embodiment, one or more APIs 806 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to terminate workload API 1102, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 806 of parallel computing environment 808 as described herein at least in connection with FIG. 9.

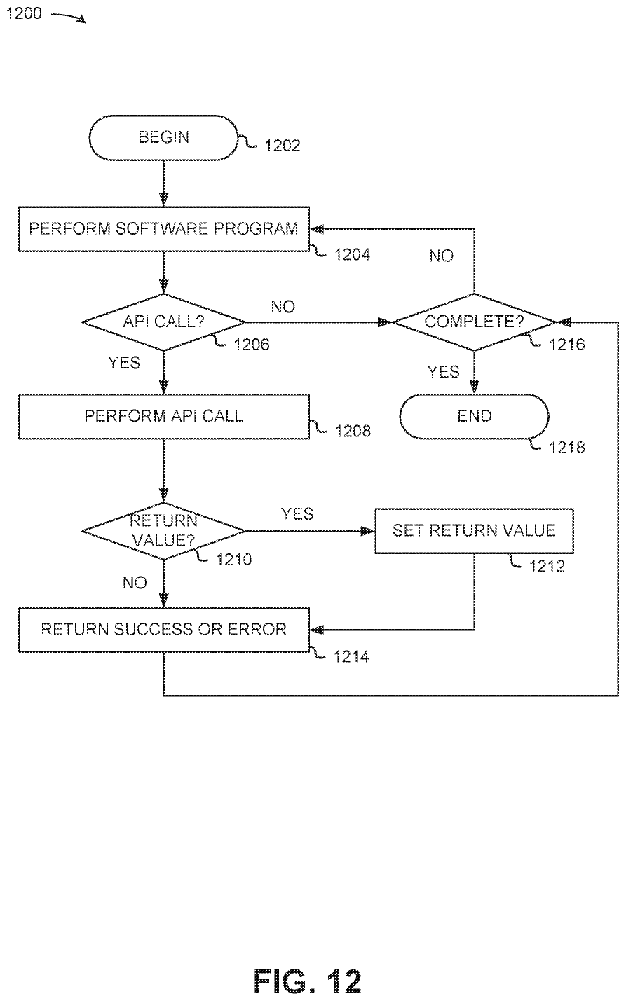

FIG. 12 illustrates a process 1200 to perform one or more application programming interfaces (APIs), in accordance with at least one embodiment. In at least one embodiment, process 1200 is a process to performing one or more APIs using one or more accelerators within a heterogeneous processor by a parallel computing environment, such as parallel computing environment 808, as described herein at least in connection with FIG. 8. In at least one embodiment, process 1200 to perform one or more application programming interfaces (APIs) begins 1202 at step 1204, whereby one or more processors are to perform a software program comprising one or more instructions that, if performed, cause said one or more processors and/or one or more other processors, such as graphics processing units (GPUs) and/or one or more accelerators within a heterogeneous processor or heterogeneous processors, to perform one or more computational operations. In at least one embodiment, at step 1204, a software program to be performed by one or more processors comprises one or more instructions that, if performed, cause one or more APIs 806 of a parallel computing environment 808 to be performed, as described above. In at least one embodiment, after step 1204, process 1200 continues at step 1206.

In at least one embodiment, at step 1206, a processor performing process 1200 determines whether performance of an API such as those described herein at least in connection with FIGS. 9-11 (e.g., launch workload API 902, monitor workload API 1002, and/or terminate workload API 1102 is to be performed. In at least one embodiment, at step 1206, if it determined that an API is not to be performed (“NO” branch), process 1200 continues at step 1216. In at least one embodiment, at step 1206, if it determined that an API is to be performed (“YES” branch), process 1200 continues at step 1208.

In at least one embodiment, at step 1208, a processor performing process 1200 performs an API such as those described herein at least in connection with FIGS. 9-11. In at least one embodiment, at step 1208, one or more processors are to perform one or more instructions to cause one or more API calls such as those described herein at least in connection with FIGS. 9-11 (e.g., launch workload API 902, monitor workload API 1002, and/or terminate workload API 1102) to be performed by said one or more processors and/or one or more other processors, such as GPUs and/or accelerators within a heterogeneous processor, as described above. In at least one embodiment, after step 1208, process 1200 continues at step 1210.

In at least one embodiment, at step 1210, a processor performing process 1200 determines whether a return value is to be returned as a result of performing one or more instructions to cause one or more API calls such as those described herein at least in connection with FIGS. 9-11 (e.g., launch workload API 902, monitor workload API 1002, and/or terminate workload API 1102) to be performed by said one or more processors and/or one or more other processors, such as GPUs and/or accelerators within a heterogeneous processor, as described above. In at least one embodiment, at step 1210 a processor performing process 1200 determines whether a return value is to be returned using an API return such as those described herein at least in connection with FIGS. 9-11 (e.g., launch workload API return 920, monitor workload API return 1020, and/or terminate workload API return 1120). In at least one embodiment, at step 1210, if it is determined that a return value is to be returned (“YES” branch), process 1200 continues at step 1212. In at least one embodiment, at step 1210, if it is determined that a return value is not to be returned (“NO” branch), process 1200 continues at step 1214.

In at least one embodiment, at step 1212, a return value is set. In at least one embodiment, at step 1212, a return value is set by storing said return value in a memory location specified by an API such as those described herein at least in connection with FIGS. 9-11 (e.g., launch workload API 902, monitor workload API 1002, and/or terminate workload API 1102). In at least one embodiment, at step 1212, a return value is set by storing said return value in a memory location included in an API return such as those described herein at least in connection with FIGS. 9-11 (e.g., launch workload API return 920, monitor workload API return 1020, and/or terminate workload API return 1120). In at least one embodiment, after step 1212, process 1200 continues at step 1214.

In at least one embodiment, at step 1214, success or failure (e.g., an error) is returned using an API return such as those described herein at least in connection with FIGS. 9-11 (e.g., launch workload API return 920, monitor workload API return 1020, and/or terminate workload API return 1120). In at least one embodiment, after step 1214, process 1200 continues at step 1216.

In at least one embodiment, at step 1216, a processor performing process 1200 determines whether performance of software program (e.g., at step 1204) is complete. In at least one embodiment, at step 1216, a processor performing process 1200 determines that performance of a software program (e.g., at step 1204) is complete based, at least in part, on whether one or more processors are executing instructions of software program (e.g., at step 1204). In at least one embodiment, at step 1216, if it is determined that performance of software program (e.g., at step 1204) is complete, process 1200 ends 1218. In at least one embodiment, at step 1216, if it is determined that performance of software program (e.g., at step 1204) is not complete, process 1200 continues at step 1204 to continue performing one or more instructions of a software program.

In at least one embodiment, operations of process 1200 to perform one or more application programming interfaces (APIs) are performed in a different order than is illustrated in FIG. 12. In at least one embodiment, operations of process 1200 to perform one or more application programming interfaces (APIs) are performed simultaneously or in parallel. In at least one embodiment, for example, operations of process 1200 to perform one or more application programming interfaces (APIs) that do not depend on each other (e.g., are order independent) are performed simultaneously or in parallel. In at least one embodiment, operations of process 1200 of process 1200 to perform one or more application programming interfaces (APIs) are performed by a plurality of threads executing on a processor such as those described herein.

FIG. 13 is a block diagram 1300 illustrating an example software stack where application programming interfaces (API) are processed, in accordance with at least one embodiment. In at least one embodiment, an API such as launch workload API 902 as described herein at least in connection with FIG. 9 is processed using software stack illustrated in block diagram 1300 to cause a first application programming interface (API) to select a second API to perform one or more software workloads identified by the first API. In at least one embodiment, an API such as monitor workload API 1002 as described herein at least in connection with FIG. 10 is processed using software stack illustrated in block diagram 1300 to perform a first application programming interface (API) to select a second API to monitor performance of one or more software workloads identified by the first API. In at least one embodiment, an API such as terminate workload API 1102 as described herein at least in connection with FIG. 11 is processed using software stack illustrated in block diagram 1300 to perform a first application programming interface (API) to select a second API to terminate performance of one or more software workloads identified by the first API. In at least one embodiment, software stack illustrated in block diagram 1300 is a software stack such as those described herein at least in connection with FIGS. 47-50. In at least one embodiment, software stack illustrated in block diagram 1300 is a software stack such as software stack 408 and/or software stack 416, described herein at least in connection with FIG. 4. In at least one embodiment, an application 1302 executes a command to determine if a feature 1304 is supported. In at least one embodiment, an application 1302 executes a command to determine if feature 1304 to perform an API such as those described herein is supported.

In at least one embodiment, application 1302 uses 1306 one or more runtime APIs 1308 to determine if feature 1304 is supported. In at least one embodiment, runtime APIs 1308 use 1310 one or more driver APIs 1312 to determine if feature 1304 is supported. In at least one embodiment, not shown in FIG. 13, application 1302 uses one or more driver APIs 1312 to determine if feature 1304 is supported. In at least one embodiment, driver APIs 1312 query 1314 computer system hardware 1316 to determine if feature 1304 is supported.

In at least one embodiment, computer system hardware 1316 determines if feature 1304 is supported by a processor 1334, by querying a set of capabilities associated with processor 1334. In at least one embodiment, processor 1334 comprises one or more processors such as those described herein (e.g., processor 114 and/or one or more of processors 104, described herein at least in connection with FIG. 1). In at least one embodiment, computer system hardware 1316 determines if a feature 1304 is supported by processor 1334, using an operating system of processor 1334. In at least one embodiment, computer system hardware 1316 determines if feature is supported by a graphics processor 1336 by querying a set of capabilities associated with graphics processor 1336. In at least one embodiment, graphics processor 1336 comprises one or more graphics processors such as those described herein (e.g., one or more of graphics processors 106, described herein at least in connection with FIG. 1). In at least one embodiment, computer system hardware 1316 determines if feature 1304 is supported by graphics processor 1336 using an operating system of processor 1334. In at least one embodiment, computer system hardware 1316 determines if feature 1304 is supported by graphics processor 1336, using an operating system of graphics processor 1336.

In at least one embodiment, after computer system hardware 1316 determines whether feature 1304 is supported, computer system hardware 1316 returns 1318 a determination result using driver APIs 1312, which may return 1320 a determination result using runtime APIs 1308, which may return 1322 a determination result to application 1302. In at least one embodiment, if application 1302 receives a determination result that indicates that feature 1304 is supported 1324, application 1302 performs a feature 1326 using one or more APIs such as those described herein. In at least one embodiment, application 1302 performs feature 1326 using systems and methods such as those described herein. In at least one embodiment, application 1302 performs feature 1326 using 1328 runtime APIs 1308 including, but not limited to, runtime versions of APIs such as those described herein at least in connection with FIGS. 9-11.

In at least one embodiment, runtime APIs 1308 perform feature 1326 using 1330 driver APIs 1312 including, but not limited to, driver versions of APIs such as those described herein. In at least one embodiment, not shown in FIG. 13, application 1302 performs feature 1326 using 1330 driver APIs 1312. In at least one embodiment, driver APIs 1312 perform feature 1326 using 1332 computer system hardware 1316.

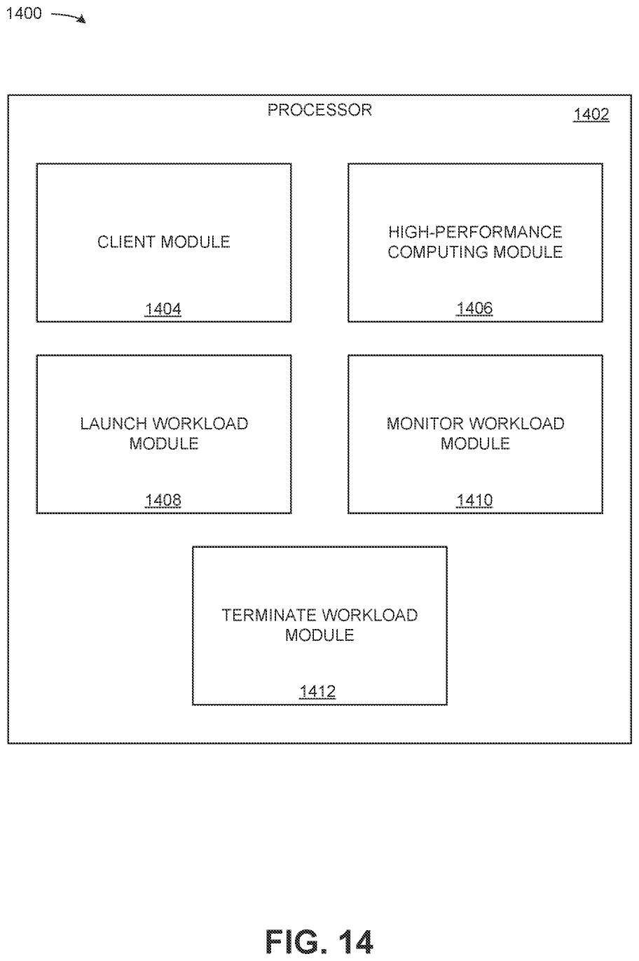

FIG. 14 is a block diagram 1400 illustrating a processor 1402 and modules, in accordance with at least one embodiment. In at least one embodiment, a processor 1402 performs one or more processes such as those described herein to cause a first application programming interface (API) to select a second API to perform one or more software workloads identified by the first API. In at least one embodiment, processor 1402 performs said process to cause one or more circuits to cause a first application programming interface (API) to select a second API to perform one or more software workloads identified by the first API using systems, methods, operations, and techniques described in connection with FIGS. 1-13.

In at least one embodiment, a processor 1402 performs one or more processes such as those described herein to perform a first application programming interface (API) to select a second API to monitor performance of one or more software workloads identified by the first API. In at least one embodiment, processor 1402 performs said process to cause one or more circuits to perform a first application programming interface (API) to select a second API to monitor performance of one or more software workloads identified by the first API using systems, methods, operations, and techniques described in connection with FIGS. 1-13.

In at least one embodiment, a processor 1402 performs one or more processes such as those described herein to perform a first application programming interface (API) to select a second API to terminate performance of one or more software workloads identified by the first API. In at least one embodiment, processor 1402 performs said process to cause one or more circuits to perform a first application programming interface (API) to select a second API to terminate performance of one or more software workloads identified by the first API using systems, methods, operations, and techniques described in connection with FIGS. 1-13.

In at least one embodiment, processor 1402 comprises one or more processors such as those described in connection with FIGS. 16-53. In at least one embodiment, processor 1402 is a processor such as processor 114, one or more of processors 104 and/or one or more of graphics processors 106, described herein at least in connection with FIG. 1. In at least one embodiment, processor 1402 is any suitable processing unit and/or combination of processing units, such as one or more CPUs, GPUs, GPGPUs, PPUs, and/or variations thereof. In at least one embodiment, processor 1402 comprises or has access to a client module 1404, a high-performance computing module 1406, a launch workload module 1408, a monitor workload module 1410, and a terminate workload module 1412. In at least one embodiment, client module 1404, high-performance computing module 1406, launch workload module 1408, monitor workload module 1410, and terminate workload module 1412 are part of processor 1402 and/or one or more other processors such as those described herein. In at least one embodiment, client module 1404, high-performance computing module 1406, launch workload module 1408, monitor workload module 1410, and terminate workload module 1412 are distributed among multiple processors that communicate over a bus, network, by writing to shared memory, and/or any suitable communication process such as those described herein.

In at least one embodiment, a module as used in any implementation described herein, unless otherwise clear from context or stated explicitly to contrary, refers to any combination of software logic, firmware logic, hardware logic, and/or circuitry configured to provide functionality described herein. In at least one embodiment, software may be embodied as a software package, code and/or instruction set or instructions, and “hardware,” as used, such as by a processor, in any implementation described herein, may include, for example, singly or in any combination, hardwired circuitry, programmable circuitry, state machine circuitry, fixed function circuitry, execution unit circuitry, and/or firmware that stores instructions executed by programmable circuitry. In at least one embodiment, modules may, collectively or individually, be embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof.

In at least one embodiment, processor 1402 uses client module 1404 to perform or otherwise implement one or more client environments such as those described herein. In at least one embodiment, processor 1402 uses client module 1404 to perform one or more APIs such as those described herein (e.g., launch workload API 902, monitor workload API 1002, and/or terminate workload API 1102). In at least one embodiment, processor 1402 performs client module 1404 and processes such as those described herein by at least including or otherwise encoding instructions that cause performance of or otherwise can be utilized to perform said one or more processes (e.g., by processor 1402). In at least one embodiment, a processor using client module 1404 obtains or is otherwise provided with one or more APIs such as those described herein. In at least one embodiment, processor 1402 uses client module 1404 to perform or otherwise implement one or more client environments using systems, methods, operations, and techniques described herein at least in connection with FIGS. 1-13. In at least one embodiment, processor 1402 uses client module 1404 to perform one or more operations to cause a first application programming interface (API) to select a second API to perform one or more software workloads identified by the first API. In at least one embodiment, processor 1402 uses client module 1404 to perform one or more operations to perform a first application programming interface (API) to select a second API to monitor performance of one or more software workloads identified by the first API. In at least one embodiment, processor 1402 uses client module 1404 to perform one or more operations to perform a first application programming interface (API) to select a second API to terminate performance of one or more software workloads identified by the first API.

In at least one embodiment, processor 1402 uses high-performance computing module 1406 to perform or otherwise implement one or more high-performance computing environments such as those as described herein. In at least one embodiment, processor 1402 uses high-performance computing module 1406 to perform one or more APIs such as those described herein (e.g., launch workload API 902, monitor workload API 1002, and/or terminate workload API 1102). In at least one embodiment, processor 1402 uses high-performance computing module 1406 to perform one or more processes such as those described herein by at least including or otherwise encoding instructions that cause performance of or otherwise can be utilized to perform said one or more processes (e.g., by processor 1402). In at least one embodiment, processor 1402 uses high-performance computing module 1406 to perform one or more APIs in connection with client module 1404. In at least one embodiment, processor 1402 uses high-performance computing module 1406 to perform one or more operations to cause a first application programming interface (API) to select a second API to perform one or more software workloads identified by the first API. In at least one embodiment, processor 1402 uses high-performance computing module 1406 to perform one or more operations to perform a first application programming interface (API) to select a second API to monitor performance of one or more software workloads identified by the first API. In at least one embodiment, processor 1402 uses high-performance computing module 1406 to perform one or more operations to perform a first application programming interface (API) to select a second API to terminate performance of one or more software workloads identified by the first API.

In at least one embodiment, processor 1402 uses launch workload module 1408 to launch one or more software workloads, as described herein. In at least one embodiment, launch workload module 1408 performs one or more processes such as those described herein by at least including or otherwise encoding instructions that cause performance of or otherwise can be utilized to perform said one or more processes (e.g., by processor 1402). In at least one embodiment, launch workload module 1408 causes one or more software workloads to be launched using systems, methods, operations, and/or techniques described herein. In at least one embodiment, launch workload module 1408 causes one or more software workloads to be launched using an API such as launch workload API 902. In at least one embodiment, a processor uses launch workload module 1408 to perform one or more operations to cause a first application programming interface (API) to select a second API to perform one or more software workloads identified by the first API. In at least one embodiment, a processor uses launch workload module 1408 to perform one or more operations to perform a first application programming interface (API) to select a second API to monitor performance of one or more software workloads identified by the first API. In at least one embodiment, a processor uses launch workload module 1408 to perform one or more operations to perform a first application programming interface (API) to select a second API to terminate performance of one or more software workloads identified by the first API.

In at least one embodiment, processor 1402 uses monitor workload module 1410 to monitor one or more software workloads, as described herein. In at least one embodiment, monitor workload module 1410 performs one or more processes such as those described herein by at least including or otherwise encoding instructions that cause performance of or otherwise can be utilized to perform said one or more processes (e.g., by processor 1402). In at least one embodiment, monitor workload module 1410 causes one or more software workloads to be monitored using systems, methods, operations, and/or techniques described herein. In at least one embodiment, monitor workload module 1410 causes one or more software workloads to be monitored using an API such as monitor workload API 1002. In at least one embodiment, a processor uses monitor workload module 1410 to perform one or more operations to cause a first application programming interface (API) to select a second API to perform one or more software workloads identified by the first API. In at least one embodiment, a processor uses monitor workload module 1410 to perform one or more operations to perform a first application programming interface (API) to select a second API to monitor performance of one or more software workloads identified by the first API. In at least one embodiment, a processor uses monitor workload module 1410 to perform one or more operations to perform a first application programming interface (API) to select a second API to terminate performance of one or more software workloads identified by the first API.

In at least one embodiment, processor 1402 uses terminate workload module 1412 to terminate one or more software workloads, as described herein. In at least one embodiment, terminate workload module 1412 performs one or more processes such as those described herein by at least including or otherwise encoding instructions that cause performance of or otherwise can be utilized to perform said one or more processes (e.g., by processor 1402). In at least one embodiment, terminate workload module 1412 causes one or more software workloads to be terminated using systems, methods, operations, and/or techniques described herein. In at least one embodiment, terminate workload module 1412 causes one or more software workloads to be terminated using an API such as terminate workload API 1102. In at least one embodiment, a processor uses terminate workload module 1412 to perform one or more operations to cause a first application programming interface (API) to select a second API to perform one or more software workloads identified by the first API. In at least one embodiment, a processor uses terminate workload module 1412 to perform one or more operations to perform a first application programming interface (API) to select a second API to monitor performance of one or more software workloads identified by the first API. In at least one embodiment, a processor uses terminate workload module 1412 to perform one or more operations to perform a first application programming interface (API) to select a second API to terminate performance of one or more software workloads identified by the first API.

In at least one embodiment, processor 1402 comprises circuitry to cause one or more circuits of processor 1402 to cause a first application programming interface (API) to select a second API to perform one or more software workloads identified by the first API using one or more of client module 1404, high-performance computing module 1406, launch workload module 1408, monitor workload module 1410, and/or terminate workload module 1412 using systems, methods, operations, and/or techniques described herein at least in connection with FIGS. 1-13. In at least one embodiment, processor 1402 comprises circuitry to cause one or more circuits of processor 1402 to perform a first application programming interface (API) to select a second API to monitor performance of one or more software workloads identified by the first API using one or more of client module 1404, high-performance computing module 1406, launch workload module 1408, monitor workload module 1410, and/or terminate workload module 1412 using systems, methods, operations, and/or techniques described herein at least in connection with FIGS. 1-13. In at least one embodiment, processor 1402 comprises circuitry to cause one or more circuits of processor 1402 to perform a first application programming interface (API) to select a second API to terminate performance of one or more software workloads identified by the first API using one or more of client module 1404, high-performance computing module 1406, launch workload module 1408, monitor workload module 1410, and/or terminate workload module 1412 using systems, methods, operations, and/or techniques described herein at least in connection with FIGS. 1-13.

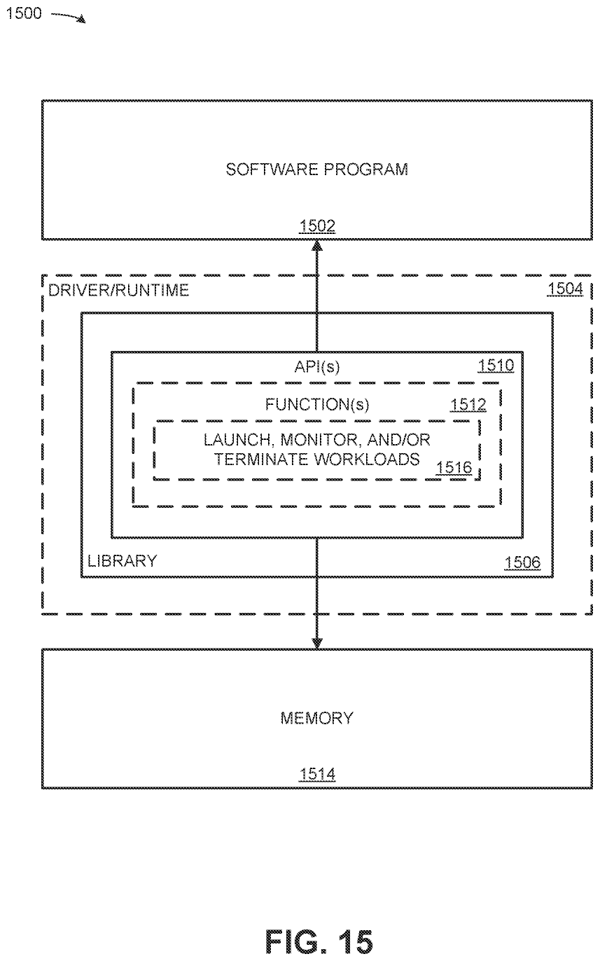

FIG. 15 is a block diagram 1500 illustrating a driver and/or runtime comprising one or more libraries to provide one or more application programming interfaces (APIs), in accordance with at least one embodiment. In at least one embodiment, a software program 1502 is a software module. In at least one embodiment, a software program 1502 comprises one or more software modules including, but not limited to, those described herein at least in connection with FIG. 14. In at least one embodiment, a software module is as further described non-exclusively in FIG. 14. In at least one embodiment, one or more APIs 1510 are sets of software instructions that, if executed, cause one or more processors to perform one or more computational operations. In at least one embodiment, one or more APIs 1510 comprise one or more of launch workload API 902, monitor workload API 1002, and/or terminate workload API 1102. In at least one embodiment, one or more APIs 1510 are sets of software instructions that, if executed, cause one or more processors to perform one or more computational operations to cause a first application programming interface (API) to select a second API to perform one or more software workloads identified by the first API. In at least one embodiment, one or more APIs 1510 are sets of software instructions that, if executed, cause one or more processors to perform one or more computational operations to perform a first application programming interface (API) to select a second API to monitor performance of one or more software workloads identified by the first API. In at least one embodiment, one or more APIs 1510 are sets of software instructions that, if executed, cause one or more processors to perform one or more computational operations to perform a first application programming interface (API) to select a second API to terminate performance of one or more software workloads identified by the first API.

In at least one embodiment, one or more APIs 1510 are distributed or otherwise provided as a part of one or more libraries 1506, drivers and/or runtimes 1504, and/or any other grouping of software and/or executable code further described herein. In at least one embodiment, one or more APIs 1510 perform one or more computational operations in response to invocation by software programs 1502. In at least one embodiment, a software program 1502 is a collection of software code, commands, instructions, or other sequences of text to instruct a computing device to perform one or more computational operations and/or invoke one or more other sets of instructions, such as APIs 1510 or API functions 1512, to be executed. In at least one embodiment, functionality provided by one or more APIs 1510 include software functions 1512, such as those usable to accelerate one or more portions of software programs 1502 using one or more parallel processing units (PPUs), such as graphics processing units (GPUs).

In at least one embodiment, APIs 1510 are hardware interfaces to one or more circuits to perform one or more computational operations. In at least one embodiment, one or more software APIs 1510 described herein are implemented as one or more circuits to perform one or more techniques described herein in conjunction with FIGS. 1-13. In at least one embodiment, one or more software programs 1502 comprise instructions that, if executed, cause one or more hardware devices and/or circuits to perform one or more techniques described herein in conjunction with FIGS. 1-13.

In at least one embodiment, software programs 1502, such as user-implemented software programs, utilize one or more application programming interfaces (APIs) 1510 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 1510 provide a set of callable functions 1512, referred to herein as APIs, API functions, and/or functions, that individually perform one or more computing operations, such as computing operations related to parallel computing. For example, in an embodiment, one or more APIs 1510 provide functions 1512 to launch workloads, monitor workloads, and/or terminate workloads, as described herein.

In at least one embodiment, one or more software programs 1502 interact or otherwise communicate with one or more APIs 1510 to perform one or more computing operations using one or more PPUs, such as GPUs. In at least one embodiment, one or more computing operations using one or more PPUs comprise at least one or more groups of computing operations to be accelerated by execution at least in part by said one or more PPUs. In at least one embodiment, one or more software programs 1502 interact with one or more APIs 1510 to facilitate parallel computing using a remote or local interface.

In at least one embodiment, an interface is software instructions that, if executed, provide access to one or more functions 1512 provided by one or more APIs 1510. In at least one embodiment, a software program 1502 uses a local interface when a software developer compiles one or more software programs 1502 in conjunction with one or more libraries 1506 comprising or otherwise providing access to one or more APIs 1510. In at least one embodiment, one or more software programs 1502 are compiled statically in conjunction with pre-compiled libraries 1506 or uncompiled source code comprising instructions to perform one or more APIs 1510. In at least one embodiment, one or more software programs 1502 are compiled dynamically and said one or more software programs utilize a linker to link to one or more pre-compiled libraries 1506 comprising one or more APIs 1510.

In at least one embodiment, a software program 1502 uses a remote interface when a software developer executes a software program that utilizes or otherwise communicates with a library 1506 comprising one or more APIs 1510 over a network or other remote communication medium. In at least one embodiment, one or more libraries 1506 comprising one or more APIs 1510 are to be performed by a remote computing service, such as a computing resource services provider. In another embodiment, one or more libraries 1506 comprising one or more APIs 1510 are to be performed by any other computing host providing said one or more APIs 1510 to one or more software programs 1502.

In at least one embodiment, a processor performing or using one or more software programs 1502 call, use, perform, or otherwise implement one or more APIs 1510 to allocate and otherwise manage memory to be used by said software programs 1502. In at least one embodiment, one or more software programs 1502 utilize one or more APIs 1510 to allocate and otherwise manage memory to be used by one or more portions of said software programs 1502 to be accelerated using one or more PPUs, such as GPUs or any other accelerator or processor further described herein. Those software programs 1502 request a processor to launch workloads, monitor workloads, and/or terminate workloads using functions 1512 provided, in an embodiment, by one or more APIs 1510.

In at least one embodiment, an API 1510 is an API to facilitate parallel computing. In at least one embodiment, an API 1510 is any other API further described herein. In at least one embodiment, an API 1510 is provided by a driver and/or runtime 1504. In at least one embodiment, an API 1510 is provided by a CUDA user-mode driver. In at least one embodiment, an API 1510 is provided by a CUDA runtime. In at least one embodiment, a driver and/or runtime 1504 is data values and software instructions that, if executed, perform or otherwise facilitate operation of one or more functions 1512 of an API 1510 during load and execution of one or more portions of a software program 1502. In at least one embodiment, drivers and/or runtimes 1504 is data values and software instructions that, if executed, perform or otherwise facilitate operation of one or more functions 1512 of an API 1510 during execution of a software program 1502. In at least one embodiment, one or more software programs 1502 utilize one or more APIs 1510 implemented or otherwise provided by a driver and/or runtime 1504 to perform combined arithmetic operations by said one or more software programs 1502 during execution by one or more PPUs, such as GPUs.

In at least one embodiment, one or more software programs 1502 utilize one or more APIs 1510 provided by a driver and/or runtime 1504 to perform combine arithmetic operations of one or more PPUs, such as GPUs. In at least one embodiment, one or more APIs 1510 provide combined arithmetic operations through a driver and/or runtime 1504, as described above. In at least one embodiment, one or more software programs 1502 utilize one or more APIs 1510 provided by a driver and/or runtime 1504 to allocate or otherwise reserve one or more blocks of memory 1514 of one or more PPUs, such as GPUs. In at least one embodiment, one or more software programs 1502 utilize one or more APIs 1510 provided by a driver and/or runtime 1504 to allocate or otherwise reserve blocks of memory. In at least one embodiment, one or more APIs 1510 are to perform combined arithmetic operations, as described herein in conjunction with FIGS. 1-13.

To improve software programs 1502 usability and/or optimization of one or more portions of said software programs 1502 to be accelerated by one or more PPUs, such as GPUs, in an embodiment, one or more APIs 1510 provide one or more API functions 1512 to launch workloads, monitor workloads, and/or terminate workloads where said workloads are usable or used by one or more computing devices as described above and further described herein in conjunction with FIGS. 1-13. In at least one embodiment, block diagram 1500 depicts a processor, comprising one or more circuits to perform one or more software programs to combine two or more application programming interfaces (APIs) into a single API. In at least one embodiment, block diagram 1500 depicts a system, comprising one or more processors to perform one or more software programs to combine two or more application programming interfaces (APIs) into a single API. In at least one embodiment, a processor uses an API to launch, monitor, and/or terminate workloads 1516 as described herein. In at least one embodiment, a processor uses an API to launch, monitor, and/or terminate workloads 1516, where said processor launches, monitors, and/or terminates workloads 1516 by causing one or more circuits to cause a first application programming interface (API) to select a second API to perform one or more software workloads identified by the first API. In at least one embodiment, a processor uses an API to launch, monitor, and/or terminate workloads 1516, where said processor launches, monitors, and/or terminates workloads 1516 by causing one or more circuits to perform a first application programming interface (API) to select a second API to monitor performance of one or more software workloads identified by the first API. In at least one embodiment, a processor uses an API to launch, monitor, and/or terminate workloads 1516, where said processor launches, monitors, and/or terminates workloads 1516 by causing one or more circuits to perform a first application programming interface (API) to select a second API to terminate performance of one or more software workloads identified by the first API.

In the following description, numerous specific details are set forth to provide a more thorough understanding of at least one embodiment. However, it will be apparent to one skilled in the art that the inventive concepts may be practiced without one or more of these specific details.

### Servers and Data Centers

The following figures set forth, without limitation, exemplary network server and data center based systems that can be used to implement at least one embodiment.

FIG. 16 illustrates a distributed system 1600, in accordance with at least one embodiment. In at least one embodiment, distributed system 1600 includes one or more client computing devices 1602, 1604, 1606, and 1608, which are configured to execute and operate a client application such as a web browser, proprietary client, and/or variations thereof over one or more network(s) 1610. In at least one embodiment, server 1612 may be communicatively coupled with remote client computing devices 1602, 1604, 1606, and 1608 via network(s) 1610.

In at least one embodiment, server 1612 may be adapted to run one or more services or software applications such as services and applications that may manage session activity of single sign-on (SSO) access across multiple data centers. In at least one embodiment, server 1612 may also provide other services or software applications can include non-virtual and virtual environments. In at least one embodiment, these services may be offered as web-based or cloud services or under a Software as a Service (SaaS) model to users of client computing devices 1602, 1604, 1606, and/or 1608. In at least one embodiment, users operating client computing devices 1602, 1604, 1606, and/or 1608 may in turn utilize one or more client applications to interact with server 1612 to utilize services provided by these components.

In at least one embodiment, software components 1618, 1620 and 1622 of system 1600 are implemented on server 1612. In at least one embodiment, one or more components of system 1600 and/or services provided by these components may also be implemented by one or more of client computing devices 1602, 1604, 1606, and/or 1608. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 1600. The embodiment shown in FIG. 16 is thus one example of a distributed system for implementing an embodiment system and is not intended to be limiting.

In at least one embodiment, client computing devices 1602, 1604, 1606, and/or 1608 may include various types of computing systems. In at least one embodiment, a client computing device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially-available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (e.g., a Microsoft Xbox gaming console with or without a Kinect® gesture input device), and/or a personal messaging device, capable of communicating over network(s) 1610. Although distributed system 1600 in FIG. 16 is shown with four client computing devices, any number of client computing devices may be supported. Other devices, such as devices with sensors, etc., may interact with server 1612.

In at least one embodiment, network(s) 1610 in distributed system 1600 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, network(s) 1610 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks).

In at least one embodiment, server 1612 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 1612 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 1612 using software defined networking. In at least one embodiment, server 1612 may be adapted to run one or more services or software applications.

In at least one embodiment, server 1612 may run any operating system, as well as any commercially available server operating system. In at least one embodiment, server 1612 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 1612 may include one or more applications to analyze and consolidate data feeds and/or event updates received from users of client computing devices 1602, 1604, 1606, and 1608. In at least one embodiment, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and/or variations thereof. In at least one embodiment, server 1612 may also include one or more applications to display data feeds and/or real-time events via one or more display devices of client computing devices 1602, 1604, 1606, and 1608.

In at least one embodiment, distributed system 1600 may also include one or more databases 1614 and 1616. In at least one embodiment, databases may provide a mechanism for storing information such as user interactions information, usage patterns information, adaptation rules information, and other information. In at least one embodiment, databases 1614 and 1616 may reside in a variety of locations. In at least one embodiment, one or more of databases 1614 and 1616 may reside on a non-transitory storage medium local to (and/or resident in) server 1612. In at least one embodiment, databases 1614 and 1616 may be remote from server 1612 and in communication with server 1612 via a network-based or dedicated connection. In at least one embodiment, databases 1614 and 1616 may reside in a storage-area network (SAN). In at least one embodiment, any necessary files for performing functions attributed to server 1612 may be stored locally on server 1612 and/or remotely, as appropriate. In at least one embodiment, databases 1614 and 1616 may include relational databases, such as databases that are adapted to store, update, and retrieve data in response to SQL-formatted commands.

In at least one embodiment, at least one component shown or described with respect to FIG. 16 is used to perform techniques and/or functions described in connection with FIGS. 1-15. In at least one embodiment, at least one component shown or described with respect to FIG. 16 is used to cause a first application programming interface (API) to select a second API to perform one or more software workloads identified by the first API. In at least one embodiment, at least one component shown or described with respect to FIG. 16 is used to perform a first application programming interface (API) to select a second API to monitor performance of one or more software workloads identified by the first API. In at least one embodiment, at least one component shown or described with respect to FIG. 16 is used to perform a first application programming interface (API) to select a second API to terminate performance of one or more software workloads identified by the first API. In at least one embodiment, at least one component shown or described with respect to FIG. 16 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

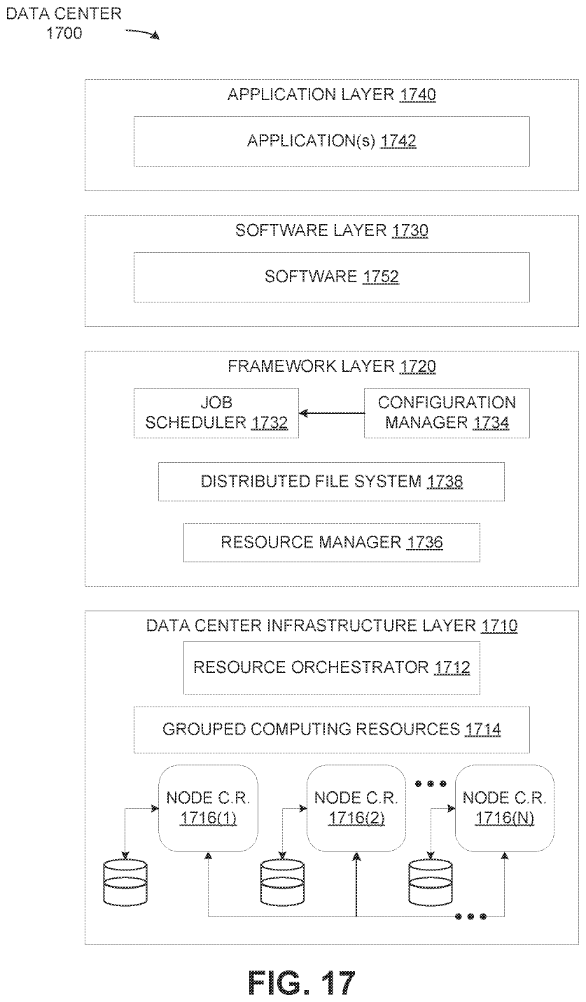

FIG. 17 illustrates an exemplary data center 1700, in accordance with at least one embodiment. In at least one embodiment, data center 1700 includes, without limitation, a data center infrastructure layer 1710, a framework layer 1720, a software layer 1730 and an application layer 1740.

In at least one embodiment, as shown in FIG. 17, data center infrastructure layer 1710 may include a resource orchestrator 1712, grouped computing resources 1714, and node computing resources (“node C.R.s”) 1716(1)-1716(N), where “N” represents any whole, positive integer. In at least one embodiment, node C.R.s 1716(1)-1716(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1716(1)-1716(N) may be a server having one or more of above-mentioned computing resources.

In at least one embodiment, grouped computing resources 1714 may include separate groupings of node C.R.s housed within one or more racks (not shown), or many racks housed in data centers at various geographical locations (also not shown). Separate groupings of node C.R.s within grouped computing resources 1714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1712 may configure or otherwise control one or more node C.R.s 1716(1)-1716(N) and/or grouped computing resources 1714. In at least one embodiment, resource orchestrator 1712 may include a software design infrastructure (“SDI”) management entity for data center 1700. In at least one embodiment, resource orchestrator 1712 may include hardware, software or some combination thereof.

In at least one embodiment, as shown in FIG. 17, framework layer 1720 includes, without limitation, a job scheduler 1732, a configuration manager 1734, a resource manager 1736 and a distributed file system 1738. In at least one embodiment, framework layer 1720 may include a framework to support software 1752 of software layer 1730 and/or one or more application(s) 1742 of application layer 1740. In at least one embodiment, software 1752 or application(s) 1742 may respectively include web-based service software or applications, such as those provided by Amazon Web Services, Google Cloud, and Microsoft Azure. In at least one embodiment, framework layer 1720 may be, but is not limited to, a type of free and open-source software web application framework such as Apache Spark™ (hereinafter “Spark”) that may utilize distributed file system 1738 for large-scale data processing (e.g., “big data”). In at least one embodiment, job scheduler 1732 may include a Spark driver to facilitate scheduling of workloads supported by various layers of data center 1700. In at least one embodiment, configuration manager 1734 may be capable of configuring different layers such as software layer 1730 and framework layer 1720, including Spark and distributed file system 1738 for supporting large-scale data processing. In at least one embodiment, resource manager 1736 may be capable of managing clustered or grouped computing resources mapped to or allocated for support of distributed file system 1738 and job scheduler 1732. In at least one embodiment, clustered or grouped computing resources may include grouped computing resource 1714 at data center infrastructure layer 1710. In at least one embodiment, resource manager 1736 may coordinate with resource orchestrator 1712 to manage these mapped or allocated computing resources.

In at least one embodiment, software 1752 included in software layer 1730 may include software used by at least portions of node C.R.s 1716(1)-1716(N), grouped computing resources 1714, and/or distributed file system 1738 of framework layer 1720. One or more types of software may include, but are not limited to, Internet web page search software, e-mail virus scan software, database software, and streaming video content software.

In at least one embodiment, application(s) 1742 included in application layer 1740 may include one or more types of applications used by at least portions of node C.R.s 1716(1)-1716(N), grouped computing resources 1714, and/or distributed file system 1738 of framework layer 1720. In at least one or more types of applications may include, without limitation, CUDA applications, 5G network applications, artificial intelligence application, data center applications, and/or variations thereof.

In at least one embodiment, any of configuration manager 1734, resource manager 1736, and resource orchestrator 1712 may implement any number and type of self-modifying actions based on any amount and type of data acquired in any technically feasible fashion. In at least one embodiment, self-modifying actions may relieve a data center operator of data center 1700 from making possibly bad configuration decisions and possibly avoiding underutilized and/or poor performing portions of a data center.

In at least one embodiment, at least one component shown or described with respect to FIG. 17 is used to perform techniques and/or functions described in connection with FIGS. 1-15. In at least one embodiment, at least one component shown or described with respect to FIG. 17 is used to cause a first application programming interface (API) to select a second API to perform one or more software workloads identified by the first API. In at least one embodiment, at least one component shown or described with respect to FIG. 17 is used to perform a first application programming interface (API) to select a second API to monitor performance of one or more software workloads identified by the first API. In at least one embodiment, at least one component shown or described with respect to FIG. 17 is used to perform a first application programming interface (API) to select a second API to terminate performance of one or more software workloads identified by the first API. In at least one embodiment, at least one component shown or described with respect to FIG. 17 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

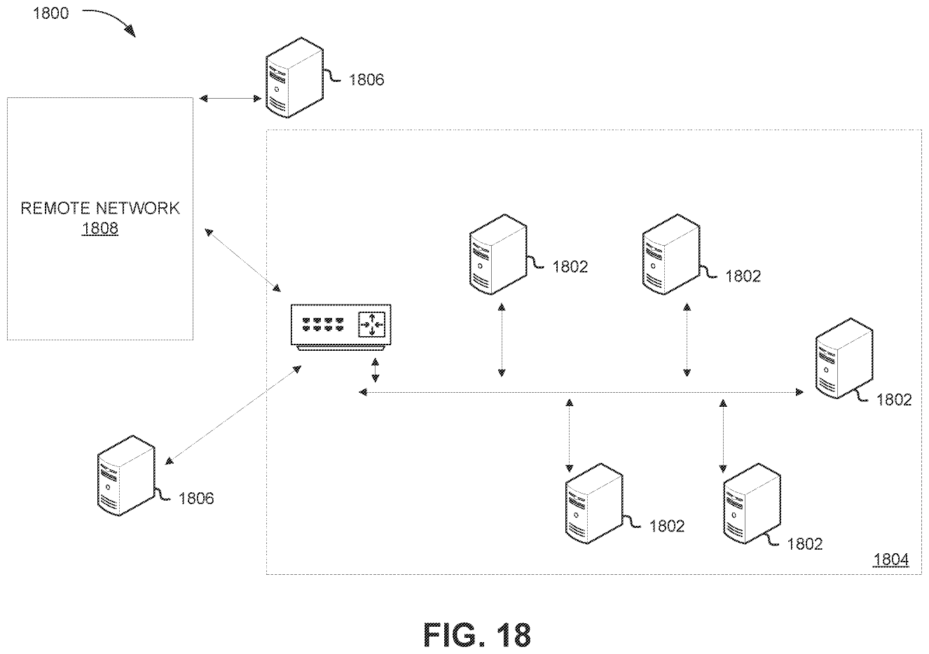

FIG. 18 illustrates a client-server network 1804 formed by a plurality of network server computers 1802 which are interlinked, in accordance with at least one embodiment. In at least one embodiment, in a system 1800, each network server computer 1802 stores data accessible to other network server computers 1802 and to client computers 1806 and networks 1808 which link into a wide area network 1804. In at least one embodiment, configuration of a client-server network 1804 may change over time as client computers 1806 and one or more networks 1808 connect and disconnect from a network 1804, and as one or more trunk line server computers 1802 are added or removed from a network 1804. In at least one embodiment, when a client computer 1806 and a network 1808 are connected with network server computers 1802, client-server network includes such client computers 1806 and network 1808. In at least one embodiment, the term computer includes any device or machine capable of accepting data, applying prescribed processes to data, and supplying results of processes.

In at least one embodiment, client-server network 1804 stores information which is accessible to network server computers 1802, remote networks 1808 and client computers 1806. In at least one embodiment, network server computers 1802 are formed by main frame computers minicomputers, and/or microcomputers having one or more processors each. In at least one embodiment, server computers 1802 are linked together by wired and/or wireless transfer media, such as conductive wire, fiber optic cable, and/or microwave transmission media, satellite transmission media or other conductive, optic or electromagnetic wave transmission media. In at least one embodiment, client computers 1806 access a network server computer 1802 by a similar wired or a wireless transfer medium. In at least one embodiment, a client computer 1806 may link into a client-server network 1804 using a modem and a standard telephone communication network. In at least one embodiment, alternative carrier systems such as cable and satellite communication systems also may be used to link into client-server network 1804. In at least one embodiment, other private or time-shared carrier systems may be used. In at least one embodiment, network 1804 is a global information network, such as the Internet. In at least one embodiment, network is a private intranet using similar protocols as the Internet, but with added security measures and restricted access controls. In at least one embodiment, network 1804 is a private, or semi-private network using proprietary communication protocols.

In at least one embodiment, client computer 1806 is any end user computer, and may also be a mainframe computer, mini-computer or microcomputer having one or more microprocessors. In at least one embodiment, server computer 1802 may at times function as a client computer accessing another server computer 1802. In at least one embodiment, remote network 1808 may be a local area network, a network added into a wide area network through an independent service provider (ISP) for the Internet, or another group of computers interconnected by wired or wireless transfer media having a configuration which is either fixed or changing over time. In at least one embodiment, client computers 1806 may link into and access a network 1804 independently or through a remote network 1808.

In at least one embodiment, at least one component shown or described with respect to FIG. 18 is used to perform techniques and/or functions described in connection with FIGS. 1-15. In at least one embodiment, at least one component shown or described with respect to FIG. 18 is used to cause a first application programming interface (API) to select a second API to perform one or more software workloads identified by the first API. In at least one embodiment, at least one component shown or described with respect to FIG. 18 is used to perform a first application programming interface (API) to select a second API to monitor performance of one or more software workloads identified by the first API. In at least one embodiment, at least one component shown or described with respect to FIG. 18 is used to perform a first application programming interface (API) to select a second API to terminate performance of one or more software workloads identified by the first API. In at least one embodiment, at least one component shown or described with respect to FIG. 18 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

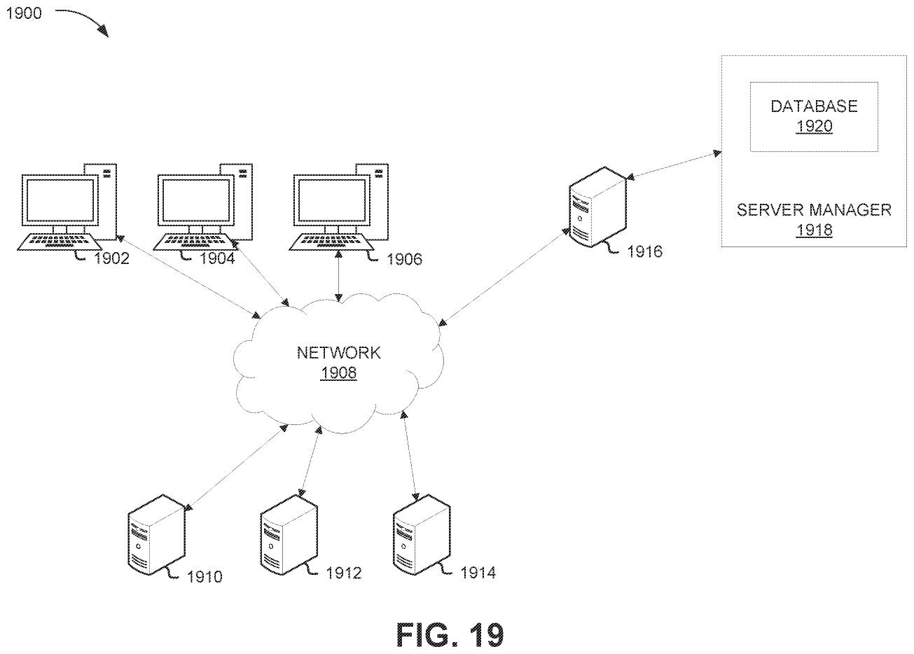

FIG. 19 illustrates an example 1900 of a computer network 1908 connecting one or more computing machines, in accordance with at least one embodiment. In at least one embodiment, network 1908 may be any type of electronically connected group of computers including, for instance, the following networks: Internet, Intranet, Local Area Networks (LAN), Wide Area Networks (WAN), or an interconnected combination of these network types. In at least one embodiment, connectivity within a network 1908 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 1908 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 1908 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (e.g. www.site.com) which maps to an IP address of a network server.

In at least one embodiment, a plurality of clients 1902, 1904, and 1906 are connected to a network 1908 via respective communication links. In at least one embodiment, each of these clients may access a network 1908 via any desired form of communication, such as via a dial-up modem connection, cable link, a digital subscriber line (DSL), wireless or satellite link, or any other form of communication. In at least one embodiment, each client may communicate using any machine that is compatible with a network 1908, such as a personal computer (PC), work station, dedicated terminal, personal data assistant (PDA), or other similar equipment. In at least one embodiment, clients 1902, 1904, and 1906 may or may not be located in a same geographical area.

In at least one embodiment, a plurality of servers 1910, 1912, and 1914 are connected to a network 1908 to serve clients that are in communication with a network 1908. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 1910, 1912, 1914 run application programs that respond to client commands. In at least one embodiment, server 1910 may run a web server application for responding to client requests for HTML, pages and may also run a mail server application for receiving and routing electronic mail. In at least one embodiment, other application programs, such as an FTP server or a media server for streaming audio/video data to clients may also be running on a server 1910. In at least one embodiment, different servers may be dedicated to performing different tasks. In at least one embodiment, server 1910 may be a dedicated web server that manages resources relating to web sites for various users, whereas a server 1912 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 1910, 1912, and 1914 are under control of a web hosting provider in a business of maintaining and delivering third party content over a network 1908.

In at least one embodiment, web hosting providers deliver services to two different types of clients. In at least one embodiment, one type, which may be referred to as a browser, requests content from servers 1910, 1912, and 1914 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 1916 is in communication with a network 1908 via a communication link. In at least one embodiment, intranet server 1916 is in communication with a server manager 1918. In at least one embodiment, server manager 1918 comprises a database of an application program configuration parameters which are being utilized in servers 1910, 1912, and 1914. In at least one embodiment, users modify a database 1920 via an intranet server 1916, and a server manager 1918 interacts with servers 1910, 1912, and 1914 to modify application program parameters so that they match a content of a database. In at least one embodiment, a user logs onto an intranet server 1916 by connecting to an intranet server 1916 via clients 1902 and entering authentication information, such as a username and password.

In at least one embodiment, when a user wishes to sign up for new service or modify an existing service, an intranet server 1916 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 1916 updates a database 1920. In at least one embodiment, server manager 1918 forwards this information to an appropriate server, and a new parameter is used during application program operation. In at least one embodiment, an intranet server 1916 is configured to provide users with access to configuration parameters of hosted network resources (e.g., web pages, email, FTP sites, media sites, etc.), for which a user has contracted with a web hosting service provider.

In at least one embodiment, at least one component shown or described with respect to FIG. 19 is used to perform techniques and/or functions described in connection with FIGS. 1-15. In at least one embodiment, at least one component shown or described with respect to FIG. 19 is used to cause a first application programming interface (API) to select a second API to perform one or more software workloads identified by the first API. In at least one embodiment, at least one component shown or described with respect to FIG. 19 is used to perform a first application programming interface (API) to select a second API to monitor performance of one or more software workloads identified by the first API. In at least one embodiment, at least one component shown or described with respect to FIG. 19 is used to perform a first application programming interface (API) to select a second API to terminate performance of one or more software workloads identified by the first API. In at least one embodiment, at least one component shown or described with respect to FIG. 19 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

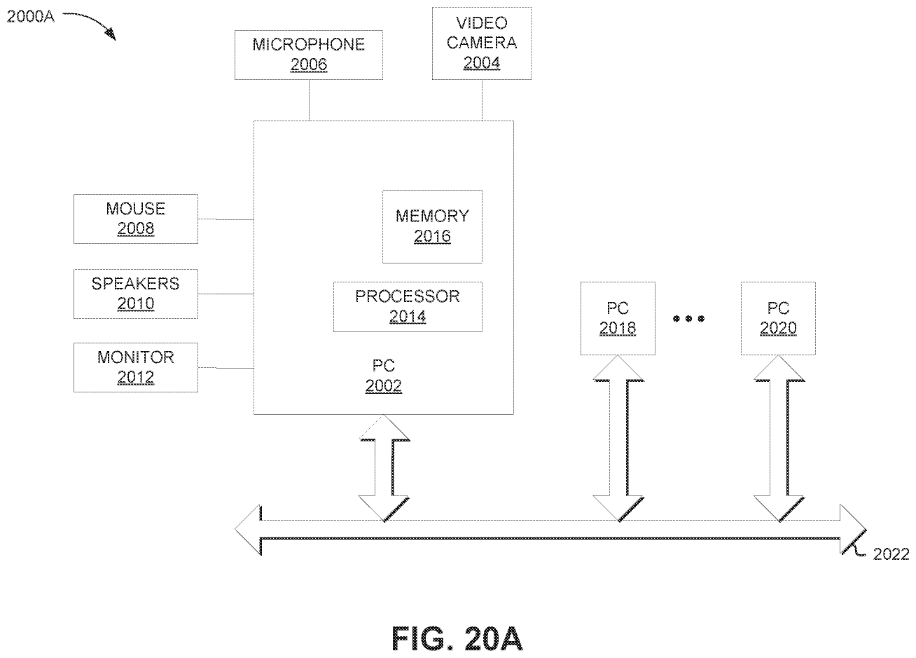

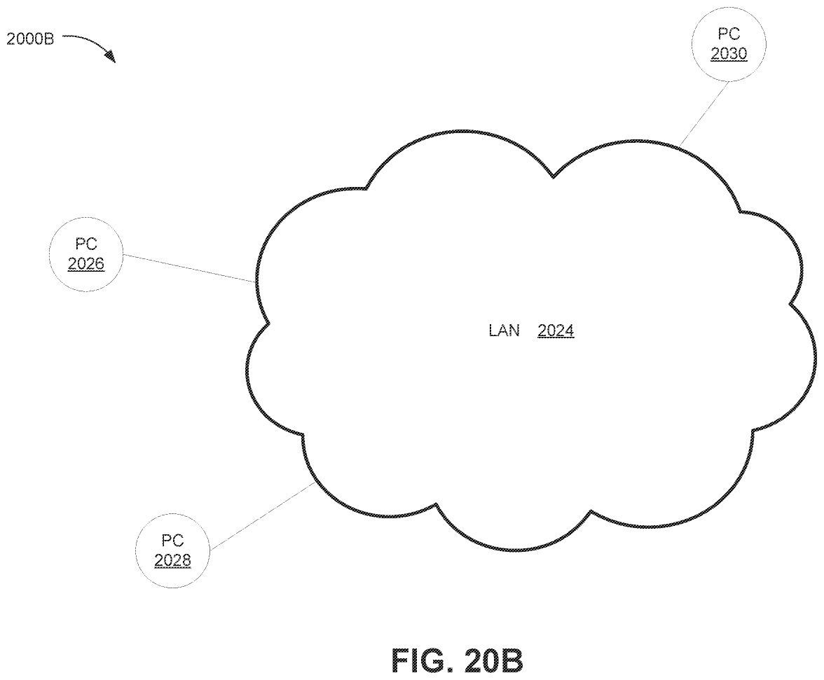

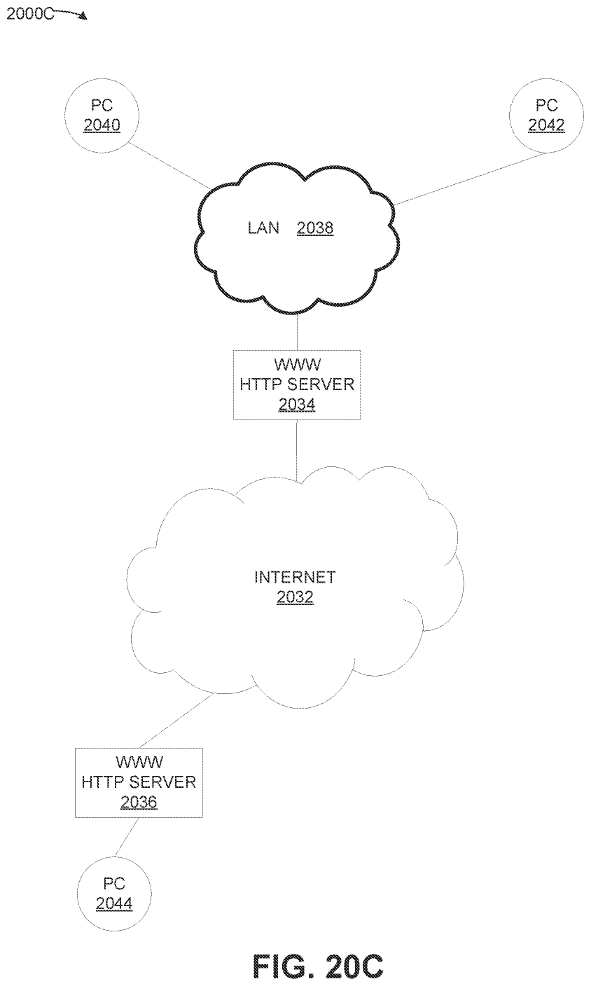

FIG. 20A illustrates a networked computer system 2000A, in accordance with at least one embodiment. In at least one embodiment, networked computer system 2000A comprises a plurality of nodes 2002, 2018, 2020 (e.g., personal computers (“PCs”)). In at least one embodiment, personal computer or node 2002 comprises a processor 2014, memory 2016, video camera 2004, microphone 2006, mouse 2008, speakers 2010, and monitor 2012. In at least one embodiment, nodes 2002, 2018, 2020 may each run one or more desktop servers of an internal network within a given company, for instance, or may be servers of a general network not limited to a specific environment. In at least one embodiment, there is one server per PC node of a network, so that each PC node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 2002, 2018, 2020 and other nodes of a network are interconnected via medium 2022. In at least one embodiment, medium 2022 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of an URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 2014 is a general-purpose programmable processor. In at least one embodiment, processors of nodes of networked computer system 2000A may also be special-purpose video processors. In at least one embodiment, various peripherals and components of a node such as those of node 2002 may vary from those of other nodes. In at least one embodiment, node 2018 and node 2020 may be configured identically to or differently than node 2002. In at least one embodiment, a node may be implemented on any suitable computer system in addition to PC systems.

In at least one embodiment, at least one component shown or described with respect to FIG. 20A is used to perform techniques and/or functions described in connection with FIGS. 1-15. In at least one embodiment, at least one component shown or described with respect to FIG. 20A is used to cause a first application programming interface (API) to select a second API to perform one or more software workloads identified by the first API. In at least one embodiment, at least one component shown or described with respect to FIG. 20A is used to perform a first application programming interface (API) to select a second API to monitor performance of one or more software workloads identified by the first API. In at least one embodiment, at least one component shown or described with respect to FIG. 20A is used to perform a first application programming interface (API) to select a second API to terminate performance of one or more software workloads identified by the first API. In at least one embodiment, at least one component shown or described with respect to FIG. 20A is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 20B illustrates a networked computer system 2000B, in accordance with at least one embodiment. In at least one embodiment, system 2000B illustrates a network such as LAN 2024, which may be used to interconnect a variety of nodes that may communicate with each other. In at least one embodiment, attached to LAN 2024 are a plurality of nodes such as PC nodes 2026, 2028, and 2030. In at least one embodiment, a node may also be connected to the LAN via a network server or other means. In at least one embodiment, system 2000B comprises other types of nodes or elements, for example including routers, servers, and nodes.

In at least one embodiment, at least one component shown or described with respect to FIG. 20B is used to perform techniques and/or functions described in connection with FIGS. 1-15. In at least one embodiment, at least one component shown or described with respect to FIG. 20B is used to cause a first application programming interface (API) to select a second API to perform one or more software workloads identified by the first API. In at least one embodiment, at least one component shown or described with respect to FIG. 20B is used to perform a first application programming interface (API) to select a second API to monitor performance of one or more software workloads identified by the first API. In at least one embodiment, at least one component shown or described with respect to FIG. 20B is used to perform a first application programming interface (API) to select a second API to terminate performance of one or more software workloads identified by the first API. In at least one embodiment, at least one component shown or described with respect to FIG. 20B is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 20C illustrates a networked computer system 2000C, in accordance with at least one embodiment. In at least one embodiment, system 2000C illustrates a WWW system having communications across a backbone communications network such as Internet 2032, which may be used to interconnect a variety of nodes of a network. In at least one embodiment, WWW is a set of protocols operating on top of the Internet, and allows a graphical interface system to operate thereon for accessing information through the Internet. In at least one embodiment, attached to Internet 2032 in WWW are a plurality of nodes such as PCs 2040, 2042, 2044. In at least one embodiment, a node is interfaced to other nodes of WWW through a WWW HTTP server such as servers 2034, 2036. In at least one embodiment, PC 2044 may be a PC forming a node of network 2032 and itself running its server 2036, although PC 2044 and server 2036 are illustrated separately in FIG. 20C for illustrative purposes.

In at least one embodiment, WWW is a distributed type of application, characterized by WWW HTTP, WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 2038 as illustrated with respect to WWW HTTP server 2034. In at least one embodiment, system 2000C may also comprise other types of nodes or elements. In at least one embodiment, a WWW HTTP server is an application running on a machine, such as a PC. In at least one embodiment, each user may be considered to have a unique “server,” as illustrated with respect to PC 2044. In at least one embodiment, a server may be considered to be a server such as WWW HTTP server 2034, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

In at least one embodiment, at least one component shown or described with respect to FIG. 20C is used to perform techniques and/or functions described in connection with FIGS. 1-15. In at least one embodiment, at least one component shown or described with respect to FIG. 20C is used to cause a first application programming interface (API) to select a second API to perform one or more software workloads identified by the first API. In at least one embodiment, at least one component shown or described with respect to FIG. 20C is used to perform a first application programming interface (API) to select a second API to monitor performance of one or more software workloads identified by the first API. In at least one embodiment, at least one component shown or described with respect to FIG. 20C is used to perform a first application programming interface (API) to select a second API to terminate performance of one or more software workloads identified by the first API. In at least one embodiment, at least one component shown or described with respect to FIG. 20C is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

### Cloud Computing and Services

The following figures set forth, without limitation, exemplary cloud-based systems that can be used to implement at least one embodiment.

In at least one embodiment, cloud computing is a style of computing in which dynamically scalable and often virtualized resources are provided as a service over the Internet. In at least one embodiment, users need not have knowledge of, expertise in, or control over technology infrastructure, which can be referred to as “in the cloud,” that supports them. In at least one embodiment, cloud computing incorporates infrastructure as a service, platform as a service, software as a service, and other variations that have a common theme of reliance on the Internet for satisfying computing needs of users. In at least one embodiment, a typical cloud deployment, such as in a private cloud (e.g., enterprise network), or a data center (DC) in a public cloud (e.g., Internet) can consist of thousands of servers (or alternatively, VMs), hundreds of Ethernet, Fiber Channel or Fiber Channel over Ethernet (FCoE) ports, switching and storage infrastructure, etc. In at least one embodiment, cloud can also consist of network services infrastructure like IPsec VPN hubs, firewalls, load balancers, wide area network (WAN) optimizers etc. In at least one embodiment, remote subscribers can access cloud applications and services securely by connecting via a VPN tunnel, such as an IPsec VPN tunnel.

In at least one embodiment, cloud computing is a model for enabling convenient, on-demand network access to a shared pool of configurable computing resources (e.g., networks, servers, storage, applications, and services) that can be rapidly provisioned and released with minimal management effort or service provider interaction.

In at least one embodiment, cloud computing is characterized by on-demand self-service, in which a consumer can unilaterally provision computing capabilities, such as server time and network storage, as needed automatically without requiring human inter-action with each service's provider. In at least one embodiment, cloud computing is characterized by broad network access, in which capabilities are available over a network and accessed through standard mechanisms that promote use by heterogeneous thin or thick client platforms (e.g., mobile phones, laptops, and PDAs). In at least one embodiment, cloud computing is characterized by resource pooling, in which a provider's computing resources are pooled to serve multiple consumers using a multi-tenant model, with different physical and virtual resources dynamically as-signed and reassigned according to consumer demand. In at least one embodiment, there is a sense of location independence in that a customer generally has no control or knowledge over an exact location of provided resources, but may be able to specify location at a higher level of abstraction (e.g., country, state, or datacenter). In at least one embodiment, examples of resources include storage, processing, memory, network bandwidth, and virtual machines. In at least one embodiment, cloud computing is characterized by rapid elasticity, in which capabilities can be rapidly and elastically provisioned, in some cases automatically, to quickly scale out and rapidly released to quickly scale in. In at least one embodiment, to a consumer, capabilities available for provisioning often appear to be unlimited and can be purchased in any quantity at any time. In at least one embodiment, cloud computing is characterized by measured service, in which cloud systems automatically control and optimize resource use by leveraging a metering capability at some level of abstraction appropriate to a type of service (e.g., storage, processing, bandwidth, and active user accounts). In at least one embodiment, resource usage can be monitored, controlled, and reported providing transparency for both a provider and consumer of a utilized service.

In at least one embodiment, cloud computing may be associated with various services. In at least one embodiment, cloud Software as a Service (SaaS) may refer to as service in which a capability provided to a consumer is to use a provider's applications running on a cloud infrastructure. In at least one embodiment, applications are accessible from various client devices through a thin client interface such as a web browser (e.g., web-based email). In at least one embodiment, consumer does not manage or control underlying cloud infrastructure including network, servers, operating systems, storage, or even individual application capabilities, with a possible exception of limited user-specific application configuration settings.

In at least one embodiment, cloud Platform as a Service (PaaS) may refer to a service in which a capability provided to a consumer is to deploy onto cloud infrastructure consumer-created or acquired applications created using programming languages and tools supported by a provider. In at least one embodiment, consumer does not manage or control underlying cloud infrastructure including networks, servers, operating systems, or storage, but has control over deployed applications and possibly application hosting environment configurations.

In at least one embodiment, cloud Infrastructure as a Service (IaaS) may refer to a service in which a capability provided to a consumer is to provision processing, storage, networks, and other fundamental computing resources where a consumer is able to deploy and run arbitrary software, which can include operating systems and applications. In at least one embodiment, consumer does not manage or control underlying cloud infrastructure, but has control over operating systems, storage, deployed applications, and possibly limited control of select networking components (e.g., host firewalls).

In at least one embodiment, cloud computing may be deployed in various ways. In at least one embodiment, a private cloud may refer to a cloud infrastructure that is operated solely for an organization. In at least one embodiment, a private cloud may be managed by an organization or a third party and may exist on-premises or off-premises. In at least one embodiment, a community cloud may refer to a cloud infrastructure that is shared by several organizations and supports a specific community that has shared concerns (e.g., mission, security requirements, policy, and compliance considerations). In at least one embodiment, a community cloud may be managed by organizations or a third party and may exist on-premises or off-premises. In at least one embodiment, a public cloud may refer to a cloud infrastructure that is made available to a general public or a large industry group and is owned by an organization providing cloud services. In at least one embodiment, a hybrid cloud may refer to a cloud infrastructure is a composition of two or more clouds (private, community, or public) that remain unique entities, but are bound together by standardized or proprietary technology that enables data and application portability (e.g., cloud bursting for load-balancing between clouds). In at least one embodiment, a cloud computing environment is service oriented with a focus on statelessness, low coupling, modularity, and semantic interoperability.

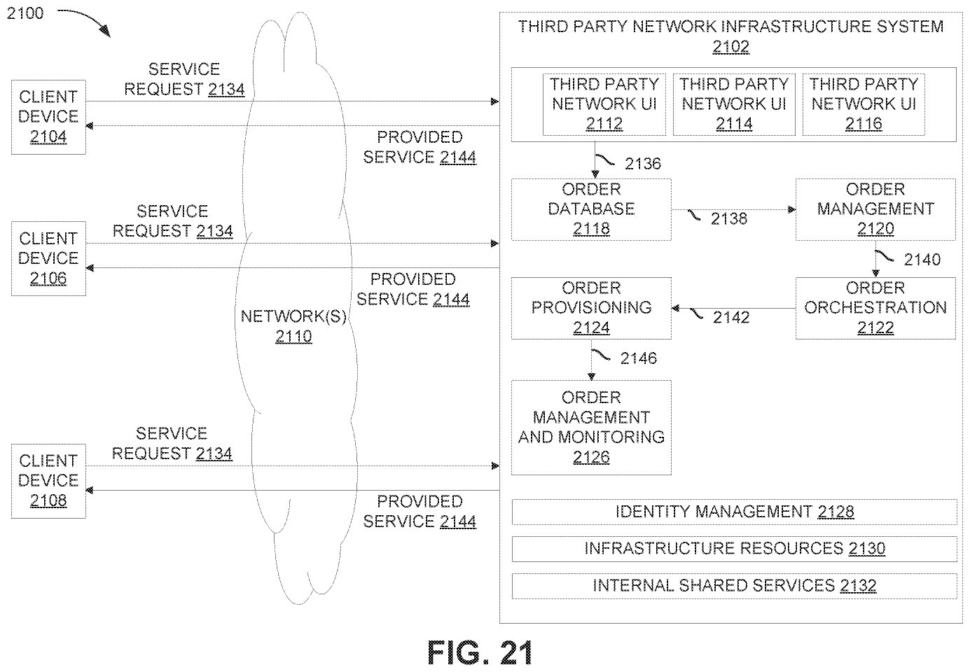

FIG. 21 illustrates one or more components of a system environment 2100 in which services may be offered as third party network services, in accordance with at least one embodiment. In at least one embodiment, a third party network may be referred to as a cloud, cloud network, cloud computing network, and/or variations thereof. In at least one embodiment, system environment 2100 includes one or more client computing devices 2104, 2106, and 2108 that may be used by users to interact with a third party network infrastructure system 2102 that provides third party network services, which may be referred to as cloud computing services. In at least one embodiment, third party network infrastructure system 2102 may comprise one or more computers and/or servers.

It should be appreciated that third party network infrastructure system 2102 depicted in FIG. 21 may have other components than those depicted. Further, FIG. 21 depicts an embodiment of a third party network infrastructure system. In at least one embodiment, third party network infrastructure system 2102 may have more or fewer components than depicted in FIG. 21, may combine two or more components, or may have a different configuration or arrangement of components.

In at least one embodiment, client computing devices 2104, 2106, and 2108 may be configured to operate a client application such as a web browser, a proprietary client application, or some other application, which may be used by a user of a client computing device to interact with third party network infrastructure system 2102 to use services provided by third party network infrastructure system 2102. Although exemplary system environment 2100 is shown with three client computing devices, any number of client computing devices may be supported. In at least one embodiment, other devices such as devices with sensors, etc. may interact with third party network infrastructure system 2102. In at least one embodiment, network(s) 2110 may facilitate communications and exchange of data between client computing devices 2104, 2106, and 2108 and third party network infrastructure system 2102.

In at least one embodiment, services provided by third party network infrastructure system 2102 may include a host of services that are made available to users of a third party network infrastructure system on demand. In at least one embodiment, various services may also be offered including without limitation online data storage and backup solutions, Web-based e-mail services, hosted office suites and document collaboration services, database management and processing, managed technical support services, and/or variations thereof. In at least one embodiment, services provided by a third party network infrastructure system can dynamically scale to meet needs of its users.

In at least one embodiment, a specific instantiation of a service provided by third party network infrastructure system 2102 may be referred to as a “service instance.” In at least one embodiment, in general, any service made available to a user via a communication network, such as the Internet, from a third party network service provider's system is referred to as a “third party network service.” In at least one embodiment, in a public third party network environment, servers and systems that make up a third party network service provider's system are different from a customer's own on-premises servers and systems. In at least one embodiment, a third party network service provider's system may host an application, and a user may, via a communication network such as the Internet, on demand, order and use an application.

In at least one embodiment, a service in a computer network third party network infrastructure may include protected computer network access to storage, a hosted database, a hosted web server, a software application, or other service provided by a third party network vendor to a user. In at least one embodiment, a service can include password-protected access to remote storage on a third party network through the Internet. In at least one embodiment, a service can include a web service-based hosted relational database and a script-language middleware engine for private use by a networked developer. In at least one embodiment, a service can include access to an email software application hosted on a third party network vendor's web site.

In at least one embodiment, third party network infrastructure system 2102 may include a suite of applications, middleware, and database service offerings that are delivered to a customer in a self-service, subscription-based, elastically scalable, reliable, highly available, and secure manner. In at least one embodiment, third party network infrastructure system 2102 may also provide “big data” related computation and analysis services. In at least one embodiment, term “big data” is generally used to refer to extremely large data sets that can be stored and manipulated by analysts and researchers to visualize large amounts of data, detect trends, and/or otherwise interact with data. In at least one embodiment, big data and related applications can be hosted and/or manipulated by an infrastructure system on many levels and at different scales. In at least one embodiment, tens, hundreds, or thousands of processors linked in parallel can act upon such data in order to present it or simulate external forces on data or what it represents. In at least one embodiment, these data sets can involve structured data, such as that organized in a database or otherwise according to a structured model, and/or unstructured data (e.g., emails, images, data blobs (binary large objects), web pages, complex event processing). In at least one embodiment, by leveraging an ability of an embodiment to relatively quickly focus more (or fewer) computing resources upon an objective, a third party network infrastructure system may be better available to carry out tasks on large data sets based on demand from a business, government agency, research organization, private individual, group of like-minded individuals or organizations, or other entity.

In at least one embodiment, third party network infrastructure system 2102 may be adapted to automatically provision, manage and track a customer's subscription to services offered by third party network infrastructure system 2102. In at least one embodiment, third party network infrastructure system 2102 may provide third party network services via different deployment models. In at least one embodiment, services may be provided under a public third party network model in which third party network infrastructure system 2102 is owned by an organization selling third party network services and services are made available to a general public or different industry enterprises. In at least one embodiment, services may be provided under a private third party network model in which third party network infrastructure system 2102 is operated solely for a single organization and may provide services for one or more entities within an organization. In at least one embodiment, third party network services may also be provided under a community third party network model in which third party network infrastructure system 2102 and services provided by third party network infrastructure system 2102 are shared by several organizations in a related community. In at least one embodiment, third party network services may also be provided under a hybrid third party network model, which is a combination of two or more different models.

In at least one embodiment, services provided by third party network infrastructure system 2102 may include one or more services provided under Software as a Service (SaaS) category, Platform as a Service (PaaS) category, Infrastructure as a Service (IaaS) category, or other categories of services including hybrid services. In at least one embodiment, a customer, via a subscription order, may order one or more services provided by third party network infrastructure system 2102. In at least one embodiment, third party network infrastructure system 2102 then performs processing to provide services in a customer's subscription order.

In at least one embodiment, services provided by third party network infrastructure system 2102 may include, without limitation, application services, platform services and infrastructure services. In at least one embodiment, application services may be provided by a third party network infrastructure system via a SaaS platform. In at least one embodiment, SaaS platform may be configured to provide third party network services that fall under a SaaS category. In at least one embodiment, SaaS platform may provide capabilities to build and deliver a suite of on-demand applications on an integrated development and deployment platform. In at least one embodiment, SaaS platform may manage and control underlying software and infrastructure for providing SaaS services. In at least one embodiment, by utilizing services provided by a SaaS platform, customers can utilize applications executing on a third party network infrastructure system. In at least one embodiment, customers can acquire an application services without a need for customers to purchase separate licenses and support. In at least one embodiment, various different SaaS services may be provided. In at least one embodiment, examples include, without limitation, services that provide solutions for sales performance management, enterprise integration, and business flexibility for large organizations.

In at least one embodiment, platform services may be provided by third party network infrastructure system 2102 via a PaaS platform. In at least one embodiment, PaaS platform may be configured to provide third party network services that fall under a PaaS category. In at least one embodiment, examples of platform services may include without limitation services that enable organizations to consolidate existing applications on a shared, common architecture, as well as an ability to build new applications that leverage shared services provided by a platform. In at least one embodiment, PaaS platform may manage and control underlying software and infrastructure for providing PaaS services. In at least one embodiment, customers can acquire PaaS services provided by third party network infrastructure system 2102 without a need for customers to purchase separate licenses and support.

In at least one embodiment, by utilizing services provided by a PaaS platform, customers can employ programming languages and tools supported by a third party network infrastructure system and also control deployed services. In at least one embodiment, platform services provided by a third party network infrastructure system may include database third party network services, middleware third party network services and third party network services. In at least one embodiment, database third party network services may support shared service deployment models that enable organizations to pool database resources and offer customers a Database as a Service in a form of a database third party network. In at least one embodiment, middleware third party network services may provide a platform for customers to develop and deploy various business applications, and third party network services may provide a platform for customers to deploy applications, in a third party network infrastructure system.

In at least one embodiment, various different infrastructure services may be provided by an IaaS platform in a third party network infrastructure system. In at least one embodiment, infrastructure services facilitate management and control of underlying computing resources, such as storage, networks, and other fundamental computing resources for customers utilizing services provided by a SaaS platform and a PaaS platform.

In at least one embodiment, third party network infrastructure system 2102 may also include infrastructure resources 2130 for providing resources used to provide various services to customers of a third party network infrastructure system. In at least one embodiment, infrastructure resources 2130 may include pre-integrated and optimized combinations of hardware, such as servers, storage, and networking resources to execute services provided by a Paas platform and a Saas platform, and other resources.

In at least one embodiment, resources in third party network infrastructure system 2102 may be shared by multiple users and dynamically re-allocated per demand. In at least one embodiment, resources may be allocated to users in different time zones. In at least one embodiment, third party network infrastructure system 2102 may enable a first set of users in a first time zone to utilize resources of a third party network infrastructure system for a specified number of hours and then enable a re-allocation of same resources to another set of users located in a different time zone, thereby maximizing utilization of resources.

In at least one embodiment, a number of internal shared services 2132 may be provided that are shared by different components or modules of third party network infrastructure system 2102 to enable provision of services by third party network infrastructure system 2102. In at least one embodiment, these internal shared services may include, without limitation, a security and identity service, an integration service, an enterprise repository service, an enterprise manager service, a virus scanning and white list service, a high availability, backup and recovery service, service for enabling third party network support, an email service, a notification service, a file transfer service, and/or variations thereof.

In at least one embodiment, third party network infrastructure system 2102 may provide comprehensive management of third party network services (e.g., SaaS, PaaS, and IaaS services) in a third party network infrastructure system. In at least one embodiment, third party network management functionality may include capabilities for provisioning, managing and tracking a customer's subscription received by third party network infrastructure system 2102, and/or variations thereof.

In at least one embodiment, as depicted in FIG. 21, third party network management functionality may be provided by one or more modules, such as an order management module 2120, an order orchestration module 2122, an order provisioning module 2124, an order management and monitoring module 2126, and an identity management module 2128. In at least one embodiment, these modules may include or be provided using one or more computers and/or servers, which may be general purpose computers, specialized server computers, server farms, server clusters, or any other appropriate arrangement and/or combination.

In at least one embodiment, at step 2134, a customer using a client device, such as client computing devices 2104, 2106 or 2108, may interact with third party network infrastructure system 2102 by requesting one or more services provided by third party network infrastructure system 2102 and placing an order for a subscription for one or more services offered by third party network infrastructure system 2102. In at least one embodiment, a customer may access a third party network User Interface (UI) such as third party network UI 2112, third party network UI 2114 and/or third party network UI 2116 and place a subscription order via these UIs. In at least one embodiment, order information received by third party network infrastructure system 2102 in response to a customer placing an order may include information identifying a customer and one or more services offered by a third party network infrastructure system 2102 that a customer intends to subscribe to.

In at least one embodiment, at step 2136, an order information received from a customer may be stored in an order database 2118. In at least one embodiment, if this is a new order, a new record may be created for an order. In at least one embodiment, order database 2118 can be one of several databases operated by third party network infrastructure system 2102 and operated in conjunction with other system elements.

In at least one embodiment, at step 2138, an order information may be forwarded to an order management module 2120 that may be configured to perform billing and accounting functions related to an order, such as verifying an order, and upon verification, booking an order.

In at least one embodiment, at step 2140, information regarding an order may be communicated to an order orchestration module 2122 that is configured to orchestrate provisioning of services and resources for an order placed by a customer. In at least one embodiment, order orchestration module 2122 may use services of order provisioning module 2124 for provisioning. In at least one embodiment, order orchestration module 2122 enables management of business processes associated with each order and applies business logic to determine whether an order should proceed to provisioning.

In at least one embodiment, at step 2142, upon receiving an order for a new subscription, order orchestration module 2122 sends a request to order provisioning module 2124 to allocate resources and configure resources needed to fulfill a subscription order. In at least one embodiment, order provisioning module 2124 enables an allocation of resources for services ordered by a customer. In at least one embodiment, order provisioning module 2124 provides a level of abstraction between third party network services provided by third party network infrastructure system 2100 and a physical implementation layer that is used to provision resources for providing requested services. In at least one embodiment, this enables order orchestration module 2122 to be isolated from implementation details, such as whether or not services and resources are actually provisioned in real-time or pre-provisioned and only allocated/assigned upon request.

In at least one embodiment, at step 2144, once services and resources are provisioned, a notification may be sent to subscribing customers indicating that a requested service is now ready for use. In at least one embodiment, information (e.g. a link) may be sent to a customer that enables a customer to start using requested services.

In at least one embodiment, at step 2146, a customer's subscription order may be managed and tracked by an order management and monitoring module 2126. In at least one embodiment, order management and monitoring module 2126 may be configured to collect usage statistics regarding a customer use of subscribed services. In at least one embodiment, statistics may be collected for an amount of storage used, an amount data transferred, a number of users, and an amount of system up time and system down time, and/or variations thereof.

In at least one embodiment, third party network infrastructure system 2100 may include an identity management module 2128 that is configured to provide identity services, such as access management and authorization services in third party network infrastructure system 2100. In at least one embodiment, identity management module 2128 may control information about customers who wish to utilize services provided by third party network infrastructure system 2102. In at least one embodiment, such information can include information that authenticates identities of such customers and information that describes which actions those customers are authorized to perform relative to various system resources (e.g., files, directories, applications, communication ports, memory segments, etc.). In at least one embodiment, identity management module 2128 may also include management of descriptive information about each customer and about how and by whom that descriptive information can be accessed and modified.

In at least one embodiment, at least one component shown or described with respect to FIG. 21 is used to perform techniques and/or functions described in connection with FIGS. 1-15. In at least one embodiment, at least one component shown or described with respect to FIG. 21 is used to cause a first application programming interface (API) to select a second API to perform one or more software workloads identified by the first API. In at least one embodiment, at least one component shown or described with respect to FIG. 21 is used to perform a first application programming interface (API) to select a second API to monitor performance of one or more software workloads identified by the first API. In at least one embodiment, at least one component shown or described with respect to FIG. 21 is used to perform a first application programming interface (API) to select a second API to terminate performance of one or more software workloads identified by the first API. In at least one embodiment, at least one component shown or described with respect to FIG. 21 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

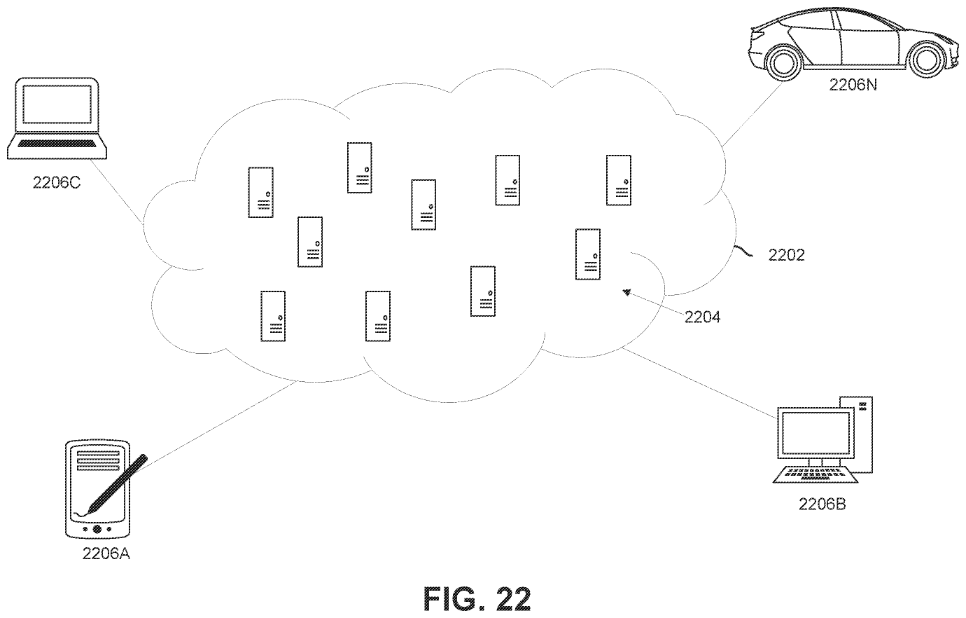

FIG. 22 illustrates a cloud computing environment 2202, in accordance with at least one embodiment. In at least one embodiment, cloud computing environment 2202 comprises one or more computer system/servers 2204 with which computing devices such as, personal digital assistant (PDA) or cellular telephone 2206A, desktop computer 2206B, laptop computer 2206C, and/or automobile computer system 2206N communicate. In at least one embodiment, this allows for infrastructure, platforms and/or software to be offered as services from cloud computing environment 2202, so as to not require each client to separately maintain such resources. It is understood that types of computing devices 2206A-N shown in FIG. 22 are intended to be illustrative only and that cloud computing environment 2202 can communicate with any type of computerized device over any type of network and/or network/addressable connection (e.g., using a web browser).

In at least one embodiment, a computer system/server 2204, which can be denoted as a cloud computing node, is operational with numerous other general purpose or special purpose computing system environments or configurations. In at least one embodiment, examples of computing systems, environments, and/or configurations that may be suitable for use with computer system/server 2204 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and/or variations thereof.

In at least one embodiment, computer system/server 2204 may be described in a general context of computer system-executable instructions, such as program modules, being executed by a computer system. In at least one embodiment, program modules include routines, programs, objects, components, logic, data structures, and so on, that perform particular tasks or implement particular abstract data types. In at least one embodiment, exemplary computer system/server 2204 may be practiced in distributed cloud computing environments where tasks are performed by remote processing devices that are linked through a communications network. In at least one embodiment, in a distributed cloud computing environment, program modules may be located in both local and remote computer system storage media including memory storage devices.

In at least one embodiment, at least one component shown or described with respect to FIG. 22 is used to perform techniques and/or functions described in connection with FIGS. 1-15. In at least one embodiment, at least one component shown or described with respect to FIG. 22 is used to cause a first application programming interface (API) to select a second API to perform one or more software workloads identified by the first API. In at least one embodiment, at least one component shown or described with respect to FIG. 22 is used to perform a first application programming interface (API) to select a second API to monitor performance of one or more software workloads identified by the first API. In at least one embodiment, at least one component shown or described with respect to FIG. 22 is used to perform a first application programming interface (API) to select a second API to terminate performance of one or more software workloads identified by the first API. In at least one embodiment, at least one component shown or described with respect to FIG. 22 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

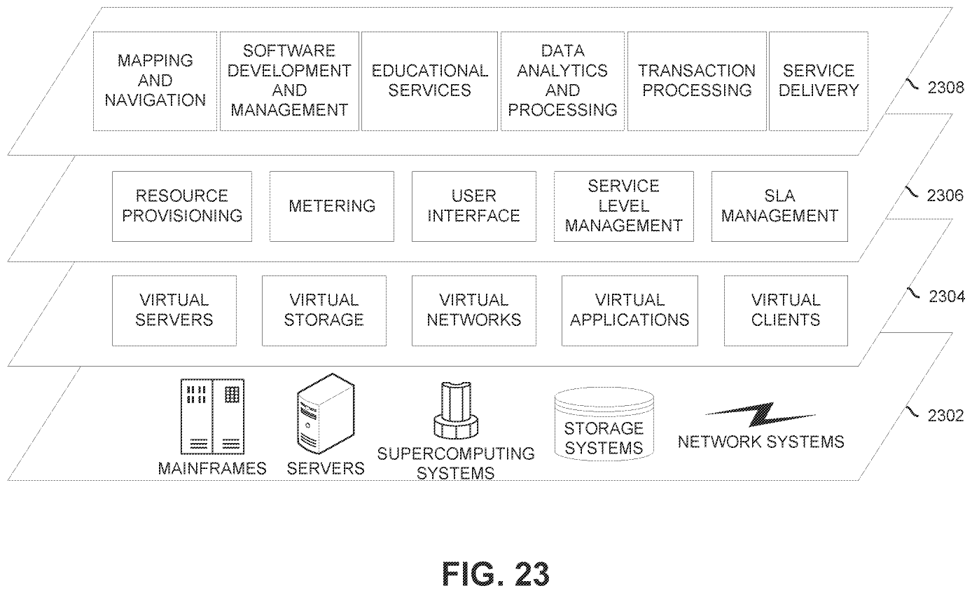

FIG. 23 illustrates a set of functional abstraction layers provided by cloud computing environment 2202 (FIG. 22), in accordance with at least one embodiment. It should be understood in advance that components, layers, and functions shown in FIG. 23 are intended to be illustrative only, and components, layers, and functions may vary.

In at least one embodiment, hardware and software layer 2302 includes hardware and software components. In at least one embodiment, examples of hardware components include mainframes, various RISC (Reduced Instruction Set Computer) architecture based servers, various computing systems, supercomputing systems, storage devices, networks, networking components, and/or variations thereof. In at least one embodiment, examples of software components include network application server software, various application server software, various database software, and/or variations thereof.

In at least one embodiment, virtualization layer 2304 provides an abstraction layer from which following exemplary virtual entities may be provided: virtual servers, virtual storage, virtual networks, including virtual private networks, virtual applications, virtual clients, and/or variations thereof.

In at least one embodiment, management layer 2306 provides various functions. In at least one embodiment, resource provisioning provides dynamic procurement of computing resources and other resources that are utilized to perform tasks within a cloud computing environment. In at least one embodiment, metering provides usage tracking as resources are utilized within a cloud computing environment, and billing or invoicing for consumption of these resources. In at least one embodiment, resources may comprise application software licenses. In at least one embodiment, security provides identity verification for users and tasks, as well as protection for data and other resources. In at least one embodiment, user interface provides access to a cloud computing environment for both users and system administrators. In at least one embodiment, service level management provides cloud computing resource allocation and management such that required service levels are met. In at least one embodiment, Service Level Agreement (SLA) management provides pre-arrangement for, and procurement of, cloud computing resources for which a future requirement is anticipated in accordance with an SLA.

In at least one embodiment, workloads layer 2308 provides functionality for which a cloud computing environment is utilized. In at least one embodiment, examples of workloads and functions which may be provided from this layer include: mapping and navigation, software development and management, educational services, data analytics and processing, transaction processing, and service delivery.

In at least one embodiment, at least one component shown or described with respect to FIG. 23 is used to perform techniques and/or functions described in connection with FIGS. 1-15. In at least one embodiment, at least one component shown or described with respect to FIG. 23 is used to cause a first application programming interface (API) to select a second API to perform one or more software workloads identified by the first API. In at least one embodiment, at least one component shown or described with respect to FIG. 23 is used to perform a first application programming interface (API) to select a second API to monitor performance of one or more software workloads identified by the first API. In at least one embodiment, at least one component shown or described with respect to FIG. 23 is used to perform a first application programming interface (API) to select a second API to terminate performance of one or more software workloads identified by the first API. In at least one embodiment, at least one component shown or described with respect to FIG. 23 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

### Supercomputing

The following figures set forth, without limitation, exemplary supercomputer-based systems that can be used to implement at least one embodiment.

In at least one embodiment, a supercomputer may refer to a hardware system exhibiting substantial parallelism and comprising at least one chip, where chips in a system are interconnected by a network and are placed in hierarchically organized enclosures. In at least one embodiment, a large hardware system filling a machine room, with several racks, each containing several boards/rack modules, each containing several chips, all interconnected by a scalable network, is one particular example of a supercomputer. In at least one embodiment, a single rack of such a large hardware system is another example of a supercomputer. In at least one embodiment, a single chip exhibiting substantial parallelism and containing several hardware components can equally be considered to be a supercomputer, since as feature sizes may decrease, an amount of hardware that can be incorporated in a single chip may also increase.

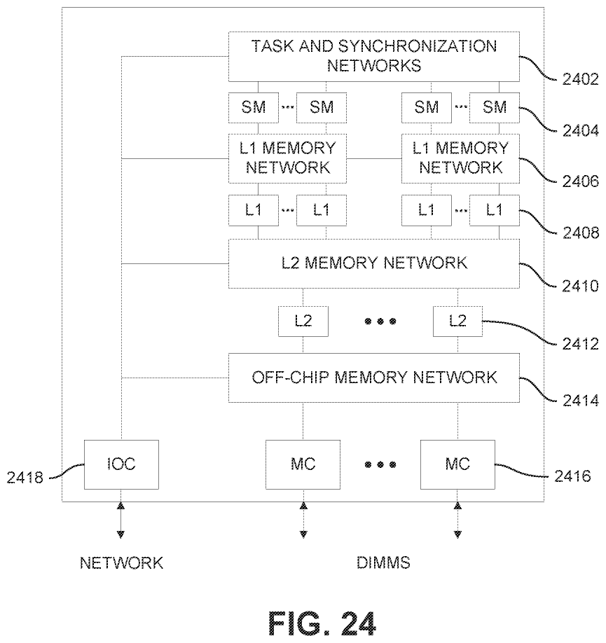

FIG. 24 illustrates a supercomputer at a chip level, in accordance with at least one embodiment. In at least one embodiment, inside an FPGA or ASIC chip, main computation is performed within finite state machines (2404) called thread units. In at least one embodiment, task and synchronization networks (2402) connect finite state machines and are used to dispatch threads and execute operations in correct order. In at least one embodiment, a multi-level partitioned on-chip cache hierarchy (2408, 2412) is accessed using memory networks (2406, 2410). In at least one embodiment, off-chip memory is accessed using memory controllers (2416) and an off-chip memory network (2414). In at least one embodiment, I/O controller (2418) is used for cross-chip communication when a design does not fit in a single logic chip.

In at least one embodiment, at least one component shown or described with respect to FIG. 24 is used to perform techniques and/or functions described in connection with FIGS. 1-15. In at least one embodiment, at least one component shown or described with respect to FIG. 24 is used to cause a first application programming interface (API) to select a second API to perform one or more software workloads identified by the first API. In at least one embodiment, at least one component shown or described with respect to FIG. 24 is used to perform a first application programming interface (API) to select a second API to monitor performance of one or more software workloads identified by the first API. In at least one embodiment, at least one component shown or described with respect to FIG. 24 is used to perform a first application programming interface (API) to select a second API to terminate performance of one or more software workloads identified by the first API. In at least one embodiment, at least one component shown or described with respect to FIG. 24 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

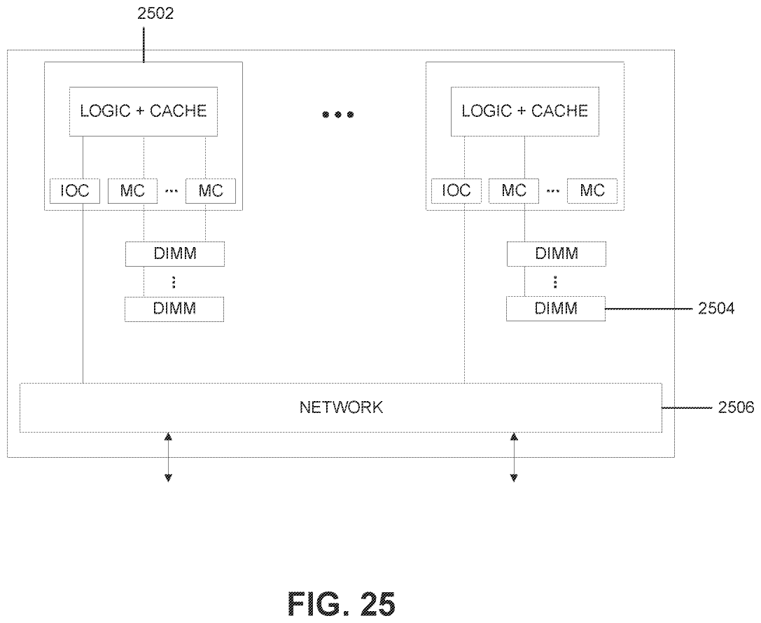

FIG. 25 illustrates a supercomputer at a rack module level, in accordance with at least one embodiment. In at least one embodiment, within a rack module, there are multiple FPGA or ASIC chips (2502) that are connected to one or more DRAM units (2504) which constitute main accelerator memory. In at least one embodiment, each FPGA/ASIC chip is connected to its neighbor FPGA/ASIC chip using wide busses on a board, with differential high speed signaling (2506). In at least one embodiment, each FPGA/ASIC chip is also connected to at least one high-speed serial communication cable.

In at least one embodiment, at least one component shown or described with respect to FIG. 25 is used to perform techniques and/or functions described in connection with FIGS. 1-15. In at least one embodiment, at least one component shown or described with respect to FIG. 25 is used to cause a first application programming interface (API) to select a second API to perform one or more software workloads identified by the first API. In at least one embodiment, at least one component shown or described with respect to FIG. 25 is used to perform a first application programming interface (API) to select a second API to monitor performance of one or more software workloads identified by the first API. In at least one embodiment, at least one component shown or described with respect to FIG. 25 is used to perform a first application programming interface (API) to select a second API to terminate performance of one or more software workloads identified by the first API. In at least one embodiment, at least one component shown or described with respect to FIG. 25 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

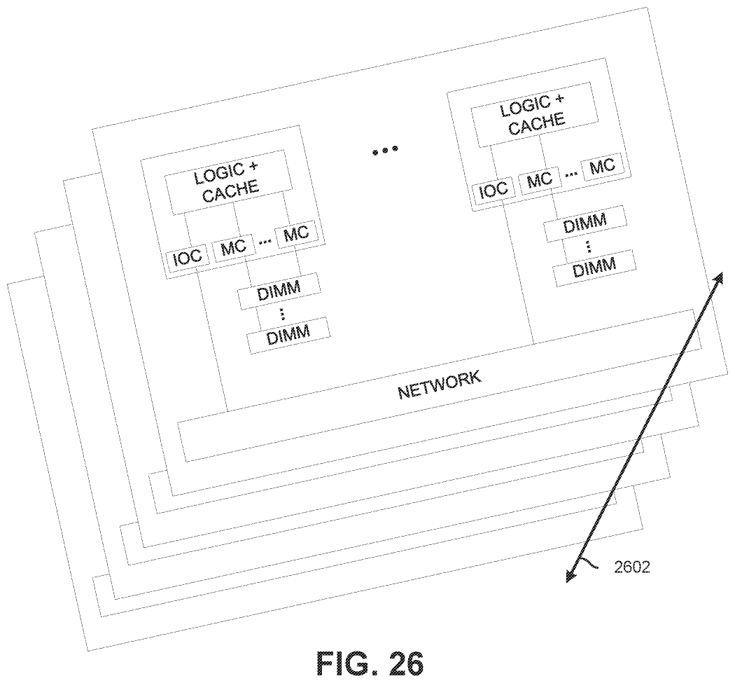

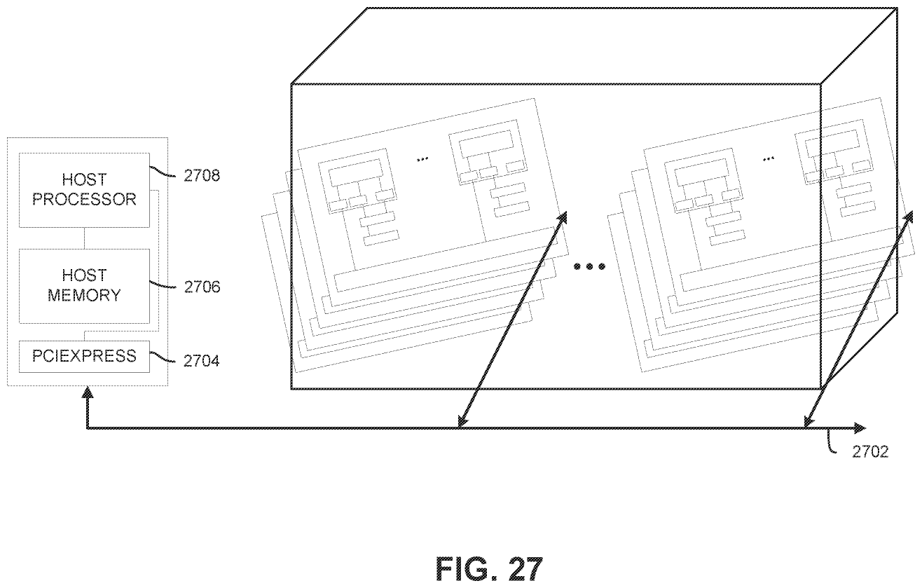

FIG. 26 illustrates a supercomputer at a rack level, in accordance with at least one embodiment. FIG. 27 illustrates a supercomputer at a whole system level, in accordance with at least one embodiment. In at least one embodiment, referring to FIG. 26 and FIG. 27, between rack modules in a rack and across racks throughout an entire system, high-speed serial optical or copper cables (2602, 2702) are used to realize a scalable, possibly incomplete hypercube network. In at least one embodiment, one of FPGA/ASIC chips of an accelerator is connected to a host system through a PCI-Express connection (2704). In at least one embodiment, host system comprises a host microprocessor (2708) that a software part of an application runs on and a memory consisting of one or more host memory DRAM units (2706) that is kept coherent with memory on an accelerator. In at least one embodiment, host system can be a separate module on one of racks, or can be integrated with one of a supercomputer's modules. In at least one embodiment, cube-connected cycles topology provide communication links to create a hypercube network for a large supercomputer. In at least one embodiment, a small group of FPGA/ASIC chips on a rack module can act as a single hypercube node, such that a total number of external links of each group is increased, compared to a single chip. In at least one embodiment, a group contains chips A, B, C and D on a rack module with internal wide differential busses connecting A, B, C and D in a torus organization. In at least one embodiment, there are 12 serial communication cables connecting a rack module to an outside world. In at least one embodiment, chip A on a rack module connects to serial communication cables 0, 1, 2. In at least one embodiment, chip B connects to cables 3, 4, 5. In at least one embodiment, chip C connects to 6, 7, 8. In at least one embodiment, chip D connects to 9, 10, 11. In at least one embodiment, an entire group {A, B, C, D} constituting a rack module can form a hypercube node within a supercomputer system, with up to 212=4096 rack modules (16384 FPGA/ASIC chips). In at least one embodiment, for chip A to send a message out on link 4 of group {A, B, C, D}, a message has to be routed first to chip B with an on-board differential wide bus connection. In at least one embodiment, a message arriving into a group {A, B, C, D} on link 4 (i.e., arriving at B) destined to chip A, also has to be routed first to a correct destination chip (A) internally within a group {A, B, C, D}. In at least one embodiment, parallel supercomputer systems of other sizes may also be implemented.

In at least one embodiment, at least one component shown or described with respect to FIG. 26 is used to perform techniques and/or functions described in connection with FIGS. 1-15. In at least one embodiment, at least one component shown or described with respect to FIG. 26 is used to cause a first application programming interface (API) to select a second API to perform one or more software workloads identified by the first API. In at least one embodiment, at least one component shown or described with respect to FIG. 26 is used to perform a first application programming interface (API) to select a second API to monitor performance of one or more software workloads identified by the first API. In at least one embodiment, at least one component shown or described with respect to FIG. 26 is used to perform a first application programming interface (API) to select a second API to terminate performance of one or more software workloads identified by the first API. In at least one embodiment, at least one component shown or described with respect to FIG. 26 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

In at least one embodiment, at least one component shown or described with respect to FIG. 27 is used to perform techniques and/or functions described in connection with FIGS. 1-15. In at least one embodiment, at least one component shown or described with respect to FIG. 27 is used to cause a first application programming interface (API) to select a second API to perform one or more software workloads identified by the first API. In at least one embodiment, at least one component shown or described with respect to FIG. 27 is used to perform a first application programming interface (API) to select a second API to monitor performance of one or more software workloads identified by the first API. In at least one embodiment, at least one component shown or described with respect to FIG. 27 is used to perform a first application programming interface (API) to select a second API to terminate performance of one or more software workloads identified by the first API. In at least one embodiment, at least one component shown or described with respect to FIG. 27 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

### Artificial Intelligence

The following figures set forth, without limitation, exemplary artificial intelligence-based systems that can be used to implement at least one embodiment.

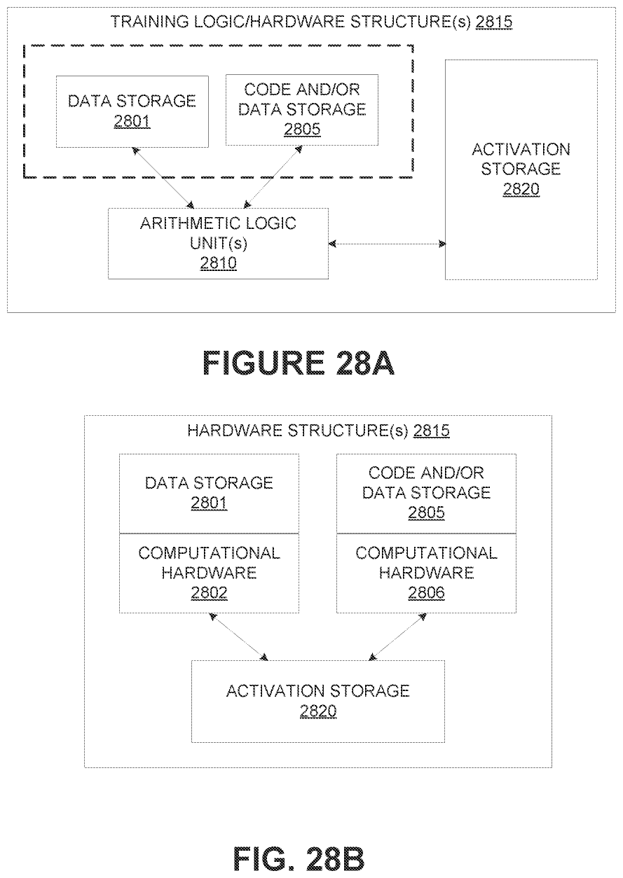

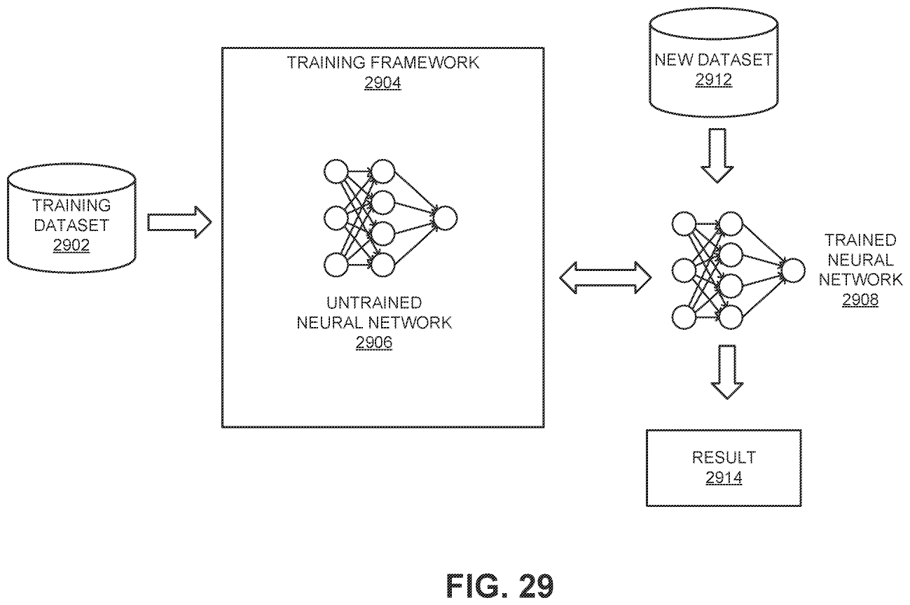

FIG. 28A illustrates inference and/or training logic 2815 used to perform inferencing and/or training operations associated with one or more embodiments. Details regarding inference and/or training logic 2815 are provided below in conjunction with FIGS. 28A and/or 28B.

In at least one embodiment, inference and/or training logic 2815 may include, without limitation, code and/or data storage 2801 to store forward and/or output weight and/or input/output data, and/or other parameters to configure neurons or layers of a neural network trained and/or used for inferencing in aspects of one or more embodiments. In at least one embodiment, training logic 2815 may include, or be coupled to code and/or data storage 2801 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which such code corresponds. In at least one embodiment code and/or data storage 2801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 2801 may be included with other on-chip or off-chip data storage, including a processor's L1, L2, or L3 cache or system memory.

In at least one embodiment, any portion of code and/or data storage 2801 may be internal or external to one or more processors or other hardware logic devices or circuits. In at least one embodiment, code and/or code and/or data storage 2801 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 2801 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2815 may include, without limitation, a code and/or data storage 2805 to store backward and/or output weight and/or input/output data corresponding to neurons or layers of a neural network trained and/or used for inferencing in aspects of one or more embodiments. In at least one embodiment, code and/or data storage 2805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 2815 may include, or be coupled to code and/or data storage 2805 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes loading of weight or other parameter information into processor ALUs based on an architecture of a neural network to which such code corresponds. In at least one embodiment, any portion of code and/or data storage 2805 may be included with other on-chip or off-chip data storage, including a processor's L1, L2, or L3 cache or system memory. In at least one embodiment, any portion of code and/or data storage 2805 may be internal or external to one or more processors or other hardware logic devices or circuits. In at least one embodiment, code and/or data storage 2805 may be cache memory, DRAM, SRAM, non-volatile memory (e.g., flash memory), or other storage. In at least one embodiment, a choice of whether code and/or data storage 2805 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 2801 and code and/or data storage 2805 may be separate storage structures. In at least one embodiment, code and/or data storage 2801 and code and/or data storage 2805 may be a combined storage structure. In at least one embodiment, code and/or data storage 2801 and code and/or data storage 2805 may be partially combined and partially separate. In at least one embodiment, any portion of code and/or data storage 2801 and code and/or data storage 2805 may be included with other on-chip or off-chip data storage, including a processor's L1, L2, or L3 cache or system memory.

In at least one embodiment, inference and/or training logic 2815 may include, without limitation, one or more arithmetic logic unit(s) (“ALU(s)”) 2810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 2820 that are functions of input/output and/or weight parameter data stored in code and/or data storage 2801 and/or code and/or data storage 2805. In at least one embodiment, activations stored in activation storage 2820 are generated according to linear algebraic and or matrix-based mathematics performed by ALU(s) 2810 in response to performing instructions or other code, wherein weight values stored in code and/or data storage 2805 and/or data storage 2801 are used as operands along with other values, such as bias values, gradient information, momentum values, or other parameters or hyperparameters, any or all of which may be stored in code and/or data storage 2805 or code and/or data storage 2801 or another storage on or off-chip.

In at least one embodiment, ALU(s) 2810 are included within one or more processors or other hardware logic devices or circuits, whereas in another embodiment, ALU(s) 2810 may be external to a processor or other hardware logic device or circuit that uses them (e.g., a co-processor). In at least one embodiment, ALUs 2810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 2801, code and/or data storage 2805, and activation storage 2820 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 2820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 2820 may be cache memory, DRAM, SRAM, non-volatile memory (e.g., flash memory), or other storage. In at least one embodiment, activation storage 2820 may be completely or partially within or external to one or more processors or other logical circuits. In at least one embodiment, a choice of whether activation storage 2820 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2815 illustrated in FIG. 28A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 2815 illustrated in FIG. 28A may be used in conjunction with central processing unit (“CPU”) hardware, graphics processing unit (“GPU”) hardware or other hardware, such as field programmable gate arrays (“FPGAs”).

In at least one embodiment, at least one component shown or described with respect to FIG. 28A is used to perform techniques and/or functions described in connection with FIGS. 1-15. In at least one embodiment, at least one component shown or described with respect to FIG. 28A is used to cause a first application programming interface (API) to select a second API to perform one or more software workloads identified by the first API. In at least one embodiment, at least one component shown or described with respect to FIG. 28A is used to perform a first application programming interface (API) to select a second API to monitor performance of one or more software workloads identified by the first API. In at least one embodiment, at least one component shown or described with respect to FIG. 28A is used to perform a first application programming interface (API) to select a second API to terminate performance of one or more software workloads identified by the first API. In at least one embodiment, at least one component shown or described with respect to FIG. 28A is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 28B illustrates inference and/or training logic 2815, according to at least one embodiment. In at least one embodiment, inference and/or training logic 2815 may include, without limitation, hardware logic in which computational resources are dedicated or otherwise exclusively used in conjunction with weight values or other information corresponding to one or more layers of neurons within a neural network. In at least one embodiment, inference and/or training logic 2815 illustrated in FIG. 28B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 2815 illustrated in FIG. 28B may be used in conjunction with central processing unit (CPU) hardware, graphics processing unit (GPU) hardware or other hardware, such as field programmable gate arrays (FPGAs). In at least one embodiment, inference and/or training logic 2815 includes, without limitation, code and/or data storage 2801 and code and/or data storage 2805, which may be used to store code (e.g., graph code), weight values and/or other information, including bias values, gradient information, momentum values, and/or other parameter or hyperparameter information. In at least one embodiment illustrated in FIG. 28B, each of code and/or data storage 2801 and code and/or data storage 2805 is associated with a dedicated computational resource, such as computational hardware 2802 and computational hardware 2806, respectively. In at least one embodiment, each of computational hardware 2802 and computational hardware 2806 comprises one or more ALUs that perform mathematical functions, such as linear algebraic functions, only on information stored in code and/or data storage 2801 and code and/or data storage 2805, respectively, result of which is stored in activation storage 2820.

In at least one embodiment, each of code and/or data storage 2801 and 2805 and corresponding computational hardware 2802 and 2806, respectively, correspond to different layers of a neural network, such that resulting activation from one storage/computational pair 2801/2802 of code and/or data storage 2801 and computational hardware 2802 is provided as an input to a next storage/computational pair 2805/2806 of code and/or data storage 2805 and computational hardware 2806, in order to mirror a conceptual organization of a neural network. In at least one embodiment, each of storage/computational pairs 2801/2802 and 2805/2806 may correspond to more than one neural network layer. In at least one embodiment, additional storage/computation pairs (not shown) subsequent to or in parallel with storage/computation pairs 2801/2802 and 2805/2806 may be included in inference and/or training logic 2815.

In at least one embodiment, at least one component shown or described with respect to FIG. 28B is used to perform techniques and/or functions described in connection with FIGS. 1-15. In at least one embodiment, at least one component shown or described with respect to FIG. 28B is used to cause a first application programming interface (API) to select a second API to perform one or more software workloads identified by the first API. In at least one embodiment, at least one component shown or described with respect to FIG. 28B is used to perform a first application programming interface (API) to select a second API to monitor performance of one or more software workloads identified by the first API. In at least one embodiment, at least one component shown or described with respect to FIG. 28B is used to perform a first application programming interface (API) to select a second API to terminate performance of one or more software workloads identified by the first API. In at least one embodiment, at least one component shown or described with respect to FIG. 28B is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

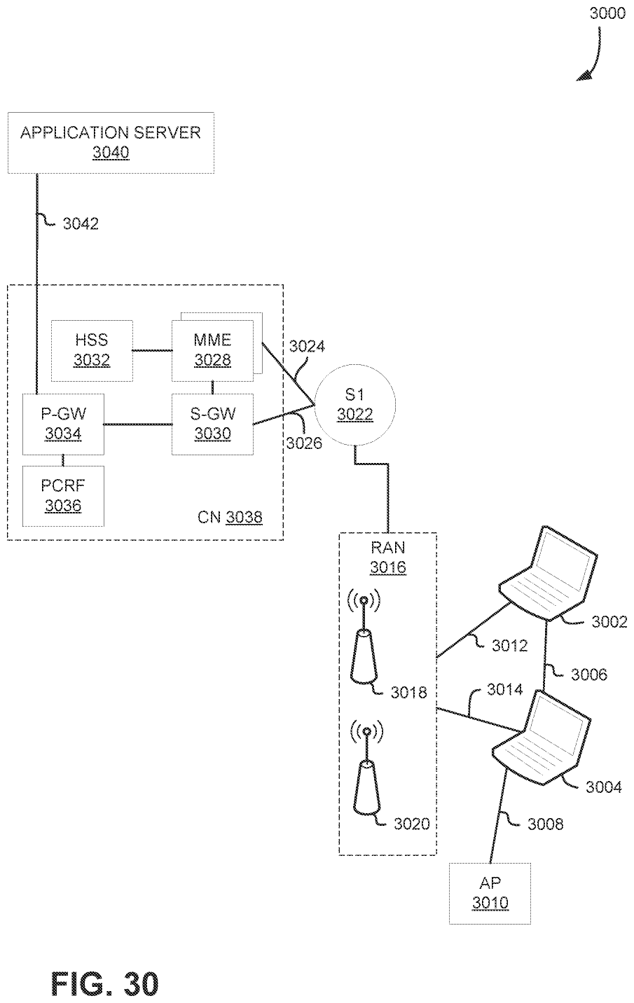

FIG. 29 illustrates training and deployment of a deep neural network, according to at least one embodiment. In at least one embodiment, untrained neural network 2906 is trained using a training dataset 2902. In at least one embodiment, training framework 2904 is a PyTorch framework, whereas in other embodiments, training framework 2904 is a TensorFlow, Boost, Caffe, Microsoft Cognitive Toolkit/CNTK, MXNet, Chainer, Keras, Deeplearning4j, or other training framework. In at least one embodiment, training framework 2904 trains an untrained neural network 2906 and enables it to be trained using processing resources described herein to generate a trained neural network 2908. In at least one embodiment, weights may be chosen randomly or by pre-training using a deep belief network. In at least one embodiment, training may be performed in either a supervised, partially supervised, or unsupervised manner.

In at least one embodiment, untrained neural network 2906 is trained using supervised learning, wherein training dataset 2902 includes an input paired with a desired output for an input, or where training dataset 2902 includes input having a known output and an output of untrained neural network 2906 is manually graded. In at least one embodiment, untrained neural network 2906 is trained in a supervised manner and processes inputs from training dataset 2902 and compares resulting outputs against a set of expected or desired outputs. In at least one embodiment, errors are then propagated back through untrained neural network 2906. In at least one embodiment, training framework 2904 adjusts weights that control untrained neural network 2906. In at least one embodiment, training framework 2904 includes tools to monitor how well untrained neural network 2906 is converging towards a model, such as trained neural network 2908, suitable to generating correct answers, such as in result 2914, based on input data such as a new dataset 2912. In at least one embodiment, training framework 2904 trains untrained neural network 2906 repeatedly while adjust weights to refine an output of untrained neural network 2906 using a loss function and adjustment algorithm, such as stochastic gradient descent. In at least one embodiment, training framework 2904 trains untrained neural network 2906 until untrained neural network 2906 achieves a desired accuracy. In at least one embodiment, trained neural network 2908 can then be deployed to implement any number of machine learning operations.

In at least one embodiment, untrained neural network 2906 is trained using unsupervised learning, wherein untrained neural network 2906 attempts to train itself using unlabeled data. In at least one embodiment, unsupervised learning training dataset 2902 will include input data without any associated output data or “ground truth” data. In at least one embodiment, untrained neural network 2906 can learn groupings within training dataset 2902 and can determine how individual inputs are related to an untrained dataset (e.g., new dataset 2912). In at least one embodiment, unsupervised training can be used to generate a self-organizing map in trained neural network 2908 capable of performing operations useful in reducing dimensionality of new dataset 2912. In at least one embodiment, unsupervised training can also be used to perform anomaly detection, which allows identification of data points in new dataset 2912 that deviate from normal patterns of new dataset 2912.

In at least one embodiment, semi-supervised learning may be used, which is a technique in which in training dataset 2902 includes a mix of labeled and unlabeled data. In at least one embodiment, training framework 2904 may be used to perform incremental learning, such as through transferred learning techniques. In at least one embodiment, incremental learning enables trained neural network 2908 to adapt to new dataset 2912 without forgetting knowledge instilled within trained neural network 2908 during initial training.

In at least one embodiment, at least one component shown or described with respect to FIG. 29 is used to perform techniques and/or functions described in connection with FIGS. 1-15. In at least one embodiment, at least one component shown or described with respect to FIG. 29 is used to cause a first application programming interface (API) to select a second API to perform one or more software workloads identified by the first API. In at least one embodiment, at least one component shown or described with respect to FIG. 29 is used to perform a first application programming interface (API) to select a second API to monitor performance of one or more software workloads identified by the first API. In at least one embodiment, at least one component shown or described with respect to FIG. 29 is used to perform a first application programming interface (API) to select a second API to terminate performance of one or more software workloads identified by the first API. In at least one embodiment, at least one component shown or described with respect to FIG. 29 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

### 5G Networks

The following figures set forth, without limitation, exemplary 5G network-based systems that can be used to implement at least one embodiment.

FIG. 30 illustrates an architecture of a system 3000 of a network, in accordance with at least one embodiment. In at least one embodiment, system 3000 is shown to include a user equipment (UE) 3002 and a UE 3004. In at least one embodiment, UEs 3002 and 3004 are illustrated as smartphones (e.g., handheld touchscreen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In at least one embodiment, any of UEs 3002 and 3004 can comprise an Internet of Things (IoT) UE, which can comprise a network access layer designed for low-power IoT applications utilizing short-lived UE connections. In at least one embodiment, an IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. In at least one embodiment, a M2M or MTC exchange of data may be a machine-initiated exchange of data. In at least one embodiment, an IoT network describes interconnecting IoT UEs, which may include uniquely identifiable embedded computing devices (within Internet infrastructure), with short-lived connections. In at least one embodiment, an IoT UEs may execute background applications (e.g., keep alive messages, status updates, etc.) to facilitate connections of an IoT network.

In at least one embodiment, UEs 3002 and 3004 may be configured to connect, e.g., communicatively couple, with a radio access network (RAN) 3016. In at least one embodiment, RAN 3016 may be, for example, an Evolved Universal Mobile Telecommunications System (UMTS) Terrestrial Radio Access Network (E-UTRAN), a NextGen RAN (NG RAN), or some other type of RAN. In at least one embodiment, UEs 3002 and 3004 utilize connections 3012 and 3014, respectively, each of which comprises a physical communications interface or layer. In at least one embodiment, connections 3012 and 3014 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and variations thereof.

In at least one embodiment, UEs 3002 and 3004 may further directly exchange communication data via a ProSe interface 3006. In at least one embodiment, ProSe interface 3006 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

In at least one embodiment, UE 3004 is shown to be configured to access an access point (AP) 3010 via connection 3008. In at least one embodiment, connection 3008 can comprise a local wireless connection, such as a connection consistent with any IEEE 802.11 protocol, wherein AP 3010 would comprise a wireless fidelity (WiFi®) router. In at least one embodiment, AP 3010 is shown to be connected to an Internet without connecting to a core network of a wireless system.

In at least one embodiment, RAN 3016 can include one or more access nodes that enable connections 3012 and 3014. In at least one embodiment, these access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). In at least one embodiment, RAN 3016 may include one or more RAN nodes for providing macrocells, e.g., macro RAN node 3018, and one or more RAN nodes for providing femtocells or picocells (e.g., cells having smaller coverage areas, smaller user capacity, or higher bandwidth compared to macrocells), e.g., low power (LP) RAN node 3020.

In at least one embodiment, any of RAN nodes 3018 and 3020 can terminate an air interface protocol and can be a first point of contact for UEs 3002 and 3004. In at least one embodiment, any of RAN nodes 3018 and 3020 can fulfill various logical functions for RAN 3016 including, but not limited to, radio network controller (RNC) functions such as radio bearer management, uplink and downlink dynamic radio resource management and data packet scheduling, and mobility management.

In at least one embodiment, UEs 3002 and 3004 can be configured to communicate using Orthogonal Frequency-Division Multiplexing (OFDM) communication signals with each other or with any of RAN nodes 3018 and 3020 over a multi-carrier communication channel in accordance various communication techniques, such as, but not limited to, an Orthogonal Frequency Division Multiple Access (OFDMA) communication technique (e.g., for downlink communications) or a Single Carrier Frequency Division Multiple Access (SC-FDMA) communication technique (e.g., for uplink and ProSe or sidelink communications), and/or variations thereof. In at least one embodiment, OFDM signals can comprise a plurality of orthogonal sub-carriers.

In at least one embodiment, a downlink resource grid can be used for downlink transmissions from any of RAN nodes 3018 and 3020 to UEs 3002 and 3004, while uplink transmissions can utilize similar techniques. In at least one embodiment, a grid can be a time frequency grid, called a resource grid or time-frequency resource grid, which is a physical resource in a downlink in each slot. In at least one embodiment, such a time frequency plane representation is a common practice for OFDM systems, which makes it intuitive for radio resource allocation. In at least one embodiment, each column and each row of a resource grid corresponds to one OFDM symbol and one OFDM subcarrier, respectively. In at least one embodiment, a duration of a resource grid in a time domain corresponds to one slot in a radio frame. In at least one embodiment, a smallest time-frequency unit in a resource grid is denoted as a resource element. In at least one embodiment, each resource grid comprises a number of resource blocks, which describe a mapping of certain physical channels to resource elements. In at least one embodiment, each resource block comprises a collection of resource elements. In at least one embodiment, in a frequency domain, this may represent a smallest quantity of resources that currently can be allocated. In at least one embodiment, there are several different physical downlink channels that are conveyed using such resource blocks.

In at least one embodiment, a physical downlink shared channel (PDSCH) may carry user data and higher-layer signaling to UEs 3002 and 3004. In at least one embodiment, a physical downlink control channel (PDCCH) may carry information about a transport format and resource allocations related to PDSCH channel, among other things. In at least one embodiment, it may also inform UEs 3002 and 3004 about a transport format, resource allocation, and HARQ (Hybrid Automatic Repeat Request) information related to an uplink shared channel. In at least one embodiment, typically, downlink scheduling (assigning control and shared channel resource blocks to UE 3002 within a cell) may be performed at any of RAN nodes 3018 and 3020 based on channel quality information fed back from any of UEs 3002 and 3004. In at least one embodiment, downlink resource assignment information may be sent on a PDCCH used for (e.g., assigned to) each of UEs 3002 and 3004.

In at least one embodiment, a PDCCH may use control channel elements (CCEs) to convey control information. In at least one embodiment, before being mapped to resource elements, PDCCH complex valued symbols may first be organized into quadruplets, which may then be permuted using a sub-block interleaver for rate matching. In at least one embodiment, each PDCCH may be transmitted using one or more of these CCEs, where each CCE may correspond to nine sets of four physical resource elements known as resource element groups (REGs). In at least one embodiment, four Quadrature Phase Shift Keying (QPSK) symbols may be mapped to each REG. In at least one embodiment, PDCCH can be transmitted using one or more CCEs, depending on a size of a downlink control information (DCI) and a channel condition. In at least one embodiment, there can be four or more different PDCCH formats defined in LTE with different numbers of CCEs (e.g., aggregation level, L=1, 2, 4, or 8).

In at least one embodiment, an enhanced physical downlink control channel (EPDCCH) that uses PDSCH resources may be utilized for control information transmission. In at least one embodiment, EPDCCH may be transmitted using one or more enhanced control channel elements (ECCEs). In at least one embodiment, each ECCE may correspond to nine sets of four physical resource elements known as an enhanced resource element groups (EREGs). In at least one embodiment, an ECCE may have other numbers of EREGs in some situations.

In at least one embodiment, RAN 3016 is shown to be communicatively coupled to a core network (CN) 3038 via an S1 interface 3022. In at least one embodiment, CN 3038 may be an evolved packet core (EPC) network, a NextGen Packet Core (NPC) network, or some other type of CN. In at least one embodiment, S1 interface 3022 is split into two parts: S1-U interface 3026, which carries traffic data between RAN nodes 3018 and 3020 and serving gateway (S-GW) 3030, and a S1-mobility management entity (MME) interface 3024, which is a signaling interface between RAN nodes 3018 and 3020 and MMEs 3028.

In at least one embodiment, CN 3038 comprises MMEs 3028, S-GW 3030, Packet Data Network (PDN) Gateway (P-GW) 3034, and a home subscriber server (HSS) 3032. In at least one embodiment, MMEs 3028 may be similar in function to a control plane of legacy Serving General Packet Radio Service (GPRS) Support Nodes (SGSN). In at least one embodiment, MMEs 3028 may manage mobility aspects in access such as gateway selection and tracking area list management. In at least one embodiment, HSS 3032 may comprise a database for network users, including subscription related information to support a network entities' handling of communication sessions. In at least one embodiment, CN 3038 may comprise one or several HSSs 3032, depending on a number of mobile subscribers, on a capacity of an equipment, on an organization of a network, etc. In at least one embodiment, HSS 3032 can provide support for routing/roaming, authentication, authorization, naming/addressing resolution, location dependencies, etc.

In at least one embodiment, S-GW 3030 may terminate a S1 interface 3022 towards RAN 3016, and routes data packets between RAN 3016 and CN 3038. In at least one embodiment, S-GW 3030 may be a local mobility anchor point for inter-RAN node handovers and also may provide an anchor for inter-3GPP mobility. In at least one embodiment, other responsibilities may include lawful intercept, charging, and some policy enforcement.

In at least one embodiment, P-GW 3034 may terminate an SGi interface toward a PDN. In at least one embodiment, P-GW 3034 may route data packets between an EPC network (e.g., CN 3038) and external networks such as a network including application server 3040 (alternatively referred to as application function (AF)) via an Internet Protocol (IP) interface 3042. In at least one embodiment, application server 3040 may be an element offering applications that use IP bearer resources with a core network (e.g., UMTS Packet Services (PS) domain, LTE PS data services, etc.). In at least one embodiment, P-GW 3034 is shown to be communicatively coupled to an application server 3040 via an Internet Protocol (IP) interface 3042. In at least one embodiment, application server 3040 can also be configured to support one or more communication services (e.g., Voice-over-Internet Protocol (VoIP) sessions, PTT sessions, group communication sessions, social networking services, etc.) for UEs 3002 and 3004 via CN 3038.

In at least one embodiment, P-GW 3034 may further be a node for policy enforcement and charging data collection. In at least one embodiment, policy and Charging Enforcement Function (PCRF) 3036 is a policy and charging control element of CN 3038. In at least one embodiment, in a non-roaming scenario, there may be a single PCRF in a Home Public Land Mobile Network (HPLMN) associated with a UE's Internet Protocol Connectivity Access Network (IP-CAN) session. In at least one embodiment, in a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). In at least one embodiment, PCRF 3036 may be communicatively coupled to application server 3040 via P-GW 3034. In at least one embodiment, application server 3040 may signal PCRF 3036 to indicate a new service flow and select an appropriate Quality of Service (QoS) and charging parameters. In at least one embodiment, PCRF 3036 may provision this rule into a Policy and Charging Enforcement Function (PCEF) (not shown) with an appropriate traffic flow template (TFT) and QoS class of identifier (QCI), which commences a QoS and charging as specified by application server 3040.

In at least one embodiment, at least one component shown or described with respect to FIG. 30 is used to perform techniques and/or functions described in connection with FIGS. 1-15. In at least one embodiment, at least one component shown or described with respect to FIG. 30 is used to cause a first application programming interface (API) to select a second API to perform one or more software workloads identified by the first API. In at least one embodiment, at least one component shown or described with respect to FIG. 30 is used to perform a first application programming interface (API) to select a second API to monitor performance of one or more software workloads identified by the first API. In at least one embodiment, at least one component shown or described with respect to FIG. 30 is used to perform a first application programming interface (API) to select a second API to terminate performance of one or more software workloads identified by the first API. In at least one embodiment, at least one component shown or described with respect to FIG. 30 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

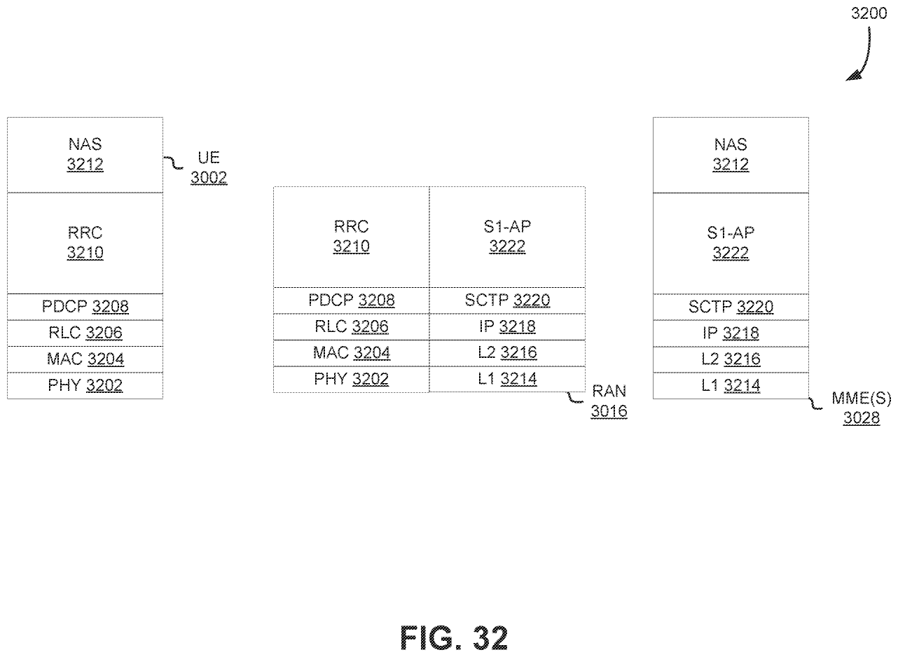

FIG. 31 illustrates an architecture of a system 3100 of a network in accordance with some embodiments. In at least one embodiment, system 3100 is shown to include a UE 3102, a 5G access node or RAN node (shown as (R)AN node 3108), a User Plane Function (shown as UPF 3104), a Data Network (DN 3106), which may be, for example, operator services, Internet access or 3rd party services, and a 5G Core Network (5GC) (shown as CN 3110).

In at least one embodiment, CN 3110 includes an Authentication Server Function (AUSF 3114); a Core Access and Mobility Management Function (AMF 3112); a Session Management Function (SMF 3118); a Network Exposure Function (NEF 3116); a Policy Control Function (PCF 3122); a Network Function (NF) Repository Function (NRF 3120); a Unified Data Management (UDM 3124); and an Application Function (AF 3126). In at least one embodiment, CN 3110 may also include other elements that are not shown, such as a Structured Data Storage network function (SDSF), an Unstructured Data Storage network function (UDSF), and variations thereof.

In at least one embodiment, UPF 3104 may act as an anchor point for intra-RAT and inter-RAT mobility, an external PDU session point of interconnect to DN 3106, and a branching point to support multi-homed PDU session. In at least one embodiment, UPF 3104 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in uplink and downlink, and downlink packet buffering and downlink data notification triggering. In at least one embodiment, UPF 3104 may include an uplink classifier to support routing traffic flows to a data network. In at least one embodiment, DN 3106 may represent various network operator services, Internet access, or third party services.

In at least one embodiment, AUSF 3114 may store data for authentication of UE 3102 and handle authentication related functionality. In at least one embodiment, AUSF 3114 may facilitate a common authentication framework for various access types.

In at least one embodiment, AMF 3112 may be responsible for registration management (e.g., for registering UE 3102, etc.), connection management, reachability management, mobility management, and lawful interception of AMF-related events, and access authentication and authorization. In at least one embodiment, AMF 3112 may provide transport for SM messages for SMF 3118, and act as a transparent proxy for routing SM messages. In at least one embodiment, AMF 3112 may also provide transport for short message service (SMS) messages between UE 3102 and an SMS function (SMSF) (not shown by FIG. 31). In at least one embodiment, AMF 3112 may act as Security Anchor Function (SEA), which may include interaction with AUSF 3114 and UE 3102 and receipt of an intermediate key that was established as a result of UE 3102 authentication process. In at least one embodiment, where USIM based authentication is used, AMF 3112 may retrieve security material from AUSF 3114. In at least one embodiment, AMF 3112 may also include a Security Context Management (SCM) function, which receives a key from SEA that it uses to derive access-network specific keys. In at least one embodiment, furthermore, AMF 3112 may be a termination point of RAN CP interface (N2 reference point), a termination point of NAS (NI) signaling, and perform NAS ciphering and integrity protection.

In at least one embodiment, AMF 3112 may also support NAS signaling with a UE 3102 over an N3 interworking-function (IWF) interface. In at least one embodiment, N3IWF may be used to provide access to untrusted entities. In at least one embodiment, N3IWF may be a termination point for N2 and N3 interfaces for control plane and user plane, respectively, and as such, may handle N2 signaling from SMF and AMF for PDU sessions and QoS, encapsulate/de-encapsulate packets for IPSec and N3 tunneling, mark N3 user-plane packets in uplink, and enforce QoS corresponding to N3 packet marking taking into account QoS requirements associated to such marking received over N2. In at least one embodiment, N3IWF may also relay uplink and downlink control-plane NAS (NI) signaling between UE 3102 and AMF 3112, and relay uplink and downlink user-plane packets between UE 3102 and UPF 3104. In at least one embodiment, N3IWF also provides mechanisms for IPsec tunnel establishment with UE 3102.

In at least one embodiment, SMF 3118 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. In at least one embodiment, SMF 3118 may include following roaming functionality: handle local enforcement to apply QoS SLAB (VPLMN); charging data collection and charging interface (VPLMN); lawful intercept (in VPLMN for SM events and interface to LI System); support for interaction with external DN for transport of signaling for PDU session authorization/authentication by external DN.

In at least one embodiment, NEF 3116 may provide means for securely exposing services and capabilities provided by 3GPP network functions for third party, internal exposure/re-exposure, Application Functions (e.g., AF 3126), edge computing or fog computing systems, etc. In at least one embodiment, NEF 3116 may authenticate, authorize, and/or throttle AFs. In at least one embodiment, NEF 3116 may also translate information exchanged with AF 3126 and information exchanged with internal network functions. In at least one embodiment, NEF 3116 may translate between an AF-Service-Identifier and an internal 5GC information. In at least one embodiment, NEF 3116 may also receive information from other network functions (NFs) based on exposed capabilities of other network functions. In at least one embodiment, this information may be stored at NEF 3116 as structured data, or at a data storage NF using a standardized interfaces. In at least one embodiment, stored information can then be re-exposed by NEF 3116 to other NFs and AFs, and/or used for other purposes such as analytics.

In at least one embodiment, NRF 3120 may support service discovery functions, receive NF Discovery Requests from NF instances, and provide information of discovered NF instances to NF instances. In at least one embodiment, NRF 3120 also maintains information of available NF instances and their supported services.

In at least one embodiment, PCF 3122 may provide policy rules to control plane function(s) to enforce them, and may also support unified policy framework to govern network behavior. In at least one embodiment, PCF 3122 may also implement a front end (FE) to access subscription information relevant for policy decisions in a UDR of UDM 3124.

In at least one embodiment, UDM 3124 may handle subscription-related information to support a network entities' handling of communication sessions, and may store subscription data of UE 3102. In at least one embodiment, UDM 3124 may include two parts, an application FE and a User Data Repository (UDR). In at least one embodiment, UDM may include a UDM FE, which is in charge of processing of credentials, location management, subscription management and so on. In at least one embodiment, several different front ends may serve a same user in different transactions. In at least one embodiment, UDM-FE accesses subscription information stored in an UDR and performs authentication credential processing; user identification handling; access authorization; registration/mobility management; and subscription management. In at least one embodiment, UDR may interact with PCF 3122. In at least one embodiment, UDM 3124 may also support SMS management, wherein an SMS-FE implements a similar application logic as discussed previously.

In at least one embodiment, AF 3126 may provide application influence on traffic routing, access to a Network Capability Exposure (NCE), and interact with a policy framework for policy control. In at least one embodiment, NCE may be a mechanism that allows a 5GC and AF 3126 to provide information to each other via NEF 3116, which may be used for edge computing implementations. In at least one embodiment, network operator and third party services may be hosted close to UE 3102 access point of attachment to achieve an efficient service delivery through a reduced end-to-end latency and load on a transport network. In at least one embodiment, for edge computing implementations, 5GC may select a UPF 3104 close to UE 3102 and execute traffic steering from UPF 3104 to DN 3106 via N6 interface. In at least one embodiment, this may be based on UE subscription data, UE location, and information provided by AF 3126. In at least one embodiment, AF 3126 may influence UPF (re)selection and traffic routing. In at least one embodiment, based on operator deployment, when AF 3126 is considered to be a trusted entity, a network operator may permit AF 3126 to interact directly with relevant NFs.

In at least one embodiment, CN 3110 may include an SMSF, which may be responsible for SMS subscription checking and verification, and relaying SM messages to/from UE 3102 to/from other entities, such as an SMS-GMSC/IWMSC/SMS-router. In at least one embodiment, SMS may also interact with AMF 3112 and UDM 3124 for notification procedure that UE 3102 is available for SMS transfer (e.g., set a UE not reachable flag, and notifying UDM 3124 when UE 3102 is available for SMS).

In at least one embodiment, system 3100 may include following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

In at least one embodiment, system 3100 may include following reference points: N1: Reference point between UE and AMF; N2: Reference point between (R)AN and AMF; N3: Reference point between (R)AN and UPF; N4: Reference point between SMF and UPF; and N6: Reference point between UPF and a Data Network. In at least one embodiment, there may be many more reference points and/or service-based interfaces between a NF services in NFs, how-ever, these interfaces and reference points have been omitted for clarity. In at least one embodiment, an NS reference point may be between a PCF and AF; an N7 reference point may be between PCF and SMF; an N11 reference point between AMF and SMF; etc. In at least one embodiment, CN 3110 may include an Nx interface, which is an inter-CN interface between MME and AMF 3112 in order to enable interworking between CN 3110 and CN 7231.

In at least one embodiment, system 3100 may include multiple RAN nodes (such as (R)AN node 3108) wherein an Xn interface is defined between two or more (R)AN node 3108 (e.g., gNBs) that connecting to 5GC 410, between a (R)AN node 3108 (e.g., gNB) connecting to CN 3110 and an eNB (e.g., a macro RAN node), and/or between two eNBs connecting to CN 3110.

In at least one embodiment, Xn interface may include an Xn user plane (Xn-U) interface and an Xn control plane (Xn-C) interface. In at least one embodiment, Xn-U may provide non-guaranteed delivery of user plane PDUs and support/provide data forwarding and flow control functionality. In at least one embodiment, Xn-C may provide management and error handling functionality, functionality to manage a Xn-C interface; mobility support for UE 3102 in a connected mode (e.g., CM-CONNECTED) including functionality to manage UE mobility for connected mode between one or more (R)AN node 3108. In at least one embodiment, mobility support may include context transfer from an old (source) serving (R)AN node 3108 to new (target) serving (R)AN node 3108; and control of user plane tunnels between old (source) serving (R)AN node 3108 to new (target) serving (R)AN node 3108.

In at least one embodiment, a protocol stack of a Xn-U may include a transport network layer built on Internet Protocol (IP) transport layer, and a GTP-U layer on top of a UDP and/or IP layer(s) to carry user plane PDUs. In at least one embodiment, Xn-C protocol stack may include an application layer signaling protocol (referred to as Xn Application Protocol (Xn-AP)) and a transport network layer that is built on an SCTP layer. In at least one embodiment, SCTP layer may be on top of an IP layer. In at least one embodiment, SCTP layer provides a guaranteed delivery of application layer messages. In at least one embodiment, in a transport IP layer point-to-point transmission is used to deliver signaling PDUs. In at least one embodiment, Xn-U protocol stack and/or a Xn-C protocol stack may be same or similar to an user plane and/or control plane protocol stack(s) shown and described herein.

In at least one embodiment, at least one component shown or described with respect to FIG. 31 is used to perform techniques and/or functions described in connection with FIGS. 1-15. In at least one embodiment, at least one component shown or described with respect to FIG. 31 is used to cause a first application programming interface (API) to select a second API to perform one or more software workloads identified by the first API. In at least one embodiment, at least one component shown or described with respect to FIG. 31 is used to perform a first application programming interface (API) to select a second API to monitor performance of one or more software workloads identified by the first API. In at least one embodiment, at least one component shown or described with respect to FIG. 31 is used to perform a first application programming interface (API) to select a second API to terminate performance of one or more software workloads identified by the first API. In at least one embodiment, at least one component shown or described with respect to FIG. 31 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

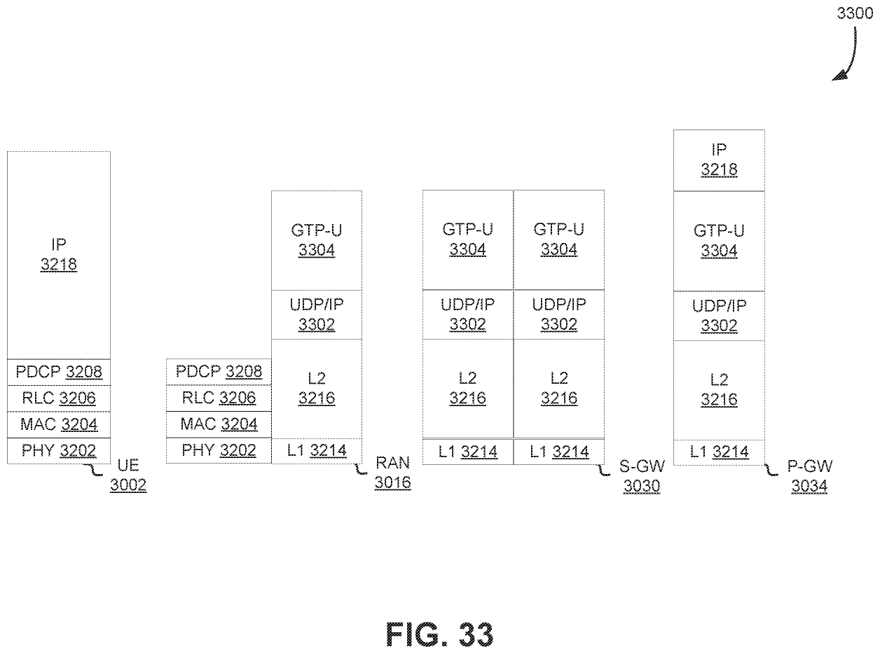

FIG. 32 is an illustration of a control plane protocol stack in accordance with some embodiments. In at least one embodiment, a control plane 3200 is shown as a communications protocol stack between UE 3002 (or alternatively, UE 3004), RAN 3016, and MME(s) 3028.

In at least one embodiment, PHY layer 3202 may transmit or receive information used by MAC layer 3204 over one or more air interfaces. In at least one embodiment, PHY layer 3202 may further perform link adaptation or adaptive modulation and coding (AMC), power control, cell search (e.g., for initial synchronization and handover purposes), and other measurements used by higher layers, such as an RRC layer 3210. In at least one embodiment, PHY layer 3202 may still further perform error detection on transport channels, forward error correction (FEC) coding/de-coding of transport channels, modulation/demodulation of physical channels, interleaving, rate matching, mapping onto physical channels, and Multiple Input Multiple Output (MIMO) antenna processing.

In at least one embodiment, MAC layer 3204 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from PHY via transport channels, multiplexing MAC SDUs onto TBs, scheduling information reporting, error correction through hybrid automatic repeat request (HARD), and logical channel prioritization.

In at least one embodiment, RLC layer 3206 may operate in a plurality of modes of operation, including: Transparent Mode (TM), Unacknowledged Mode (UM), and Acknowledged Mode (AM). In at least one embodiment, RLC layer 3206 may execute transfer of upper layer protocol data units (PDUs), error correction through automatic repeat request (ARQ) for AM data transfers, and concatenation, segmentation and reassembly of RLC SDUs for UM and AM data transfers. In at least one embodiment, RLC layer 3206 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

In at least one embodiment, PDCP layer 3208 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

In at least one embodiment, main services and functions of a RRC layer 3210 may include broadcast of system information (e.g., included in Master Information Blocks (MIBs) or System Information Blocks (SIBs) related to a non-access stratum (NAS)), broadcast of system information related to an access stratum (AS), paging, establishment, maintenance and release of an RRC connection between an UE and E-UTRAN (e.g., RRC connection paging, RRC connection establishment, RRC connection modification, and RRC connection release), establishment, configuration, maintenance and release of point-to-point radio bearers, security functions including key management, inter radio access technology (RAT) mobility, and measurement configuration for UE measurement reporting. In at least one embodiment, said MIBs and SIBs may comprise one or more information elements (IEs), which may each comprise individual data fields or data structures.

In at least one embodiment, UE 3002 and RAN 3016 may utilize a Uu interface (e.g., an LTE-Uu interface) to exchange control plane data via a protocol stack comprising PHY layer 3202, MAC layer 3204, RLC layer 3206, PDCP layer 3208, and RRC layer 3210.

In at least one embodiment, non-access stratum (NAS) protocols (NAS protocols 3212) form a highest stratum of a control plane between UE 3002 and MME(s) 3028. In at least one embodiment, NAS protocols 3212 support mobility of UE 3002 and session management procedures to establish and maintain IP connectivity between UE 3002 and P-GW 3034.

In at least one embodiment, Si Application Protocol (S1-AP) layer (Si-AP layer 3222) may support functions of a Si interface and comprise Elementary Procedures (EPs). In at least one embodiment, an EP is a unit of interaction between RAN 3016 and CN 3038. In at least one embodiment, S1-AP layer services may comprise two groups: UE-associated services and non UE-associated services. In at least one embodiment, these services perform functions including, but not limited to: E-UTRAN Radio Access Bearer (E-RAB) management, UE capability indication, mobility, NAS signaling transport, RAN Information Management (RIM), and configuration transfer.

In at least one embodiment, Stream Control Transmission Protocol (SCTP) layer (alternatively referred to as a stream control transmission protocol/internet protocol (SCTP/IP) layer) (SCTP layer 3220) may ensure reliable delivery of signaling messages between RAN 3016 and MME(s) 3028 based, in part, on an IP protocol, supported by an IP layer 3218. In at least one embodiment, L2 layer 3216 and an L1 layer 3214 may refer to communication links (e.g., wired or wireless) used by a RAN node and MME to exchange information.

In at least one embodiment, RAN 3016 and MME(s) 3028 may utilize an S1-MME interface to exchange control plane data via a protocol stack comprising a L1 layer 3214, L2 layer 3216, IP layer 3218, SCTP layer 3220, and Si-AP layer 3222.

In at least one embodiment, at least one component shown or described with respect to FIG. 32 is used to perform techniques and/or functions described in connection with FIGS. 1-15. In at least one embodiment, at least one component shown or described with respect to FIG. 32 is used to cause a first application programming interface (API) to select a second API to perform one or more software workloads identified by the first API. In at least one embodiment, at least one component shown or described with respect to FIG. 32 is used to perform a first application programming interface (API) to select a second API to monitor performance of one or more software workloads identified by the first API. In at least one embodiment, at least one component shown or described with respect to FIG. 32 is used to perform a first application programming interface (API) to select a second API to terminate performance of one or more software workloads identified by the first API. In at least one embodiment, at least one component shown or described with respect to FIG. 32 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

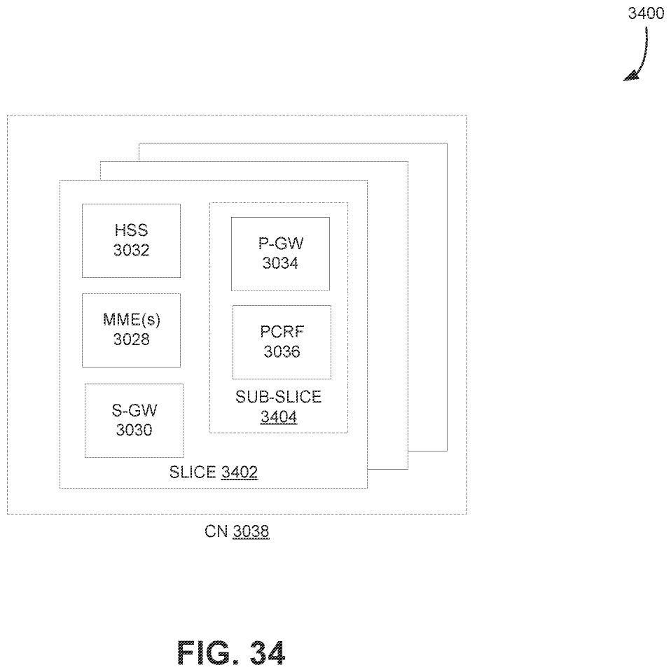

FIG. 33 is an illustration of a user plane protocol stack in accordance with at least one embodiment. In at least one embodiment, a user plane 3300 is shown as a communications protocol stack between a UE 3002, RAN 3016, S-GW 3030, and P-GW 3034. In at least one embodiment, user plane 3300 may utilize a same protocol layers as control plane 3200. In at least one embodiment, for example, UE 3002 and RAN 3016 may utilize a Uu interface (e.g., an LTE-Uu interface) to exchange user plane data via a protocol stack comprising PHY layer 3202, MAC layer 3204, RLC layer 3206, PDCP layer 3208.

In at least one embodiment, General Packet Radio Service (GPRS) Tunneling Protocol for a user plane (GTP-U) layer (GTP-U layer 3304) may be used for carrying user data within a GPRS core network and between a radio access network and a core network. In at least one embodiment, user data transported can be packets in any of IPv4, IPv6, or PPP formats, for example. In at least one embodiment, UDP and IP security (UDP/IP) layer (UDP/IP layer 3302) may provide checksums for data integrity, port numbers for addressing different functions at a source and destination, and encryption and authentication on selected data flows. In at least one embodiment, RAN 3016 and S-GW 3030 may utilize an S1-U interface to exchange user plane data via a protocol stack comprising L1 layer 3214, L2 layer 3216, UDP/IP layer 3302, and GTP-U layer 3304. In at least one embodiment, S-GW 3030 and P-GW 3034 may utilize an S5/S8a interface to exchange user plane data via a protocol stack comprising L1 layer 3214, L2 layer 3216, UDP/IP layer 3302, and GTP-U layer 3304. In at least one embodiment, as discussed above with respect to FIG. 32, NAS protocols support a mobility of UE 3002 and session management procedures to establish and maintain IP connectivity between UE 3002 and P-GW 3034.

In at least one embodiment, at least one component shown or described with respect to FIG. 33 is used to perform techniques and/or functions described in connection with FIGS. 1-15. In at least one embodiment, at least one component shown or described with respect to FIG. 33 is used to cause a first application programming interface (API) to select a second API to perform one or more software workloads identified by the first API. In at least one embodiment, at least one component shown or described with respect to FIG. 33 is used to perform a first application programming interface (API) to select a second API to monitor performance of one or more software workloads identified by the first API. In at least one embodiment, at least one component shown or described with respect to FIG. 33 is used to perform a first application programming interface (API) to select a second API to terminate performance of one or more software workloads identified by the first API. In at least one embodiment, at least one component shown or described with respect to FIG. 33 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

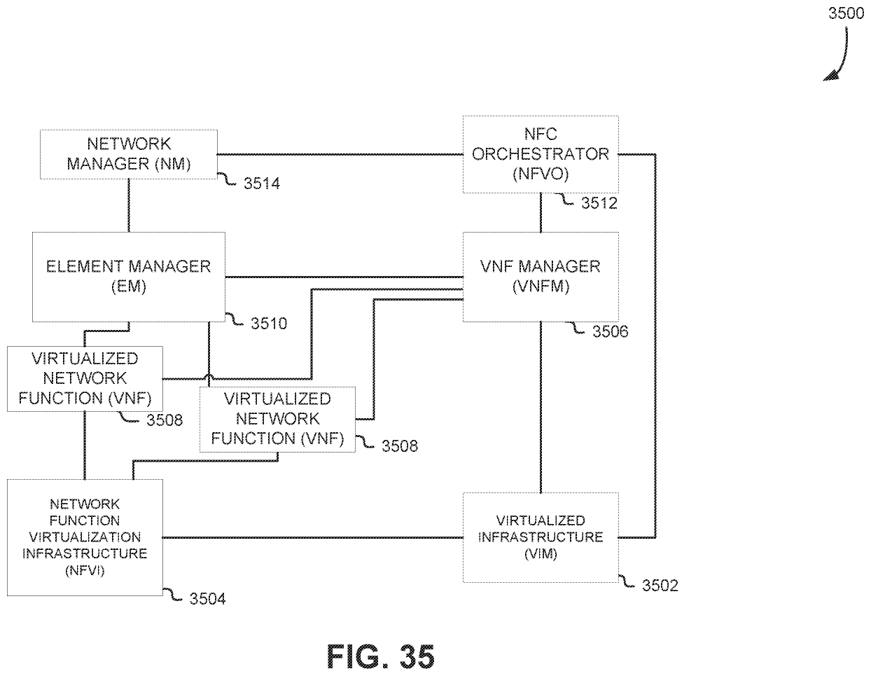

FIG. 34 illustrates components 3400 of a core network in accordance with at least one embodiment. In at least one embodiment, components of CN 3038 may be implemented in one physical node or separate physical nodes including components to read and execute instructions from a machine-readable or computer-readable medium (e.g., a non-transitory machine-readable storage medium). In at least one embodiment, Network Functions Virtualization (NFV) is utilized to virtualize any or all of above described network node functions via executable instructions stored in one or more computer readable storage mediums (described in further detail below). In at least one embodiment, a logical instantiation of CN 3038 may be referred to as a network slice 3402 (e.g., network slice 3402 is shown to include HSS 3032, MME(s) 3028, and S-GW 3030). In at least one embodiment, a logical instantiation of a portion of CN 3038 may be referred to as a network sub-slice 3404 (e.g., network sub-slice 3404 is shown to include P-GW 3034 and PCRF 3036).

In at least one embodiment, NFV architectures and infrastructures may be used to virtualize one or more network functions, alternatively performed by proprietary hardware, onto physical resources comprising a combination of industry-standard server hardware, storage hardware, or switches. In at least one embodiment, NFV systems can be used to execute virtual or reconfigurable implementations of one or more EPC components/functions.

In at least one embodiment, at least one component shown or described with respect to FIG. 34 is used to perform techniques and/or functions described in connection with FIGS. 1-15. In at least one embodiment, at least one component shown or described with respect to FIG. 34 is used to cause a first application programming interface (API) to select a second API to perform one or more software workloads identified by the first API. In at least one embodiment, at least one component shown or described with respect to FIG. 34 is used to perform a first application programming interface (API) to select a second API to monitor performance of one or more software workloads identified by the first API. In at least one embodiment, at least one component shown or described with respect to FIG. 34 is used to perform a first application programming interface (API) to select a second API to terminate performance of one or more software workloads identified by the first API. In at least one embodiment, at least one component shown or described with respect to FIG. 34 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

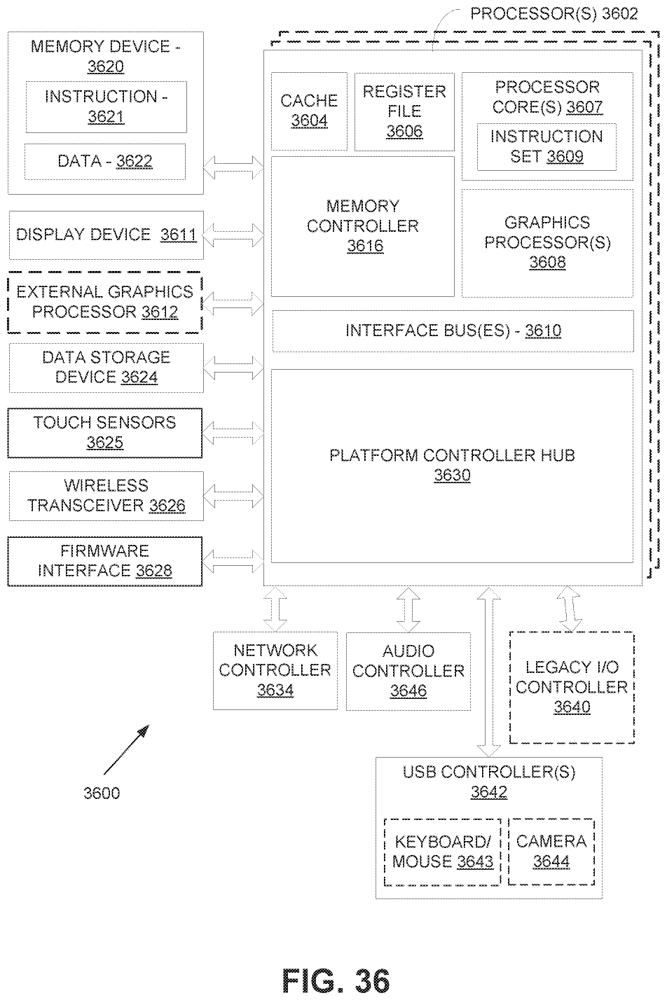

FIG. 35 is a block diagram illustrating components, according to at least one embodiment, of a system 3500 to support network function virtualization (NFV). In at least one embodiment, system 3500 is illustrated as including a virtualized infrastructure manager (shown as VIM 3502), a network function virtualization infrastructure (shown as NFVI 3504), a VNF manager (shown as VNFM 3506), virtualized network functions (shown as VNF 3508), an element manager (shown as EM 3510), an NFV Orchestrator (shown as NFVO 3512), and a network manager (shown as NM 3514).

In at least one embodiment, VIM 3502 manages resources of NFVI 3504. In at least one embodiment, NFVI 3504 can include physical or virtual resources and applications (including hypervisors) used to execute system 3500. In at least one embodiment, VIM 3502 may manage a life cycle of virtual resources with NFVI 3504 (e.g., creation, maintenance, and tear down of virtual machines (VMs) associated with one or more physical resources), track VM instances, track performance, fault and security of VM instances and associated physical resources, and expose VM instances and associated physical resources to other management systems.

In at least one embodiment, VNFM 3506 may manage VNF 3508. In at least one embodiment, VNF 3508 may be used to execute EPC components/functions. In at least one embodiment, VNFM 3506 may manage a life cycle of VNF 3508 and track performance, fault and security of virtual aspects of VNF 3508. In at least one embodiment, EM 3510 may track performance, fault and security of functional aspects of VNF 3508. In at least one embodiment, tracking data from VNFM 3506 and EM 3510 may comprise, for example, performance measurement (PM) data used by VIM 3502 or NFVI 3504. In at least one embodiment, both VNFM 3506 and EM 3510 can scale up/down a quantity of VNFs of system 3500.

In at least one embodiment, NFVO 3512 may coordinate, authorize, release and engage resources of NFVI 3504 in order to provide a requested service (e.g., to execute an EPC function, component, or slice). In at least one embodiment, NM 3514 may provide a package of end-user functions with responsibility for a management of a network, which may include network elements with VNFs, non-virtualized network functions, or both (management of VNFs may occur via an EM 3510).

In at least one embodiment, at least one component shown or described with respect to FIG. 35 is used to perform techniques and/or functions described in connection with FIGS. 1-15. In at least one embodiment, at least one component shown or described with respect to FIG. 35 is used to cause a first application programming interface (API) to select a second API to perform one or more software workloads identified by the first API. In at least one embodiment, at least one component shown or described with respect to FIG. 35 is used to perform a first application programming interface (API) to select a second API to monitor performance of one or more software workloads identified by the first API. In at least one embodiment, at least one component shown or described with respect to FIG. 35 is used to perform a first application programming interface (API) to select a second API to terminate performance of one or more software workloads identified by the first API. In at least one embodiment, at least one component shown or described with respect to FIG. 35 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

### Computer-Based Systems

The following figures set forth, without limitation, exemplary computer-based systems that can be used to implement at least one embodiment.

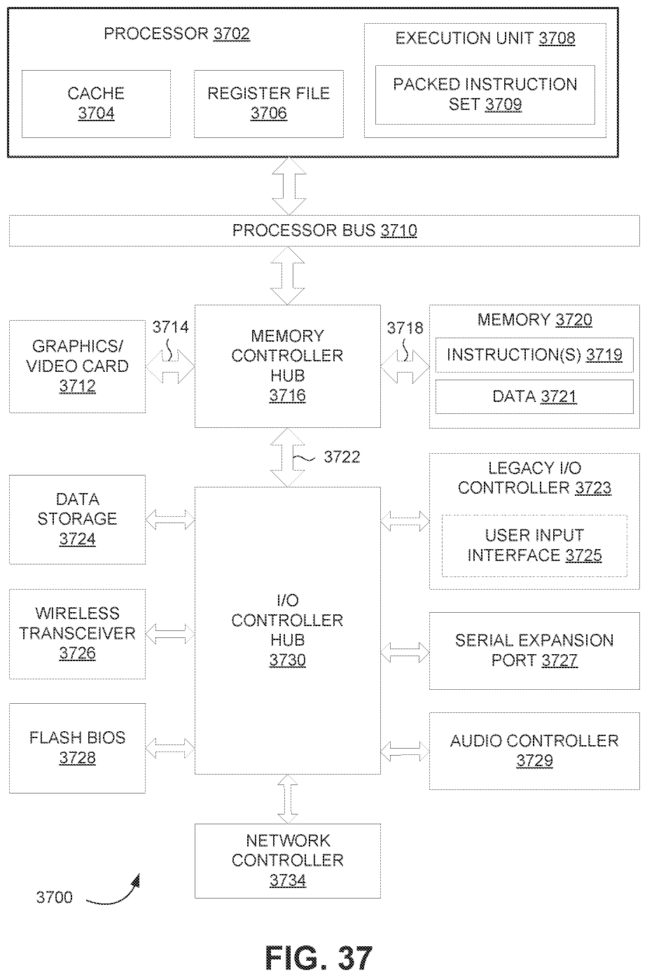

FIG. 36 illustrates a processing system 3600, in accordance with at least one embodiment. In at least one embodiment, processing system 3600 includes one or more processors 3602 and one or more graphics processors 3608, and may be a single processor desktop system, a multiprocessor workstation system, or a server system having a large number of processors 3602 or processor cores 3607. In at least one embodiment, processing system 3600 is a processing platform incorporated within a system-on-a-chip (“SoC”) integrated circuit for use in mobile, handheld, or embedded devices.

In at least one embodiment, processing system 3600 can include, or be incorporated within a server-based gaming platform, a game console, a media console, a mobile gaming console, a handheld game console, or an online game console. In at least one embodiment, processing system 3600 is a mobile phone, smart phone, tablet computing device or mobile Internet device. In at least one embodiment, processing system 3600 can also include, couple with, or be integrated within a wearable device, such as a smart watch wearable device, smart eyewear device, augmented reality device, or virtual reality device. In at least one embodiment, processing system 3600 is a television or set top box device having one or more processors 3602 and a graphical interface generated by one or more graphics processors 3608.

In at least one embodiment, one or more processors 3602 each include one or more processor cores 3607 to process instructions which, when executed, perform operations for system and user software. In at least one embodiment, each of one or more processor cores 3607 is configured to process a specific instruction set 3609. In at least one embodiment, instruction set 3609 may facilitate Complex Instruction Set Computing (“CISC”), Reduced Instruction Set Computing (“RISC”), or computing via a Very Long Instruction Word (“VLIW”). In at least one embodiment, processor cores 3607 may each process a different instruction set 3609, which may include instructions to facilitate emulation of other instruction sets. In at least one embodiment, processor core 3607 may also include other processing devices, such as a digital signal processor (“DSP”).

In at least one embodiment, processor 3602 includes cache memory (‘cache”) 3604. In at least one embodiment, processor 3602 can have a single internal cache or multiple levels of internal cache. In at least one embodiment, cache memory is shared among various components of processor 3602. In at least one embodiment, processor 3602 also uses an external cache (e.g., a Level 3 (“L3”) cache or Last Level Cache (“LLC”)) (not shown), which may be shared among processor cores 3607 using known cache coherency techniques. In at least one embodiment, register file 3606 is additionally included in processor 3602 which may include different types of registers for storing different types of data (e.g., integer registers, floating point registers, status registers, and an instruction pointer register). In at least one embodiment, register file 3606 may include general-purpose registers or other registers.

In at least one embodiment, one or more processor(s) 3602 are coupled with one or more interface bus(es) 3610 to transmit communication signals such as address, data, or control signals between processor 3602 and other components in processing system 3600. In at least one embodiment interface bus 3610, in one embodiment, can be a processor bus, such as a version of a Direct Media Interface (“DMI”) bus. In at least one embodiment, interface bus 3610 is not limited to a DMI bus, and may include one or more Peripheral Component Interconnect buses (e.g., “PCI,” PCI Express (“PCIe”)), memory buses, or other types of interface buses. In at least one embodiment processor(s) 3602 include an integrated memory controller 3616 and a platform controller hub 3630. In at least one embodiment, memory controller 3616 facilitates communication between a memory device and other components of processing system 3600, while platform controller hub (“PCH”) 3630 provides connections to Input/Output (“I/O”) devices via a local I/O bus.

In at least one embodiment, memory device 3620 can be a dynamic random access memory (“DRAM”) device, a static random access memory (“SRAM”) device, flash memory device, phase-change memory device, or some other memory device having suitable performance to serve as processor memory. In at least one embodiment memory device 3620 can operate as system memory for processing system 3600, to store data 3622 and instructions 3621 for use when one or more processors 3602 executes an application or process. In at least one embodiment, memory controller 3616 also couples with an optional external graphics processor 3612, which may communicate with one or more graphics processors 3608 in processors 3602 to perform graphics and media operations. In at least one embodiment, a display device 3611 can connect to processor(s) 3602. In at least one embodiment display device 3611 can include one or more of an internal display device, as in a mobile electronic device or a laptop device or an external display device attached via a display interface (e.g., DisplayPort, etc.). In at least one embodiment, display device 3611 can include a head mounted display (“HMD”) such as a stereoscopic display device for use in virtual reality (“VR”) applications or augmented reality (“AR”) applications.

In at least one embodiment, platform controller hub 3630 enables peripherals to connect to memory device 3620 and processor 3602 via a high-speed I/O bus. In at least one embodiment, I/O peripherals include, but are not limited to, an audio controller 3646, a network controller 3634, a firmware interface 3628, a wireless transceiver 3626, touch sensors 3625, a data storage device 3624 (e.g., hard disk drive, flash memory, etc.). In at least one embodiment, data storage device 3624 can connect via a storage interface (e.g., SATA) or via a peripheral bus, such as PCI, or PCIe. In at least one embodiment, touch sensors 3625 can include touch screen sensors, pressure sensors, or fingerprint sensors. In at least one embodiment, wireless transceiver 3626 can be a Wi-Fi transceiver, a Bluetooth transceiver, or a mobile network transceiver such as a 3G, 4G, or Long Term Evolution (“LTE”) transceiver. In at least one embodiment, firmware interface 3628 enables communication with system firmware, and can be, for example, a unified extensible firmware interface (“UEFI”). In at least one embodiment, network controller 3634 can enable a network connection to a wired network. In at least one embodiment, a high-performance network controller (not shown) couples with interface bus 3610. In at least one embodiment, audio controller 3646 is a multi-channel high definition audio controller. In at least one embodiment, processing system 3600 includes an optional legacy I/O controller 3640 for coupling legacy (e.g., Personal System 2 (“PS/2”)) devices to processing system 3600. In at least one embodiment, platform controller hub 3630 can also connect to one or more Universal Serial Bus (“USB”) controllers 3642 connect input devices, such as keyboard and mouse 3643 combinations, a camera 3644, or other USB input devices.

In at least one embodiment, an instance of memory controller 3616 and platform controller hub 3630 may be integrated into a discreet external graphics processor, such as external graphics processor 3612. In at least one embodiment, platform controller hub 3630 and/or memory controller 3616 may be external to one or more processor(s) 3602. For example, in at least one embodiment, processing system 3600 can include an external memory controller 3616 and platform controller hub 3630, which may be configured as a memory controller hub and peripheral controller hub within a system chipset that is in communication with processor(s) 3602.

In at least one embodiment, at least one component shown or described with respect to FIG. 36 is used to perform techniques and/or functions described in connection with FIGS. 1-15. In at least one embodiment, at least one component shown or described with respect to FIG. 36 is used to cause a first application programming interface (API) to select a second API to perform one or more software workloads identified by the first API. In at least one embodiment, at least one component shown or described with respect to FIG. 36 is used to perform a first application programming interface (API) to select a second API to monitor performance of one or more software workloads identified by the first API. In at least one embodiment, at least one component shown or described with respect to FIG. 36 is used to perform a first application programming interface (API) to select a second API to terminate performance of one or more software workloads identified by the first API. In at least one embodiment, at least one component shown or described with respect to FIG. 36 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

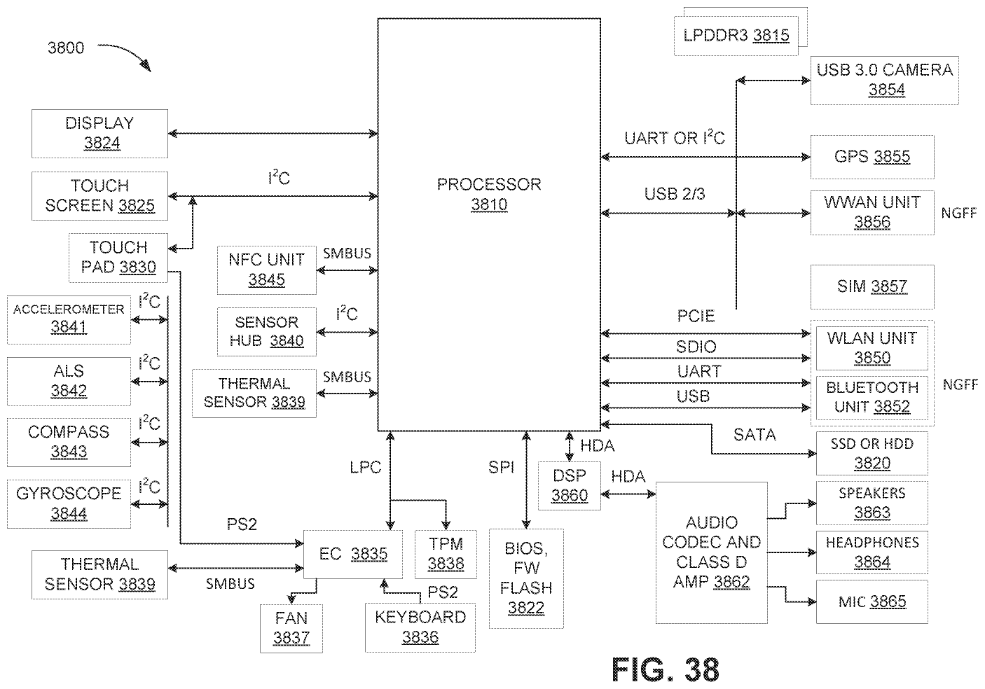

FIG. 37 illustrates a computer system 3700, in accordance with at least one embodiment. In at least one embodiment, computer system 3700 may be a system with interconnected devices and components, an SOC, or some combination. In at least on embodiment, computer system 3700 is formed with a processor 3702 that may include execution units to execute an instruction. In at least one embodiment, computer system 3700 may include, without limitation, a component, such as processor 3702 to employ execution units including logic to perform algorithms for processing data. In at least one embodiment, computer system 3700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 3700 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 3700 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions.

In at least one embodiment, computer system 3700 may include, without limitation, processor 3702 that may include, without limitation, one or more execution units 3708 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 3700 is a single processor desktop or server system. In at least one embodiment, computer system 3700 may be a multiprocessor system. In at least one embodiment, processor 3702 may include, without limitation, a CISC microprocessor, a RISC microprocessor, a VLIW microprocessor, a processor implementing a combination of instruction sets, or any other processor device, such as a digital signal processor, for example. In at least one embodiment, processor 3702 may be coupled to a processor bus 3710 that may transmit data signals between processor 3702 and other components in computer system 3700.

In at least one embodiment, processor 3702 may include, without limitation, a Level 1 (“L1”) internal cache memory (“cache”) 3704. In at least one embodiment, processor 3702 may have a single internal cache or multiple levels of internal cache. In at least one embodiment, cache memory may reside external to processor 3702. In at least one embodiment, processor 3702 may also include a combination of both internal and external caches. In at least one embodiment, a register file 3706 may store different types of data in various registers including, without limitation, integer registers, floating point registers, status registers, and instruction pointer register.

In at least one embodiment, execution unit 3708, including, without limitation, logic to perform integer and floating point operations, also resides in processor 3702. Processor 3702 may also include a microcode (“ucode”) read only memory (“ROM”) that stores microcode for certain macro instructions. In at least one embodiment, execution unit 3708 may include logic to handle a packed instruction set 3709. In at least one embodiment, by including packed instruction set 3709 in an instruction set of a general-purpose processor 3702, along with associated circuitry to execute instructions, operations used by many multimedia applications may be performed using packed data in a general-purpose processor 3702. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 3708 may also be used in microcontrollers, embedded processors, graphics devices, DSPs, and other types of logic circuits. In at least one embodiment, computer system 3700 may include, without limitation, a memory 3720. In at least one embodiment, memory 3720 may be implemented as a DRAM device, an SRAM device, flash memory device, or other memory device. Memory 3720 may store instruction(s) 3719 and/or data 3721 represented by data signals that may be executed by processor 3702.

In at least one embodiment, a system logic chip may be coupled to processor bus 3710 and memory 3720. In at least one embodiment, a system logic chip may include, without limitation, a memory controller hub (“MCH”) 3716, and processor 3702 may communicate with MCH 3716 via processor bus 3710. In at least one embodiment, MCH 3716 may provide a high bandwidth memory path 3718 to memory 3720 for instruction and data storage and for storage of graphics commands, data and textures. In at least one embodiment, MCH 3716 may direct data signals between processor 3702, memory 3720, and other components in computer system 3700 and to bridge data signals between processor bus 3710, memory 3720, and a system I/O 3722. In at least one embodiment, system logic chip may provide a graphics port for coupling to a graphics controller. In at least one embodiment, MCH 3716 may be coupled to memory 3720 through high bandwidth memory path 3718 and graphics/video card 3712 may be coupled to MCH 3716 through an Accelerated Graphics Port (“AGP”) interconnect 3714.

In at least one embodiment, computer system 3700 may use system I/O 3722 that is a proprietary hub interface bus to couple MCH 3716 to I/O controller hub (“ICH”) 3730. In at least one embodiment, ICH 3730 may provide direct connections to some I/O devices via a local I/O bus. In at least one embodiment, local I/O bus may include, without limitation, a high-speed I/O bus for connecting peripherals to memory 3720, a chipset, and processor 3702. Examples may include, without limitation, an audio controller 3729, a firmware hub (“flash BIOS”) 3728, a wireless transceiver 3726, a data storage 3724, a legacy I/O controller 3723 containing a user input interface 3725 and a keyboard interface, a serial expansion port 3727, such as a USB, and a network controller 3734. Data storage 3724 may comprise a hard disk drive, a floppy disk drive, a CD-ROM device, a flash memory device, or other mass storage device.

In at least one embodiment, FIG. 37 illustrates a system, which includes interconnected hardware devices or “chips.” In at least one embodiment, FIG. 37 may illustrate an exemplary SoC. In at least one embodiment, devices illustrated in FIG. 37 may be interconnected with proprietary interconnects, standardized interconnects (e.g., PCIe), or some combination thereof. In at least one embodiment, one or more components of system 3700 are interconnected using compute express link (“CXL”) interconnects.

In at least one embodiment, at least one component shown or described with respect to FIG. 37 is used to perform techniques and/or functions described in connection with FIGS. 1-15. In at least one embodiment, at least one component shown or described with respect to FIG. 37 is used to cause a first application programming interface (API) to select a second API to perform one or more software workloads identified by the first API. In at least one embodiment, at least one component shown or described with respect to FIG. 37 is used to perform a first application programming interface (API) to select a second API to monitor performance of one or more software workloads identified by the first API. In at least one embodiment, at least one component shown or described with respect to FIG. 37 is used to perform a first application programming interface (API) to select a second API to terminate performance of one or more software workloads identified by the first API. In at least one embodiment, at least one component shown or described with respect to FIG. 37 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

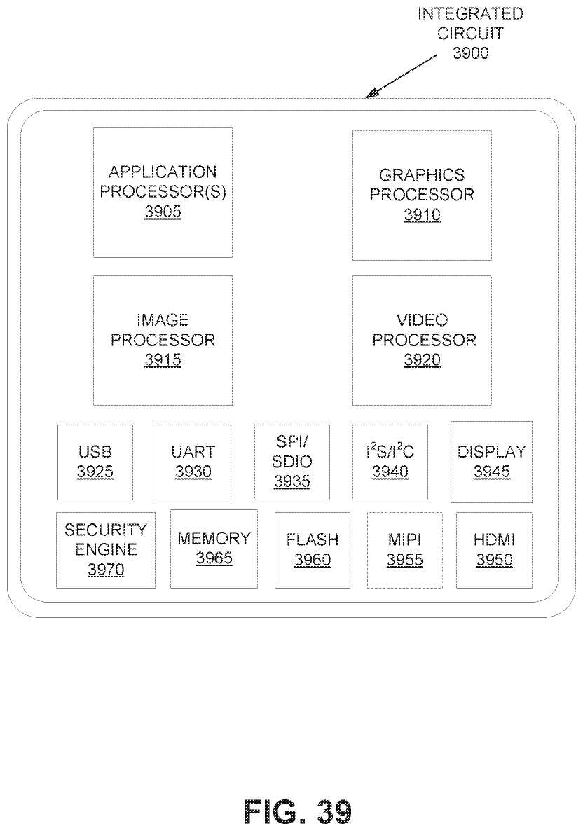

FIG. 38 illustrates a system 3800, in accordance with at least one embodiment. In at least one embodiment, system 3800 is an electronic device that utilizes a processor 3810. In at least one embodiment, system 3800 may be, for example and without limitation, a notebook, a tower server, a rack server, a blade server, a laptop, a desktop, a tablet, a mobile device, a phone, an embedded computer, or any other suitable electronic device.

In at least one embodiment, system 3800 may include, without limitation, processor 3810 communicatively coupled to any suitable number or kind of components, peripherals, modules, or devices. In at least one embodiment, processor 3810 is coupled using a bus or interface, such as an I²C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, FIG. 38 illustrates a system which includes interconnected hardware devices or “chips.” In at least one embodiment, FIG. 38 may illustrate an exemplary SoC. In at least one embodiment, devices illustrated in FIG. 38 may be interconnected with proprietary interconnects, standardized interconnects (e.g., PCIe) or some combination thereof. In at least one embodiment, one or more components of FIG. 38 are interconnected using CXL interconnects.

In at least one embodiment, FIG. 38 may include a display 3824, a touch screen 3825, a touch pad 3830, a Near Field Communications unit (“NFC”) 3845, a sensor hub 3840, a thermal sensor 3839, an Express Chipset (“EC”) 3835, a Trusted Platform Module (“TPM”) 3838, BIOS/firmware/flash memory (“BIOS, FW Flash”) 3822, a DSP 3860, a Solid State Disk (“SSD”) or Hard Disk Drive (“HDD”) 3820, a wireless local area network unit (“WLAN”) 3850, a Bluetooth unit 3852, a Wireless Wide Area Network unit (“WWAN”) 3856, a Global Positioning System (“GPS”) 3855, a camera (“USB 3.0 camera”) 3854 such as a USB 3.0 camera, or a Low Power Double Data Rate (“LPDDR”) memory unit (“LPDDR3”) 3815 implemented in, for example, LPDDR3 standard. These components may each be implemented in any suitable manner.

In at least one embodiment, other components may be communicatively coupled to processor 3810 through components discussed above. In at least one embodiment, an accelerometer 3841, an Ambient Light Sensor (“ALS”) 3842, a compass 3843, and a gyroscope 3844 may be communicatively coupled to sensor hub 3840. In at least one embodiment, a thermal sensor 3839, a fan 3837, a keyboard 3846, and a touch pad 3830 may be communicatively coupled to EC 3835. In at least one embodiment, a speaker 3863, a headphones 3864, and a microphone (“mic”) 3865 may be communicatively coupled to an audio unit 3862 (e.g., an “audio codec and class d amp”), which may in turn be communicatively coupled to DSP 3860. In at least one embodiment, audio unit 3864 may include, for example and without limitation, an audio coder/decoder (“codec”) and a class D amplifier. In at least one embodiment, a SIM card (“SIM”) 3857 may be communicatively coupled to WWAN unit 3856. In at least one embodiment, components such as WLAN unit 3850 and Bluetooth unit 3852, as well as WWAN unit 3856 may be implemented in a Next Generation Form Factor (“NGFF”).

In at least one embodiment, at least one component shown or described with respect to FIG. 38 is used to perform techniques and/or functions described in connection with FIGS. 1-15. In at least one embodiment, at least one component shown or described with respect to FIG. 38 is used to cause a first application programming interface (API) to select a second API to perform one or more software workloads identified by the first API. In at least one embodiment, at least one component shown or described with respect to FIG. 38 is used to perform a first application programming interface (API) to select a second API to monitor performance of one or more software workloads identified by the first API. In at least one embodiment, at least one component shown or described with respect to FIG. 38 is used to perform a first application programming interface (API) to select a second API to terminate performance of one or more software workloads identified by the first API. In at least one embodiment, at least one component shown or described with respect to FIG. 38 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

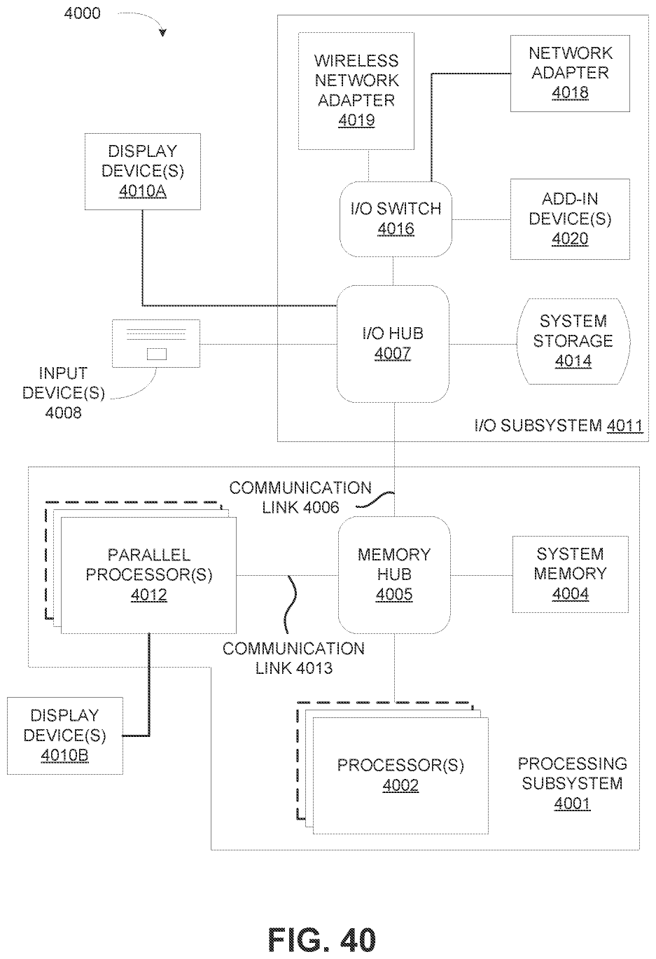

FIG. 39 illustrates an exemplary integrated circuit 3900, in accordance with at least one embodiment. In at least one embodiment, exemplary integrated circuit 3900 is an SoC that may be fabricated using one or more IP cores. In at least one embodiment, integrated circuit 3900 includes one or more application processor(s) 3905 (e.g., CPUs), at least one graphics processor 3910, and may additionally include an image processor 3915 and/or a video processor 3920, any of which may be a modular IP core. In at least one embodiment, integrated circuit 3900 includes peripheral or bus logic including a USB controller 3925, a UART controller 3930, an SPI/SDIO controller 3935, and an I²S/I²C controller 3940. In at least one embodiment, integrated circuit 3900 can include a display device 3945 coupled to one or more of a high-definition multimedia interface (“HDMI”) controller 3950 and a mobile industry processor interface (“MIPI”) display interface 3955. In at least one embodiment, storage may be provided by a flash memory subsystem 3960 including flash memory and a flash memory controller. In at least one embodiment, a memory interface may be provided via a memory controller 3965 for access to SDRAM or SRAM memory devices. In at least one embodiment, some integrated circuits additionally include an embedded security engine 3970.

In at least one embodiment, at least one component shown or described with respect to FIG. 39 is used to perform techniques and/or functions described in connection with FIGS. 1-15. In at least one embodiment, at least one component shown or described with respect to FIG. 39 is used to cause a first application programming interface (API) to select a second API to perform one or more software workloads identified by the first API. In at least one embodiment, at least one component shown or described with respect to FIG. 39 is used to perform a first application programming interface (API) to select a second API to monitor performance of one or more software workloads identified by the first API. In at least one embodiment, at least one component shown or described with respect to FIG. 39 is used to perform a first application programming interface (API) to select a second API to terminate performance of one or more software workloads identified by the first API. In at least one embodiment, at least one component shown or described with respect to FIG. 39 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

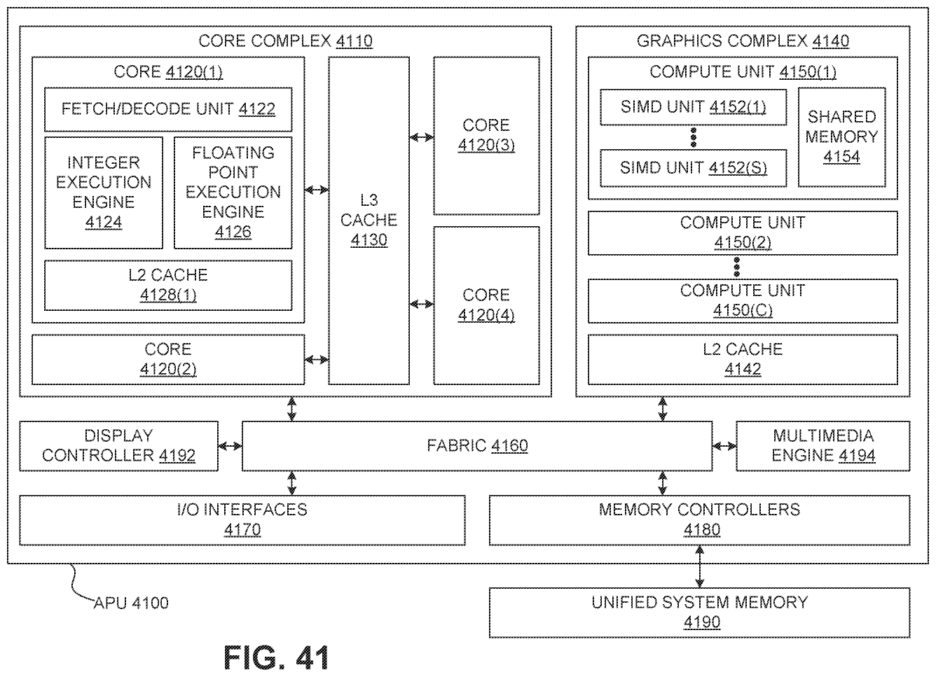

FIG. 40 illustrates a computing system 4000, according to at least one embodiment; In at least one embodiment, computing system 4000 includes a processing subsystem 4001 having one or more processor(s) 4002 and a system memory 4004 communicating via an interconnection path that may include a memory hub 4005. In at least one embodiment, memory hub 4005 may be a separate component within a chipset component or may be integrated within one or more processor(s) 4002. In at least one embodiment, memory hub 4005 couples with an I/O subsystem 4011 via a communication link 4006. In at least one embodiment, I/O subsystem 4011 includes an I/O hub 4007 that can enable computing system 4000 to receive input from one or more input device(s) 4008. In at least one embodiment, I/O hub 4007 can enable a display controller, which may be included in one or more processor(s) 4002, to provide outputs to one or more display device(s) 4010A. In at least one embodiment, one or more display device(s) 4010A coupled with I/O hub 4007 can include a local, internal, or embedded display device.

In at least one embodiment, processing subsystem 4001 includes one or more parallel processor(s) 4012 coupled to memory hub 4005 via a bus or other communication link 4013. In at least one embodiment, communication link 4013 may be one of any number of standards based communication link technologies or protocols, such as, but not limited to PCIe, or may be a vendor specific communications interface or communications fabric. In at least one embodiment, one or more parallel processor(s) 4012 form a computationally focused parallel or vector processing system that can include a large number of processing cores and/or processing clusters, such as a many integrated core processor. In at least one embodiment, one or more parallel processor(s) 4012 form a graphics processing subsystem that can output pixels to one of one or more display device(s) 4010A coupled via I/O Hub 4007. In at least one embodiment, one or more parallel processor(s) 4012 can also include a display controller and display interface (not shown) to enable a direct connection to one or more display device(s) 4010B.

In at least one embodiment, a system storage unit 4014 can connect to I/O hub 4007 to provide a storage mechanism for computing system 4000. In at least one embodiment, an I/O switch 4016 can be used to provide an interface mechanism to enable connections between I/O hub 4007 and other components, such as a network adapter 4018 and/or wireless network adapter 4019 that may be integrated into a platform, and various other devices that can be added via one or more add-in device(s) 4020. In at least one embodiment, network adapter 4018 can be an Ethernet adapter or another wired network adapter. In at least one embodiment, wireless network adapter 4019 can include one or more of a Wi-Fi, Bluetooth, NFC, or other network device that includes one or more wireless radios.

In at least one embodiment, computing system 4000 can include other components not explicitly shown, including USB or other port connections, optical storage drives, video capture devices, and/or variations thereof, that may also be connected to I/O hub 4007. In at least one embodiment, communication paths interconnecting various components in FIG. 40 may be implemented using any suitable protocols, such as PCI based protocols (e.g., PCIe), or other bus or point-to-point communication interfaces and/or protocol(s), such as NVLink high-speed interconnect, or interconnect protocols.

In at least one embodiment, one or more parallel processor(s) 4012 incorporate circuitry optimized for graphics and video processing, including, for example, video output circuitry, and constitutes a graphics processing unit (“GPU”). In at least one embodiment, one or more parallel processor(s) 4012 incorporate circuitry optimized for general purpose processing. In at least embodiment, components of computing system 4000 may be integrated with one or more other system elements on a single integrated circuit. For example, in at least one embodiment, one or more parallel processor(s) 4012, memory hub 4005, processor(s) 4002, and I/O hub 4007 can be integrated into a SoC integrated circuit. In at least one embodiment, components of computing system 4000 can be integrated into a single package to form a system in package (“SIP”) configuration. In at least one embodiment, at least a portion of components of computing system 4000 can be integrated into a multi-chip module (“MCM”), which can be interconnected with other multi-chip modules into a modular computing system. In at least one embodiment, I/O subsystem 4011 and display devices 4010B are omitted from computing system 4000.

In at least one embodiment, at least one component shown or described with respect to FIG. 40 is used to perform techniques and/or functions described in connection with FIGS. 1-15. In at least one embodiment, at least one component shown or described with respect to FIG. 40 is used to cause a first application programming interface (API) to select a second API to perform one or more software workloads identified by the first API. In at least one embodiment, at least one component shown or described with respect to FIG. 40 is used to perform a first application programming interface (API) to select a second API to monitor performance of one or more software workloads identified by the first API. In at least one embodiment, at least one component shown or described with respect to FIG. 40 is used to perform a first application programming interface (API) to select a second API to terminate performance of one or more software workloads identified by the first API. In at least one embodiment, at least one component shown or described with respect to FIG. 40 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

### Processing Systems

The following figures set forth, without limitation, exemplary processing systems that can be used to implement at least one embodiment.

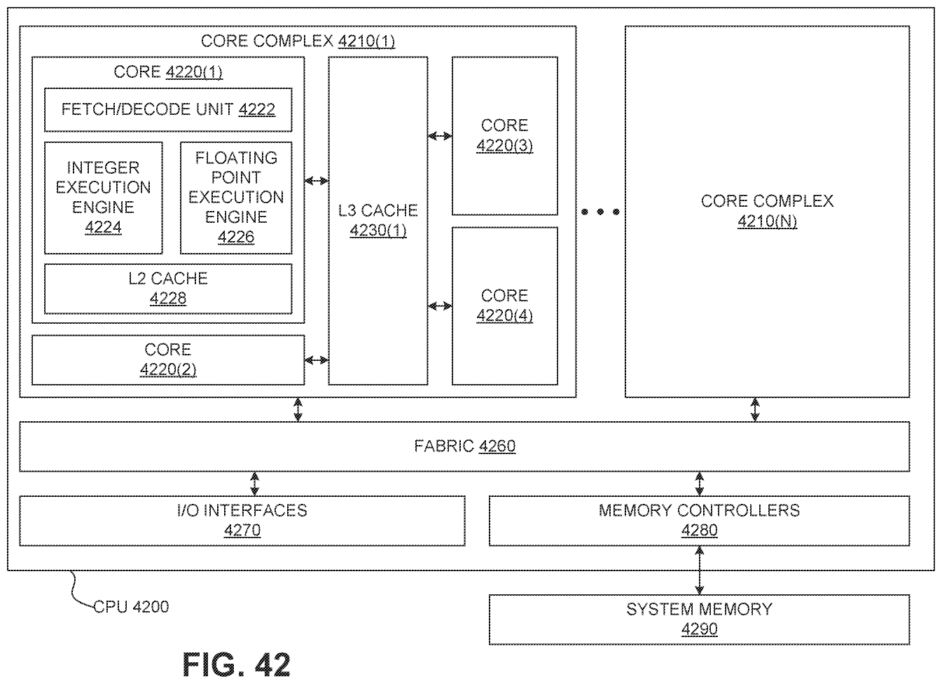

FIG. 41 illustrates an accelerated processing unit (“APU”) 4100, in accordance with at least one embodiment. In at least one embodiment, APU 4100 is developed by AMD Corporation of Santa Clara, CA. In at least one embodiment, APU 4100 can be configured to execute an application program, such as a CUDA program. In at least one embodiment, APU 4100 includes, without limitation, a core complex 4110, a graphics complex 4140, fabric 4160, I/O interfaces 4170, memory controllers 4180, a display controller 4192, and a multimedia engine 4194. In at least one embodiment, APU 4100 may include, without limitation, any number of core complexes 4110, any number of graphics complexes 4140, any number of display controllers 4192, and any number of multimedia engines 4194 in any combination. For explanatory purposes, multiple instances of like objects are denoted herein with reference numbers identifying an object and parenthetical numbers identifying an instance where needed.

In at least one embodiment, core complex 4110 is a CPU, graphics complex 4140 is a GPU, and APU 4100 is a processing unit that integrates, without limitation, 4110 and 4140 onto a single chip. In at least one embodiment, some tasks may be assigned to core complex 4110 and other tasks may be assigned to graphics complex 4140. In at least one embodiment, core complex 4110 is configured to execute main control software associated with APU 4100, such as an operating system. In at least one embodiment, core complex 4110 is a master processor of APU 4100, controlling and coordinating operations of other processors. In at least one embodiment, core complex 4110 issues commands that control an operation of graphics complex 4140. In at least one embodiment, core complex 4110 can be configured to execute host executable code derived from CUDA source code, and graphics complex 4140 can be configured to execute device executable code derived from CUDA source code.

In at least one embodiment, core complex 4110 includes, without limitation, cores 4120(1)-4120(4) and an L3 cache 4130. In at least one embodiment, core complex 4110 may include, without limitation, any number of cores 4120 and any number and type of caches in any combination. In at least one embodiment, cores 4120 are configured to execute instructions of a particular instruction set architecture (“ISA”). In at least one embodiment, each core 4120 is a CPU core.

In at least one embodiment, each core 4120 includes, without limitation, a fetch/decode unit 4122, an integer execution engine 4124, a floating point execution engine 4126, and an L2 cache 4128. In at least one embodiment, fetch/decode unit 4122 fetches instructions, decodes such instructions, generates micro-operations, and dispatches separate micro-instructions to integer execution engine 4124 and floating point execution engine 4126. In at least one embodiment, fetch/decode unit 4122 can concurrently dispatch one micro-instruction to integer execution engine 4124 and another micro-instruction to floating point execution engine 4126. In at least one embodiment, integer execution engine 4124 executes, without limitation, integer and memory operations. In at least one embodiment, floating point execution engine 4126 executes, without limitation, floating point and vector operations. In at least one embodiment, fetch-decode unit 4122 dispatches micro-instructions to a single execution engine that replaces both integer execution engine 4124 and floating point execution engine 4126.

In at least one embodiment, each core 4120(i), where i is an integer representing a particular instance of core 4120, may access L2 cache 4128(i) included in core 4120(i). In at least one embodiment, each core 4120 included in core complex 4110(j), where j is an integer representing a particular instance of core complex 4110, is connected to other cores 4120 included in core complex 4110(j) via L3 cache 4130(j) included in core complex 4110(j). In at least one embodiment, cores 4120 included in core complex 4110(j), where j is an integer representing a particular instance of core complex 4110, can access all of L3 cache 4130(j) included in core complex 4110(j). In at least one embodiment, L3 cache 4130 may include, without limitation, any number of slices.

In at least one embodiment, graphics complex 4140 can be configured to perform compute operations in a highly-parallel fashion. In at least one embodiment, graphics complex 4140 is configured to execute graphics pipeline operations such as draw commands, pixel operations, geometric computations, and other operations associated with rendering an image to a display. In at least one embodiment, graphics complex 4140 is configured to execute operations unrelated to graphics. In at least one embodiment, graphics complex 4140 is configured to execute both operations related to graphics and operations unrelated to graphics.

In at least one embodiment, graphics complex 4140 includes, without limitation, any number of compute units 4150 and an L2 cache 4142. In at least one embodiment, compute units 4150 share L2 cache 4142. In at least one embodiment, L2 cache 4142 is partitioned. In at least one embodiment, graphics complex 4140 includes, without limitation, any number of compute units 4150 and any number (including zero) and type of caches. In at least one embodiment, graphics complex 4140 includes, without limitation, any amount of dedicated graphics hardware.

In at least one embodiment, each compute unit 4150 includes, without limitation, any number of SIMD units 4152 and a shared memory 4154. In at least one embodiment, each SIMD unit 4152 implements a SIMD architecture and is configured to perform operations in parallel. In at least one embodiment, each compute unit 4150 may execute any number of thread blocks, but each thread block executes on a single compute unit 4150. In at least one embodiment, a thread block includes, without limitation, any number of threads of execution. In at least one embodiment, a workgroup is a thread block. In at least one embodiment, each SIMD unit 4152 executes a different warp. In at least one embodiment, a warp is a group of threads (e.g., 16 threads), where each thread in a warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 4154.

In at least one embodiment, fabric 4160 is a system interconnect that facilitates data and control transmissions across core complex 4110, graphics complex 4140, I/O interfaces 4170, memory controllers 4180, display controller 4192, and multimedia engine 4194. In at least one embodiment, APU 4100 may include, without limitation, any amount and type of system interconnect in addition to or instead of fabric 4160 that facilitates data and control transmissions across any number and type of directly or indirectly linked components that may be internal or external to APU 4100. In at least one embodiment, I/O interfaces 4170 are representative of any number and type of I/O interfaces (e.g., PCI, PCI-Extended (“PCI-X”), PCIe, gigabit Ethernet (“GBE”), USB, etc.). In at least one embodiment, various types of peripheral devices are coupled to I/O interfaces 4170 In at least one embodiment, peripheral devices that are coupled to I/O interfaces 4170 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 4194 includes, without limitation, any amount and type of circuitry that is related to multimedia, such as a video decoder, a video encoder, an image signal processor, etc. In at least one embodiment, memory controllers 4180 facilitate data transfers between APU 4100 and a unified system memory 4190. In at least one embodiment, core complex 4110 and graphics complex 4140 share unified system memory 4190.

In at least one embodiment, APU 4100 implements a memory subsystem that includes, without limitation, any amount and type of memory controllers 4180 and memory devices (e.g., shared memory 4154) that may be dedicated to one component or shared among multiple components. In at least one embodiment, APU 4100 implements a cache subsystem that includes, without limitation, one or more cache memories (e.g., L2 caches 4228, L3 cache 4130, and L2 cache 4142) that may each be private to or shared between any number of components (e.g., cores 4120, core complex 4110, SIMD units 4152, compute units 4150, and graphics complex 4140).

In at least one embodiment, at least one component shown or described with respect to FIG. 41 is used to perform techniques and/or functions described in connection with FIGS. 1-15. In at least one embodiment, at least one component shown or described with respect to FIG. 41 is used to cause a first application programming interface (API) to select a second API to perform one or more software workloads identified by the first API. In at least one embodiment, at least one component shown or described with respect to FIG. 41 is used to perform a first application programming interface (API) to select a second API to monitor performance of one or more software workloads identified by the first API. In at least one embodiment, at least one component shown or described with respect to FIG. 41 is used to perform a first application programming interface (API) to select a second API to terminate performance of one or more software workloads identified by the first API. In at least one embodiment, at least one component shown or described with respect to FIG. 41 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

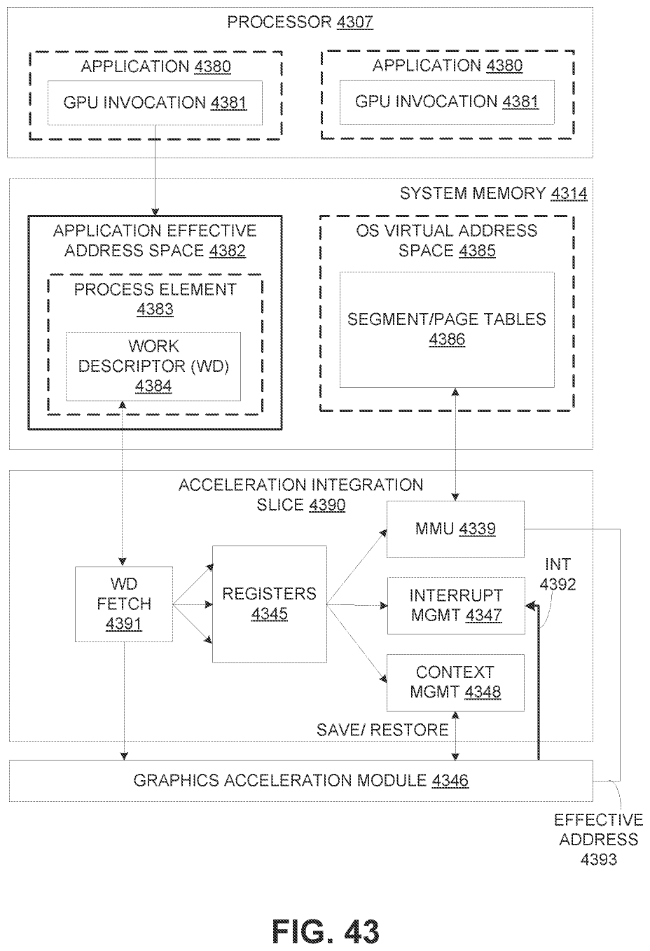

FIG. 42 illustrates a CPU 4200, in accordance with at least one embodiment. In at least one embodiment, CPU 4200 is developed by AMD Corporation of Santa Clara, CA. In at least one embodiment, CPU 4200 can be configured to execute an application program. In at least one embodiment, CPU 4200 is configured to execute main control software, such as an operating system. In at least one embodiment, CPU 4200 issues commands that control an operation of an external GPU (not shown). In at least one embodiment, CPU 4200 can be configured to execute host executable code derived from CUDA source code, and an external GPU can be configured to execute device executable code derived from such CUDA source code. In at least one embodiment, CPU 4200 includes, without limitation, any number of core complexes 4210, fabric 4260, I/O interfaces 4270, and memory controllers 4280.

In at least one embodiment, core complex 4210 includes, without limitation, cores 4220(1)-4220(4) and an L3 cache 4230. In at least one embodiment, core complex 4210 may include, without limitation, any number of cores 4220 and any number and type of caches in any combination. In at least one embodiment, cores 4220 are configured to execute instructions of a particular ISA. In at least one embodiment, each core 4220 is a CPU core.

In at least one embodiment, each core 4220 includes, without limitation, a fetch/decode unit 4222, an integer execution engine 4224, a floating point execution engine 4226, and an L2 cache 4228. In at least one embodiment, fetch/decode unit 4222 fetches instructions, decodes such instructions, generates micro-operations, and dispatches separate micro-instructions to integer execution engine 4224 and floating point execution engine 4226. In at least one embodiment, fetch/decode unit 4222 can concurrently dispatch one micro-instruction to integer execution engine 4224 and another micro-instruction to floating point execution engine 4226. In at least one embodiment, integer execution engine 4224 executes, without limitation, integer and memory operations. In at least one embodiment, floating point engine 4226 executes, without limitation, floating point and vector operations. In at least one embodiment, fetch-decode unit 4222 dispatches micro-instructions to a single execution engine that replaces both integer execution engine 4224 and floating point execution engine 4226.

In at least one embodiment, each core 4220(i), where i is an integer representing a particular instance of core 4220, may access L2 cache 4228(i) included in core 4220(i). In at least one embodiment, each core 4220 included in core complex 4210(j), where j is an integer representing a particular instance of core complex 4210, is connected to other cores 4220 in core complex 4210(j) via L3 cache 4230(j) included in core complex 4210(j). In at least one embodiment, cores 4220 included in core complex 4210(j), where j is an integer representing a particular instance of core complex 4210, can access all of L3 cache 4230(j) included in core complex 4210(j). In at least one embodiment, L3 cache 4230 may include, without limitation, any number of slices.

In at least one embodiment, fabric 4260 is a system interconnect that facilitates data and control transmissions across core complexes 4210(1)-4210(N) (where N is an integer greater than zero), I/O interfaces 4270, and memory controllers 4280. In at least one embodiment, CPU 4200 may include, without limitation, any amount and type of system interconnect in addition to or instead of fabric 4260 that facilitates data and control transmissions across any number and type of directly or indirectly linked components that may be internal or external to CPU 4200. In at least one embodiment, I/O interfaces 4270 are representative of any number and type of I/O interfaces (e.g., PCI, PCI-X, PCIe, GBE, USB, etc.). In at least one embodiment, various types of peripheral devices are coupled to I/O interfaces 4270 In at least one embodiment, peripheral devices that are coupled to I/O interfaces 4270 may include, without limitation, displays, keyboards, mice, printers, scanners, joysticks or other types of game controllers, media recording devices, external storage devices, network interface cards, and so forth.

In at least one embodiment, memory controllers 4280 facilitate data transfers between CPU 4200 and a system memory 4290. In at least one embodiment, core complex 4210 and graphics complex 4240 share system memory 4290. In at least one embodiment, CPU 4200 implements a memory subsystem that includes, without limitation, any amount and type of memory controllers 4280 and memory devices that may be dedicated to one component or shared among multiple components. In at least one embodiment, CPU 4200 implements a cache subsystem that includes, without limitation, one or more cache memories (e.g., L2 caches 4228 and L3 caches 4230) that may each be private to or shared between any number of components (e.g., cores 4220 and core complexes 4210).

In at least one embodiment, at least one component shown or described with respect to FIG. 42 is used to perform techniques and/or functions described in connection with FIGS. 1-15. In at least one embodiment, at least one component shown or described with respect to FIG. 42 is used to cause a first application programming interface (API) to select a second API to perform one or more software workloads identified by the first API. In at least one embodiment, at least one component shown or described with respect to FIG. 42 is used to perform a first application programming interface (API) to select a second API to monitor performance of one or more software workloads identified by the first API. In at least one embodiment, at least one component shown or described with respect to FIG. 42 is used to perform a first application programming interface (API) to select a second API to terminate performance of one or more software workloads identified by the first API. In at least one embodiment, at least one component shown or described with respect to FIG. 42 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

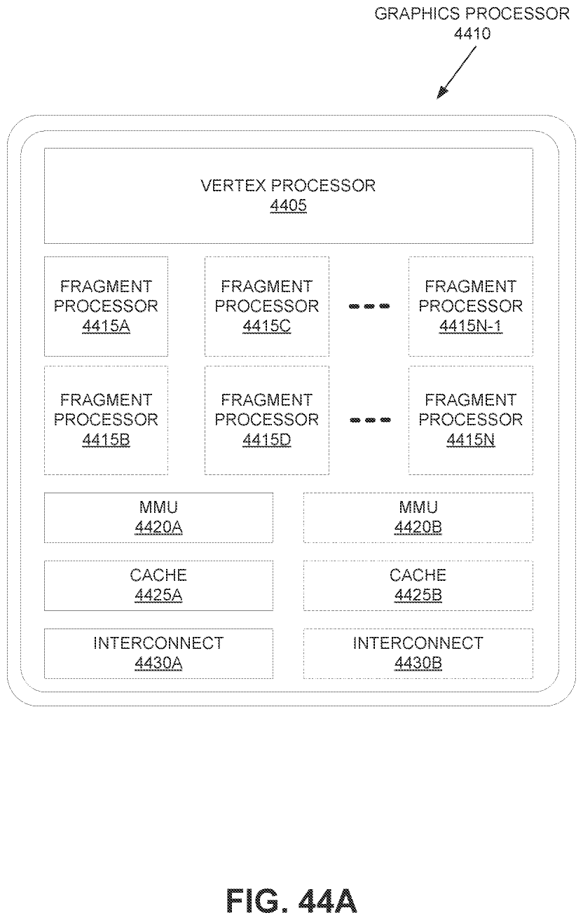

FIG. 43 illustrates an exemplary accelerator integration slice 4390, in accordance with at least one embodiment. As used herein, a “slice” comprises a specified portion of processing resources of an accelerator integration circuit. In at least one embodiment, an accelerator integration circuit provides cache management, memory access, context management, and interrupt management services on behalf of multiple graphics processing engines included in a graphics acceleration module. Graphics processing engines may each comprise a separate GPU. Alternatively, graphics processing engines may comprise different types of graphics processing engines within a GPU such as graphics execution units, media processing engines (e.g., video encoders/decoders), samplers, and blit engines. In at least one embodiment, a graphics acceleration module may be a GPU with multiple graphics processing engines. In at least one embodiment, graphics processing engines may be individual GPUs integrated on a common package, line card, or chip.

An application effective address space 4382 within system memory 4314 stores process elements 4383. In one embodiment, process elements 4383 are stored in response to GPU invocations 4381 from applications 4380 executed on processor 4307. A process element 4383 contains process state for corresponding application 4380. A work descriptor (“WD”) 4384 contained in process element 4383 can be a single job requested by an application or may contain a pointer to a queue of jobs. In at least one embodiment, WD 4384 is a pointer to a job request queue in application effective address space 4382.

Graphics acceleration module 4346 and/or individual graphics processing engines can be shared by all or a subset of processes in a system. In at least one embodiment, an infrastructure for setting up process state and sending WD 4384 to graphics acceleration module 4346 to start a job in a virtualized environment may be included.

In at least one embodiment, a dedicated-process programming model is implementation-specific. In this model, a single process owns graphics acceleration module 4346 or an individual graphics processing engine. Because graphics acceleration module 4346 is owned by a single process, a hypervisor initializes an accelerator integration circuit for an owning partition and an operating system initializes accelerator integration circuit for an owning process when graphics acceleration module 4346 is assigned.

In operation, a WD fetch unit 4391 in accelerator integration slice 4390 fetches next WD 4384 which includes an indication of work to be done by one or more graphics processing engines of graphics acceleration module 4346. Data from WD 4384 may be stored in registers 4345 and used by a memory management unit (“MMU”) 4339, interrupt management circuit 4347 and/or context management circuit 4348 as illustrated. For example, one embodiment of MMU 4339 includes segment/page walk circuitry for accessing segment/page tables 4386 within OS virtual address space 4385. Interrupt management circuit 4347 may process interrupt events (“INT”) 4392 received from graphics acceleration module 4346. When performing graphics operations, an effective address 4393 generated by a graphics processing engine is translated to a real address by MMU 4339.

In one embodiment, a same set of registers 4345 are duplicated for each graphics processing engine and/or graphics acceleration module 4346 and may be initialized by a hypervisor or operating system. Each of these duplicated registers may be included in accelerator integration slice 4390. Exemplary registers that may be initialized by a hypervisor are shown in Table 1.

TABLE 1
Hypervisor Initialized Registers

| | |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record Pointer |
| 9 | Storage Description Register |

Exemplary registers that may be initialized by an operating system are shown in Table 2.

TABLE 2
Operating System Initialized Registers

| | |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In one embodiment, each WD 4384 is specific to a particular graphics acceleration module 4346 and/or a particular graphics processing engine. It contains all information required by a graphics processing engine to do work or it can be a pointer to a memory location where an application has set up a command queue of work to be completed.

In at least one embodiment, at least one component shown or described with respect to FIG. 43 is used to perform techniques and/or functions described in connection with FIGS. 1-15. In at least one embodiment, at least one component shown or described with respect to FIG. 43 is used to cause a first application programming interface (API) to select a second API to perform one or more software workloads identified by the first API. In at least one embodiment, at least one component shown or described with respect to FIG. 43 is used to perform a first application programming interface (API) to select a second API to monitor performance of one or more software workloads identified by the first API. In at least one embodiment, at least one component shown or described with respect to FIG. 43 is used to perform a first application programming interface (API) to select a second API to terminate performance of one or more software workloads identified by the first API. In at least one embodiment, at least one component shown or described with respect to FIG. 43 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

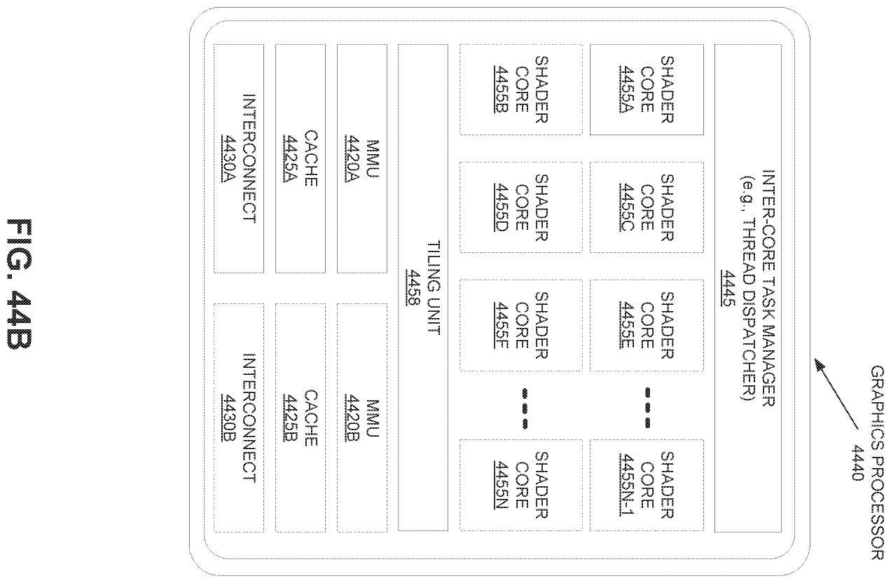

FIGS. 44A and 44B illustrate exemplary graphics processors, in accordance with at least one embodiment. In at least one embodiment, any of the exemplary graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the exemplary graphics processors are for use within an SoC.

FIG. 44A illustrates an exemplary graphics processor 4410 of an SoC integrated circuit that may be fabricated using one or more IP cores, in accordance with at least one embodiment. FIG. 44B illustrates an additional exemplary graphics processor 4440 of an SoC integrated circuit that may be fabricated using one or more IP cores, in accordance with at least one embodiment. In at least one embodiment, graphics processor 4410 of FIG. 44A is a low power graphics processor core. In at least one embodiment, graphics processor 4440 of FIG. 44B is a higher performance graphics processor core. In at least one embodiment, each of graphics processors 4410, 4440 can be variants of a graphics processor such as those described herein.

In at least one embodiment, graphics processor 4410 includes a vertex processor 4405 and one or more fragment processor(s) 4415A-4415N (e.g., 4415A, 4415B, 4415C, 4415D, through 4415N-1, and 4415N). In at least one embodiment, graphics processor 4410 can execute different shader programs via separate logic, such that vertex processor 4405 is optimized to execute operations for vertex shader programs, while one or more fragment processor(s) 4415A-4415N execute fragment (e.g., pixel) shading operations for fragment or pixel shader programs. In at least one embodiment, vertex processor 4405 performs a vertex processing stage of a 3D graphics pipeline and generates primitives and vertex data. In at least one embodiment, fragment processor(s) 4415A-4415N use primitive and vertex data generated by vertex processor 4405 to produce a framebuffer that is displayed on a display device. In at least one embodiment, fragment processor(s) 4415A-4415N are optimized to execute fragment shader programs as provided for in an OpenGL API, which may be used to perform similar operations as a pixel shader program as provided for in a Direct 3D API.

In at least one embodiment, graphics processor 4410 additionally includes one or more MMU(s) 4420A-4420B, cache(s) 4425A-4425B, and circuit interconnect(s) 4430A-4430B. In at least one embodiment, one or more MMU(s) 4420A-4420B provide for virtual to physical address mapping for graphics processor 4410, including for vertex processor 4405 and/or fragment processor(s) 4415A-4415N, which may reference vertex or image/texture data stored in memory, in addition to vertex or image/texture data stored in one or more cache(s) 4425A-4425B. In at least one embodiment, one or more MMU(s) 4420A-4420B may be synchronized with other MMUs within a system, including one or more MMUs associated with one or more application processor(s) 2005, image processors 2015, and/or video processors such as those described herein, such that each processor 2005-2020 can participate in a shared or unified virtual memory system. In at least one embodiment, one or more circuit interconnect(s) 4430A-4430B enable graphics processor 4410 to interface with other IP cores within an SoC, either via an internal bus of an SoC or via a direct connection.

In at least one embodiment, graphics processor 4440 includes one or more MMU(s) 4420A-4420B, caches 4425A-4425B, and circuit interconnects 4430A-4430B of graphics processor 4410 of FIG. 44A. In at least one embodiment, graphics processor 4440 includes one or more shader core(s) 4455A-4455N (e.g., 4455A, 4455B, 4455C, 4455D, 4455E, 4455F, through 4455N-1, and 4455N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 4440 includes an inter-core task manager 4445, which acts as a thread dispatcher to dispatch execution threads to one or more shader cores 4455A-4455N and a tiling unit 4458 to accelerate tiling operations for tile-based rendering, in which rendering operations for a scene are subdivided in image space, for example to exploit local spatial coherence within a scene or to optimize use of internal caches.

In at least one embodiment, at least one component shown or described with respect to FIGS. 44A and 44B is used to perform techniques and/or functions described in connection with FIGS. 1-15. In at least one embodiment, at least one component shown or described with respect to FIGS. 44A and 44B is used to cause a first application programming interface (API) to select a second API to perform one or more software workloads identified by the first API. In at least one embodiment, at least one component shown or described with respect to FIGS. 44A and 44B is used to perform a first application programming interface (API) to select a second API to monitor performance of one or more software workloads identified by the first API. In at least one embodiment, at least one component shown or described with respect to FIGS. 44A and 44B is used to perform a first application programming interface (API) to select a second API to terminate performance of one or more software workloads identified by the first API. In at least one embodiment, at least one component shown or described with respect to FIGS. 44A and 44B is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

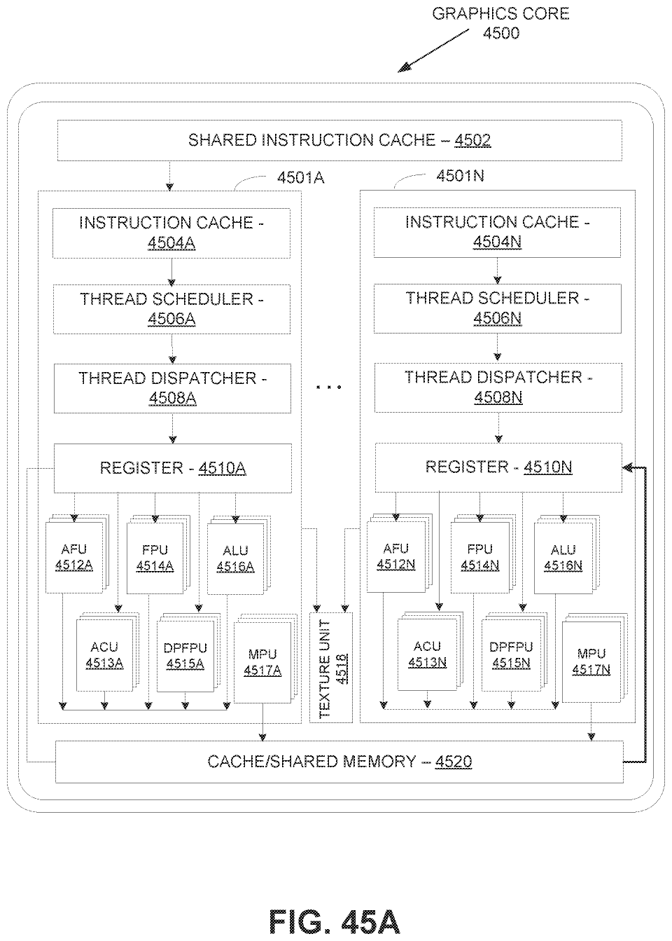

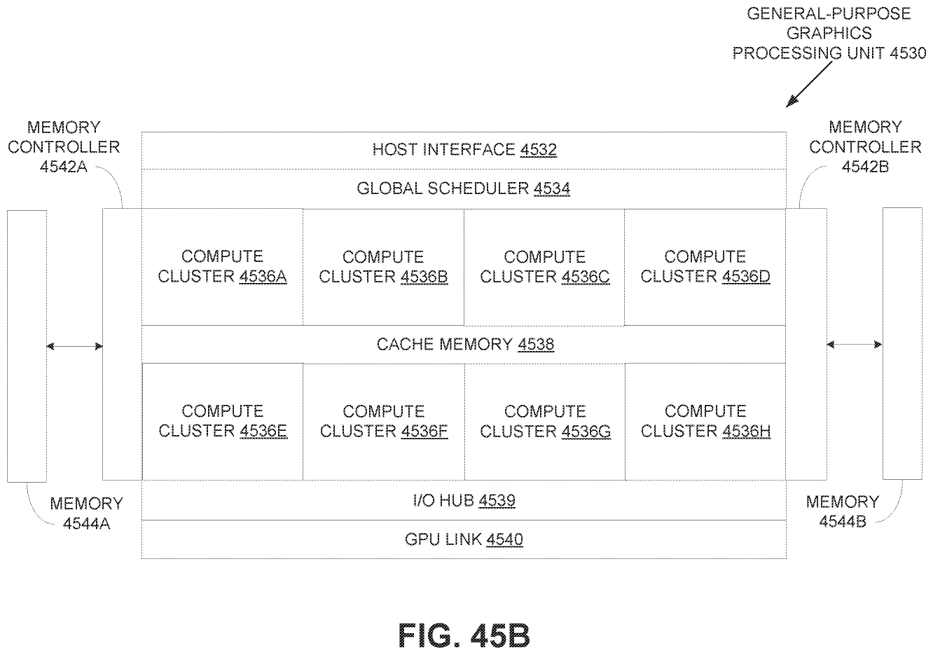

FIG. 45A illustrates a graphics core 4500, in accordance with at least one embodiment. In at least one embodiment, graphics core 4500 may be included within graphics processor 3910 of FIG. 39. In at least one embodiment, graphics core 4500 may be a unified shader core 4455A-4455N as in FIG. 44B. In at least one embodiment, graphics core 4500 includes a shared instruction cache 4502, a texture unit 4518, and a cache/shared memory 4520 that are common to execution resources within graphics core 4500. In at least one embodiment, graphics core 4500 can include multiple slices 4501A-4501N or partition for each core, and a graphics processor can include multiple instances of graphics core 4500. Slices 4501A-4501N can include support logic including a local instruction cache 4504A-4504N, a thread scheduler 4506A-4506N, a thread dispatcher 4508A-4508N, and a set of registers 4510A-4510N. In at least one embodiment, slices 4501A-4501N can include a set of additional function units (“AFUs”) 4512A-4512N, floating-point units (“FPUs”) 4514A-4514N, integer arithmetic logic units (“ALUs”) 4516-4516N, address computational units (“ACUs”) 4513A-4513N, double-precision floating-point units (“DPFPUs”) 4515A-4515N, and matrix processing units (“MPUs”) 4517A-4517N.

In at least one embodiment, FPUs 4514A-4514N can perform single-precision (32-bit) and half-precision (16-bit) floating point operations, while DPFPUs 4515A-4515N perform double precision (64-bit) floating point operations. In at least one embodiment, ALUs 4516A-4516N can perform variable precision integer operations at 8-bit, 16-bit, and 32-bit precision, and can be configured for mixed precision operations. In at least one embodiment, MPUs 4517A-4517N can also be configured for mixed precision matrix operations, including half-precision floating point and 8-bit integer operations. In at least one embodiment, MPUs 4517-4517N can perform a variety of matrix operations to accelerate CUDA programs, including enabling support for accelerated general matrix to matrix multiplication (“GEMM”). In at least one embodiment, AFUs 4512A-4512N can perform additional logic operations not supported by floating-point or integer units, including trigonometric operations (e.g., Sine, Cosine, etc.).

In at least one embodiment, at least one component shown or described with respect to FIG. 45A is used to perform techniques and/or functions described in connection with FIGS. 1-15. In at least one embodiment, at least one component shown or described with respect to FIG. 45A is used to cause a first application programming interface (API) to select a second API to perform one or more software workloads identified by the first API. In at least one embodiment, at least one component shown or described with respect to FIG. 45A is used to perform a first application programming interface (API) to select a second API to monitor performance of one or more software workloads identified by the first API. In at least one embodiment, at least one component shown or described with respect to FIG. 45A is used to perform a first application programming interface (API) to select a second API to terminate performance of one or more software workloads identified by the first API. In at least one embodiment, at least one component shown or described with respect to FIG. 45A is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 45B illustrates a general-purpose graphics processing unit (“GPGPU”) 4530, in accordance with at least one embodiment. In at least one embodiment, GPGPU 4530 is highly-parallel and suitable for deployment on a multi-chip module. In at least one embodiment, GPGPU 4530 can be configured to enable highly-parallel compute operations to be performed by an array of GPUs. In at least one embodiment, GPGPU 4530 can be linked directly to other instances of GPGPU 4530 to create a multi-GPU cluster to improve execution time for CUDA programs. In at least one embodiment, GPGPU 4530 includes a host interface 4532 to enable a connection with a host processor. In at least one embodiment, host interface 4532 is a PCIe interface. In at least one embodiment, host interface 4532 can be a vendor specific communications interface or communications fabric. In at least one embodiment, GPGPU 4530 receives commands from a host processor and uses a global scheduler 4534 to distribute execution threads associated with those commands to a set of compute clusters 4536A-4536H. In at least one embodiment, compute clusters 4536A-4536H share a cache memory 4538. In at least one embodiment, cache memory 4538 can serve as a higher-level cache for cache memories within compute clusters 4536A-4536H.

In at least one embodiment, GPGPU 4530 includes memory 4544A-4544B coupled with compute clusters 4536A-4536H via a set of memory controllers 4542A-4542B. In at least one embodiment, memory 4544A-4544B can include various types of memory devices including DRAM or graphics random access memory, such as synchronous graphics random access memory (“SGRAM”), including graphics double data rate (“GDDR”) memory.

In at least one embodiment, compute clusters 4536A-4536H each include a set of graphics cores, such as graphics core 4500 of FIG. 45A, which can include multiple types of integer and floating point logic units that can perform computational operations at a range of precisions including suited for computations associated with CUDA programs. For example, in at least one embodiment, at least a subset of floating point units in each of compute clusters 4536A-4536H can be configured to perform 16-bit or 32-bit floating point operations, while a different subset of floating point units can be configured to perform 64-bit floating point operations.

In at least one embodiment, multiple instances of GPGPU 4530 can be configured to operate as a compute cluster. In at least one embodiment, compute clusters 4536A-4536H may implement any technically feasible communication techniques for synchronization and data exchange. In at least one embodiment, multiple instances of GPGPU 4530 communicate over host interface 4532. In at least one embodiment, GPGPU 4530 includes an I/O hub 4539 that couples GPGPU 4530 with a GPU link 4540 that enables a direct connection to other instances of GPGPU 4530. In at least one embodiment, GPU link 4540 is coupled to a dedicated GPU-to-GPU bridge that enables communication and synchronization between multiple instances of GPGPU 4530. In at least one embodiment GPU link 4540 couples with a high speed interconnect to transmit and receive data to other GPGPUs 4530 or parallel processors. In at least one embodiment, multiple instances of GPGPU 4530 are located in separate data processing systems and communicate via a network device that is accessible via host interface 4532. In at least one embodiment GPU link 4540 can be configured to enable a connection to a host processor in addition to or as an alternative to host interface 4532. In at least one embodiment, GPGPU 4530 can be configured to execute a CUDA program.

In at least one embodiment, at least one component shown or described with respect to FIG. 45B is used to perform techniques and/or functions described in connection with FIGS. 1-15. In at least one embodiment, at least one component shown or described with respect to FIG. 45B is used to cause a first application programming interface (API) to select a second API to perform one or more software workloads identified by the first API. In at least one embodiment, at least one component shown or described with respect to FIG. 45B is used to perform a first application programming interface (API) to select a second API to monitor performance of one or more software workloads identified by the first API. In at least one embodiment, at least one component shown or described with respect to FIG. 45B is used to perform a first application programming interface (API) to select a second API to terminate performance of one or more software workloads identified by the first API. In at least one embodiment, at least one component shown or described with respect to FIG. 45B is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

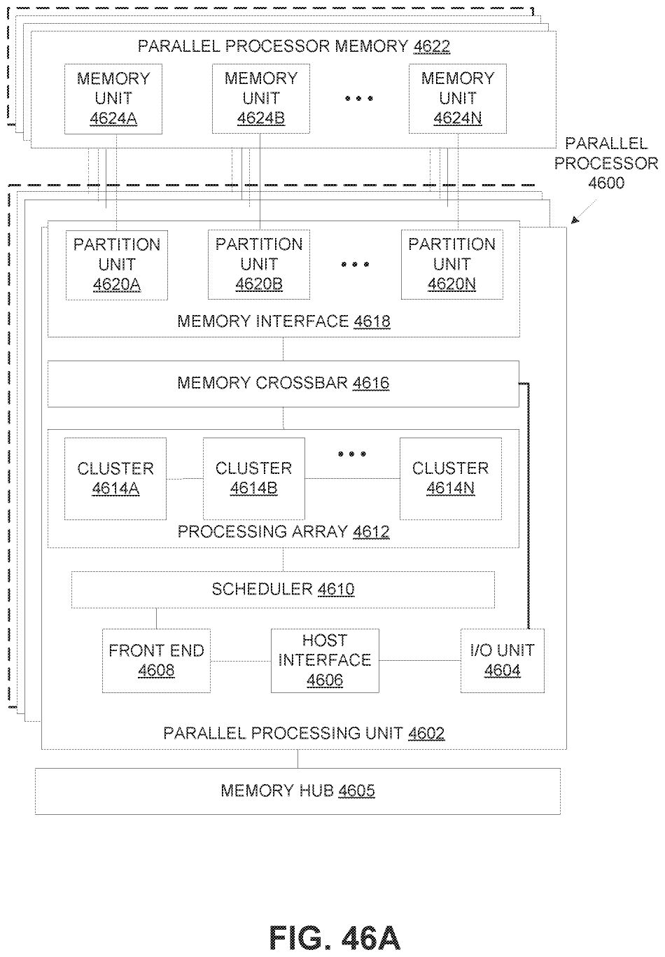

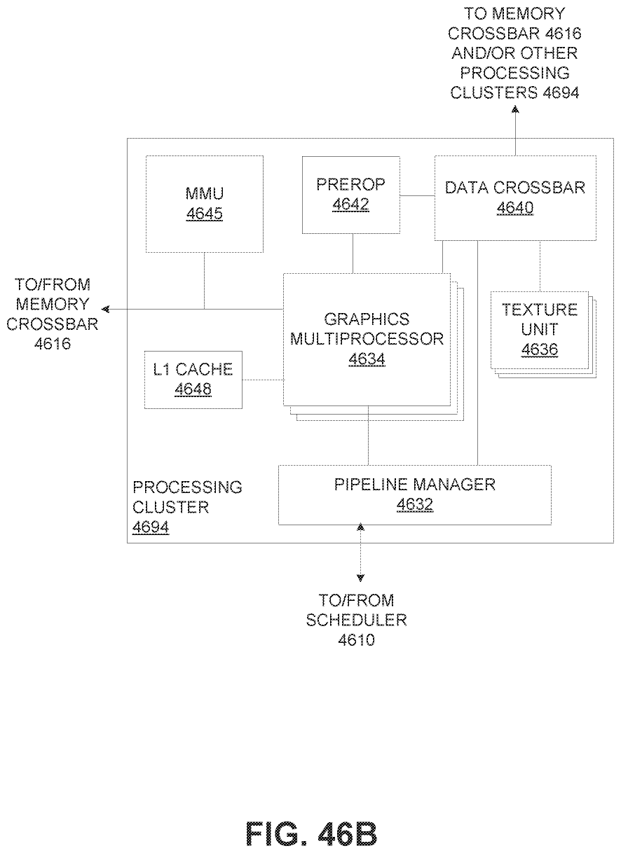

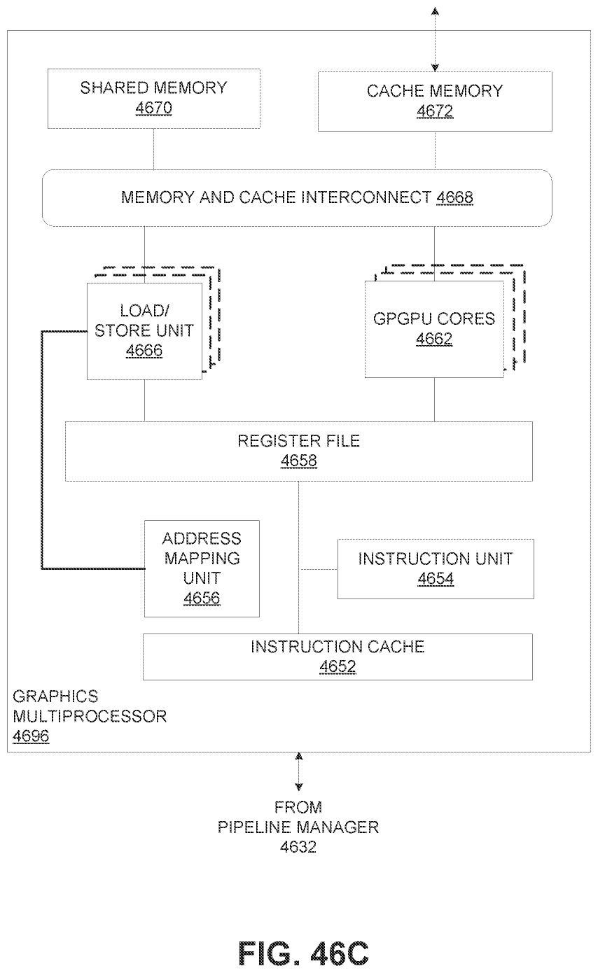

FIG. 46A illustrates a parallel processor 4600, in accordance with at least one embodiment. In at least one embodiment, various components of parallel processor 4600 may be implemented using one or more integrated circuit devices, such as programmable processors, application specific integrated circuits (“ASICs”), or FPGAs.

In at least one embodiment, parallel processor 4600 includes a parallel processing unit 4602. In at least one embodiment, parallel processing unit 4602 includes an I/O unit 4604 that enables communication with other devices, including other instances of parallel processing unit 4602. In at least one embodiment, I/O unit 4604 may be directly connected to other devices. In at least one embodiment, I/O unit 4604 connects with other devices via use of a hub or switch interface, such as memory hub 2105. In at least one embodiment, connections between memory hub 2105 and I/O unit 4604 form a communication link. In at least one embodiment, I/O unit 4604 connects with a host interface 4606 and a memory crossbar 4616, where host interface 4606 receives commands directed to performing processing operations and memory crossbar 4616 receives commands directed to performing memory operations.

In at least one embodiment, when host interface 4606 receives a command buffer via I/O unit 4604, host interface 4606 can direct work operations to perform those commands to a front end 4608. In at least one embodiment, front end 4608 couples with a scheduler 4610, which is configured to distribute commands or other work items to a processing array 4612. In at least one embodiment, scheduler 4610 ensures that processing array 4612 is properly configured and in a valid state before tasks are distributed to processing array 4612. In at least one embodiment, scheduler 4610 is implemented via firmware logic executing on a microcontroller. In at least one embodiment, microcontroller implemented scheduler 4610 is configurable to perform complex scheduling and work distribution operations at coarse and fine granularity, enabling rapid preemption and context switching of threads executing on processing array 4612. In at least one embodiment, host software can prove workloads for scheduling on processing array 4612 via one of multiple graphics processing doorbells. In at least one embodiment, workloads can then be automatically distributed across processing array 4612 by scheduler 4610 logic within a microcontroller including scheduler 4610.

In at least one embodiment, processing array 4612 can include up to “N” clusters (e.g., cluster 4614A, cluster 4614B, through cluster 4614N). In at least one embodiment, each cluster 4614A-4614N of processing array 4612 can execute a large number of concurrent threads. In at least one embodiment, scheduler 4610 can allocate work to clusters 4614A-4614N of processing array 4612 using various scheduling and/or work distribution algorithms, which may vary depending on a workload arising for each type of program or computation. In at least one embodiment, scheduling can be handled dynamically by scheduler 4610, or can be assisted in part by compiler logic during compilation of program logic configured for execution by processing array 4612. In at least one embodiment, different clusters 4614A-4614N of processing array 4612 can be allocated for processing different types of programs or for performing different types of computations.

In at least one embodiment, processing array 4612 can be configured to perform various types of parallel processing operations. In at least one embodiment, processing array 4612 is configured to perform general-purpose parallel compute operations. For example, in at least one embodiment, processing array 4612 can include logic to execute processing tasks including filtering of video and/or audio data, performing modeling operations, including physics operations, and performing data transformations.

In at least one embodiment, processing array 4612 is configured to perform parallel graphics processing operations. In at least one embodiment, processing array 4612 can include additional logic to support execution of such graphics processing operations, including, but not limited to texture sampling logic to perform texture operations, as well as tessellation logic and other vertex processing logic. In at least one embodiment, processing array 4612 can be configured to execute graphics processing related shader programs such as, but not limited to vertex shaders, tessellation shaders, geometry shaders, and pixel shaders. In at least one embodiment, parallel processing unit 4602 can transfer data from system memory via I/O unit 4604 for processing. In at least one embodiment, during processing, transferred data can be stored to on-chip memory (e.g., a parallel processor memory 4622) during processing, then written back to system memory.

In at least one embodiment, when parallel processing unit 4602 is used to perform graphics processing, scheduler 4610 can be configured to divide a processing workload into approximately equal sized tasks, to better enable distribution of graphics processing operations to multiple clusters 4614A-4614N of processing array 4612. In at least one embodiment, portions of processing array 4612 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 4614A-4614N may be stored in buffers to allow intermediate data to be transmitted between clusters 4614A-4614N for further processing.

In at least one embodiment, processing array 4612 can receive processing tasks to be executed via scheduler 4610, which receives commands defining processing tasks from front end 4608. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 4610 may be configured to fetch indices corresponding to tasks or may receive indices from front end 4608. In at least one embodiment, front end 4608 can be configured to ensure processing array 4612 is configured to a valid state before a workload specified by incoming command buffers (e.g., batch-buffers, push buffers, etc.) is initiated.

In at least one embodiment, each of one or more instances of parallel processing unit 4602 can couple with parallel processor memory 4622. In at least one embodiment, parallel processor memory 4622 can be accessed via memory crossbar 4616, which can receive memory requests from processing array 4612 as well as I/O unit 4604. In at least one embodiment, memory crossbar 4616 can access parallel processor memory 4622 via a memory interface 4618. In at least one embodiment, memory interface 4618 can include multiple partition units (e.g., a partition unit 4620A, partition unit 4620B, through partition unit 4620N) that can each couple to a portion (e.g., memory unit) of parallel processor memory 4622. In at least one embodiment, a number of partition units 4620A-4620N is configured to be equal to a number of memory units, such that a first partition unit 4620A has a corresponding first memory unit 4624A, a second partition unit 4620B has a corresponding memory unit 4624B, and an Nth partition unit 4620N has a corresponding Nth memory unit 4624N. In at least one embodiment, a number of partition units 4620A-4620N may not be equal to a number of memory devices.

In at least one embodiment, memory units 4624A-4624N can include various types of memory devices, including DRAM or graphics random access memory, such as SGRAM, including GDDR memory. In at least one embodiment, memory units 4624A-4624N may also include 3D stacked memory, including but not limited to high bandwidth memory (“HBM”). In at least one embodiment, render targets, such as frame buffers or texture maps may be stored across memory units 4624A-4624N, allowing partition units 4620A-4620N to write portions of each render target in parallel to efficiently use available bandwidth of parallel processor memory 4622. In at least one embodiment, a local instance of parallel processor memory 4622 may be excluded in favor of a unified memory design that utilizes system memory in conjunction with local cache memory.

In at least one embodiment, any one of clusters 4614A-4614N of processing array 4612 can process data that will be written to any of memory units 4624A-4624N within parallel processor memory 4622. In at least one embodiment, memory crossbar 4616 can be configured to transfer an output of each cluster 4614A-4614N to any partition unit 4620A-4620N or to another cluster 4614A-4614N, which can perform additional processing operations on an output. In at least one embodiment, each cluster 4614A-4614N can communicate with memory interface 4618 through memory crossbar 4616 to read from or write to various external memory devices. In at least one embodiment, memory crossbar 4616 has a connection to memory interface 4618 to communicate with I/O unit 4604, as well as a connection to a local instance of parallel processor memory 4622, enabling processing units within different clusters 4614A-4614N to communicate with system memory or other memory that is not local to parallel processing unit 4602. In at least one embodiment, memory crossbar 4616 can use virtual channels to separate traffic streams between clusters 4614A-4614N and partition units 4620A-4620N.

In at least one embodiment, multiple instances of parallel processing unit 4602 can be provided on a single add-in card, or multiple add-in cards can be interconnected. In at least one embodiment, different instances of parallel processing unit 4602 can be configured to inter-operate even if different instances have different numbers of processing cores, different amounts of local parallel processor memory, and/or other configuration differences. For example, in at least one embodiment, some instances of parallel processing unit 4602 can include higher precision floating point units relative to other instances. In at least one embodiment, systems incorporating one or more instances of parallel processing unit 4602 or parallel processor 4600 can be implemented in a variety of configurations and form factors, including but not limited to desktop, laptop, or handheld personal computers, servers, workstations, game consoles, and/or embedded systems.

In at least one embodiment, at least one component shown or described with respect to FIG. 46A is used to perform techniques and/or functions described in connection with FIGS. 1-15. In at least one embodiment, at least one component shown or described with respect to FIG. 46A is used to cause a first application programming interface (API) to select a second API to perform one or more software workloads identified by the first API. In at least one embodiment, at least one component shown or described with respect to FIG. 46A is used to perform a first application programming interface (API) to select a second API to monitor performance of one or more software workloads identified by the first API. In at least one embodiment, at least one component shown or described with respect to FIG. 46A is used to perform a first application programming interface (API) to select a second API to terminate performance of one or more software workloads identified by the first API. In at least one embodiment, at least one component shown or described with respect to FIG. 46A is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 46B illustrates a processing cluster 4694, in accordance with at least one embodiment. In at least one embodiment, processing cluster 4694 is included within a parallel processing unit. In at least one embodiment, processing cluster 4694 is one of processing clusters 4614A-4614N of FIG. 46. In at least one embodiment, processing cluster 4694 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 4694.

In at least one embodiment, operation of processing cluster 4694 can be controlled via a pipeline manager 4632 that distributes processing tasks to SIMT parallel processors. In at least one embodiment, pipeline manager 4632 receives instructions from scheduler 4610 of FIG. 46 and manages execution of those instructions via a graphics multiprocessor 4634 and/or a texture unit 4636. In at least one embodiment, graphics multiprocessor 4634 is an exemplary instance of a SIMT parallel processor. However, in at least one embodiment, various types of SIMT parallel processors of differing architectures may be included within processing cluster 4694. In at least one embodiment, one or more instances of graphics multiprocessor 4634 can be included within processing cluster 4694. In at least one embodiment, graphics multiprocessor 4634 can process data and a data crossbar 4640 can be used to distribute processed data to one of multiple possible destinations, including other shader units. In at least one embodiment, pipeline manager 4632 can facilitate distribution of processed data by specifying destinations for processed data to be distributed via data crossbar 4640.

In at least one embodiment, each graphics multiprocessor 4634 within processing cluster 4694 can include an identical set of functional execution logic (e.g., arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 4694 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 4634. In at least one embodiment, a thread group may include fewer threads than a number of processing engines within graphics multiprocessor 4634. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 4634. In at least one embodiment, when a thread group includes more threads than a number of processing engines within graphics multiprocessor 4634, processing can be performed over consecutive clock cycles. In at least one embodiment, multiple thread groups can be executed concurrently on graphics multiprocessor 4634.

In at least one embodiment, graphics multiprocessor 4634 includes an internal cache memory to perform load and store operations. In at least one embodiment, graphics multiprocessor 4634 can forego an internal cache and use a cache memory (e.g., L1 cache 4648) within processing cluster 4694. In at least one embodiment, each graphics multiprocessor 4634 also has access to Level 2 (“L2”) caches within partition units (e.g., partition units 4620A-4620N of FIG. 46A) that are shared among all processing clusters 4694 and may be used to transfer data between threads. In at least one embodiment, graphics multiprocessor 4634 may also access off-chip global memory, which can include one or more of local parallel processor memory and/or system memory. In at least one embodiment, any memory external to parallel processing unit 4602 may be used as global memory. In at least one embodiment, processing cluster 4694 includes multiple instances of graphics multiprocessor 4634 that can share common instructions and data, which may be stored in L1 cache 4648.

In at least one embodiment, each processing cluster 4694 may include an MMU 4645 that is configured to map virtual addresses into physical addresses. In at least one embodiment, one or more instances of MMU 4645 may reside within memory interface 4618 of FIG. 46. In at least one embodiment, MMU 4645 includes a set of page table entries (“PTEs”) used to map a virtual address to a physical address of a tile and optionally a cache line index. In at least one embodiment, MMU 4645 may include address translation lookaside buffers (“TLBs”) or caches that may reside within graphics multiprocessor 4634 or L1 cache 4648 or processing cluster 4694. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 4694 may be configured such that each graphics multiprocessor 4634 is coupled to a texture unit 4636 for performing texture mapping operations, e.g., determining texture sample positions, reading texture data, and filtering texture data. In at least one embodiment, texture data is read from an internal texture L1 cache (not shown) or from an L1 cache within graphics multiprocessor 4634 and is fetched from an L2 cache, local parallel processor memory, or system memory, as needed. In at least one embodiment, each graphics multiprocessor 4634 outputs a processed task to data crossbar 4640 to provide a processed task to another processing cluster 4694 for further processing or to store a processed task in an L2 cache, a local parallel processor memory, or a system memory via memory crossbar 4616. In at least one embodiment, a pre-raster operations unit (“preROP”) 4642 is configured to receive data from graphics multiprocessor 4634, direct data to ROP units, which may be located with partition units as described herein (e.g., partition units 4620A-4620N of FIG. 46). In at least one embodiment, PreROP 4642 can perform optimizations for color blending, organize pixel color data, and perform address translations.

In at least one embodiment, at least one component shown or described with respect to FIG. 46B is used to perform techniques and/or functions described in connection with FIGS. 1-15. In at least one embodiment, at least one component shown or described with respect to FIG. 46B is used to cause a first application programming interface (API) to select a second API to perform one or more software workloads identified by the first API. In at least one embodiment, at least one component shown or described with respect to FIG. 46B is used to perform a first application programming interface (API) to select a second API to monitor performance of one or more software workloads identified by the first API. In at least one embodiment, at least one component shown or described with respect to FIG. 46B is used to perform a first application programming interface (API) to select a second API to terminate performance of one or more software workloads identified by the first API. In at least one embodiment, at least one component shown or described with respect to FIG. 46B is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 46C illustrates a graphics multiprocessor 4696, in accordance with at least one embodiment. In at least one embodiment, graphics multiprocessor 4696 is graphics multiprocessor 4634 of FIG. 46B. In at least one embodiment, graphics multiprocessor 4696 couples with pipeline manager 4632 of processing cluster 4694. In at least one embodiment, graphics multiprocessor 4696 has an execution pipeline including but not limited to an instruction cache 4652, an instruction unit 4654, an address mapping unit 4656, a register file 4658, one or more GPGPU cores 4662, and one or more LSUs 4666. GPGPU cores 4662 and LSUs 4666 are coupled with cache memory 4672 and shared memory 4670 via a memory and cache interconnect 4668.

In at least one embodiment, instruction cache 4652 receives a stream of instructions to execute from pipeline manager 4632. In at least one embodiment, instructions are cached in instruction cache 4652 and dispatched for execution by instruction unit 4654. In at least one embodiment, instruction unit 4654 can dispatch instructions as thread groups (e.g., warps), with each thread of a thread group assigned to a different execution unit within GPGPU core 4662. In at least one embodiment, an instruction can access any of a local, shared, or global address space by specifying an address within a unified address space. In at least one embodiment, address mapping unit 4656 can be used to translate addresses in a unified address space into a distinct memory address that can be accessed by LSUs 4666.

In at least one embodiment, register file 4658 provides a set of registers for functional units of graphics multiprocessor 4696. In at least one embodiment, register file 4658 provides temporary storage for operands connected to data paths of functional units (e.g., GPGPU cores 4662, LSUs 4666) of graphics multiprocessor 4696. In at least one embodiment, register file 4658 is divided between each of functional units such that each functional unit is allocated a dedicated portion of register file 4658. In at least one embodiment, register file 4658 is divided between different thread groups being executed by graphics multiprocessor 4696.

In at least one embodiment, GPGPU cores 4662 can each include FPUs and/or integer ALUs that are used to execute instructions of graphics multiprocessor 4696. GPGPU cores 4662 can be similar in architecture or can differ in architecture. In at least one embodiment, a first portion of GPGPU cores 4662 include a single precision FPU and an integer ALU while a second portion of GPGPU cores 4662 include a double precision FPU. In at least one embodiment, FPUs can implement IEEE 754-2008 standard for floating point arithmetic or enable variable precision floating point arithmetic. In at least one embodiment, graphics multiprocessor 4696 can additionally include one or more fixed function or special function units to perform specific functions such as copy rectangle or pixel blending operations. In at least one embodiment one or more of GPGPU cores 4662 can also include fixed or special function logic.

In at least one embodiment, GPGPU cores 4662 include SIMD logic capable of performing a single instruction on multiple sets of data. In at least one embodiment GPGPU cores 4662 can physically execute SIMD4, SIMD8, and SIMD16 instructions and logically execute SIMD1, SIMD2, and SIMD32 instructions. In at least one embodiment, SIMD instructions for GPGPU cores 4662 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 4668 is an interconnect network that connects each functional unit of graphics multiprocessor 4696 to register file 4658 and to shared memory 4670. In at least one embodiment, memory and cache interconnect 4668 is a crossbar interconnect that allows LSU 4666 to implement load and store operations between shared memory 4670 and register file 4658. In at least one embodiment, register file 4658 can operate at a same frequency as GPGPU cores 4662, thus data transfer between GPGPU cores 4662 and register file 4658 is very low latency. In at least one embodiment, shared memory 4670 can be used to enable communication between threads that execute on functional units within graphics multiprocessor 4696. In at least one embodiment, cache memory 4672 can be used as a data cache for example, to cache texture data communicated between functional units and texture unit 4636. In at least one embodiment, shared memory 4670 can also be used as a program managed cached. In at least one embodiment, threads executing on GPGPU cores 4662 can programmatically store data within shared memory in addition to automatically cached data that is stored within cache memory 4672.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high speed interconnect such as PCIe or NVLink). In at least one embodiment, a GPU may be integrated on a same package or chip as cores and communicatively coupled to cores over a processor bus/interconnect that is internal to a package or a chip. In at least one embodiment, regardless of a manner in which a GPU is connected, processor cores may allocate work to a GPU in a form of sequences of commands/instructions contained in a WD. In at least one embodiment, a GPU then uses dedicated circuitry/logic for efficiently processing these commands/instructions.

In at least one embodiment, at least one component shown or described with respect to FIG. 46C is used to perform techniques and/or functions described in connection with FIGS. 1-15. In at least one embodiment, at least one component shown or described with respect to FIG. 46C is used to cause a first application programming interface (API) to select a second API to perform one or more software workloads identified by the first API. In at least one embodiment, at least one component shown or described with respect to FIG. 46C is used to perform a first application programming interface (API) to select a second API to monitor performance of one or more software workloads identified by the first API. In at least one embodiment, at least one component shown or described with respect to FIG. 46C is used to perform a first application programming interface (API) to select a second API to terminate performance of one or more software workloads identified by the first API. In at least one embodiment, at least one component shown or described with respect to FIG. 46C is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

### General Computing

The following figures set forth, without limitation, exemplary software constructs within general computing that can be used to implement at least one embodiment.

FIG. 47 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 4700 of a programming platform provides an execution environment for an application 4701. In at least one embodiment, application 4701 may include any computer software capable of being launched on software stack 4700. In at least one embodiment, application 4701 may include, but is not limited to, an artificial intelligence (“AI”)/machine learning (“ML”) application, a high performance computing (“HPC”) application, a virtual desktop infrastructure (“VDI”), or a data center workload.

In at least one embodiment, application 4701 and software stack 4700 run on hardware 4707. Hardware 4707 may include one or more GPUs, CPUs, FPGAs, AI engines, and/or other types of compute devices that support a programming platform, in at least one embodiment. In at least one embodiment, such as with CUDA, software stack 4700 may be vendor specific and compatible with only devices from particular vendor(s). In at least one embodiment, such as in with OpenCL, software stack 4700 may be used with devices from different vendors. In at least one embodiment, hardware 4707 includes a host connected to one more devices that can be accessed to perform computational tasks via application programming interface (“API”) calls. A device within hardware 4707 may include, but is not limited to, a GPU, FPGA, AI engine, or other compute device (but may also include a CPU) and its memory, as opposed to a host within hardware 4707 that may include, but is not limited to, a CPU (but may also include a compute device) and its memory, in at least one embodiment.

In at least one embodiment, software stack 4700 of a programming platform includes, without limitation, a number of libraries 4703, a runtime 4705, and a device kernel driver 4706. Each of libraries 4703 may include data and programming code that can be used by computer programs and leveraged during software development, in at least one embodiment. In at least one embodiment, libraries 4703 may include, but are not limited to, pre-written code and subroutines, classes, values, type specifications, configuration data, documentation, help data, and/or message templates. In at least one embodiment, libraries 4703 include functions that are optimized for execution on one or more types of devices. In at least one embodiment, libraries 4703 may include, but are not limited to, functions for performing mathematical, deep learning, and/or other types of operations on devices. In at least one embodiment, libraries 4803 are associated with corresponding APIs 4802, which may include one or more APIs, that expose functions implemented in libraries 4803.

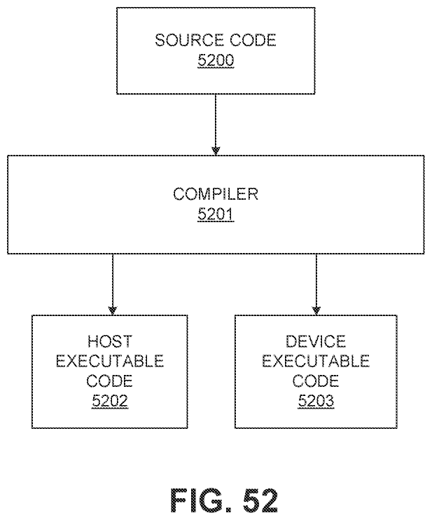

In at least one embodiment, application 4701 is written as source code that is compiled into executable code, as discussed in greater detail below in conjunction with FIG. 52. Executable code of application 4701 may run, at least in part, on an execution environment provided by software stack 4700, in at least one embodiment. In at least one embodiment, during execution of application 4701, code may be reached that needs to run on a device, as opposed to a host. In such a case, runtime 4705 may be called to load and launch requisite code on a device, in at least one embodiment. In at least one embodiment, runtime 4705 may include any technically feasible runtime system that is able to support execution of application S01.

In at least one embodiment, runtime 4705 is implemented as one or more runtime libraries associated with corresponding APIs, which are shown as API(s) 4704. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 4704 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, device kernel driver 4706 is configured to facilitate communication with an underlying device. In at least one embodiment, device kernel driver 4706 may provide low-level functionalities upon which APIs, such as API(s) 4704, and/or other software relies. In at least one embodiment, device kernel driver 4706 may be configured to compile intermediate representation (“IR”) code into binary code at runtime. For CUDA, device kernel driver 4706 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 4706 to compile IR code at runtime.

In at least one embodiment, at least one component shown or described with respect to FIG. 47 is used to perform techniques and/or functions described in connection with FIGS. 1-15. In at least one embodiment, at least one component shown or described with respect to FIG. 47 is used to cause a first application programming interface (API) to select a second API to perform one or more software workloads identified by the first API. In at least one embodiment, at least one component shown or described with respect to FIG. 47 is used to perform a first application programming interface (API) to select a second API to monitor performance of one or more software workloads identified by the first API. In at least one embodiment, at least one component shown or described with respect to FIG. 47 is used to perform a first application programming interface (API) to select a second API to terminate performance of one or more software workloads identified by the first API. In at least one embodiment, at least one component shown or described with respect to FIG. 47 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

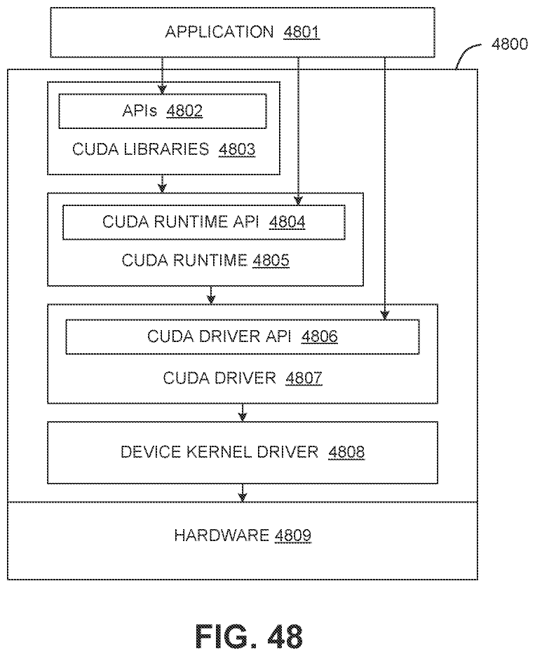

FIG. 48 illustrates a CUDA implementation of software stack 4700 of FIG. 47, in accordance with at least one embodiment. In at least one embodiment, a CUDA software stack 4800, on which an application 4801 may be launched, includes CUDA libraries 4803, a CUDA runtime 4805, a CUDA driver 4807, and a device kernel driver 4808. In at least one embodiment, CUDA software stack 4800 executes on hardware 4809, which may include a GPU that supports CUDA and is developed by NVIDIA Corporation of Santa Clara, CA.

In at least one embodiment, application 4801, CUDA runtime 4805, and device kernel driver 4808 may perform similar functionalities as application 4701, runtime 4705, and device kernel driver 4706, respectively, which are described above in conjunction with FIG. 47. In at least one embodiment, CUDA driver 4807 includes a library (libcuda.so) that implements a CUDA driver API 4806. Similar to a CUDA runtime API 4804 implemented by a CUDA runtime library (cudart), CUDA driver API 4806 may, without limitation, expose functions for memory management, execution control, device management, error handling, synchronization, and/or graphics interoperability, among other things, in at least one embodiment. In at least one embodiment, CUDA driver API 4806 differs from CUDA runtime API 4804 in that CUDA runtime API 4804 simplifies device code management by providing implicit initialization, context (analogous to a process) management, and module (analogous to dynamically loaded libraries) management. In contrast to high-level CUDA runtime API 4804, CUDA driver API 4806 is a low-level API providing more fine-grained control of a device, particularly with respect to contexts and module loading, in at least one embodiment. In at least one embodiment, CUDA driver API 4806 may expose functions for context management that are not exposed by CUDA runtime API 4804. In at least one embodiment, CUDA driver API 4806 is also language-independent and supports, e.g., OpenCL in addition to CUDA runtime API 4804. Further, in at least one embodiment, development libraries, including CUDA runtime 4805, may be considered as separate from driver components, including user-mode CUDA driver 4807 and kernel-mode device driver 4808 (also sometimes referred to as a “display” driver).

In at least one embodiment, CUDA libraries 4803 may include, but are not limited to, mathematical libraries, deep learning libraries, parallel algorithm libraries, and/or signal/image/video processing libraries, which parallel computing applications such as application 4801 may utilize. In at least one embodiment, CUDA libraries 4803 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 4803 may include deep learning libraries such as a cuDNN library of primitives for deep neural networks and a TensorRT platform for high-performance deep learning inference, among others.

In at least one embodiment, at least one component shown or described with respect to FIG. 48 is used to perform techniques and/or functions described in connection with FIGS. 1-15. In at least one embodiment, at least one component shown or described with respect to FIG. 48 is used to cause a first application programming interface (API) to select a second API to perform one or more software workloads identified by the first API. In at least one embodiment, at least one component shown or described with respect to FIG. 48 is used to perform a first application programming interface (API) to select a second API to monitor performance of one or more software workloads identified by the first API. In at least one embodiment, at least one component shown or described with respect to FIG. 48 is used to perform a first application programming interface (API) to select a second API to terminate performance of one or more software workloads identified by the first API. In at least one embodiment, at least one component shown or described with respect to FIG. 48 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

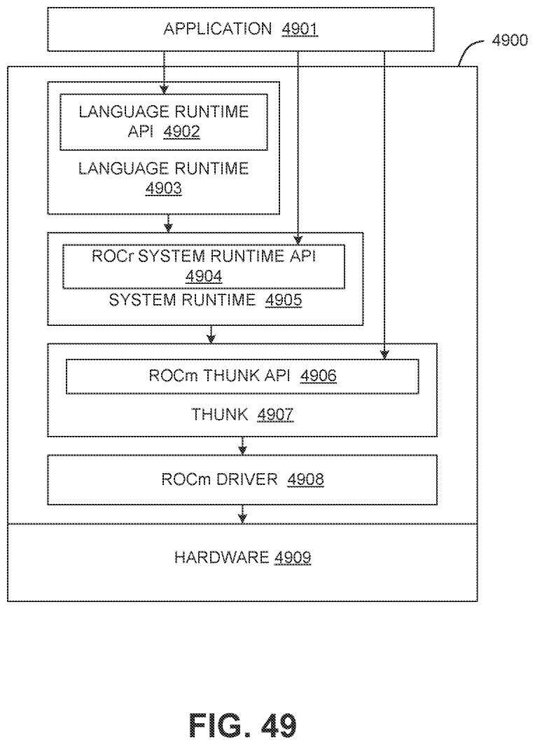

FIG. 49 illustrates a ROCm implementation of software stack 4700 of FIG. 47, in accordance with at least one embodiment. In at least one embodiment, a ROCm software stack 4900, on which an application 4901 may be launched, includes a language runtime 4903, a system runtime 4905, a thunk 4907, a ROCm kernel driver 4908, and a device kernel driver 4909. In at least one embodiment, ROCm software stack 4900 executes on hardware 4910, which may include a GPU that supports ROCm and is developed by AMD Corporation of Santa Clara, CA.

In at least one embodiment, application 4901 may perform similar functionalities as application 4701 discussed above in conjunction with FIG. 47. In addition, language runtime 4903 and system runtime 4905 may perform similar functionalities as runtime 4705 discussed above in conjunction with FIG. 47, in at least one embodiment. In at least one embodiment, language runtime 4903 and system runtime 4905 differ in that system runtime 4905 is a language-independent runtime that implements a ROCr system runtime API 4904 and makes use of a Heterogeneous System Architecture (“HAS”) Runtime API. HAS runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 4905, language runtime 4903 is an implementation of a language-specific runtime API 4902 layered on top of ROCr system runtime API 4904, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 4804 discussed above in conjunction with FIG. 48, such as functions for memory management, execution control, device management, error handling, and synchronization, among other things.

In at least one embodiment, thunk (ROCt) 4907 is an interface that can be used to interact with underlying ROCm driver 4908. In at least one embodiment, ROCm driver 4908 is a ROCk driver, which is a combination of an AMDGPU driver and a HAS kernel driver (amdkfd). In at least one embodiment, AMDGPU driver is a device kernel driver for GPUs developed by AMD that performs similar functionalities as device kernel driver 4706 discussed above in conjunction with FIG. 47. In at least one embodiment, HAS kernel driver is a driver permitting different types of processors to share system resources more effectively via hardware features.

In at least one embodiment, various libraries (not shown) may be included in ROCm software stack 4900 above language runtime 4903 and provide functionality similarity to CUDA libraries 4803, discussed above in conjunction with FIG. 48. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

In at least one embodiment, at least one component shown or described with respect to FIG. 49 is used to perform techniques and/or functions described in connection with FIGS. 1-15. In at least one embodiment, at least one component shown or described with respect to FIG. 49 is used to cause a first application programming interface (API) to select a second API to perform one or more software workloads identified by the first API. In at least one embodiment, at least one component shown or described with respect to FIG. 49 is used to perform a first application programming interface (API) to select a second API to monitor performance of one or more software workloads identified by the first API. In at least one embodiment, at least one component shown or described with respect to FIG. 49 is used to perform a first application programming interface (API) to select a second API to terminate performance of one or more software workloads identified by the first API. In at least one embodiment, at least one component shown or described with respect to FIG. 49 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

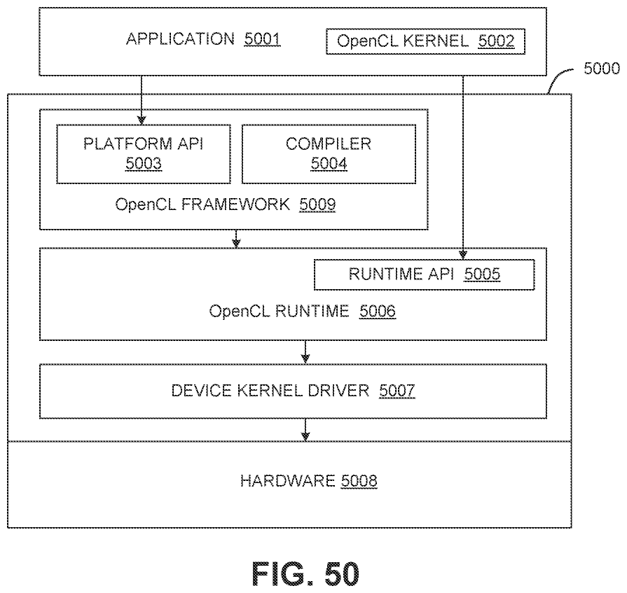

FIG. 50 illustrates an OpenCL implementation of software stack 4700 of FIG. 47, in accordance with at least one embodiment. In at least one embodiment, an OpenCL software stack 5000, on which an application 5001 may be launched, includes an OpenCL framework 5009, an OpenCL runtime 5006, and a driver 5007. In at least one embodiment, OpenCL software stack 5000 executes on hardware 4809 that is not vendor-specific. As OpenCL is supported by devices developed by different vendors, specific OpenCL drivers may be required to interoperate with hardware from such vendors, in at least one embodiment.

In at least one embodiment, application 5001, OpenCL runtime 5006, device kernel driver 5007, and hardware 5008 may perform similar functionalities as application 4701, runtime 4705, device kernel driver 4706, and hardware 4707, respectively, that are discussed above in conjunction with FIG. 47. In at least one embodiment, application 5001 further includes an OpenCL kernel 5002 with code that is to be executed on a device.

In at least one embodiment, OpenCL defines a “platform” that allows a host to control devices connected to a host. In at least one embodiment, an OpenCL framework provides a platform layer API and a runtime API, shown as platform API 5003 and runtime API 5005. In at least one embodiment, runtime API 5005 uses contexts to manage execution of kernels on devices. In at least one embodiment, each identified device may be associated with a respective context, which runtime API 5005 may use to manage command queues, program objects, and kernel objects, share memory objects, among other things, for that device. In at least one embodiment, platform API 5003 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 5004 is also included in OpenCL framework 5009. Source code may be compiled offline prior to executing an application or online during execution of an application, in at least one embodiment. In contrast to CUDA and ROCm, OpenCL applications in at least one embodiment may be compiled online by compiler 5004, which is included to be representative of any number of compilers that may be used to compile source code and/or IR code, such as Standard Portable Intermediate Representation (“SPIR-V”) code, into binary code. Alternatively, in at least one embodiment, OpenCL applications may be compiled offline, prior to execution of such applications.

In at least one embodiment, at least one component shown or described with respect to FIG. 50 is used to perform techniques and/or functions described in connection with FIGS. 1-15. In at least one embodiment, at least one component shown or described with respect to FIG. 50 is used to cause a first application programming interface (API) to select a second API to perform one or more software workloads identified by the first API. In at least one embodiment, at least one component shown or described with respect to FIG. 50 is used to perform a first application programming interface (API) to select a second API to monitor performance of one or more software workloads identified by the first API. In at least one embodiment, at least one component shown or described with respect to FIG. 50 is used to perform a first application programming interface (API) to select a second API to terminate performance of one or more software workloads identified by the first API. In at least one embodiment, at least one component shown or described with respect to FIG. 50 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

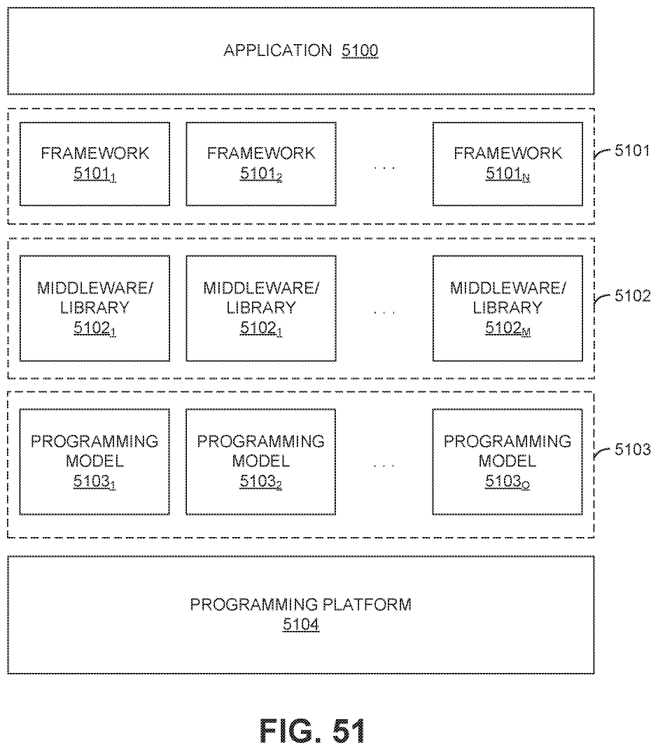

FIG. 51 illustrates software that is supported by a programming platform, in accordance with at least one embodiment. In at least one embodiment, a programming platform 5104 is configured to support various programming models 5103, middlewares and/or libraries 5102, and frameworks 5101 that an application 5100 may rely upon. In at least one embodiment, application 5100 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 5104 may be one of a CUDA, ROCm, or OpenCL platform described above in conjunction with FIG. 48, FIG. 49, and FIG. 50, respectively. In at least one embodiment, programming platform 5104 supports multiple programming models 5103, which are abstractions of an underlying computing system permitting expressions of algorithms and data structures. Programming models 5103 may expose features of underlying hardware in order to improve performance, in at least one embodiment. In at least one embodiment, programming models 5103 may include, but are not limited to, CUDA, HIP, OpenCL, C++ Accelerated Massive Parallelism (“C++ AMP”), Open Multi-Processing (“OpenMP”), Open Accelerators (“OpenACC”), and/or Vulcan Compute.

In at least one embodiment, middlewares and/or libraries 5102 provide implementations of abstractions of programming models 5104. In at least one embodiment, such libraries include data and programming code that may be used by computer programs and leveraged during software development. In at least one embodiment, such middlewares include software that provides services to applications beyond those available from programming platform 5104. In at least one embodiment, middlewares and/or libraries 5102 may include, but are not limited to, cuBLAS, cuFFT, cuRAND, and other CUDA libraries, or rocBLAS, rocFFT, rocRAND, and other ROCm libraries. In addition, in at least one embodiment, middlewares and/or libraries 5102 may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

In at least one embodiment, application frameworks 5101 depend on middlewares and/or libraries 5102. In at least one embodiment, each of application frameworks 5101 is a software framework used to implement a standard structure of application software. An AI/ML application may be implemented using a framework such as Caffe, Caffe2, TensorFlow, Keras, PyTorch, or MxNet deep learning frameworks, in at least one embodiment.

In at least one embodiment, at least one component shown or described with respect to FIG. 51 is used to perform techniques and/or functions described in connection with FIGS. 1-15. In at least one embodiment, at least one component shown or described with respect to FIG. 51 is used to cause a first application programming interface (API) to select a second API to perform one or more software workloads identified by the first API. In at least one embodiment, at least one component shown or described with respect to FIG. 51 is used to perform a first application programming interface (API) to select a second API to monitor performance of one or more software workloads identified by the first API. In at least one embodiment, at least one component shown or described with respect to FIG. 51 is used to perform a first application programming interface (API) to select a second API to terminate performance of one or more software workloads identified by the first API. In at least one embodiment, at least one component shown or described with respect to FIG. 51 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 52 illustrates compiling code to execute on one of programming platforms of FIGS. 47-50, in accordance with at least one embodiment. In at least one embodiment, a compiler 5201 receives source code 5200 that includes both host code as well as device code. In at least one embodiment, compiler 5201 is configured to convert source code 5200 into host executable code 5202 for execution on a host and device executable code 5203 for execution on a device. In at least one embodiment, source code 5200 may either be compiled offline prior to execution of an application, or online during execution of an application.

In at least one embodiment, source code 5200 may include code in any programming language supported by compiler 5201, such as C++, C, Fortran, etc. In at least one embodiment, source code 5200 may be included in a single-source file having a mixture of host code and device code, with locations of device code being indicated therein. In at least one embodiment, a single-source file may be a .cu file that includes CUDA code or a .hip.cpp file that includes HIP code. Alternatively, in at least one embodiment, source code 5200 may include multiple source code files, rather than a single-source file, into which host code and device code are separated.

In at least one embodiment, compiler 5201 is configured to compile source code 5200 into host executable code 5202 for execution on a host and device executable code 5203 for execution on a device. In at least one embodiment, compiler 5201 performs operations including parsing source code 5200 into an abstract system tree (AST), performing optimizations, and generating executable code. In at least one embodiment in which source code 5200 includes a single-source file, compiler 5201 may separate device code from host code in such a single-source file, compile device code and host code into device executable code 5203 and host executable code 5202, respectively, and link device executable code 5203 and host executable code 5202 together in a single file, as discussed in greater detail below with respect to FIG. 41.

In at least one embodiment, host executable code 5202 and device executable code 5203 may be in any suitable format, such as binary code and/or IR code. In a case of CUDA, host executable code 5202 may include native object code and device executable code 5203 may include code in PTX intermediate representation, in at least one embodiment. In a case of ROCm, both host executable code 5202 and device executable code 5203 may include target binary code, in at least one embodiment.

In at least one embodiment, at least one component shown or described with respect to FIG. 52 is used to perform techniques and/or functions described in connection with FIGS. 1-15. In at least one embodiment, at least one component shown or described with respect to FIG. 52 is used to cause a first application programming interface (API) to select a second API to perform one or more software workloads identified by the first API. In at least one embodiment, at least one component shown or described with respect to FIG. 52 is used to perform a first application programming interface (API) to select a second API to monitor performance of one or more software workloads identified by the first API. In at least one embodiment, at least one component shown or described with respect to FIG. 52 is used to perform a first application programming interface (API) to select a second API to terminate performance of one or more software workloads identified by the first API. In at least one embodiment, at least one component shown or described with respect to FIG. 52 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

FIG. 53 is a system diagram illustrating system 5300 for interfacing with an application 5302 to process data, according to at least one embodiment. In at least one embodiment, application 5302 uses large language model (LLM) 5312 to generate output data 5320 based, at least in part, on input data 5310. In at least one embodiment, input data 5310 is a text prompt. In at least one embodiment, input data 5310 includes unstructured text. In at least one embodiment, input data 5310 includes a sequence of tokens. In at least one embodiment, a token is a portion of input data. In at least one embodiment, a token is a word. In at least one embodiment, a token is a character. In at least one embodiment, a token is a subword. In at least one embodiment, input data 5310 is formatted in Chat Markup Language (ChatML). In at least one embodiment, input data 5310 is an image. In at least one embodiment, input data 5310 is one or more video frames. In at least one embodiment, input data 5310 is any other expressive medium.

In at least one embodiment, large language model 5312 comprises a deep neural network. In at least one embodiment, a deep neural network is a neural network with two or more layers. In at least one embodiment, large language model 5312 comprises a transformer model. In at least one embodiment, large language model 5312 comprises a neural network configured to perform natural language processing. In at least one embodiment, large language model 5312 is configured to process one or more sequences of data. In at least one embodiment, large language model 5312 is configured to process text. In at least one embodiment, weights and biases of a large language model 5312 are configured to process text. In at least one embodiment, large language model 5312 is configured to determine patterns in data to perform one or more natural language processing tasks. In at least one embodiment, a natural language processing task comprises text generation. In at least one embodiment, a natural language processing task comprises question answering. In at least one embodiment, performing a natural language processing task results in output data 5320.

In at least one embodiment, a processor uses input data 5310 to query retrieval database 5314. In at least one embodiment, retrieval database 5314 is a key-value store. In at least one embodiment, retrieval database 5314 is a corpus used to train large language model 5312. In at least one embodiment, a processor uses retrieval database 5314 to provide large language model 5312 with updated information. In at least one embodiment, retrieval database 5314 comprises data from an internet source. In at least one embodiment, large language model 5312 does not use retrieval database 5314 to perform inferencing.

In at least one embodiment, an encoder encodes input data 5310 into one or more feature vectors. In at least one embodiment, an encoder encodes input data 5310 into a sentence embedding vector. In at least one embodiment, a processor uses said sentencing embedding vector to perform a nearest neighbor search to generate one or more neighbors 5316. In at least one embodiment, one or more neighbors 5316 is value in retrieval database 5314 corresponding to a key comprising input data 5310. In at least one embodiment, one or more neighbors 5316 comprise text data. In at least one embodiment, encoder 5318 encodes one or more neighbors 5316. In at least one embodiment, encoder 5318 encodes one or more neighbors 5316 into a text embedding vector. In at least one embodiment, encoder 5318 encodes one or more neighbors 5316 into a sentence embedding vector. In at least one embodiment, large language model 5312 uses input data 5310 and data generated by encoder 5318 to generate output data 5320. In at least one embodiment, processor 5306 interfaces with application 5302 using large language model (LLM) application programming interface(s) (API(s)) 5304. In at least one embodiment, processor 5306 accesses large language model 5312 using large language model (LLM) application programming interface(s) (API(s)) 5304.

In at least one embodiment, output data 5320 comprise computer instructions. In at least one embodiment, output data 5320 comprise instructions written in CUDA programming language. In at least one embodiment, output data 5320 comprise instructions to be performed by processor 5306. In at least one embodiment, output data 5320 comprise instructions to control execution of one or more algorithm modules 5308. In at least one embodiment, one or more algorithm modules 5308 comprise, for example, one or more neural networks to perform pattern recognition. In at least one embodiment, one or more algorithm modules 5308 comprise, for example, one or more neural networks to perform frame generation. In at least one embodiment, one or more algorithm modules 5308 comprise, for example, one or more neural networks to generate a drive path. In at least one embodiment, one or more algorithm modules 5308 comprise, for example, one or more neural networks to generate a 5G signal. In at least one embodiment, processor 5306 interfaces with application 5302 using large language model (LLM) application programming interface(s) (API(s)) 5304. In at least one embodiment, processor 5306 may use one or more parallel computing platforms and/or programming models (e.g., NVIDIA's CUDA model).

In at least one embodiment, aspects of systems and techniques described herein in relation to FIG. 53 are incorporated into aspects of preceding figure(s). For example, in at least one embodiment, an apparatus depicted in preceding figure(s) includes processor 5306. For example, in at least one embodiment, system 5300 uses ChatGPT to write CUDA code. For example, in at least one embodiment, system 5300 uses ChatGPT to train an object classification neural network. For example, in at least one embodiment, system 5300 uses ChatGPT and a neural network to identify a driving path. For example, in at least one embodiment, system 5300 uses ChatGPT and a neural network to generate a 5G signal.

It should be noted that, while example embodiments described herein may relate to a CUDA programming model, techniques described herein can be utilized with any suitable programming model, such HIP, oneAPI (e.g., using oneAPI-based programming to perform or implement a method disclosed herein), and/or variations thereof.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

In at least one embodiment, at least one component shown or described with respect to FIG. 53 is used to perform techniques and/or functions described in connection with FIGS. 1-15. In at least one embodiment, at least one component shown or described with respect to FIG. 53 is used to cause a first application programming interface (API) to select a second API to perform one or more software workloads identified by the first API. In at least one embodiment, at least one component shown or described with respect to FIG. 53 is used to perform a first application programming interface (API) to select a second API to monitor performance of one or more software workloads identified by the first API. In at least one embodiment, at least one component shown or described with respect to FIG. 53 is used to perform a first application programming interface (API) to select a second API to terminate performance of one or more software workloads identified by the first API. In at least one embodiment, at least one component shown or described with respect to FIG. 53 is used to perform at least one aspect described with respect to block diagram 100, block diagram 200, process 300, block diagram 400, process 500, process 600, process 700, block diagram 800, block diagram 900, block diagram 1000, block diagram 1100, process 1200, block diagram 1300, block diagram 1400, block diagram 1500, and/or other systems, methods, or operations described herein.

At least one embodiment of the disclosure can be described in view of the following clauses:
1. A processor, comprising:
   one or more circuits to cause a first application programming interface (API) to select a second API to perform one or more software workloads identified by the first API.
2. The processor of clause 1, wherein the first API is to receive one or more input values indicating the one or more software workloads.
3. The processor of clause 1 or 2, wherein the first API is to receive one or more input values indicating a number of nodes to be used to perform the second API.
4. The processor of any of clauses 1-3, wherein the first API is to receive one or more input values indicating a number of tasks per node to be used to perform the second API.
5. The processor of any of clauses 1-4, wherein the first API is to receive one or more input values indicating one or more environment variables to be used to perform the second API.
6. The processor of any of clauses 1-5, wherein the first API is to receive one or more input values indicating a working directory to be used to perform the second API.
7. The processor of any of clauses 1-6, wherein the first API is to receive one or more input values indicating a launcher to be used to perform the second API.
8. The processor of any of clauses 1-7, wherein the first API is to receive one or more input values indicating one or more execution modes to be used to perform the second API.
9. A computer system, comprising:
   one or more processors and memory to store executable instructions that, if performed by the one or more processors, cause the one or more processors to cause a first application programming interface (API) to select a second API to perform one or more software workloads identified by the first API.
10. The computer system of clause 9, wherein:
   the first API is to receive one or more first input values indicating the one or more software workloads; and
   the second API is to receive one or more second input values based, at least in part, on the one or more first input values.
11. The computer system of clause 9 or 10, wherein the first API is to receive one or more input values indicating a number of nodes of a high-performance computing system to be used to perform the second API.
12. The computer system of any of clauses 9-11, wherein the first API is to receive one or more input values indicating one or more environment variables to be used to perform the second API.
13. The computer system of any of clauses 9-12, wherein the first API is to receive one or more input values indicating a working directory to be used to perform the second API.
14. The computer system of any of clauses 9-13, wherein the first API is to receive one or more input values indicating a launcher to be used to perform the second API.
15. A computer-implemented method, comprising:
   causing a first application programming interface (API) to select a second API to perform one or more software workloads identified by the first API.
16. The computer-implemented method of clause 15, wherein the first API is to receive one or more input values indicating the one or more software workloads.
17. The computer-implemented method of clause 15 or 16, wherein the first API is to receive one or more input values indicating a number of nodes to be used to perform the second API.
18. The computer-implemented method of any of clauses 15-17, wherein the first API is to receive one or more input values indicating one or more environment variables to be used to perform the second API.
19. The computer-implemented method of any of clauses 15-18, wherein the first API is to receive one or more input values indicating a launcher to be used to perform the second API.
20. The computer-implemented method of any of clauses 15-18, wherein the second API is to provide one or more output values indicating one or more job identifiers of the one or more software workloads.
21. A processor, comprising:
   one or more circuits to perform a first application programming interface (API) to select a second API to monitor performance of one or more software workloads identified by the first API.
22. The processor of clause 21, wherein the first API is to receive one or more input values indicating one or more job identifiers of the one or more software workloads.
23. The processor of clause 21 or 22, wherein the one or more software workloads are to be identified by the first API based, at least in part, on an output value of a third API to perform the one or more software workloads.
24. The processor of any of clauses 21-23, wherein the one or more software workloads are to be identified by the first API based, at least in part, on performing a third API to launch the one or more software workloads.
25. The processor of any of clauses 21-24, wherein the one or more software workloads are performed using a high-performance computing system.
26. The processor of any of clauses 21-25, wherein the one or more software workloads are performed using one or more nodes of a high-performance computing system.
27. The processor of any of clauses 21-26, wherein the second API is to provide one or more output values indicating one or more workload statuses of the one or more software workloads.
28. A computer system, comprising:
   one or more processors and memory to store executable instructions that, if performed by the one or more processors, cause the one or more processors to perform a first application programming interface (API) to select a second API to monitor performance of one or more software workloads identified by the first API.
29. The computer system of clause 28, wherein the first API is to receive one or more input values indicating one or more job identifiers of the one or more software workloads.
30. The computer system of clause 28 or 29, wherein the one or more software workloads are to be identified by the first API based, at least in part, on an output value of a third API to perform the one or more software workloads.
31. The computer system of any of clauses 22-30, wherein the one or more software workloads are to be identified by the first API based, at least in part, on performing a third API to launch the one or more software workloads.
32. The computer system of any of clauses 22-31, wherein the one or more software workloads are performed using a high-performance computing system.
33. The computer system of any of clauses 22-32, wherein the one or more software workloads are performed using one or more nodes of a high-performance computing system.
34. The computer system of any of clauses 22-33, wherein the second API is to provide one or more output values indicating one or more workload statuses of the one or more software workloads.
35. A computer-implemented method, comprising:
   performing a first application programming interface (API) to select a second API to monitor performance of one or more software workloads identified by the first API.
36. The computer-implemented method of clause 35, wherein the first API is to receive one or more input values indicating one or more job identifiers of the one or more software workloads.
37. The computer-implemented method of clause 35 or 36, wherein the one or more software workloads are to be identified by the first API based, at least in part, on performing a third API to launch the one or more software workloads.
38. The computer-implemented method of any of clauses 35-37, wherein the one or more software workloads are performed using a deep-learning computing system.
39. The computer-implemented method of any of clauses 35-38, wherein the one or more software workloads are performed using one or more nodes of a deep-learning computing system.
40. The computer-implemented method of any of clauses 35-39, wherein the second API is to provide one or more output values indicating one or more workload statuses of the one or more software workloads.
41. A processor, comprising:
   one or more circuits to perform a first application programming interface (API) to select a second API to terminate performance of one or more software workloads identified by the first API.
42. The processor of clause 41, wherein the first API is to receive one or more input values indicating one or more job identifiers of the one or more software workloads.
43. The processor of clause 41 or 42, wherein the one or more software workloads are to be identified by the first API based, at least in part, on an output value of a third API to perform the one or more software workloads.
44. The processor of any of clauses 41-43, wherein the one or more software workloads are to be identified by the first API based, at least in part, on performing a third API to launch the one or more software workloads.
45. The processor of any of clauses 41-44, wherein the one or more software workloads are performed using a high-performance computing system.
46. The processor of any of clauses 41-45, wherein the one or more software workloads are performed using one or more nodes of a high-performance computing system.
47. The processor of any of clauses 41-46, wherein the second API is to provide one or more output values indicating one or more statuses of the one or more software workloads based, at least in part, on performing the second API to terminate performance.
48. A computer system, comprising:
   one or more processors and memory to store executable instructions that, if performed by the one or more processors, cause the one or more processors to perform a first application programming interface (API) to select a second API to terminate performance of one or more software workloads identified by the first API.
49. The computer system of clause 48, wherein the first API is to receive one or more input values indicating one or more job identifiers of the one or more software workloads.
50. The computer system of clause 48 or 49, wherein the one or more software workloads are to be identified by the first API based, at least in part, on an output value of a third API to perform the one or more software workloads.
51. The computer system of any of clauses 48-50, wherein the one or more software workloads are to be identified by the first API based, at least in part, on performing a third API to launch the one or more software workloads.
52. The computer system of any of clauses 48-51, wherein the one or more software workloads are performed using a high-performance computing system.
53. The computer system of any of clauses 48-52, wherein the one or more software workloads are performed using one or more nodes of a high-performance computing system.
54. The computer system of any of clauses 48-53, wherein the second API is to provide one or more output values indicating one or more statuses of the one or more software workloads based, at least in part, on performing the second API to terminate performance.
55. A computer-implemented method, comprising:
   performing a first application programming interface (API) to select a second API to terminate performance of one or more software workloads identified by the first API.
56. The computer-implemented method of clause 55, wherein the first API is to receive one or more input values indicating one or more job identifiers of the one or more software workloads.
57. The computer-implemented method of clause 55 or 56, wherein the one or more software workloads are to be identified by the first API based, at least in part, on performing a third API to launch the one or more software workloads.
58. The computer-implemented method of any of clauses 55-57, wherein the one or more software workloads are performed using a deep-learning computing system.
59. The computer-implemented method of any of clauses 55-58, wherein the one or more software workloads are performed using one or more nodes of a deep-learning computing system.
60. The computer-implemented method of any of clauses 55-59, wherein the second API is to provide one or more output values indicating one or more statuses of the one or more software workloads based, at least in part, on performing the second API to terminate performance of the one or more software workloads.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium. In at least one embodiment, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—in at least one embodiment, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, in at least one embodiment, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising:
one or more circuits to perform a first application programming interface (API) to select a second API to terminate performance of one or more software workloads identified by the first API.

2. The processor of claim 1, wherein the first API is to receive one or more input values indicating one or more job identifiers of the one or more software workloads.

3. The processor of claim 1, wherein the one or more software workloads are to be identified by the first API based, at least in part, on an output value of a third API to perform the one or more software workloads.

4. The processor of claim 1, wherein the one or more software workloads are to be identified by the first API based, at least in part, on performing a third API to launch the one or more software workloads.

5. The processor of claim 1, wherein the one or more software workloads are performed using a high-performance computing system.

6. The processor of claim 1, wherein the one or more software workloads are performed using one or more nodes of a high-performance computing system.

7. The processor of claim 1, wherein the second API is to provide one or more output values indicating one or more statuses of the one or more software workloads based, at least in part, on performing the second API to terminate performance.

8. A computer system, comprising:
one or more processors and memory to store executable instructions that, if performed by the one or more processors, cause the one or more processors to perform a first application programming interface (API) to select a second API to terminate performance of one or more software workloads identified by the first API.

9. The computer system of claim 8, wherein the first API is to receive one or more input values indicating one or more job identifiers of the one or more software workloads.

10. The computer system of claim 8, wherein the one or more software workloads are to be identified by the first API based, at least in part, on an output value of a third API to perform the one or more software workloads.

11. The computer system of claim 8, wherein the one or more software workloads are to be identified by the first API based, at least in part, on performing a third API to launch the one or more software workloads.

12. The computer system of claim 8, wherein the one or more software workloads are performed using a high-performance computing system.

13. The computer system of claim 8, wherein the one or more software workloads are performed using one or more nodes of a high-performance computing system.

14. The computer system of claim 8, wherein the second API is to provide one or more output values indicating one or more statuses of the one or more software workloads based, at least in part, on performing the second API to terminate performance.

15. A computer-implemented method, comprising:
performing a first application programming interface (API) to select a second API to terminate performance of one or more software workloads identified by the first API.

16. The computer-implemented method of claim 15, wherein the first API is to receive one or more input values indicating one or more job identifiers of the one or more software workloads.

17. The computer-implemented method of claim 15, wherein the one or more software workloads are to be identified by the first API based, at least in part, on performing a third API to launch the one or more software workloads.

18. The computer-implemented method of claim 15, wherein the one or more software workloads are performed using a deep-learning computing system.

19. The computer-implemented method of claim 15, wherein the one or more software workloads are performed using one or more nodes of a deep-learning computing system.

20. The computer-implemented method of claim 15, wherein the second API is to provide one or more output values indicating one or more statuses of the one or more software workloads based, at least in part, on performing the second API to terminate performance of the one or more software workloads.
